(19) United States
(12) Patent Application Publication
(10) Pub. No.: US 2024/0373890 A1
(43) Pub. Date: Nov. 14, 2024

(54) SWEETENER AND FLAVORING COMPOSITIONS PREPARED BY GLYCOSYLATED MOGROSIDES OR MONK FRUIT EXTRACTS, METHOD OF MAKING AND METHOD OF USE THEREOF

(71) Applicant: EPC NATURAL PRODUCTS CO., LTD., BEIJING (CN)

(72) Inventors: Jingang SHI, BEIJING (CN); Hansheng WANG, BEIJING (CN); Thomas EIDENBERGER, WELS (AT)

(21) Appl. No.: 18/552,834

(22) PCT Filed: Mar. 28, 2022
(86) PCT No.: PCT/CN2022/083427

§ 371 Date: Sep. 27, 2023

Related U.S. Application Data
(60) Provisional application No. 63/169,499, filed on Apr. 1, 2021.

(51) Int. Cl. A23L 27/21; A23L 2/56; A23L 2/60; A23L 27/22; A23L 27/29; A23L 27/30

(52) U.S. Cl. CPC A23L 27/215; A23L 2/56; A23L 2/60; A23L 27/22; A23L 27/29; A23L 27/31; A23L 27/36

(57) ABSTRACT

A composition comprising a Maillard reaction product (MRP) prepared from one or more glycosylated mogrosides (GMGs) and/or glycosylated monk fruit extracts (GMEs) is disclosed. Also disclosed are the methods of making the composition and methods of using the composition.

### RELATED APPLICATIONS

This application claims priority to U.S. Provisional Patent Application Ser. No. 63/169,499, filed on Apr. 1, 2021, the contents of which are expressly incorporated herein by reference herein.

### FIELD

The present disclosure relates generally to sweeteners and flavoring agents, and their use in food and beverage products.

### BACKGROUND

Caloric sugars are widely used in the food and beverage industry. However, there is a growing trend toward use of more healthy alternatives, including non-caloric or low caloric sweeteners. Popular non-caloric sweeteners include high intensity synthetic sweeteners, such as aspartame (e.g., NutraSweet, Equal), sucralose (Splenda), and acesulfame potassium (also known as acesulfame K, or Ace-K), as well as high intensity natural sweeteners, which are typically derived from plants such as Stevia plants, sweet tea plants and monk fruit plants.

Despite the widespread use of non-caloric sweeteners, which are gaining in popularity, many consumers are reluctant to use these products, since their taste properties are often considered to insufficiently mimic the taste profile of caloric sugars, such as sucrose. Therefore, there is a need in further developing and enhancing the taste properties of natural and synthetic sweeteners to better reproduce the taste properties associated with conventional sugar products and provide increased consumer satisfaction.

Monk fruit (also referred to as luo han guo or swingle) extracts from Siraitia grosvenorii are cultivated on an industrial scale for their use as natural sweeteners. Mogrosides (MGs) present in the monk fruit constitute a family of triterpene glycosides responsible for sweetness in the fruit. Monk fruit extracts contain a variety of compounds classified as curcubitane-type triterpenoid glycosides, which are formed by a mogrol aglycone glycosylated with glucose units. The main compound found is mogroside V, which is known to exert a sweetness intensity 250-300 times higher than that of sucrose. By contrast, mogrosides with fewer than three glycoside units are not sweet.

However, non-caloric sweeteners are often associated with a bitter and astringent taste when used at higher concentration, thereby limiting its application in consumer products. Previous reports have suggested a high level of bitterness and metallic flavor in mogroside extract (mogroside V, 50%), similar to that found in rebaudioside A, one of the major steviol glycosides present in commercial stevia mixtures. Others have reported a relatively low bitter taste, but a high intensity of licorice flavor and general aftertaste. (Id.)

The inventors of the present application have surprisingly discovered that certain high intensity natural sweeteners derived from Siraitia grosvenorii (Swingle or monk fruit), Stevia rebaudiana, and Rubus suavissimus (Chinese sweet tea plant), and, particularly diterpene and triterpene glycosides therefrom can serve as substrates with or without reducing sugars in a Maillard reaction, producing Maillard reaction product (MRP) compositions having improved taste profiles over previously reported high intensity natural sweetener compositions.

Accordingly, there is need for using such compositions to overcome the disadvantages associated with certain high intensity natural sweeteners and provide improved sweetening and flavoring compositions for in the food and beverage industries, among others.

### SUMMARY

The present application relates to compositions comprising one or more glycosylated mogroside-Maillard reaction products (GMG-MRPs), as well as methods for making and using such compositions to improve the taste and/or flavor of a consumable product.

In one aspect, the present application is directed to a composition comprising GMG-MRP in an amount of 0.1-99.9 wt % of the composition.

In some embodiments, the GMG-MRP containing composition is a sweetening composition.

In some embodiments, the GMG-MRP containing composition is a flavoring composition.

In another embodiment, the GMG-MRP containing composition is prepared from a Maillard reaction mixture comprising a monk fruit extract.

In another embodiment, the GMG-MRP containing composition is prepared from a Maillard reaction mixture comprising one or more mogrosides selected from the group consisting of mogroside V (MGV), isomogroside V (IMGV), dehydroxy mogroside V (DMGV), 7-oxomogroside V (7-OMGV), 11-oxomogroside V (11-OMGV), mogroside II B, mogroside IIe (MGIIe), 7-oxo-mogroside II E, mogroside III (MGIII), 11-deoxy-mogroside III, mogroside IIIe (MGIIIe), mogroside III A2, mogroside IV (MGIV), mogroside IVa (MGIVa), mogroside IVe (MGIVe), -oxomogroside IV A mogroside VI (MGVI), 11-oxomogroside VI (11-OMGVI), mogroside A (MGA), 11-oxo-mogroside A1, neomogroside (NMG), mogroester (MG-E), siamenoside I (SSI), grosvenorine I (GVRI), grosvenorine II (GVRII), grosmomoside I (GMSI) and grosmomoside II (GMSII), and neomogroside.

In another embodiment, the GMG-MRP containing composition is prepared from a Maillard reaction mixture comprising a mogroside and an amine donor.

In another embodiment, the GMG-MRP containing composition is prepared from a Maillard reaction mixture comprising a mogroside, an amine donor and a reducing sugar.

In one embodiment, the present application provides a tangerine flavored GMG-MRP composition prepared from a Maillard reaction mixture comprising a GMG composition, glutamic acid, and fructose.

In another embodiment, the present application provides a caramel flavored GMG-MRP composition prepared from a Maillard reaction mixture comprising a GMG composition, alanine, and xylose.

In another embodiment, the present application provides a popcorn flavored GMG-MRP composition prepared from a Maillard reaction mixture comprising a GMG composition, proline and rhamnose.

In another embodiment, the present application provides a honey flavored GMG-MRP composition prepared from a Maillard reaction mixture comprising a GMG composition, phenylalanine, and xylose.

In some embodiments, the GMG-MRP containing composition further comprises one or more MGs, GMGs, monk fruit extracts, glycosylated monk fruit extracts, triterpene glycosides naturally present in monk fruit, or a combination thereof.

In some embodiments, the GMG-MRP containing composition further comprises one or more conventional MRPs (C-MRPs).

In some embodiments, the GMG-MRP containing composition further comprises one or more monk fruit ingredients selected from the group consisting of polysaccharides, polyphenols, flavonoids, di-terpene glycosides, and mono-terpene glycosides.

In some embodiments, the GMG-MRP containing composition further comprises one or more high intensity sweeteners.

In some embodiments, the GMG-MRP containing composition further comprises one or more high intensity natural sweeteners.

In some embodiments, the GMG-MRP containing composition further comprises one or more components selected from the group consisting of SGs, SEs, GSGs, GSEs, STGs, STEs, GSTGs, GSTEs, S-MRPs, ST-MRPs, C-MRPs, sucralose, aspartame, acesulfame-K, neotame, saccharin and aspartame, glycyrrhizic acid ammonium salt, sodium cyclamate, saccharin, advantame, neohesperidin dihydrochalcone (NHDC), mixtures thereof, salts thereof, and derivatives thereof.

In some embodiments, the GMG-MRP containing composition further comprises one or more components selected from the group Reb-A, Reb-M, Reb-D, combinations thereof, and stevia extracts thereof.

Another aspect of the present application relates to a consumable product comprising one or more GMG-MRPs in a total amount of 0.00001-99.9 wt %.

In some embodiments, the GMG-MRP containing consumable product is selected from the group consisting of beverage products, confections, condiments, dairy products, cereal compositions, chewing compositions, tabletop sweetener compositions, medicinal compositions, oral hygiene compositions, cosmetic compositions, and smokable compositions.

In some embodiments, the GMG-MRP containing consumable product is a beverage selected from the group consisting of water, fruit juices, teas, carbonated beverages, dairy beverages, and functional beverages.

In some embodiments, the consumable product comprises one or more GMG-MRPs and one or more components selected from the group consisting of SGs, SEs, GSGs, GSEs, STGs, STEs, GSTGs, GSTEs, S-MRPs, ST-MRPs, C-MRPs, sucralose, aspartame, acesulfame-K, neotame, saccharin and aspartame, glycyrrhizic acid ammonium salt, sodium cyclamate, saccharin, advantame, neohesperidin dihydrochalcone (NHDC), mixtures thereof, salts thereof, and derivatives thereof, wherein each of the GMG-MRPs or the one or more components is present in the consumable product in a concentration ranging from 0.0001 wt % to 99.9999 wt %, 0.0001 wt % to 75 wt %, 0.0001 wt % to 50 wt %, 0.0001 wt % to 25 wt %, 0.0001 wt % to 10 wt %, 0.0001 wt % to 5 wt %, 0.0001 wt % to 1 wt %, 0.0001 wt % to 0.5 wt %, 0.0001 wt % to 0.2 wt %, 0.0001 wt % to 0.05 wt %, 0.0001 wt % to 0.01 wt %, 0.0001 wt % to 0.005 wt %, or any range derived from any two of these values.

In another aspect, the present application provides a method for modifying a consumable product, comprising adding to the consumable product one or more GMG-MRPs at a final concentration ranging from 0.0001 wt % to 99.9999 wt %, 0.0001 wt % to 75 wt %, 0.0001 wt % to 50 wt %, 0.0001 wt % to 25 wt %, 0.0001 wt % to 10 wt %, 0.0001 wt % to 5 wt %, 0.0001 wt % to 1 wt %, 0.0001 wt % to 0.5 wt %, 0.0001 wt % to 0.2 wt %, 0.0001 wt % to 0.05 wt %, 0.0001 wt % to 0.01 wt %, 0.0001 wt % to 0.005 wt %, or any range derived from any two of these values.

In one embodiment, the consumable product is a beverage product, wherein the one or more GMG-MRPs are added in a final concentration range of 1-15,000 ppm.

In another embodiment, the consumable product is a food product, wherein the one or more GMG-MRPs are added at a final concentration ranging from 0.0001 wt % to 99.9999 wt %, 0.0001 wt % to 75 wt %, 0.0001 wt % to 50 wt %, 0.0001 wt % to 25 wt %, 0.0001 wt % to 10 wt %, 0.0001 wt % to 5 wt %, 0.0001 wt % to 1 wt %, 0.0001 wt % to 0.5 wt %, 0.0001 wt % to 0.2 wt %, 0.0001 wt % to 0.05 wt %, 0.0001 wt % to 0.01 wt %. 0.0001 wt % to 0.005 wt %, or any range derived from any two of these values.

In another embodiment, the present application provides a method for modifying a consumable product, comprising adding to the consumable product one or more GMG-MRPs in combination with one or more components selected from the group consisting of MGs, MEs, MCs, GMGs, GMEs, GMCs, SGs, SEs, GSGs, GSEs, STGs, STEs, GSTGs, GSTEs, S-MRPs, ST-MRPs, C-MRPs, sucralose, aspartame, acesulfame-K, neotame, saccharin and aspartame, glycyrrhizic acid ammonium salt, sodium cyclamate, saccharin, advantame, neohesperidin dihydrochalcone (NIDC), mixtures thereof, salts thereof, and derivatives thereof.

### BRIEF DESCRIPTION OF THE DRAWINGS

FIG. 1 shows a schematic diagram of a typical time-intensity curve.

### DETAILED DESCRIPTION

### I. Definitions

Unless defined otherwise, all technical and scientific terms used herein have the same meanings as commonly understood by one of ordinary skill in the art to which this application belongs. All publications and patents specifically mentioned herein are incorporated by reference in their entirety for all purposes including describing and disclosing the chemicals, instruments, statistical analyses, and methodologies which are reported in the publications which might be used in connection with the application. All references cited in this specification are to be taken as indicative of the level of skill in the art. Nothing herein is to be construed as an admission that the application is not entitled to antedate such disclosure by virtue of prior invention.

In the specification and in the claims, the terms “including” and “comprising” are open-ended terms and should be interpreted to mean “including, but not limited to . . . . ” These terms encompass the more restrictive terms “consisting essentially of” and “consisting of.”

It must be noted that as used herein and in the appended claims, the singular forms “a,” “an,” and “the” include plural reference unless the context clearly dictates otherwise. Further, the terms “a” (or “an”), “one or more” and “at least one” can be used interchangeably herein. It is also to be noted that the terms “comprising,” “including,” “characterized by” and “having” can be used interchangeably. Further, any reactant concentrations described herein should be considered as being described on a weight to weight (w/w) basis, unless otherwise specified to the contrary (e.g., mole to mole, weight to volume (w/v), etc.).

As used herein, the term “glycoside” refers to a molecule in which a sugar (the “glycone” part or “glycone component” of the glycoside) is bonded to a non-sugar (the “aglycone” part or “aglycone component”) via a glycosidic bond.

The terms “glycosidic bond” and “glycosidic linkage” refer to a type of chemical bond or linkage formed between the anomeric hydroxyl group of a saccharide or saccharide derivative (glycone) and the hydroxyl group of another saccharide or a non-saccharide organic compound (aglycone) such as an alcohol. The reducing end of the di- or polysaccharide lies towards the last anomeric carbon of the structure, whereas the terminal end lies in the opposite direction.

By way of example, a glycosidic bond in steviol and isosteviol involves the hydroxyl-group at the sugar carbon atom numbered 1 (so-called anomeric carbon atom) and a hydroxyl-group in the C19 carbonyl group of the steviol or isosteviol molecule building up a so-called O-glycoside or glycosidic ester. Additional glycosidic ester linkages can be formed at the hydroxyl group at C13 of steviol and at the carbonyl oxygen at C16 of isosteviol. Linkages at carbon atoms in the C1, C2, C3, C6, C7, C11, C12 and C15 positions of both steviol and isosteviol yield C-glycosides. In addition, C-glycosides can also be formed at the 2 methyl groups at C18 and C20 in both steviol and isosteviol.

The sugar part can be selected from any sugar with 3-7 carbon atoms, derived from either a dihydroxy-acetone (ketose) or a glycerin-aldehyde (aldose). The sugars can occur in open chain or in cyclic form, as D- or L-enantiomers and in α- or β-conformation. Representative structures of sugar (Sug) conformations exemplified by glucose include D-glucopyranose and L-glucopyranose in which the position 1 is determinative of the α- or β-conformation:

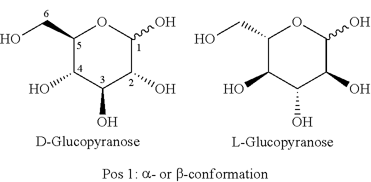 [SMILES: OC[C@H]1OC(O)[C@H](O)[C@@H](O)[C@@H]1O ; OC[C@@H]1OC(O)[C@@H](O)[C@H](O)[C@H]1O]

The term “terpene” is used with reference to a large and diverse class of organic hydrocarbon molecules classified according to the number of isoprene units in the molecule. Although terpenoids are sometimes used interchangeably with “terpenes”, terpenoids (or isoprenoids) are modified terpenes as they contain additional functional groups, usually oxygen-containing. The term “terpene” includes hemiterpenes (isoprene, single isoprene unit), monoterpenes (two isoprene units), sesquiterpenes (three isoprene units), diterpenes (four isoprene units), sesterterpenes (five isoprene units), triterpenes (six isoprene units), sesquarterpenes (seven isoprene units), tetraterpenes (eight isoprene units) and polyterpenes (long chains of many isoprene units).

The term “terpenoid” is used with reference to a large and diverse class of organic molecules derived from terpenes, more specifically five-carbon isoprenoid units assembled and modified in a variety of ways and classified in groups based on the number of isoprenoid units used in group members. Although terpenoids are sometimes used interchangeably with “terpenes”, terpenoids (or isoprenoids) are modified terpenes as they contain additional functional groups, usually oxygen-containing. Similar to the nomenclature for terpenes, the term “terpenoids” includes hemiterpenoids, monoterpenoids, sesquiterpenoids, diterpenoids, sesterterpenoids, triterpenoids, tetraterpenoids and polyterpenoids.

The terms “terpene glycoside” and “terpene sweetener” refer to a compound having a terpene aglycone linked by a glycosidic bond to a glycone. Terpene glycosides include, but are not limited to, diterpene glycosides, such as steviol glycosides and suaviosides, and triterpene compounds, such as mogrosides.

Exemplary diterpene glycosides include glycosides from Stevia rebaudiana and Rubus suavissimus (sweet tea) and include steviol glycosides, such as steviol monoside, rebaudioside A, rebaudioside B, stevioside, rubusoside, as well as kaurane-type diterpene glycosides found in sweet tea plants, such as the sweet tasting suaviosides B (SU-B), SU-G, SU-H, SU-I and SU-J, respectively. Additional SUs include bitter suaviosides, such as SU-C1, SU-D2, SU-F and tasteless suaviosides, such as SU-D1 and SU-E.

Exemplary triterpene glycosides from plants or extracts include those derived from the fruit of Siraitia grosvenorii (also referred to monk fruit, luo han guo or swingle), including mogrosides and others described herein.

The term “mogroside” or “MG”, as used herein, refers to a family of triterpene glycosides isolated from the fruit of Siraitia grosvenorii (Swingle), also known as Momordica grosvenori (Swingle), Luo Han Guo or monk fruit. Monk fruit extracts are commercially used as natural sweeteners. Mogrosides are responsible for sweetness. Exemplary mogrosides from monk fruit for use in accordance with the present application include, but are not limited to, mogroside V (MGV), isomogroside V (IMGV), dehydroxy mogroside V (DMGV), 7-oxomogroside V (7-OMGV), 11-oxomogroside V (11-OMGV), mogroside IIb, mogroside IIe (MGIIe), 7-oxo-mogroside IIe, mogroside III (MGIII), 11-deoxy-mogroside III, mogroside IIIe (MGIIIe), mogroside IIIa2, mogroside IV (MGIV), mogroside IVa (MGIVa), mogroside IVe (MGIVe), -oxomogroside IVa, mogroside VI (MGVI), 11-oxomogroside VI (11-OMGVI), mogroside A (MGA), 11-oxo-mogroside A1, neomogroside (NMG), mogroester (MG-E), siamenoside I (SSI), grosvenorine I (GVRI), grosvenorine II (GVRII), grosmomoside I (GMSI) and grosmomoside II (GMSII), and neomogroside.

MGV is a mogrol glycoside containing five sugar residues per molecule. The chemical structures of e.g., MGV, MGIIe, MGIII and MGIV are represented by formula (I) below. In recent years, various extraction and purification methods have been developed which can provide monk fruit extracts having a relatively high content of MGV. Such extracts are now being marketed as non-caloric natural sweeteners in some countries.

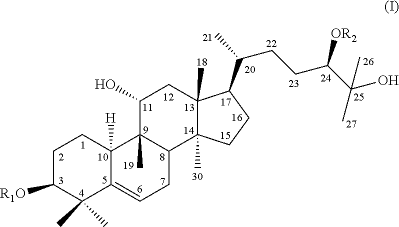

| Compound | | | |
|---|---|---|---|
| name | R₁ | R₂ | R₃ |
| Mogrol | H | H | α-OH |
| Mogroside IA | H | Glc(β1 | H₂ |
| Mogroside IE1 | Glc(β1 | H | α-OH |
| Mogroside IIA1 | H | Glc(β1-6)Glc(β1 | α-OH |
| Mogroside IIA2 | Glc(β1-6)Glc(β1 | H | α-OH |
| Mogroside IIE | Glc(β1 | Glc(β1 | α-OH |
| Mogroside IIIA1 | H | Glc(β1-6) | α-OH |
| | | [Glc(β1-2)]Glc(β1 | |
| Mogroside IIIA2 | Glc(β1-6)Glc(β1 | Glc(β1 | α-OH |
| Mogroside IIIE | Glc(β1 | Glc(β1-6)Glc(β1 | α-OH |
| Mogroside IVA | Glc(β1-6)Glc(β1 | Glc(β1-6)Glc(β1 | α-OH |
| Mogroside IVE | Glc(β1-6)Glc(β1 | Glc(β1-6)Glc(β1 | α-OH |
| Mogroside V | Glc(β1-6)Glc(β1 | Glc(β1-6) | α-OH |
| | | [Glc(β1-2)]Glc(β1 | |
| Mogroside VI | Glc(β1-6) | Glc(β1-6) | α-OH |
| | [Glc(β1-2)] | [Glc(β1-2)]Glc(β1 | |
| | Glc(β1 | | |

As used herein, the terms “glycosylated MG” and “GMG” refer to a glycosylated mogroside, glycosylated monk fruit extract prepared by glycosylating a monk fruit extract. As such, a GMG is used with reference to a mogroside or mogroside extract that has been subjected to an exogenous glycosylation process. Alternatively, a MG or GMG may be artificially produced by chemical synthesis, by a fermentation process or by another enzymatic process. It should be understood that glycosylation products produced from an MG composition or extract may contain unreacted starting materials. For example, a GMG may contain glycosylated mogrosides (GMGs), unreacted mogrosides (MGs), and unreacted sugar donors, such as maltodextrin.

As used herein, the acronym “GMGVx” refers to a glycosylated MGV (GMGV) composition with about x % GMGV by weight. For example, the acronym “GMGV50” refers to a composition with about 50% GMGV by weight. In some embodiments, the acronym “GMGVx” refers to a GMGV composition with GMGV in an amount of (x−5)% to (x+5)% by weight. In some embodiments, the acronym “GMGVx” refers to a GMGV composition with GMGV in an amount of (x−10)% to (x+10)% by weight.

The term “enriched GMGV” refers to a GMGV composition or monk fruit extract that contains at least 5% GMGV by weight. Preferably an enriched GMGV composition is prepared from monk fruit plants. Alternatively, an enriched GMGV composition is prepared by fermentation or from a chemical or enzymatic process. In particular embodiments, the term “enriched GMGV” refers to a GMGV composition that contains at least 5%, 10%, 15%, 20%, 25%, 30%, 35%, 40% or 45% GMGV by weight or any range specified by two of these values.

The term “purified GMGV” refers to a GMGV composition prepared from monk fruit plants, from a chemical or enzymatic process or prepared by fermentation that contains at least 50% MGV by weight. A purified GMGV composition may be prepared. In some embodiments, the term “purified GMGV” or “purified GMGV composition” refers to a GMGV preparation that contains at least 60%, 70%, 80%, 85%, 90%, 95%, 96%, 97%, 98%, or 99% GMGV by weight or any range specified by two of these values.

The term “non-GMGV” refers to a GMG that is not GMGV. A non-GMGV may be prepared from monk fruit plants, from a chemical or enzymatic process or prepared by fermentation. The non-GMGV can be a volatile compound or a non-volatile compound.

The terms “steviol glycoside,” and “SG” are used interchangeably with reference to a glycoside of steviol, a diterpene compound shown in Formula I, wherein one or more sugar residues are attached to the steviol compound of Formula I.

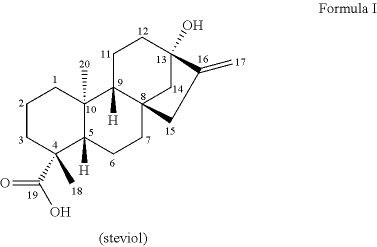

Steviol glycosides also include glycosides of isomers of steviol (isosteviol) as depicted in Formula II below, and derivatives of steviol, such as 12α-hydroxy-steviol and 15α-hydroxy-steviol.

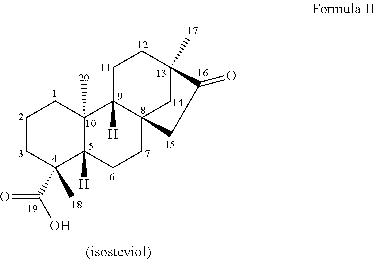

Stevia plants contain a variety of different SGs in varying percentages. The phrase “steviol glycoside” is recognized in the art and is intended to include the major and minor constituents of Stevia. These “SGs” include, for example, stevioside, steviolbioside, rebaudioside A (RA), rebaudioside B (RB), rebaudioside C (RC), rebaudioside D (RD), rebaudioside E (RE), rebaudioside F (RF), rebaudioside M (RM), rebaudioside O (RO), rebaudioside H (RH), rebaudioside I (RI), rebaudioside L (RL), rebaudioside N (RN), rebaudioside K (RK), rebaudioside J (RJ), rebaudioside U, rubusoside, dulcoside A (DA) as well as those listed in Tables A and B or mixtures thereof.

As used herein, the terms “rebaudioside A,” “Reb A,” “Reb-A” and “RA” are equivalent terms referring to the same molecule. The same condition applies to all lettered rebaudiosides except for rebaudioside U, which may be referred to as Reb-U or Reb U, but not RU, so as to not be confused with rubusoside which is also referred to as RU.

The steviol glycosides for use in the sweetener or flavor compositions of the present application may be present in their native form or they may be further glycosylated. The steviol glycosides for use in the present application are not limited by source or origin. Steviol glycosides may be extracted from Stevia leaves, Sweet tea leaves, or they may be synthesized by an enzymatic process, by chemical syntheses, or by a fermentation process.

The term “glycosylated steviol glycoside” or “GSG” refers to a molecule that contains a SG backbone and one or more additional sugar residues, which can be produced by enzymatic conversion from an SG, from fermentation or from chemical synthesis.

The terms “ST plant”, “Chinese sweet tea plant”, “sweet tea plant”, and “Rubus suavissimus plant” are used interchangeably with reference to a Rubus suavissimus plant.

The term “sweet tea glycoside” or “STG” refers to a glycoside naturally found in sweet tea plants. Exemplary STGs include, but are not limited to rubusoside, various suaviosides, steviolmonoside, rebaudioside A, 13-O-β-D-glucosyl-steviol, isomers of rebaudioside B, isomers of stevioside, panicloside IV and sugeroside.

The term “sauvioside” refers to a group of kaurane-type diterpene glycosides that can be isolated from the leaves of the leaves of the sweet tea plant, Rubus suavissimus. Exemplary suaviosides (SUs) include, but are not limited to, SU-A, SU-B, SU-C1, SU-D1, SU-D2, SU-E, SU-F, SU-G, SU-H, SU-I, and SU-J.

The terms “rubusoside” or “RU” are used interchangeably with reference to a steviol glycoside that is structurally characterized as a steviol in which both the carboxy group and the tertiary allylic hydroxy group have been converted to their corresponding beta-D-glucosides. Rubusoside may be extracted from a natural source, e.g., leaves from Rubus suavissimus, produced by a chemical or enzymatic process, or produced by fermentation.

The term “sweet tea extract (STE)” refers to an extract prepared from the whole ST plant, in the aerial part of an ST plant, in the leaves of an ST plant, in the flowers of an ST plant, in the fruit of an ST plant, in the seeds of an ST plant, in the roots of an ST plant, branches of an ST plant, and/or any other portions of an ST plant. It should also be understood that a sweet tea extract (STE) can be purified and/or separated into one or more sweet tea glycosides or sweet tea components therefrom.

Additional compounds present in sweet tea plants and extracts derived therefrom include ent-16α,17-dihydroxy-kaurane-19-oic acid, ent-13-hydroxy-kaurane-16-en-19-oic acid, ent-kaurane-16-en-19-oic-13-O-β-D-glucoside, ent-16,17-dihydroxy-kaurane-3-one, ent-16α,17-dihydroxy-kaurane-19-oic acid, ent-kaurane-16β,17-diol-3-one-17-O-β-D-glucoside, ent-16α,17-dihydroxy-kaurane-3-one, ent-kaurane-3α,16β,17-3-triol, ent-13,17-dihydroxy-kaurane-15-en-19-oic acid, ellagic acid, gallic acid, oleanolic acid, ursolic acid, rutin, quercetin, and isoquercitrin.

As used herein, the acronym “RUx” is used with reference to a sweet tea extract (ST-E) that is defined by its concentration of RU. More particularly, the acronym “RUx” refers to a sweet tea extract (ST-E) containing rubusoside (RU) in amount of ≥x % and <(x+10)%, except as otherwise noted, where e.g., the acronym “RU100” specifically refers to pure RU; the acronym “RU99.5” specifically refers to a composition where the amount of RA is ≥99.5 wt %, but <100 wt %; the acronym “RU99” specifically refers to a composition where the amount of RU is ≥99 wt %, but <100 wt %; the acronym “RU98” specifically refers to a composition where the amount of RU is ≥98 wt %, but <99 wt %; the acronym “RU97” specifically refers to a composition where the amount of RU is ≥97 wt %, but <98 wt %; the acronym “RAU95” specifically refers to a composition where the amount of RU is ≥95 wt %, but <97 wt %; the acronym “RU85” specifically refers to a composition where the amount of RU is ≥85 wt %, but <90 wt %; the acronym “RU75” specifically refers to a composition where the amount of RU is ≥75 wt %, but <80 wt %; the acronym “RU65” specifically refers to a composition where the amount of RU is ≥65 wt %, but <70 wt %; the acronym “RU20” specifically refers to a composition where the amount of RU is ≥15 wt %, but <30 wt %. Sweet tea extracts include, but are not limited to, RU10, RU20, RU30, RU40, RU50, RU60, RU80, RU90, RU95, RU97, RU98, RU99, RU99.5, or any integer defining a lower limit of RU wt %.

The term “purified RU” refers to an RU preparation that contains at least 50% RU by weight. Purified RU may be prepared from a natural source, such a Stevia extract or a sweet tea extract, or produced by a chemical or enzymatic process, or fermentation. In some embodiments, the term “purified RU” refers to an RU preparation that contains at least 60%, 70%, 80%, 85%, 90%, 95%, 96%, 97%, 98%, or 99% RU by weight.

The term “enriched RU” refers to an RU preparation that contains at least 5% RU by weight. Enriched RU may be prepared from a natural source, such a Stevia extract or a sweet tea extract, or produced by a chemical or enzymatic process, or fermentation. In some embodiments, the term “enriched RU” refers to an RU preparation that contains at least 5%, 10%, 15%, 20%, 25%, 30%, 35%, 40% or 45% RU by weight.

The terms “non-RU STC” or “non-RU-STG” refers to a STC or STG that is not RU. A non-RU STC or non-RU STG may be purified from a natural source, or produced by a chemical or enzymatic process, or fermentation. The non-RU STC can be a volatile compound or a non-volatile compound.

The term “glycosylated sweet tea extract (GSTE)” refers to a STE that has been subjected to an exogenously preformed glycosylation process. A GSTE may be artificially produced by enzymatic conversion or fermentation. It should be understood that a glycosylation product of STE may contain unreacted starting materials. For example, a GSTE may contain glycosylated sweet tea components, unreacted sweet tea components, and unreacted sugar donors such as maltodextrin.

The term “glycosylated sweet tea component (GSTC)” refers to a STC that has been subjected to an exogenously preformed glycosylation process. A GSTC may be artificially produced by enzymatic conversion, fermentation, or chemical synthesis.

The term “glycosylated sweet tea glycoside (GSTG)” refers to a molecule that (1) contains a STG backbone and one or more additional sugar residues, and (2) is artificially produced by enzymatic conversion, fermentation, or chemical synthesis.

The terms “glycosylated rubusoside”, “glycosylated RU” and “GRU” are used interchangeably with reference molecules having an RU backbone (with a molecular weight of 641) and additional sugar units added in a glycosylation reaction under man-made conditions. GRUs include, but are not limited to, molecules having an RU backbone and 1-50 additional sugar units. As used herein, the term “sugar unit” refers to a monosaccharide unit.

Examples of mono-glucosylated RU include, but are not limited to, the molecules listed in Table A below.

TABLE A
Mono-glucosylated forms of RU.

| | Position 19 | Position 13 | |
|---|---|---|---|
| Rubusoside (RU) | β-glc (1′ (19)) | β-glc (1′ (13)) | Common Name |
| Mono-Glc RU | β-glc (1-2′ (19)) | — | Reb-KA |
| | β-glc (1-3′ (19)) | — | Stevioside B |
| | β-glc (1-4′ (19)) | — | |
| | β-glc (1-6′ (19)) | — | |
| | α-glc (1-2′ (19)) | — | |
| | α-glc (1-3′ (19)) | — | |
| | α-glc (1-4′ (19)) | — | |
| | α-glc (1-6′ (19)) | — | |
| | — | β-glc (1-2′ (13)) | Stevioside |

The term “glycosylated suavioside,” “glycosylated SU’ and “GSU” are used interchangeably with reference to an exogenously glycosylated suavioside.

As used herein, the term “enzymatically catalyzed method” refers to a method that is performed under the catalytic action of an enzyme, in particular a glycosidase or a glycosyltransferase. The method can be performed in the presence of said glycosidase or glycosyltransferase in isolated (purified, enriched) or crude form.

The term “glycosyltransferase” (GT) refers to an enzyme that catalyzes the formation of a glycosidic linkage to form a glycoside. As used herein, the term “glycosyltransferase” also includes variants, mutants, and enzymatically active portions of glycosyltransferases. Likewise, the term “glycosidase” also includes variants, mutants, and enzymatically active portions of glycosidases.

The term “monosaccharide” as used herein refers to a single unit of a polyhydroxyaldehyde forming an intramolecular hemiacetal the structure of which including a six-membered ring of five carbon atoms and one oxygen atom. Monosaccharides may be present in different diasteromeric forms, such as a or R anomers, and D or L isomers. An “oligosaccharide” consists of short chains of covalently linked monosaccharide units. Oligosaccharides comprise disaccharides which include two monosaccharide units, as well as trisaccharides which include three monosaccharide units. A “polysaccharide” consists of long chains of covalently linked monosaccharide units.

As used herein, the term “Maillard reaction” refers to a non-enzymatic reaction of (1) one or more reducing and/or non-reducing sugars, and (2) one or more amine donors in the presence of heat, wherein the non-enzymatic reaction produces a Maillard reaction product and/or a flavor. Thus, this term is used unconventionally, since it accommodates the use of non-reducing sweetening agents as substrates, which were not heretofore thought to serve as substrates for the Maillard reaction.

The term “reaction mixture” refers to a composition comprising at least one amine donor and one sugar donor, wherein the reaction mixture is to be subjected to a Maillard reaction; a “reaction mixture” is not to be construed as the reaction contents after a Maillard reaction has been conducted, unless otherwise noted.

The term “sugar,” as used herein, refers to a sweet-tasting, soluble carbohydrate, typically used in consumer food and beverage products.

The term “sugar donor,” as used herein, refers to a sweet-tasting compound or substance from natural or synthetic sources, which can participate as a substrate in a Maillard reaction with an amine group-containing donor molecule.

The term “amine donor,” as used herein, refers to a compound or substance containing a free amino group, which can participate in a Maillard reaction.

The term “Maillard reaction product” or “MRP” refers to any compound produced by a Maillard reaction between an amine donor and a sugar donor in the form of a reducing sugar, non-reducing sugar, or both. Preferably, the sugar donor includes at least one carbonyl group. In certain embodiments, the MRP comprises a compound that provides a flavor (“Maillard flavor”), a color (“Maillard color”), or both.

As used hereinafter, the term “conventional MRP” (C-MRP) refers to an MRP formed from a reaction mixture that contains (1) one or more mono and/or disaccharides as sugar donor and (2) one or more free amino acids as amine donor(s).

The term “GMG-MRP” refers to one or more Maillard reaction product(s) or MRP(s) that are produced from a Maillard reaction mixture containing a GMG, GMGE or non-GMGV-MRP. A GMGE may be defined by its content of a particular mogroside, such as a GMGV50 extract. In some embodiments, a GMG-MRP is produced from a Maillard reaction mixture that does not include a conventional reducing sugar donor.

The terms “Stevia-MRP” and “S-MRP” refer to the product of a Maillard reaction, where the starting material of the Maillard reaction comprises a Stevia extract (SE), a steviol glycoside (SG), a glycosylated Stevia extract (GSE), a glycosylated steviol glycoside (GSG) or a combination thereof.

The terms “sweet tea-MRP” and “ST-MRP” refer to the product of a Maillard reaction, where the starting material of the Maillard reaction comprises a sweet tea glycoside (STG), sweet tea extract (STE), sweet tea component (STC), glycosylated sweet tea glycoside (GSTG), glycosylated sweet tea extract (GSTE), glucosylated sweet tea component (GSTC), or a combination thereof.

The generic terms “MRP composition,” “Maillard product composition” and “Maillard flavor composition” are used interchangeably with reference to a composition comprising one or more GMG-MRP(s), MG-MRP(s), S-MRP(s), ST-MRP(s), C-MRP(s) or a combination thereof.

The term “thaumatin”, as used herein, is used generically with reference to thaumatin I, II, III, a, b, c, etc. and/or combinations thereof.

The term “non-volatile”, as used herein, refers to a compound having a negligible vapor pressure at room temperature, and/or exhibits a vapor pressure of less than about 2 mm of mercury at 20° C.

The term “volatile”, as used herein, refers to a compound having a measurable vapor pressure at room temperature, and/or exhibits a vapor pressure of, or greater than, about 2 mm of mercury at 20° C.

As used herein, the term “sweetener” generally refers to a consumable product, which produces a sweet taste when consumed alone. Examples of sweeteners include, but are not limited to, high-intensity sweeteners, bulk sweeteners, sweetening agents, and low sweetness products produced by synthesis, fermentation, or enzymatic conversion methods.

As used herein the term “high-intensity sweetener,” refers to any synthetic or semi-synthetic sweetener or sweetener found in nature. High-intensity sweeteners are compounds or mixtures of compounds which are sweeter than sucrose. High-intensity sweeteners are typically many times (e.g., 20 times and more, 30 times and more, 50 times and more or 100 times sweeter than sucrose). For example, sucralose is about 600 times sweeter than sucrose, sodium cyclamate is about 30 times sweeter, Aspartame is about 160-200 times sweeter, and thaumatin is about 2000 times sweeter than sucrose (the sweetness depends on the tested concentration compared with sucrose).

High-intensity sweeteners are commonly used as sugar substitutes or sugar alternatives because they are many times sweeter than sugar but contribute only a few to no calories when added to foods. High-intensity sweeteners may also be used to enhance the flavor of foods. High-intensity sweeteners generally will not raise blood sugar levels.

As used herein, the term “high intensity natural sweetener,” refers to sweeteners found in nature, typically in plants, which may be in raw, extracted, purified, refined, or any other form, singularly or in combination thereof. High intensity natural sweeteners characteristically have higher sweetness potency, but fewer calories than sucrose, fructose, or glucose. Examples of high intensity natural sweetener include, but are not limited to, sweet tea extracts, stevia extracts, swingle extracts, steviol glycosides, suaviosides, mogrosides, mixtures thereof, salts thereof, and derivatives thereof.

As used herein, the term “high intensity synthetic sweetener” or “high intensity artificial sweetener” refers to high intensity sweeteners that are not found in nature. High intensity synthetic sweeteners include “high intensity semi-synthetic sweeteners” or “high intensity semi-artificial sweeteners”, which are synthesized from, artificially modified from, or derived from natural products. Examples of high intensity synthetic sweeteners include, but are not limited to, sucralose, aspartame, acesulfame-K, neotame, saccharin and aspartame, glycyrrhizic acid ammonium salt, sodium cyclamate, saccharin, advantame, neohesperidin dihydrochalcone (NHDC) and mixtures, salts, and derivatives thereof.

As used herein, the term “sweetening agent” refers to a high intensity sweetener.

As used herein, the term “bulk sweetener” refers to a sweetener, which typically adds both bulk and sweetness to a confectionery composition and includes, but is not limited to, sugars, sugar alcohols, sucrose, commonly referred to as “table sugar,” fructose, commonly referred to as “fruit sugar,” honey, unrefined sweeteners, syrups, such as agave syrup or agave nectar, maple syrup, corn syrup and high fructose corn syrup (or HFCS).

As used herein, the term “sweetener enhancer” refers to a compound (or composition) capable of enhancing or intensifying sensitivity of the sweet taste. The term “sweetener enhancer” is synonymous with a “sweetness enhancer,” “sweet taste potentiator,” “sweetness potentiator,” and/or “sweetness intensifier.” A sweetener enhancer enhances the sweet taste, flavor, mouth feel and/or the taste profile of a sweetener without giving a detectable sweet taste by the sweetener enhancer itself at an acceptable use concentration. In some embodiments, the sweetener enhancer provided herein may provide a sweet taste at a higher concentration by itself. Certain sweetener enhancers provided herein may also be used as sweetening agents.

Sweetener enhancers can be used as food additives or flavors to reduce the amounts of sweeteners in foods while maintaining the same level of sweetness. Sweetener enhancers work by interacting with sweet receptors on the tongue, helping the receptor to stay switched “on” once activated by the sweetener, so that the receptors respond to a lower concentration of sweetener. These ingredients could be used to reduce the calorie content of foods and beverages, as well as save money by using less sugar and/or less other sweeteners. Examples of sweetener enhancers include, but are not limited to, brazzein, miraculin, curculin, pentadin, mabinlin, thaumatin, and mixtures thereof.

In some cases, sweetening agents or sweeteners can be used as sweetener enhancers or flavors when their dosages in food and beverage are low. In some cases, sweetener enhancers can be utilized as sweeteners where their dosages in foods and beverages are higher than dosages regulated by FEMA, EFSA or other related authorities.

As used herein, the phrase “low sweetness products produced by synthesis, fermentation or enzymatic conversion” refers to products that have less sweetness or similar sweetness than sucrose. Examples of low sweetness products produced by extraction, synthesis, fermentation, or enzymatic conversion method include, but are not limited to, sorbitol, xylitol, mannitol, erythritol, trehalose, raffinose, cellobiose, tagatose, DOLCIA PRIMA™ allulose, inulin, N-[N-[3-(3-hydroxy-4-methoxyphenyl)propyl]-alpha-aspartyl]-L-phenylalanine 1-methyl ester, glycyrrhizin, and mixtures thereof.

For example, “sugar alcohols” or “polyols” are sweetening and bulking ingredients used in manufacturing of foods and beverages. As sugar substitutes, they supply fewer calories (about a half to one-third fewer calories) than sugar, are converted to glucose slowly, and are not characterized as causing spiked increases in blood glucose levels.

Sorbitol, xylitol, and lactitol are exemplary sugar alcohols (or polyols). These are generally less sweet than sucrose but have similar bulk properties and can be used in a wide range of food and beverage products. In some case, their sweetness profile can be fine-tuned by being mixed with high-intensity sweeteners.

The terms “flavor” and “flavor characteristic” are used interchangeably with reference to the combined sensory perception of one or more components of taste, aroma, and/or texture.

The terms “flavoring agent”, “flavoring” and “flavorant” are used interchangeably with reference to a product added to food or beverage products to impart, modify, or enhance the flavor of food. As used herein, these terms do not include substances having an exclusively sweet, sour, or salty taste (e.g., sugar, vinegar, and table salt).

The term “natural flavoring substance” refers to a flavoring substance obtained by physical processes that may result in unavoidable but unintentional changes in the chemical structure of the components of the flavoring (e.g., distillation and solvent extraction), or by enzymatic or microbiological processes, from material of plant or animal origin.

The term “synthetic flavoring substance” refers to a flavoring substance formed by chemical synthesis.

The term “enhance,” as used herein, includes augmenting, intensifying, accentuating, magnifying, and potentiating the sensory perception of a flavor characteristic without changing the nature or quality thereof.

Unless otherwise specified, the terms “modify” or “modified” as used herein, includes altering, varying, suppressing, depressing, fortifying, and supplementing the sensory perception of a flavor characteristic where the quality or duration of such characteristic was deficient.

The phrase “sensory profile” or “taste profile” is defined as the temporal profile of all basic tastes of a sweetener. The onset and decay of sweetness when a sweetener is consumed, as perceived by trained human tasters and measured in seconds from first contact with a taster's tongue (“onset”) to a cutoff point (typically 180 seconds after onset), is called the “temporal profile of sweetness.” A plurality of such human tasters is called a “sensory panel”. In addition to sweetness, sensory panels can also judge the temporal profile of the other “basic tastes”: bitterness, saltiness, sourness, piquance (aka spiciness), and umami (aka savoriness or meatiness). The onset and decay of bitterness when a sweetener is consumed, as perceived by trained human tasters and measured in seconds from first perceived taste to the last perceived aftertaste at the cutoff point, is called the “temporal profile of bitterness”.

The phrase “sucrose equivalence” or “SugarE” is the amount of non-sucrose sweetener required to provide the sweetness of a given percentage of sucrose in the same food, beverage, or solution. For instance, a non-diet soft drink typically contains 12 grams of sucrose per 100 ml of water, i.e., 12% sucrose. This means that to be commercially accepted, diet soft drinks must generally have the same sweetness as a 12% sucrose soft drink, i.e., a diet soft drink must have a 12% SugarE. Soft drink dispensing equipment assumes an SugarE of 12%, since such equipment is set up for use with sucrose-based syrups.

As used herein, the term “off-taste” refers to an amount or degree of taste that is not characteristically or usually found in a beverage product or a consumable product of the present disclosure. For example, an off-taste is an undesirable taste of a sweetened consumable to consumers, such as, a bitter taste, a licorice-like taste, a metallic taste, an aversive taste, an astringent taste, a delayed sweetness onset, a lingering sweet aftertaste, and the like, etc.

The term “orally consumable product” refers to a composition that can be drunk, eaten, swallowed, inhaled, ingested or otherwise in contact with the mouth or nose of man or animal, including compositions which are taken into and subsequently ejected from the mouth or nose. Orally consumable products are safe for human or animal consumption when used in a generally acceptable range.

As used herein, the term “fruit” refers to firm fruits, soft fruits, sliced pieces with skin remaining, and/or dried/scarified/pricked/scraped fruit, which are well-known in the art, and described herein. Examples of fruit include, but are not limited to, apple, pear, orange, tangerine, lemon, lime, apricot, plum, prune, kiwi, guava, pineapple, coconut, papaya, mango, grape, cherry, pomegranate, grapefruit, passion fruit, dragon fruit, melons, and berries. Example of berries include, but are not limited to, cranberry, blueberry, boysenberry, elderberry, chokeberry, lingonberry, raspberry, mulberry, gooseberry, huckleberry, strawberry, blackberry, cloudberry, blackcurrant, red currant, and white currant. Examples of melon include, but are not limited to, watermelon, cantaloup, Muskmelon, honeydew melon, canary melon, casaba melon, charentais melon, crenshaw melon, galia melon, golden Langkawi melon, hami melon, honey globe melon, horned melon, jadedew melon, kantola melon and Korean melon.

The term “fruit juice” refers to a juice derived from one or more fruits. Fruit juices include freshly prepare fruit juices, concentrated fruit juices, and juices reconstituted from concentrated fruit juices.

The term “vegetables” refers to fresh vegetables, preserved vegetables, dried vegetables, vegetable juice and vegetable extracts. Examples of vegetables include, but are not limited to, broccoli, cauliflower, artichokes, capers, cabbage, turnip, radish, carrot, celery, parsnip, beetroot, lettuce, beans, peas, potato, eggplant, tomato, sweet corn, cucumber, squash, zucchinis, pumpkins, onion, garlic, leek, pepper, spinach, yam, sweet potato, taro, and yams and cassava.

The term “vegetable juice” refers to a juice derived from one or more vegetables. Vegetables juices include freshly prepare vegetables juices, concentrated vegetables juices, and juices reconstituted from concentrated vegetables juices.

Unless otherwise noted, the term “ppm” (parts per million) means parts per million on a w/w or wt/wt basis.

### II. The Maillard Reaction Products

The present application provides Maillard reaction product (MRP)-based sweetening and flavoring compositions made from Maillard reaction mixtures containing glycosylated mogrosides (GMGs), where the resulting products (GMG-MRPs) provide uniquely beneficial sweetening or flavoring properties with wide-ranging applications to the food and beverage industry, among others. Accordingly, in preferred embodiments, the present application provides compositions containing GMG-MRPs in combination with one or more high intensity sweeteners as further described below.

As used herein, the Maillard reaction refers to a non-enzymatic browning reaction of a sugar donor with an amine donor in the presence of heat which produces flavor. Common flavors resulting from the Maillard reaction include, for example, those associated with red meat, poultry, coffee, vegetables, bread crust etc. subjected to heat. A Maillard reaction relies mainly on sugars and amino acids, but it can also contain other ingredients including autolyzed yeast extracts, hydrolyzed vegetable proteins, gelatin (protein source), vegetable extracts (i.e., onion powder), enzyme treated proteins, meat fats or extracts and acids or bases to adjust the pH of the reaction. The reaction can be in an aqueous environment with an adjusted pH at specific temperatures for a specified amount of time to produce a variety of flavors. Typical flavors include those associated with chicken, pork, beef, caramel, chocolate etc. However, a wide variety of different taste and aroma profiles can be achieved by adjusting the ingredients, the temperature and/or the pH of the reaction. The main advantage of the reaction flavors is that they can produce characteristic meat, burnt, roasted, caramellic, or chocolate profiles desired by the food industry, which are not typically achievable by using compounding of flavor ingredients.

Reducing groups can be found on reducing sugars (sugar donors) and amino groups can be found on amino donors such as free amino acids, peptides, and proteins. Initially, a reactive carbonyl group of a reducing sugar condenses with a free amino group, with a concomitant loss of a water molecule. A reducing sugar substrate for Maillard reaction typically has a reactive carbonyl group in the form of a free aldehyde or a free ketone. The resultant N-substituted glycoaldosylamine is not stable. The aldosylamine compound rearranges, through an Amadori rearrangement, to form a ketosamine. Ketosamines that are so-formed may further react through any of the following three pathways: (a) further dehydration to form reductones and dehydroreductones; (b) hydrolytic fission to form short chain products, such as diacetyl, acetol, pyruvaldehyde, and the like, which can, in turn, undergo Strecker degradation with additional amino groups to form aldehydes, and condensation, to form aldols; and (c) loss of water molecules, followed by reaction with additional amino groups and water, followed by condensation and/or polymerization into melanoids. Factors that affect the rate and/or extent of Maillard reactions include among others the temperature, water activity, and pH. The Maillard reaction is enhanced by high temperature, low moisture levels, and alkaline pH.

In the Maillard reaction, suitable carbonyl containing reactants include those that comprise a reactive aldehyde (—CHO) or keto (—CO—) group, such that the carbonyl free aldehyde or free keto group is available to react with an amino group associated with the reactant. Typically, the reducing reactant is a reducing sugar, e.g., a sugar that can reduce a test reagent, e.g., can reduce Cu2+ to Cu+, or can be oxidized by such reagents.

Monosaccharides, disaccharides, oligosaccharides, polysaccharides (e.g., dextrins, starches, and edible gums) and their hydrolysis products are suitable reducing reactants if they have at least one reducing group that can participate in a Maillard reaction. Reducing sugars include aldoses or ketoses such as glucose, fructose, maltose, lactose, glyceraldehyde, dihydroxyacetone, arabinose, xylose, ribose, mannose, erythrose, threose, and galactose. Other reducing reactants include uronic acids (e.g., glucuronic acid, glucuronolactone, and galacturonic acid, mannuronic acid, iduronic acid) or Maillard reaction intermediates bearing at least one carbonyl group such as aldehydes, ketones, alpha-hydroxycarbonyl or dicarbonyl compounds.

### A. Maillard Reaction Components

### Amine Donor

The MRP compositions of the present application are formed from a reaction mixture comprising at least one exogenous amine donor comprising a free amino group. As used herein, the term “amine donor” refers to a compound or substance containing a free amino group, which can participate in a Maillard reaction. Amine containing reactants include amino acids, peptides (including dipeptides, tripeptides, and oligopeptides), proteins, proteolytic or nonenzymatic digests thereof, and other compounds that react with reducing sugars and similar compounds in a Maillard reaction, such as phospholipids, chitosan, lipids, etc. In some embodiments, the amine donor also provides one or more sulfur-containing groups. Exemplary amine donors include amino acids, peptides, proteins, protein extracts.

Exemplary amino acids include, for example, nonpolar amino acids, such as alanine, glycine, isoleucine, leucine, methionine, tryptophan, phenylalanine, proline, valine; polar amino acids, such as cysteine, serine, threonine, tyrosine, asparagine, and glutamine; polar basic (positively charged) amino acids, such as histidine and lysine; and polar acidic (negatively charged) amino acids, such as aspartate and glutamate.

Exemplary peptides include, for example, hydrolyzed vegetable proteins (HVPs) and mixtures thereof.

Exemplary proteins include, for example, sweet taste-modifying proteins, soy protein, sodium caseinate, whey protein, wheat gluten or mixtures thereof. Exemplary sweet taste-modifying proteins include, for example, thaumatin, monellin, brazzein, miraculin, curculin, pentadin, mabinlin, and mixtures thereof. In certain embodiments, the sweet-taste modifying proteins may be used interchangeably with the term “sweetener enhancer.”

Exemplary protein extracts include yeast extracts, plant extracts, bacterial extracts, and the like.

The nature of the amino donor can play an important role in accounting for the many flavors produced from a Maillard reaction. In some embodiments, the amine donor may account for one or more flavors produced from a Maillard reaction. In some embodiments, a flavor may be produced from a Maillard reaction by using one or more amine donors, or a particular combination of an amine donor and sugar donor.

In certain embodiments, the amine donor is present in the compositions described herein in a range of from about 1 to about 99 weight percent, from about 1 to about 50 weight percent, from about 1 to about 10 weight percent, from about 2 to about 9 weight percent, from about 3 to about 8 weight percent, from about 4 to about 7 weight percent, from about 5 to about 6 weight percent and all values and ranges encompassed over the range of from about 1 to about 50 weight percent. In some embodiments, the amine donor is from a plant source, such as vegetable juice, fruit juice, berry juice, etc.

### Sugar Donor

In some embodiments, the sugar donor is a reducing sugar. Reducing sugars for use in the present application include, for example, all monosaccharides and some disaccharides, which can be aldose reducing sugars or ketose reducing sugars. Typically, the reducing sugar may be selected from the group consisting of aldotetrose, aldopentose, aldohexose, ketotetrose, ketopentose, and ketohexose reducing sugars. Suitable examples of aldose reducing sugars include erythrose, threose, ribose, arabinose, xylose, lyxose, allose, altrose, glucose, mannose, gulose, idose, galactose and talose. Suitable examples of ketose reducing sugars include erythrulose, ribulose, xylulose, psicose, fructose, sorbose, and tagatose. The aldose or the ketose may also be a deoxy-reducing sugar, for example a 6-deoxy reducing sugar, such as fucose or rhamnose.

Specific monosaccharide aldoses include, for example, reducing agents include, for example, where at least one reducing sugar is a monosaccharide, or the one or more reducing sugars are selected from a group comprising monosaccharide reducing sugars, typically at least one monosaccharide reducing sugar is an aldose or a ketose.

Where the reducing sugar is a monosaccharide, the monosaccharide may be in the D- or L-configuration, or a mixture thereof. Typically, the monosaccharide is present in the configuration in which it most commonly occurs in nature. For example, the one or more reducing sugars may be selected from the group consisting of D-ribose, L-arabinose, D-xylose, D-lyxose, D-glucose, D-mannose, D-galactose, D-psicose, D-fructose, L-fucose and L-rhamnose. In a more particular embodiment, the one or more reducing sugars are selected from the group consisting of D-xylose, D-glucose, D-mannose, D-galactose, L-rhamnose and lactose.

Specific reducing sugars include ribose, glucose, fructose, maltose, lyxose, galactose, mannose, arabinose, xylose, rhamnose, rutinose, lactose, maltose, cellobiose, glucuronolactone, glucuronic acid, D-allose, D-psicose, xylitol, allulose, melezitose, D-tagatose, D-altrose, D-alditol, L-gulose, L-sorbose, D-talitol, inulin, stachyose, including mixtures and derivatives therefrom.

Exemplary disaccharide reducing sugars for use in the present application include maltose, lactose, lactulose, cellubiose, kojibiose, nigerose, sophorose, laminarbiose, gentiobiose, turanose, maltulose, palantinose, gentiobiulose, mannobiose, melibiose, melibiulose, rutinose, rutinulose or xylobiose.

Mannose and glucuronolactone or glucuronic acid can be used as sugar donors under Maillard reaction conditions, although they have seldom been used. Maillard reaction products of mannose, glucuronolactone or glucuronic acid provide yet another unique approach to provide new taste profiles with the sweetening agents described throughout the specification alone or in combination with additional natural sweeteners, synthetic sweeteners, and/or flavoring agents described herein.

In some embodiments, one or more carbohydrate sweeteners may be added to a reaction mixture subjected to the Maillard reaction. In other embodiments, one or more carbohydrate sweeteners may be added to an MRP composition. Non-limiting examples of carbohydrate sweeteners for use in the present application include caloric sweeteners, such as, sucrose, fructose, glucose, D-tagatose, trehalose, galactose, rhamnose, cyclodextrin (e.g., α-cyclodextrin, β-cyclodextrin, and γ-cyclodextrin), ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, glucosamine, mannosamine, fucose, glucuronic acid, gluconic acid, glucono-lactone, abequose, galactosamine, sugar alcohols, such as erythritol, xylitol, mannitol, sorbitol, maltitol, lactitol, mannitol, and inositol; xylooligosaccharides (xylotriose, xylobiose and the like), gentio-oligoscaccharides (gentiobiose, gentiotriose, gentiotetraose and the like), galacto-oligosaccharides, sorbose, nigero-oligosaccharides, fructooligosaccharides (kestose, nystose and the like), maltotetraol, maltotriol, malto-oligosaccharides (maltotriose, maltotetraose, maltopentaose, maltohexaose, maltoheptaose and the like), lactulose, melibiose, raffinose, rhamnose, ribose, isomerized liquid sugars such as high fructose corn/starch syrup (containing fructose and glucose, e.g., HFCS55, HFCS42, or HFCS90), coupling sugars, soybean oligosaccharides, and glucose syrup. Additionally, the above carbohydrates may be in either the D- or L-configuration.

It should be noted, however, that not all carbohydrate sweeteners are reducing sugars. Sugars having acetal or ketal linkages are not reducing sugars, as they do not have free aldehyde chains. They therefore do not react with reducing-sugar test solutions (e.g., in a Tollens' test or Benedict's test). However, a non-reducing sugar can be hydrolyzed using diluted hydrochloric acid.

In some embodiments, the sugar donor is a non-reducing sugar that does not contain free aldehyde or free keto groups. Exemplary non-reducing sugars include, but are not limited to, sucrose, trehalose, xylitol, and raffinose. In some embodiments, the sugar donor comprises both reducing sugar and non-reducing sugar. In some embodiments, the sugar donor is derived from a food ingredient, such as sugar, flour, starch, vegetable, and fruits. In some embodiments, the sugar donor is from a plant source, such as fruit juice, berry juice, vegetable juice, etc. In some embodiments, the sugar donor is orange juice, cranberry juice, apple juice, peach juice, watermelon juice, pineapple juice, grape juice, and concentrated product thereof. In some embodiments, the fruit juice, berry juice or vegetable juice serves as both amine donor and sugar donor.

In some embodiments, the sugar donor and amino donor are present in the reaction mixture in a molar ratio of 10:1 to 1:10, 8:1 to 1:8, 6:1 to 1:6, 4:1 to 1:4, 3:1 to 1:3 or 2:1 to 1:2. In some embodiments, the sugar donor and amino donor are present in the reaction mixture in a molar ratio of 10:1, 9:1, 8:1, 7:1, 6:1, 5:1, 4:1, 3:1, 2:1, 1:1, 1:2, 1:3, 1:4, 1:5, 1:6, 1:7, 1;8, 1:9 or 1:10.

In some embodiments, the sugar donor and amino donor are present in the reaction mixture in a sugar donor:amino donor weight ratio of 10:1 to 1:10, 8:1 to 1:8, 6:1 to 1:6, 4:1 to 1:4, 3:1 to 1:3 or 2:1 to 1:2. In some embodiments, the sugar donor and amino donor are present in the reaction mixture in a molar ratio of 10:1, 9:1, 8:1, 7:1, 6:1, 5:1, 4:1, 3:1, 2:1, 1:1, 1:2, 1:3, 1:4, 1:5, 1:6, 1:7, 1;8, 1:9 or 1:10.

In some embodiments, the weight ratio between the total amount of MGs or GMGs and the total amount of sugar donor and amine donor (Total MG/GMG: Total sugar/amine) in the reaction mixture is from 10:1 to 1:10, from 8:1 to 1:8, from 6:1 to 1:6, from 4:1 to 1:4, from 3:1 to 1:3 or from 2:1 to 1:2.

It should be understood that different components can be included in a glycosylation reaction as further described below. These components include MGs, GMGs, MG-MRPs, GMG-MRPs, SGs, SGEs, GSGs, GSGEs, STEs, STCs, RU, GSTEs, GSTCs, GSUs, S-MRPs, ST-MRPs, RU-MRPs, C-MRPs, sugar donors, amine donors, sweeteners, non-nutritive sweeteners, high intensity natural sweeteners, high intensity synthetic or semi-synthetic sweeteners, sweetener enhancers, individual components of sweeteners, including components in stevia extracts, such as stevioside, steviolbioside, RA, RB, RC, RD, RE, RF, RH, RI, RJ, RK, RL, RM, RN, RO, rubusoside and dulcoside A, etc.; components in monk fruit extracts, and components in sweet tea extracts as further described herein.

In one embodiment, the Maillard mixture includes two different components in weight ratios of 1:99, 2:98, 3:97, 4:96, 5:95, 6:94, 7:93, 8:92, 9:91, 10:90, 11:89, 12:88, 13:87, 14:86, 15:85, 16:84, 17:83, 18:82, 19:81, 20:80, 21:79, 22:78, 23:77, 24:76, 25:75, 26:74, 27:73, 28:72, 29:71, 30:70, 31:69, 32:68, 33:67, 34:66, 35:65, 36:64, 37:63, 38:62, 39:61, 40:60, 41:59, 42:58, 43:57, 44:56, 45:55, 46:54, 47:53, 48:52, 49:51 and 50:50, and all ranges therebetween, where the ratios are from 1:99 and vice versa, e.g., a ratio of from 1:99 to 50:50, from 30:70 to 42:58, etc.

In another embodiment, the Maillard reaction mixture includes three different components in weight ratios of 1:1:98, 1:2:97, 1:3:96, 1:4:95, 1:5:94, 1:6:93, 1:7:92, 1:8:91, 1:9:90, 1:10:89, 1:11:88, 1:12:87, 1:13:86, 1:14:85, 1:15:84, 1:16:83, 1:17:82, 1:18:81, 1:19:80, 1:20:79, 1:21:78, 1:22:77, 1:23:76, 1:24:75, 1:25:74, 1:26:73, 1:27:72, 1:28:71, 1:29:70, 1:30:69, 1:31:68, 1:32:67, 2:3:95, 2:4:94, 2:5:93, 2:6:92, 2:7:91, 2:8:90, 2:9:89, 2:10:88, 2:11:87, 2:12:86, 2:13:85, 2:14:84, 2:15:83, 2:16:82, 2:17:81, 2:18:80, 2:19:79, 2:20:78, 2:21:77, 2:22:76, 2:23:75, 2:24:74, 2:25:73, 2:26:72, 2:27:71, 2:28:70, 2:29:69, 2:30:68, 2:31:67, 2:32:66, 2:3:95, 3:3:94, 3:4:93, 3:5:92, 3:6:91, 3:7:90, 3:8:89, 3:9:88, 3:10:87, 3:11:86, 3:12:85, 3:13:84, 3:14:83, 3:15:82, 3:16:81, 2:17:80, 3:18:79, 3:19:78, 3:20:77, 3:21:76, 3:22:75, 3:23:74, 3:24:73, 3:25:72, 3:26:71, 3:27:70, 3:28:69, 3:29:68, 3:30:67, 3:31:66, 3:32:65, 4:4:92, 4:5:91, 4:6:90, 4:7:89, 4:8:88, 4:9:87, 4:10:86, 4:11:85, 4:12:84, 4:13:83, 4:14:82, 4:15:81, 4:16:80, 4:17:79, 4:18:78, 4:19:77, 4:20:76, 4:21:75, 4:22:74, 4:23:73, 4:24:72, 4:25:71, 4:26:70, 4:27:69, 4:28:68, 4:29:67, 4:30:66, 4:31:65, 4:32:64, 5:5:90, 5:6:89, 5:7:88, 5:8:87, 5:9:86, 5:10:85, 5:11:84, 5:12:83, 5:13:82, 5:14:81, 5:15:80, 5:16:79, 5:17:78, 5:18:77, 5:19:76, 5:20:75, 5:21:74, 5:22:73, 5:23:72, 5:24:71, 5:25:70, 5:26:69, 5:27:68, 5:28:67, 5:29:66, 5:30:65, 5:31:64, 5:32:63, 6:6:88, 6:7:87, 6:8:86, 6:9:85, 6:10:84, 6:11:83, 6:12:82, 6:13:81, 6:14:80, 6:15:79, 6:16:78, 6:17:77, 6:18:76, 6:19:75, 6:20:74, 6:21:73, 6:22:72, 6:23:71, 6:24:70, 6:25:69, 6:26:68, 6:27:67, 6:28:66, 6:29:65, 6:30:64, 6:31:63, 6:32:62, 7:7:86, 7:8:85, 7:9:84, 7:10:83, 7:11:82, 7:12:81, 7:13:80, 7:14:79, 7:15:78, 7:16:77, 7:17:76, 7:18:75, 7:19:74, 7:20:73, 7:21:72, 7:22:71, 7:23:70, 7:24:69, 7:25:68, 7:26:67, 7:27:66, 7:28:65, 7:29:64, 7:30:63, 7:31:62, 7:32:61, 8:8:84, 8:9:83, 8:10:82, 8:11:81, 8:12:80, 8:13:79, 8:14:78, 8:15:77, 8:16:76, 8:17:75, 8:18:74, 8:19:73, 8:20:72, 8:21:71, 8:22:70, 8:23:69, 8:24:68, 8:25:67, 8:26:66, 8:27:65, 8:28:64, 8:29:63, 8:30:62, 8:31:61, 8:32:60, 9:9:82, 9:10:81, 9:11:80, 9:12:79, 9:13:78, 9:14:77, 9:15:76, 9:16:75, 9:17:74, 9:18:73, 9:19:72, 9:20:71, 9:21:70, 9:22:69, 9:23:68, 9:24:67, 9:25:66, 9:26:65, 9:27:64, 9:28:63, 9:29:62, 9:30:61, 9:31:60, 9:32:59, 10:10:80, 10:11:79, 10:12:78, 10:13:77, 10:14:76, 10:15:75, 10:16:74, 10:17:73, 10:18:72, 10:19:71, 10:20:70, 10:21:69, 10:22:68, 10:23:67, 10:24:66, 10:25:65, 10:26:64, 10:27:63, 10:28:62, 10:29:61, 10:30:60, 10:31:59, 10:32:58, 11:11:78, 11:12:77, 11:13:76, 11:14:75, 11:15:74, 11:16:73, 11:17:72, 11:18:71, 11:19:70, 11:20:69, 11:21:68, 11:22:67, 11:23:66, 11:24:65, 11:25:64, 11:26:63, 11:27:62, 11:28:61, 11:29:60, 11:30:59, 11:31:58, 11:32:57, 12:12:76, 12:13:75, 12:14:74, 12:15:73, 12:16:72, 12:17:71, 12:18:70, 12:19:69, 12:20:68, 12:21:67, 12:22:66, 12:23:65, 12:24:64, 12:25:63, 12:26:62, 12:27:61, 12:28:60, 12:29:59, 12:30:58, 12:31:57, 12:32:56, 13:13:74, 13:14:73, 13:15:72, 13:16:71, 13:17:70, 13:18:69, 13:19:68, 13:20:67, 13:21:66, 13:22:65, 13:23:64, 13:24:63, 13:25:62, 13:26:61, 13:27:60, 13:28:59, 13:29:58, 13:30:57, 13:31:56, 13:32:55, 14:14:72, 14:15:71, 14:16:70, 14:17:69, 14:18:68, 14:19:67, 14:20:66, 14:21:65, 14:22:64, 14:23:63, 14:24:62, 14:25:61, 14:26:60, 14:27:59, 14:28:58, 14:29:57, 14:30:56, 14:31:55, 14:32:54, 15:15:70, 15:16:69, 15:17:68, 15:18:67, 15:19:66, 15:20:65, 15:21:64, 15:22:63, 15:23:62, 15:24:61, 15:25:60, 15:26:59, 15:27:58, 17:28:57, 15:29:56, 15:30:55, 15:31:54, 15:32:53, 16:16:68, 16:17:67, 16:18:66, 16:19:65, 16:20:64, 16:21:63, 16:22:62, 16:23:61, 16:24:60, 16:25:59, 16:26:58, 16:27:57, 16:28:56, 16:29:55, 16:30:54, 16:31:53, 16:32:52, 17:17:66, 17:18:65, 17:19:64, 17:20:63, 17:21:62, 17:22:61, 17:23:60, 17:24:59, 17:25:58, 17:26:57, 17:27:56, 17:28:55, 17:29:54, 17:30:53, 17:31:52, 17:32:51, 18:18:64, 18:19:63, 18:20:62, 18:21:61, 18:22:60, 18:23:59, 18:24:58, 18:25:57, 18:26:56, 18:27:55, 18:28:54, 18:29:53, 18:30:52, 18:31:51, 18:32:50, 19:19:62, 19:20:61, 19:21:60, 19:22:59, 19:23:58, 19:24:57, 19:25:56, 19:26:55, 19:27:54, 19:28:53, 19:29:52, 19:30:51, 19:31:50, 19:32:49, 20:20:60, 20:21:59, 20:22:58, 20:23:57, 20:24:56, 20:25:55, 20:26:54, 20:27:53, 20:28:52, 20:29:51, 20:30:50, 20:31:49, 20:32:48, 21:21:58, 21:22:57, 21:23:56, 21:24:55, 21:25:54, 21:26:53, 21:27:52, 21:28:51, 21:29:50, 21:30:49, 21:31:48, 21:32:47, 22:22:56, 22:23:55, 22:24:54, 22:25:53, 22:26:52, 22:27:51, 22:28:50, 22:29:49, 22:30:48, 22:31:47, 22:32:46, 23:23:54, 23:24:53, 23:25:52, 23:26:51, 23:27:50, 23:28:49, 23:29:48, 23:30:47, 23:31:46, 23:32:45, 24:24:52, 24:25:51, 24:26:50, 24:27:49, 24:28:48, 24:29:47, 24:30:46, 24:31:45, 24:32:44, 25:25:50, 25:26:49, 25:27:48, 25:28:47, 25:29:46, 25:30:45, 25:31:44, 25:32:43, 26:26:48, 26:27:47, 26:28:46, 26:29:45, 26:30:44, 26:31:43, 26:32:42, 27:27:46, 27:28:45, 27:29:44, 27:30:43, 27:31:42, 27:32:41, 28:28:44, 28:29:43, 28:30:42, 28:31:41, 28:32:40, 29:29:42, 29:30:41, 29:31:40, 29:32:39, 30:30:40, 30:31:39, 30:32:38, 31:31:38, 31:32:37, 32:32:36, 32:33:35, and 33.3:33.3:33.3, and all ranges therebetween, where the ratios are from 1:1:98 and vice versa, e.g., a ratio of from 1:1:98 to 33.3:33.3:33.3, from 10:30:70 to 15:40:45, etc.

It is noted that the present disclosure is not limited to compositions having only two or three different components, and that the exemplary ratios are non-limiting. Rather, the same formula can be followed for establishing ratios of as many different components as are contained within a given composition. As a further example, in a composition that comprises 20 different components described herein, the components can have ratios of from 1:1:1:1:1:1:1:1:1:1:1:1:1:1:1:1:1:1:1:81 to 5:5:5:5:5:5:5:5:5:5:5:5:5:5:5:5:5:5:5:5, and all possible combinations of ratios therebetween. In some embodiments, a composition of the present disclosure may have up to and including a combination of all compounds.

In some embodiments, the present application provides one or more GMG-MRPs formed from heating a reaction mixture comprising (1) one or more exogenously added amine donors, and (2) one or more GMGs.

In another embodiment, the present application provides one or more GMG-MRPs formed from heating a reaction mixture comprising (1) one or more exogenously added amine donors, and (2) one or more exogenously added reducing sugars; and (3) one or more GMGs.

In another embodiment, the present application provides one or more GMG-MRPs formed from heating a reaction mixture comprising (1) one or more exogenously added amine donors, and (2) GMGV.

In another embodiment, the present application provides one or more GMG-MRPs formed from heating a reaction mixture comprising (1) one or more exogenously added amine donors, and (2) one or more exogenously added reducing sugars; and (3) GMGV.

In another embodiment, the present application provides one or more GMG-MRPs formed from heating a reaction mixture comprising (1) one or more exogenously added amine donors, (2) one or more exogenously added non-reducing sugars; and (3) one or more GMGs.

In another embodiment, the present application provides one or more GMG-MRPs formed from heating a reaction mixture comprising (1) one or more exogenously added non-reducing sugars; and (2) one or more GMGs.

In another embodiment, the present application provides one or more GMG-MRPs formed from heating a reaction mixture comprising (1) one or more exogenously added amine donors, (2) one or more exogenously added reducing sugars; (3) one or more exogenously added non-reducing sugars; and (4) one or more GMGs.

In another embodiment, the present application provides one or more GMG-MRPs formed from heating a reaction mixture comprising (1) one or more exogenously added reducing sugars; (2) one or more exogenously added non-reducing sugars; and (3) one or more GMGs.

In another embodiment, the present application provides one or more GMG-MRPs formed by glycosylation of an MG-MRP.

In some embodiments, the one or more GMG-MRPs are prepared from a Maillard reaction mixture that contains an enriched GMG composition.

In some embodiments, the one or more GMG-MRPs are prepared from a Maillard reaction mixture that contains an enriched triterpene glycoside composition.

In some embodiments, the one or more GMG-MRPs are prepared from a Maillard reaction mixture that contains an enriched GMGV composition.

In some embodiments, the one or more GMG-MRPs are prepared from a Maillard reaction mixture that includes one or more GMGs selected from the group consisting of glycosylated mogroside V (MGV), glycosylated isomogroside V (IMGV), glycosylated dehydroxy mogroside V (DMGV), glycosylated 7-oxomogroside V (7-OMGV), glycosylated 11-oxomogroside V (11-OMGV), glycosylated mogroside II B, glycosylated mogroside IIe (MGIIe), glycosylated 7-oxo-mogroside II E, glycosylated mogroside III (MGIII), glycosylated 11-deoxy-mogroside III, glycosylated mogroside IIIe (MGIIIe), glycosylated mogroside III A2, glycosylated mogroside IV (MGIV), glycosylated mogroside IVa (MGIVa), glycosylated mogroside IVe (MGIVe), glycosylated -oxomogroside IV A, glycosylated mogroside VI (MGVI), glycosylated 11-oxomogroside VI (11-OMGVI), glycosylated mogroside A (MGA), glycosylated 11-oxo-mogroside A1, glycosylated neomogroside (NMG), glycosylated mogroester (MG-E), glycosylated siamenoside I (SSI), glycosylated grosvenorine I (GVRI), glycosylated grosvenorine II (GVRII), glycosylated grosmomoside I (GMSI) and glycosylated grosmomoside II (GMSII), and glycosylated neomogroside.

In some embodiments, the one or more GMG-MRPs are formed from a Maillard reaction mixture containing a GMGV content of 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt %.

In some embodiments, the one or more GMG-MRPs are formed from a Maillard reaction mixture containing a GMGV content of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

The Maillard reaction is conducted with a suitable solvent. Additionally, solvents can be employed along with water. Suitable solvents approved for oral use include, for example, alcohols, such as low molecular weight alcohols, e.g., methanol, ethanol, propanol, butanol, pentanol, hexanol, ethylene glycol, propylene glycol, butyl glycol, etc. The following additional solvents may be used in the Maillard reaction or may act as carriers for Maillard reaction products: acetone, benzyl alcohol, 1,3-butylene glycol, carbon dioxide, castor oil, citric acid esters of mono- and di-glycerides, ethyl acetate, ethyl alcohol, ethyl alcohol denatured with methanol, glycerol (glycerin), glyceryl diacetate, glyceryl triacetate (triacetin), glyceryl tributyrate (tributyrin), hexane, isopropyl alcohol, methyl alcohol, methyl ethyl ketone (2-butanone), methylene chloride, monoglycerides and diglycerides, monoglyceride citrate, 1,2-propylene glycol, propylene glycol mono-esters and diesters, triethyl citrate, and mixtures thereof.

Although recognizing that other suitable solvents may be used for flavoring agents, The International Organization of the Flavor Industry (IOFI) Code of Practice (Version 1.3, dated Feb. 29, 2012) lists the following solvents as being appropriate for use in flavoring agents: acetic acid, benzyl alcohol, edible oils, ethyl alcohol, glycerol, hydrogenated vegetable oils, isopropyl alcohol, mannitol, propylene glycol, sorbitol, sorbitol syrup, water, and xylitol. Accordingly, in certain embodiments, these are preferred solvents.

In some embodiments, the solvent is water. In some embodiments, the solvent is glycerol. In some embodiments, the solvent is a glycerol-water mixture with a glycerol:water ratio (v:v) of 10:1 to 1:10, 9:1 to 1:9, 8:1 to 1:8, 7:1 to 1:7, 6:1 to 1:6, 1:5 to 5:1, 1:4 to 4:1, 1:3 to 3:1, 1:2 to 2:1. In some embodiments, the solvent is a glycerol-water mixture with a glycerol:water ratio (v:v) of 1:9, 1:8, 1:7, 1:6, 1:5, 1:4, 1:3, 1:2, 1:1, 2:1, 3:1, 4:1, 5:1, 6:1, 7:1, 8:1 or 9:1.

In some embodiments, the reaction mixture comprises a solvent in an amount of 10-90 wt %, 10-80 wt %, 10-70 wt %, 10-60 wt %, 10-50 wt %, 10-40 wt %, 10-30 wt %, 10-20 wt %, 20-90 wt %, 20-80 wt %, 20-70 wt %, 20-60 wt %, 20-50 wt %, 20-40 wt %, 20-30 wt %, 30-90 wt %, 30-80 wt %, 30-70 wt %, 30-60 wt %, 30-50 wt %, 30-40 wt %, 40-90 wt %, 40-80 wt %, 40-70 wt %, 40-60 wt %, 40-50 wt %, 50-90 wt %, 50-80 wt %, 50-70 wt %, 50-60 wt %, 60-90 wt %, 60-80 wt %, 60-70 wt %, 70-90 wt %, 70-80 wt %, or 80-90 wt % of the reaction mixture. In some embodiments, the reaction mixture comprises a solvent in an amount of about 10 wt %, about 15 wt %, about 20 wt %, about 25 wt %, about 30 wt %, about 33 wt % about 35 wt %, about 40 wt %, about 45 wt %, about 50 wt %, about 55 wt %, about 60 wt % about 65 wt %, about 70 wt %, about 75 wt %, about 80 wt %, about 85 wt %, or about 90 wt % of the reaction mixture.

In some embodiments, the sugar donor may account for one or more flavors produced from a Maillard reaction. More particularly, a flavor may be produced from a Maillard reaction by using one or more sugar donors, wherein at least one sugar donor is selected from a product comprising a glycoside and a free carbonyl group. In some embodiments, glycosidic materials for use in Maillard reactions include natural juice/concentrates/extracts selected from strawberry, blueberry, blackberry, bilberry, raspberry, lingonberry, cranberry, red currants, white currants, blackcurrants, apple, peach, pear, apricot, mango, grape, water melon, cantaloupe, grapefruit, passion fruit, dragon fruit, carrot, celery, eggplant, tomato, etc.

The natural extracts used in Maillard reactions described herein can include any solvent extract-containing substances, such as polyphenols, free amino acids, flavonoids etc. The extracts can be further purified by methods such as resin-enriched, membrane filtration, crystallization etc., as further described herein.

In one embodiment, a Maillard reaction mixture or an MRP composition produced thereof may include a sweetener, thaumatin, and optionally one or more MRP products, wherein the sweetener is selected from date paste, apple juice concentrate, monk fruit concentrate, sugar beet syrup, pear juice or puree concentrate, apricot juice concentrate. Alternatively, a root or berry juice may be used as sugar donor or sweetener added to an MRP composition.

In some embodiments, particular flavors may be produced from a Maillard reaction using one or more sugar donors, where at least one sugar donor is selected from plant juice/powder, vegetable juice/powder, berries juice/powder, fruit juice/powder. In certain preferred embodiments, a concentrate or extract may be used, such as a bilberry juice concentrate or extract having an abundance of anthocyanins. Optionally, at least one sugar donor and/or one amine donor is selected from animal source-based products, such as meat, oil etc. Meat from any part of an animal, or protein(s) from any part of a plant could be used as source of amino donor(s) in this application.

In some embodiments, the Maillard reactants may further include one or more high intensity synthetic sweeteners, non-mogroside natural sweeteners, and/or the glycosylation products thereof. Alternatively, or in addition, the high intensity synthetic sweeteners may be added to an MRP composition comprising reaction products formed in the Maillard reaction.

High intensity synthetic sweeteners are synthetically produced sugar substitutes or sugar alternatives that are similarly many times sweeter than sugar and contribute few to no calories when added to foods. Moreover, they can be similarly used as Maillard reaction components or as flavor enhancers added to MRP compositions of the present application. High intensity synthetic sweeteners include Advantame, Aspartame, Acesulfame potassium (Ace-K), Neotame, Sucralose, and Saccharin.

The inventor has found that Advantame, a non-caloric high intensity synthetic sweetener and aspartame analog, can boost the flavor and taste profile of the compositions disclosed herein, especially when added after Maillard reaction. Generally, Advantame and other high intensity synthetic sweeteners can be added in the range of 0.01 ppm to 100 ppm.

The inventor has found that the content of the solid materials in the starting mixture of a Maillard reaction has an impact on the outcome of the Maillard reaction. In some embodiments, the MRP of the present application is prepared from a reaction mixture with a solid material content of about 20 wt %, 30 wt %, 40 wt %, 50 wt %, 60 wt %, 65 wt %, 70 wt %, 75 wt %, 80 wt %, 85 wt %, 90 wt % or 95 wt %. In some embodiments, the MRP of the present application is prepared from a reaction mixture with a solid material content greater than 60 wt %, 65 wt %, 70 wt %, 75 wt %, 80 wt %, 85 wt %, 90 wt % or 95 wt %.

### B. Use of Raw Materials in MRP Reactions

In some embodiments, the reactants for the Maillard reaction include several different raw materials for producing MRP compositions. The raw materials may be categorized into the following groups comprising the following exemplary materials:
1) Protein nitrogen sources:

Protein nitrogen containing foods (meat, poultry, eggs, dairy products, cereals, vegetable products, fruits, yeasts), extracts thereof and hydrolysis products thereof, autolyzed yeasts, peptides, amino acids and/or their salts.

### 2) Carbohydrate Sources:

Foods containing carbohydrates (cereals, vegetable products and fruits) and their extracts; mono-, di- and polysaccharides (sugars, dextrins, starches and edible gums), and hydrolysis products thereof.

### 3) Fat or Fatty Acid Sources:

Foods containing fats and oils, edible fats, and oil from animal, marine or vegetable origin, hydrogenated, trans-esterified and/or fractionated fats and oils, and hydrolysis products thereof.

### 4) Miscellaneous List of Additional Ingredients:

Foodstuffs, herbs, spices, their extracts, and flavoring agents identified therein
Water
Thiamine and its hydrochloric salt
Ascorbic, Citric, Lactic, Fumaric, Malic, Succinic, Tartaric and the Na, K, Ca, Mg and NH4 salts of these acids
Guanylic acid and inosinic acid and its Na, K and Ca salts
Inositol
Sodium, potassium and ammonium sulphides, hydrosulphides, and polysulphides
Lecithin
Acids, bases, and salts as pH regulators:
Acetic, hydrochloric, phosphoric, and sulphuric acids
Sodium, potassium, calcium, and ammonium hydroxide.
Salts of the above acids and bases
qPolymethylsiloxane as antifoaming agent.

In another aspect, the present application contemplates the use of any one of several raw materials exemplified below to produce NATURAL PRODUCTS:

Sugar Syrups: Xylose syrup, arabinose syrup and rhamnose syrup manufactured from beech wood. Ardilla Technologies supply these along with natural crystalline L-xylose, L-arabinose and L-rhamnose. Xylose syrup may also be obtained from natural sources, such as the xylan-rich portion of hemicellulose, mannose syrup from ivory nut, etc. These and other types of syrup described herein can be used as sugar donors in the compositions described herein.

Hydrolyzed gum arabic: Thickeners, such as gum arabic can be hydrolyzed with an organic acid or by enzyme hydrolysis to produce a mixture containing arabinose. Arabinose could also be obtained from other wood-based or biomass hydrolysate. Cellulose enzymes can also be used.
Meat Extracts: Commercially available from several companies, such as Henningsens (Chicken skin and meat), which gives excellent chicken notes.
Jardox: Meat and poultry extracts and stocks.
Kanegrade: Fish powders, anchovy, squid, tuna, and others.
Vegetable Powders: onion and garlic powders, celery, tomato, and leek powders are effective flavor contributors to reaction flavors.
Egg Yolk: Contains 50% fat and 50% protein. The fat contains phospholipids and lecithin. The proteins are coagulating proteins and their activity must be destroyed by hydrolysis with acid or using proteases prior to use. This will also liberate amino acids and peptides useful in reaction flavors (Allergen activity).
Vegetable oils: Peanut (groundnut) oil—Oleic acid 50%, Linoleic acid 32%—beef and lamb profile. Sunflower—linoleic acid 50-75%, oleic 25%—chicken profile. Canola (rapeseed)—oleic 60%, linoleic 20%, alpha-linoleic 10%, gadoleic 12%.
Sauces: Fish sauce, soy sauce, oyster sauce, miso.
Enzyme Digests: Beef heart digest—rich in phospholipids. Liver digest—at low levels <5% gives a rich meaty character. Meat digests can also add authenticity, but they are usually not as powerful as yeast extracts and HVPs.
Enzyme enhanced umami products—shitake or porcini mushrooms, kombu, etc. Enzyme digested fats—beef, lamb, etc.

All the components of the compositions disclosed herein can be purchased or made by processes known to those of ordinary skill in the art and combined (e.g., precipitation/co-precipitation, mixing, blending, grounding, mortar, and pestle, microemulsion, solvothermal, sonochemical, etc.) or treated as defined by the current invention.

### Fruit Juices

Reducing sugars can be derived from various sources for use as a sugar donor in the Maillard reaction or as a component added to an MRP composition. For example, a sugar syrup may be extracted from a natural source, such as monk fruit, fruit juice or juice concentrate (e.g., grape juice, apple juice, etc.), vegetable juice (e.g., onion etc.), or fruit (e.g., apples, pears, cherries, etc.), could be used as sugar donor. Such a syrup may include any type of juice regardless of whether there is any ingredient being isolated from juice, such as purified apple juice with trace amount of malic acid etc. The juice could be in the form of liquid, paste or solid. Reducing sugars may also be extracted from Stevia, sweet tea, luohanguo, etc. after isolation of high intensity sweetening agents described herein (containing non-reducing sugars) from crude extracts and mixtures thereof. Extract from any part of plant containing reduced sugar could be used as sugar donor in Maillard reaction with or without other additional reduced sugar. An embodiment of composition of Maillard Reaction Products prepared by using plant extract as sugar donor.

### C. Maillard Reaction Conditions

Maillard reaction conditions are affected by temperature, pressure, pH, reaction times, ratio of different reactants, types of solvents, and solvents-to-reactants ratio. Accordingly, in certain embodiments, the reaction mixture may include a pH regulator, which can be an acid or a base. Suitable base regulators include, for example, sodium hydroxide, potassium hydroxide, baking powder, baking soda any useable food grade base salts including alkaline amino acids. Additionally, the Maillard reaction can be conducted in the presence of alkalinic amino acids without the need of an additional base where the alkaline amino acid serves as the base itself. The pH of the reaction mixture can be maintained at any pH suitable for the Maillard reaction. In certain embodiments, the pH is maintained at a pH of from about 2 to about 14, from about 2 to about 7, from about 3 to about 9, from about 4 to about 8, from about 5 to about 7, from about 7 to about 14, from about 8 to about 10, from about 9 to about 11, from about 10 to about 12, or any pH range derived from these integer values.

In some embodiments, the reaction mixture has a pH of 4, 5, 6, 7, 8 or 9 at the initiation of the Maillard reaction.

In any of the embodiments described in the present application, the reaction temperature in any of the Maillard reaction mixtures described in the present application may be 0° C., 5° C., 10° C., 20° C., 25° C., 30° C., 35° C., 40° C., 50° C., 55° C., 60° C., 65° C., 70° C., 80° C., 90° C., 100° C., 110° C., 120° C., 125° C., 130° C., 135° C., 140° C., 150° C., 155° C., 160° C., 165° C., 170° C., 180° C., 190° C., 200° C., 210° C., 220° C., 225° C., 230° C., 235° C., 240° C., 250° C., 255° C., 260° C., 265° C., 270° C., 280° C., 290° C., 300° C., 400° C., 500° C., 600° C., 700° C., 800° C., 900° C., 1000° C., or any temperature range defined by any two temperature values in this paragraph.

In more particular embodiments, the reaction temperature in any of the Maillard reaction mixtures described in the present application may range from 0° C. to 1000° C., 10° C. to 300° C., from 15° C. to 250° C., from 20° C. to 250° C., from 40° C. to 250° C., from 60° C. to 250° C., from 80° C. to 250° C., from 100° C. to 250° C., from 120° C. to 250° C., from 140° C. to 250° C., from 160° C. to 250° C., from 180° C. to 250° C., from 200° C. to 250° C., from 220° C. to 250° C., from 240° C. to 250° C., from 40° C. to 225° C., from 60° C. to 225° C., from 80° C. to 225° C., from 100° C. to 225° C., from 120° C. to 225° C., from 140° C. to 225° C., from 160° C. to 225° C., from 180° C. to 225° C., from 200° C. to 225° C., from 40° C. to 200° C., from 60° C. to 200° C., from 80° C. to 200° C., from 100° C. to 200° C., from 120° C. to 200° C., from 140° C. to 200° C., from 160° C. to 200° C., from 180° C. to 200° C., from 40° C. to 180° C., from 60° C. to 180° C., from 80° C. to 180° C., from 100° C. to 180° C., from 120° C. to 180° C., from 140° C. to 180° C., from 160° C. to 180° C., from 40° C. to 160° C., from 60° C. to 160° C., from 80° C. to 160° C., from 100° C. to 160° C., from 120° C. to 160° C., from 140° C. to 160° C., from 40° C. to 140° C., from 60° C. to 140° C., from 80° C. to 140° C., from 100° C. to 140° C., from 120° C. to 140° C., from 40° C. to 120° C., from 60° C. to 120° C., from 80° C. to 120° C., from 100° C. to 120° C., from 40° C. to 100° C., from 60° C. to 100° C., from 80° C. to 100° C., from 40° C. to 80° C., from 60° C. to 80° C. or from 60° C. to 80° C. or any aforementioned temperature value in this paragraph, or a temperature range defined by any pair of the aforementioned temperature values in this paragraph.

Maillard reaction(s) can be conducted either under open or sealed conditions. The reaction time is generally from 1 second to 100 hours, more particularly from 1 minute to 24 hours, from 1 minute to 12 hours, from 1 minute to 8 hours, from 1 minute to 4 hours, from 1 minute to 2 hours, from 1 minute to 1 hour, from 1 minute to 40 minutes, from 1 minute to 20 minutes, from 1 minute to 10 minutes, from 10 minutes to 24 hours, from 10 minutes to 12 hours, from 10 minutes to 8 hours, from 10 minutes to 4 hours, from 10 minutes to 2 hours, from 10 minutes to 1 hour, from 10 minutes to 40 minutes, from 10 minutes to 20 minutes, from 20 minutes to 24 hours, from 20 minutes to 12 hours, from 20 minutes to 8 hours, from 20 minutes to 4 hours, from 20 minutes to 2 hours, from 20 minutes to 1 hour, from 20 minutes to 40 minutes, from 40 minutes to 24 hours, from 40 minutes to 12 hours, from 40 minutes to 8 hours, from 40 minutes to 4 hours, from 40 minutes to 2 hours, from 40 minutes to 1 hour, from 1 hour to 24 hours, from 1 hour to 12 hours, from 1 hour to 8 hours, from 1 hour to 4 hours, from 1 hour to 2 hours, from 2 hour to 24 hours, from 2 hour to 12 hours, from 2 hour to 8 hours, from 2 hour to 4 hours, from 4 hour to 24 hours, from 4 hour to 12 hours, from 4 hour to 8 hours, from 8 hour to 24 hours, from 8 hour to 12 hours, or from 12 hour to 24 hours. Depending on the desired taste, the reaction can be terminated at any time. The Maillard reaction mixture can contain unreacted reactants, degraded substances from the reactants, pH regulator(s), and/or salt(s).

The Maillard reactions can be conducted at atmospheric pressure or under pressure. When conducted under pressure, the reaction mixture may be subjected to constant pressure, or it may be subjected to varying pressures over time. In certain embodiments, the pressure in the reaction vessel is at least 10 MPa, at least 20 MPa, at least 30 MPa, at least 40 MPa, at least 50 MPa, at least 75 MPa, at least 100 MPa, at least 150 MPa, at least 200 MPa, at least 250 MPa, at least 300 MPa, at least 400 MPa, at least 500 MPa, at least 600 MPa, at least 700 MPa, at least 800 MPa, and any pressure range derived from the aforementioned pressure values.

In some embodiments, it is desirable to suppress the Maillard reaction, in part. This can be achieved by exercising one or more of the following approaches, including the use of raw materials that are not susceptible to browning, adjusting the factors affecting the browning velocity of Maillard reaction, lowering the temperature, lowering pH, adjusting water activity, increasing the level of oxygen, using oxidant, introducing enzymes, etc.

In certain embodiments, the use of low solubility or insoluble amino acids in the Maillard reaction may result in insoluble reactants present in the final MRP composition. In such cases, filtration may be used to remove any insoluble components present in the MIRP compositions.

A general method to prepare derived Maillard reaction product(s) is described as follows. Briefly, a high intensity sweetener (as described herein), such as a GMG is dissolved with or without a sugar donor, and together with an amino acid donor in water, followed by heating of the solution at an elevated temperature, for example from about 50 to about 200 degrees centigrade. The reaction time can be varied from more than one second to a few days, more generally a few hours, until Maillard reaction products (MRPs) are formed, or the reaction components have been exhausted or the reaction has been completed, with or without formation of caramelization reaction products (CRPs), which are further described below. When required, a pH adjuster or pH buffer can be added to regulate the pH of the reaction mixture before, during or after reaction as further described herein. The resultant solution is dried by spray dryer or hot air oven to remove the water and to obtain the MRP(s).

When the reaction is completed, the product mixture does not need to be neutralized or it can be neutralized. Water and/or solvent(s) do not necessarily need to be removed but can be removed by distillation, spray drying or other known methods if the product is desired as a powder or liquid, whatever the case may be.

Interestingly, when a reaction mixture is dried to a powder, such as by spray drying, the resultant powders only have a slight smell associated with them. This contrasts with regular powdered flavoring agents that generally have a strong smell. The dried powdered reaction mixtures of the embodiments, when dissolved in a solvent, such as water or alcohol or mixtures thereof, release the smell. This demonstrates that the volatile substances in e.g., the GMG-MRPs can be preserved by MGs or monk fruit extracts (MEs) present in the reaction products and compositions of the present application. Powders with strong aroma can be obtained too, particularly where the carrier has a much less flavor compared with MRPs flavors or strong flavor substances used in the Maillard reaction.

In some embodiments, the Maillard reaction mixtures may further include one or more carriers (or flavor carriers) acceptable for use with sweetening agents or flavoring agents. In addition, such carriers may be suitable e.g., as solvents for the Maillard reaction.

Exemplary carriers include acetylated distarch adipate, acetylated distarch phosphate, agar, alginic acid, beeswax, beta-cyclodextrin, calcium carbonate, calcium silicate, calcium sulphate, candelilla wax, carboxymethyl cellulose, sodium salt, carnauba wax, carrageenan, microcrystalline cellulose, dextran, dextrin, diammonium phosphate, distarch phosphate, edible fats, elemi resin, ethyl lactate, ethyl cellulose, ethyl hydroxyethyl cellulose, ethyl tartrate, gelatin, gellan gum, ghatti gum, glucose, glyceryl diacetate, glyceryl diesters of aliphatic fatty acids C6-C18, glyceryl monoesters of aliphatic fatty acids C6-C18, glyceryl triacetate (triacetin), glyceryl triesters of aliphatic fatty acids C6-C18, glyceryl tripropanoate, guar gum, gum arabic, hydrolyzed vegetable protein, hydroxyproplymethyl cellulose, hydroxypropyl cellulose, hydroxypropyl distarch phosphate, hydroxypropyl starch, karaya gum, konjac gum, lactic acid, lactose, locust bean gum (carob bean gum), magnesium carbonate, magnesium salts of fatty acids, maltodextrin, methyl cellulose, medium chain triglyceride, modified starches, such as acetylated distarch adipate, acetylated oxidized starch, acid-treated starch, alkaline treated starch, bleached starch, roasted starch dextrins, distarch phosphate, hydroxypropyl distarch phosphate, acetylated distarch phosphate, hydroxypropyl starch, monostarch phosphate, oxidized starch, phosphated distarch phosphate, starch acetate, starch sodium octenyl succinate, and enzyme treated starches; mono-,di- and tri-calcium orthophosphate, Na, K, NH₄ and Ca alginate, pectins, processed euchema seaweed, propylene glycol alginate, sodium chloride (salt), silicon dioxide, sodium aluminium diphosphate, sodium aluminium silicate, Sodium, potassium and calcium salts of fatty acids, starch, starch (sodium) octenyl succinate, starch acetate, sucro glycerides, sucrose, sucrose esters of fatty acids, type I and type II sucrose oligoesters, taragum, tragacanth, triethylcitrate, whey powder, xanthan gum, fibers such as non-starch polysaccharides, lignin, cellulose, methylcellulose, the hemicelluloses, β-glucans, mucilage, inulins, oligosaccharides, polydextrose, fructooligosaccharides, cyclodextrins, chitins, and combinations thereof, and thickeners such as carbomers, cellulose base materials, gums, waxes, algin, agar, pectins, carrageenan, gelatin, mineral or modified mineral thickeners, polyethylene glycol and polyalcohols, polyacrylamide and other polymeric thickeners, and combinations thereof.

When utilizing the MRP compositions for use in a sweetening or flavoring composition, one or more additional components may be added to the MRP composition after the Maillard reaction has occurred. These additional components include flavoring substances. Moreover, the reaction products after the Maillard reaction have been completed can further include, for example, one or more sweetening agents, reducing sugars (i.e., residue sugar donors), amine donors, sweetener enhancers, and caramelization reaction products (CRPs), as well as one or more degraded sweetening agents, degraded sugar donors, degraded amine donors, and salts.

It should also be understood, for example, that the Maillard reaction can be performed under conditions containing an excess of amine donors in comparison to reducing sugars or much less than the amount of reducing sugars present. In the first instance, the resultant MRPs would include unreacted amine donors, degraded amine donors and/or residues from reacted amine donors. Conversely, when there is an excess of reducing sugars present in the Maillard reaction, the amine donors would be more fully reacted during the reaction and a greater amount of unreacted reducing sugars as well as degraded reducing sugars and/or degrading reducing sugars and residues therefrom. Surprisingly, where the reducing sugar is replaced with a sweetening agent (e.g., a material such as an MG or ME that does not include a reactive aldehydic or ketone moiety) and reacted with one or more amine donors, the amine donors may be present in the reaction products in reduced amounts reflecting their consumption in the Maillard type reaction or there excess of amine donors, as well as amine donor residues and/or amine degradation products after the Maillard reaction has been completed.

There are many ways to control the Maillard reaction to produce desired MRP compositions. For instance, adjusting the pH, pressure, reaction time, and ingredient additions to optimize the ratio of raw materials etc. Further, the separation of MRPs products can provide a means for preparing different types of flavors or flavor enhancers. For example, MRPs include both volatile substances and non-volatile substances. Therefore, by evaporating the volatile substances, non-volatile substances can be purified for use. These non-volatile substances (or products) can be used as flavor modifiers or with the top note flavor in final products, such as volatile peach, lemon flavor provided by traditional flavor houses.

Volatile substances can be used as flavor or flavor enhancers as well. Partial separation of MRPs can be carried out to obtain volatile substances, which can be further separated by distillation etc. or obtain non-volatile substances for instance by recrystallization, chromatograph etc. could be done to meet different targets of taste and flavor. Therefore, in this specification, MRPs include a composition including one or more volatile substances, one or more non-volatile substances or mixtures thereof. Non-volatile substances in MRPs or isolated from MRPs can provide a good mouth feel, umami and Kokumi taste.

### III. Glycosylated Morosides from Monk Fruit for Preparation of GMG-MRPs

Monk fruit (luo han guo or swingle) extracts from Siraitia grosvenorii are cultivated on an industrial scale for their use as natural sweeteners. Mogrosides (MGs) present in the monk fruit constitute a family of triterpene glycosides responsible for sweetness in the fruit. The inventors of the present application have found that when glycosylated mogrosides (GMGs) are used as substrates in a Maillard reaction to form Maillard reaction products (MRPs), the resulting GMG-MRP products provide unique sweetening or flavoring compositions with wide-ranging applications to the food and beverage industry, among others.

In one aspect, the present application provides a GMG-MRP based sweetening and flavoring composition comprising a GMG-MRP alone or in combination with one or more high intensity sweeteners, including GMGs and others described herein.

### A. The Glycosylation Reaction

### Glycosyltransferases, Glycosyl Hydrolases and Transglycosidases

The GMGs described in the present application are formed by an exogenous glycosylation reaction in the present of a glycosyltransferase.

As used herein, a “glycosyltransferase” refers to an enzyme that catalyzes the formation of a glycosidic linkage to form a glycoside. A glycoside is any molecule in which a sugar group is bonded through its anomeric carbon to another group via a glycosidic bond. Glycosides can be linked by an O- (an O-glycoside), N- (a glycosylamine), S- (a thioglycoside), or C- (a C-glycoside) glycosidic bond. The sugar group is known as the glycone, and the non-sugar group is known as the aglycone. The glycone can be part of a single sugar group (monosaccharide) or several sugar groups (oligosaccharide). A glycosyltransferase according to the present application further embraces “glycosyltransferase variants” engineered for enhanced activities.

Glycosyltransferases utilize “activated” sugar phosphates as glycosyl donors and catalyze glycosyl group transfer to an acceptor molecule comprising a nucleophilic group, usually an alcohol. A retaining glycosyltransferase is one which transfers a sugar residue with the retention of anomeric configuration. Retaining glycosyltransferase enzymes retain the stereochemistry of the donor glycosidic linkage after transfer to an acceptor molecule. An inverting glycosyltransferase, on the other hand, is one which transfers a sugar residue with the inversion of anomeric configuration. Glycosyltransferases are classified based on amino acid sequence similarities. Glycosyltransferases are classified by the Nomenclature Committee of the International Union of Biochemistry and Molecular Biology (NC-IUBMB) in the enzyme class of EC 2.4.1 based on the reaction catalyzed and the specificity.

Glycosyltransferases can utilize a range of donor substrates. Based on the type of donor sugar transferred, these enzymes are grouped into families based on sequence similarities. Exemplary glycosyltransferases include glucanotransferases, N-acetylglucosaminyltransferases, N-acetylgalactosaminyltransferases, fucosyltransferases, mannosyltransferases, galactosyltransferases, sialyltransferases, galactosyltransferases, fucosyltransferase, Leloir glycosyltransferases, non-Leloir glycosyltransferases, and other glycosyltransferases in the enzyme class of EC 2.4.1. The Carbohydrate-Active Enzymes database (CAZy) provides a continuously updated list of the glycosyltransferase families.

In some embodiments, the glycosylation products described in the present application, such as the GMGs and GMG-MRPs, are formed from a reaction mixture comprising an exogenous glycosyltransferase classified as an EC 2.4.1 enzyme, including but not limited to members selected from the group consisting of cyclomaltodextrin glucanotransferase (CGTase; EC 2.4.1.19), amylosucrase (EC 2.4.1.4), dextransucrase (EC 2.4.1.5), amylomaltase, sucrose:sucrose fructosyltransferase (EC 2.4.1.99), 4-α-glucanotransferase (EC 2.4.1.25), lactose synthase (EC 2.4.1.22), sucrose-1,6-α-glucan 3(6)-α-glucosyltransferase, maltose synthase (EC 2.4.1.139), alternasucrase (EC 2.4.1.140), including variants thereof.

Cyclomaltodextrin glucanotransferase, also known as CGTase, is an enzyme assigned with enzyme classification number EC 2.4.1.19, which can catalyze the hydrolysis and formation of (1→4)-α-D-glucosidic bonds, and in particular the formation of cyclic maltodextrins from polysaccharides as well as the disproportionation of linear oligosaccharides.

Dextransucrase is an enzyme assigned with enzyme classification number EC 2.4.1.5, and is also known as sucrose 6-glucosyltransferase, SGE, CEP, sucrose-1,6-α-glucan glucosyltransferase, or sucrose: 1,6-α-D-glucan 6-α-D-glucosyltransferase. Dextransucrases can catalyze the reaction: sucrose+[(1→6)-α-D-glucosyl]n=D-fructose+[(1→6)-α-D-glucosyl]n+1. In addition, a glucosyltransferase (DsrE) from Leuconostoc mesenteroides, NRRL B-1299 has a second catalytic domain (“CD2”) capable of adding alpha-1,2 branching to dextrans.

Glycosyltransferases and other glycosylating enzymes for use in the present application may be derived from any source and may be used in a purified form, in an enriched concentrate or as a crude enzyme preparation.

In some embodiments, the glycosylation reaction is carried out by glycosylating an aglycone or glycoside substrate using e.g., a nucleotide sugar donor (e.g., sugar mono- or diphosphonucleotide) or “Leloir donor” in conjunction with a “Leloir glycosyltransferase” (after Nobel prize winner, Luis Leloir) that catalyzes the transfer of a monosaccharide unit from the nucleotide-sugar (“glycosyl donor’) to a “glycosyl acceptor”, typically a hydroxyl group in an aglycone or glycoside substrate.

Accordingly, in some embodiments the glycosylation product of the present application is formed from a reaction mixture comprising a nucleotide sugar.

In certain embodiments, the glycosylation reactions may involve the use of a specific Leloir glycosyltransferase in conjunction with a wide range of sugar nucleotides donors, including e.g., UDP-glucose, GDP-glucose, ADP-glucose, CDP-glucose, TDP-glucose or IDT-glucose in combination with a glucose-dependent glycosyltransferase (GDP-glycosyltransferases; GGTs), ADP-glucose-dependent glycosyltransferase (ADP-glycosyltransferases; AGTs), CDP-glucose-dependent glycosyltransferase (CDP-glycosyltransferases; CGTs), TDP-glucose-dependent glycosyltransferase (TDP-glycosyltransferases; TGTs) or IDP-glucose-dependent glycosyltransferase (IDP-glycosyltransferases; IGTs), respectively.

In particular embodiments, the exogenous glycosylation reaction is carried out using an exogenous Leloir-type UDP-glycosyltransferase enzyme of the classification EC 2.4.1.17, which catalyzes the transfer of glucose from UDP-α-D-glucuronate (also known as UDP-glucose) to an acceptor, releasing UDP and forming acceptor β-D-glucuronoside. In some embodiments, the glycosyltransferases include, but are not limited to, enzymes classified in the GT1 family. In certain preferred embodiment, the glycosylation reaction is catalyzed by an exogenous UDP-glucose-dependent glycosyltransferase. In some embodiments, the glycosylation reaction is catalyzed by a glycosyltransferase capable of transferring a non-glucose monosaccharide, such as fructose, galactose, ribose, arabinose, xylose, mannose, psicose, fucose and rhamnose, and derivative thereof, to the recipient.

U.S. Pat. No. 9,567,619 describes several UDP-dependent glycosyltransferases that can be used to transfer monosaccharides to rubusoside, including UGT76G1 UDP glycosyltransferase, HV1 UDP-glycosyltransferase, and EUGT11, a UDP glycosyltransferase-sucrose synthase fusion enzyme. The EUGT11 fusion enzyme contains a uridine diphospho glycosyltransferase domain coupled to a sucrose synthase domain and can exhibit 1,2-β glycosidic linkage and 1,6-β glycosidic linkage enzymatic activities, as well as sucrose synthase activity. Of the foregoing enzymes, UGT76G1 UDP glycosyltransferase contains a 1,3-O-glucose glycosylation activity which can transfer a second glucose moiety to the C-3′ of 13-O-glucose of rubusoside to produce rebaudioside G (“Reb G”); HV1 UDP-glycosyltransferase contains a 1,2-O-glucose glycosylation activity which can transfer a second glucoside moiety to the C-2′ of 19-O-glucose of rubusoside to produce rebaudioside KA (“Reb KA”); and the EUGT11 fusion enzyme contains a 1,2-O-glucose glycosylation activity which transfers a second glucose moiety to the C-2′ of 19-O-glucose of rubusoside to produce rebaudioside KA or transfer a second glucose moiety to the C-2′ of 13-O-glucose of rubusoside to produce stevioside. In addition, HV1 and EUGT11 can transfer a second sugar moiety to the C-2′ of 19-O-glucose of rebaudioside G to produce rebaudioside V (“Reb V”) and can additionally transfer a second glucose moiety to the C-2′ of 13-O-glucose of rebaudioside KA to produce rebaudioside E (“Reb E”). Furthermore, when used singly or in combination, these enzymes can be used to generate a variety of steviol glycosides known to be present in Stevia rebaudiana, including rebaudioside D (“Reb D”) and rebaudioside M (“Reb M”).

In some embodiments, monosaccharides that can be transferred to a saccharide or monosaccharide acceptor include, but are not limited to glucose, fructose, galactose, ribose, arabinose, xylose, mannose, psicose, fucose and rhamnose, and derivative thereof, as well as acidic sugars, such as sialic acid, glucuronic acid and galacturonic acid.

In some embodiments, glycosylation of MGs is driven by an exogenous glycosyl hydrolase or glycosidase from the enzyme class of EC 3.2.1. GHs normally cleave a glycosidic bond. However, they can be used to form glycosides by selecting conditions that favor synthesis via reverse hydrolysis. Reverse hydrolysis is frequently applied e.g., in the synthesis of aliphatic alkylmonoglucosides.

Glycosyl hydrolases have a wide range of donor substrates usually employing monosaccharides, oligosaccharides, or/and engineered substrates (i.e., substrates carrying various functional groups). They often display activity towards a large variety of carbohydrate and non-carbohydrate acceptors. Glycosidases usually catalyze the hydrolysis of glycosidic linkages with either retention or inversion of stereochemical configuration in the product.

In some embodiments, the glycosylation products of the present application, including the GMGs and GMG-MRPs, are formed from a reaction mixture comprising an exogenous glycosyl hydrolase classified as an EC 3.2.1 enzyme, including but not limited to alpha-glucosidase, beta-glucosidase and beta-fructofuranosidase.

Exemplary glycosyl hydrolases for use in the present application include, but are not limited to α-amylases (EC 3.2.1.1), α-glucosidases (EC 3.2.1.20), β-glucosidases (EC 3.2.1.21), α-galactosidases (EC 3.2.1.22), β-galactosidases (EC 3.2.1.23), α-mannosidase (EC 3.2.1.24), β-mannosidase (EC 3.2.1.25), β-fructofuranosidase (EC 3.2.1.26), amylo-1,6-glucosidases (EC 3.2.1.33), β-D-fucosidases (EC 3.2.1.38), α-L-rhamnosidases (EC 3.21.40), glucan 1,6-α-glucosidases (EC 3.2.70), and variants thereof.

In some embodiments, the glycosylation products of the present application are formed using a class of glycoside hydrolases or glycosyltransferases known as “transglycosylases.” As used herein, the term “transglycosylase” and “transglycosidase” (TG) are used interchangeably with reference to a glycoside hydrolase (GH) or glycosyltransferase (GT) enzyme capable of transferring a monosaccharide moiety from one molecule to another. Thus, a GH can catalyze the formation of a new glycosidic bond either by transglycosylation or by reverse hydrolysis (i.e., condensation).

The acceptor for transglycosylase reaction acceptor can be saccharide acceptor or a monosaccharide acceptor. Thus, a transglycosidase can transfer a monosaccharide moiety to a diverse set of aglycones, including e.g., monosaccharide acceptors, such as aromatic and aliphatic alcohols. Transglycosidases can transfer a wide variety of monosaccharides (D- or L-configurations) to saccharide acceptors, including glycosides, as well as monosaccharide acceptors, including a wide variety of flavonoid aglycones, such as naringenin, quercetin, hesperetin.

Monosaccharides that can be transferred to a saccharide or monosaccharide acceptor include, but are not limited to glucose, fructose, galactose, ribose, arabinose, xylose, mannose, psicose, fucose and rhamnose, and derivative thereof, as well as acidic sugars, such as sialic acid, glucuronic acid and galacturonic acid. The term “transglucosidase” is used when the monosaccharide moiety is a glucose moiety.

Transglycosidases include GHs or GTs from the enzyme classes of EC 3.2.1 or 2.4.1, respectively. In spite of the inclusion of certain glycosyltransferases as transglycosidases, TGs are classified into various GH families on the basis of sequence similarity. Many retaining glycosidases catalyze both hydrolysis and transglycosylation reactions. These enzymes catalyze the intra- or intermolecular substitution of the anomeric position of a glycoside. Under kinetically controlled reactions, retaining glycosidases can be used to form glycosidic linkages using a glycosyl donor activated by a good anomeric leaving group (e.g., nitrophenyl glycoside). In contrast, the thermodynamically controlled reverse hydrolysis uses high concentrations of free sugars.

Transglycosidases corresponding to any of the GH families with notable transglycosylase activity may be used in the present application, and may include the use of e.g., members of the GH2 family, including LacZ β-galactosidase, which converts lactose to allolactose; GH13 family, which includes cyclodextrin glucanotransferases that convert linear amylose to cyclodextrins, glycogen debranching enzyme, which transfers three glucose residues from the four-residue glycogen branch to a nearby branch, and trehalose synthase, which catalyzes the interconversion of maltose and trehalose; GH16 family, including xyloglucan endotransglycosylases, which cuts and rejoins xyloglucan chains in the plant cell wall; GH31, for example α-transglucosidases, which catalyze the transfer of individual glucosyl residues between α-(1→4)-glucans; GH70 family, for example glucansucrases, which catalyze the synthesis of high molecular weight glucans, from sucrose; GH77 family, for examples amylomaltase, which catalyzes the synthesis of maltodextrins from maltose; and the GH23, GH102, GH103, and GH104 families, which include lytic transglycosylases that convert peptidoglycan to 1,6-anhydrosugars.

In one embodiment, the glycosyltransferase is a transglucosylase from the glycoside hydrolase 70 (GH70) family. GH70 enzymes are transglucosylases produced by lactic acid bacteria from, e.g., Streptococcus, Leuconostoc, Weisella or Lactobacillus genera. Together with the families GH13 and GH77 enzymes, they form the clan GH-H. Most of the enzymes classified in this family use sucrose as the D-glucopyranosyl donor to synthesize α-D-glucans of high molecular mass (>106 Da) with the concomitant release of D-fructose. They are also referred to as glucosyltransferases or glucansucrases.

A wide range of α-D-glucans, varying in size, structure, degree of branching and spatial arrangements can thus be produced by GH70 family members. For example, GH70 glucansucrases can transfer D-glucosyl units from sucrose onto hydroxyl acceptor groups. Glucansucrases catalyze the formation of linear as well as branched α-D-glucan chains with various types of glycosidic linkages, namely α-1,2; α-1,3; α-1,4; and/or α-1,6.

In addition, sucrose analogues such as α-D-glucopyranosyl fluoride, p-nitrophenyl α-D-glucopyranoside, α-D-glucopyranosyl α-L-sorofuranoside and lactulosucrose can be utilized as D-glucopyranosyl donors. A large variety of acceptors may be recognized by glucansucrases, including carbohydrates, alcohols, polyols, or flavonoids to yield oligosaccharides or gluco-conjugates.

Exemplary glucansucrases for use in the present application include e.g., dextransucrase (sucrose:1,6-α-D-glucosyltransferase; EC 2.4.1.5), alternansucrase (sucrose:1,6(1,3)-α-D-glucan-6(3)-α-D-glucosyltransferase, EC 2.4.1.140), mutansucrase (sucrose:1,3-α-D-glucan-3-α-D-glucosyltransferase; EC 2.4.1.125), and reuteransucrase (sucrose:1,4(6-α-D-glucan-4(6)-α-D-glucosyltransferase; EC 2.4.1.-). The structure of the resultant glucosylated product is dependent upon the enzyme specificity.

In some embodiments, a fructosyltransferase may be used to catalyze the transfer of one or more fructose units, optionally comprising terminal glucose, of the following sequence: (Fru)n-Glc consisting of one or more of: β 2,1, β 2,6, α 1,2 and β-1,2 glycosidic bonds, wherein n typically is 3-10. Variants include Inulin type β-1,2 and Levan type β-2,6 linkages between fructosyl units in the main chain. Exemplary fructosytransferase for use in the present application include e.g., β-fructofuranosidase (EC 3.2.1.26), inulosucrase (EC 2.4.1.9) levansucrase (EC 2.4.1.10), or endoinulinase.

In some embodiments, a galactosyltransferase or β-galactosidase may be used to catalyze the transfer of multiple saccharide units, in which one of the units is a terminal glucose and the remaining units are galactose and disaccharides comprising two units of galactose. In certain embodiments, the resulting structure includes a mixture of galactopyranosyl oligomers (DP=3-8) linked mostly by 3-(1,4) or 3-(1,6) bonds, although low proportions of 3-(1,2) or 3-(1,3) linkages may also be present. Terminal glucosyl residues are linked by 3-(1,4) bonds to galactosyl units. These structures may be synthesized by the reverse action of β-galactosidases (EC 3.2.1.23) on lactose at relatively high concentrations of lactose.

In some embodiments, the transglycosidase is an enzyme having trans-fucosidase, trans-sialidase, trans-lacto-N-biosidase and/or trans-N-acetyllactosaminidase activity.

In some embodiments, the glycosylation reactions may utilize a combination of any of glycosyltransferases described herein in combination with any one of the glycosyl hydrolases or transglycosidases described herein. In these reactions, the transglycosylase and the glycosyl hydrolase or transglycosidase may be present in a range of ratios (w/w), wherein the transglycosylase/glycosyl hydrolase ratio (w/w) ranges from 100:1, 80:1, 60:1, 40:1, 30:1, 25:1, 20:1, 15:1, 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, 1:10, 1:15, 1:20, 1:25, 1:30, 1:40, 1:50, 1:60, 1:80, 1:100, or any ratio derived from any two of the aforementioned integers.

### B. Reaction Conditions for Glycosylation

The GMGs of the present application can be obtained for example, by synthetic manipulation or by enzymatic processes. The GMGs obtained by these methods are therefore non-naturally occurring MGs.

The glycosylating enzyme may be dissolved in the reaction mixture or immobilized on a solid support which is contacted with the reaction mixture. If the enzyme is immobilized, it may be attached to an inert carrier. Suitable carrier materials are known in the art. Examples for suitable carrier materials are clays, clay minerals such as kaolinite, diatomeceous earth, perlite, silica, alumina, sodium carbonate, calcium carbonate, cellulose powder, anion exchanger materials, synthetic polymers, such as polystyrene, acrylic resins, phenol formaldehyde resins, polyurethanes, and polyolefins, such as polyethylene and polypropylene. For preparing carrier-bound enzymes the carrier materials usually are used in the form of fine powders, wherein porous forms are preferred. The particle size of the carrier material usually does not exceed 5 mm, in particular 2 mm. Further, suitable carrier materials are calcium alginate and carrageenan. Enzymes may directly be linked by glutaraldehyde. A wide range of immobilization methods are known in the art. Ratio of reactants can be adjusted based on the desired performance of the final product. The temperature of the glycosylation reaction can be in the range of 1-100° C., preferably 40-80° C., more preferably 50-70° C.

In certain embodiments, the GMGs of the present application are prepared as follows: i) mixing a starting MG composition or monk fruit extract with a sugar-donor material to obtain a mixture; and ii) adding an effective amount of an enzyme to the mixture to form a reaction mixture, wherein the enzyme catalyzes the transfer of sugar moieties from the sugar-donor material to MGs in the starting MG composition or monk fruit extract; and iii) incubating the reaction mixture at a desired temperature for a desired length of reaction time to glycosylate MGs with sugar moieties present in the sugar-donor molecule. In some embodiments, after achieving a desired ratio of GMGs to residual MG contents, the reaction mixture can be heated to a sufficient temperature for a sufficient amount of time to inactivate the enzyme. In some embodiments, the enzyme is removed by filtration in lieu of inactivation. In other embodiments, the enzyme is removed by filtration following inactivation. In some embodiments the resulting solution comprising GMGs, residual MGs, residual reducing sugar donors and/or residual amine donors is decolorized.

In some embodiments, the GMG composition used in the present application is prepared as follows: (i) dissolving a glucose-donor material in water to form a liquefied glucose-donor material; (ii) adding a starting MG composition or monk fruit extract to liquefied glucose-donor material to obtain a mixture; and (iii) adding an effective amount of an enzyme to the mixture to form a reaction mixture, wherein the enzyme catalyzes the transfer of glucose moieties from the glucose-donor material to the MGs in the reaction mixture; and iv) incubating the reaction mixture at a desired temperature for a desired length of reaction time to glycosylate the MGs with glucose moieties present in the glucose-donor molecule.

In some embodiments, after achieving a desired ratio of GMGs, alone or in combination with residual MG contents, the reaction mixture can be heated to a sufficient temperature for a sufficient amount of time to inactivate the enzyme. In some embodiments, the enzyme is removed by filtration in lieu of inactivation. In other embodiments, the enzyme is removed by filtration following inactivation. In some embodiments the resulting solution comprising GMGs, residual MGs, and/or dextrin is decolorized.

In some embodiments the resulting solution of GMGs, including residual MGs and dextrin is dried. In some embodiments, the drying is by spray drying. In some embodiments, step (i) comprises the substeps of (a) mixing a glucose-donor material with a desired amount of water to form a suspension, (b) adding a desired amount of enzyme to the suspension and (c) incubating the suspension at a desired temperature for a desired time to form liquefied glucose-donor material. Starch can be a suitable substitute for dextrin(s). Dextrins can be obtained by the hydrolysis of starch.

The enzymatically catalyzed reaction can be carried out batch wise, semi-batch wise or continuously. Reactants can be supplied at the start of reaction or can be supplied subsequently, either semi-continuously or continuously. The catalytic amount of glycosidase or glycosyltransferase required for the method of the invention depends on the reaction conditions, such as temperature, solvents, and amount of substrate.

The reaction can be performed in aqueous media such as buffer. A buffer adjusts the pH of the reaction mixture to a value suitable for effective enzymatic catalysis. Typically, the pH is in the range of about pH 4 to about pH 9, for example of about pH 5 to about pH 7. Suitable buffers comprise, but are not limited to, sodium acetate, tris(hydroxymethyl) aminomethane (“Tris”) and phosphate buffers.

Optionally, the reaction may take place in the presence of a solvent mixture of water and a water miscible organic solvent at a weight ratio of water to organic solvent of from 0.1:1 to 9:1, for example from 1:1 to 3:1. The organic solvent is no primary or secondary alcohol and, accordingly, is non-reactive towards the polysaccharide. Suitable organic solvents comprise alkanones, alkylnitriles, tertiary alcohols and cyclic ethers, and mixtures thereof, for example acetone, acetonitrile, t-pentanol, t-butanol, 1,4-dioxane and tetrahydrofuran, and mixtures thereof. Generally, the use of organic solvents is not preferred.

In certain embodiments, the GMGs of the present application are prepared as follows: i) dissolving a glucose-donor material in water to form a liquefied glucose-donor material; ii) adding a starting GMG composition or glycosylated monk fruit extract (GME) to liquefied glucose-donor material to obtain a mixture; and iii) adding an effective amount of an enzyme to the mixture to form a reaction mixture, wherein the enzyme catalyzes the transfer of glucose moieties from the glucose-donor material to MGs in the starting GMG composition or GMFE; and iv) incubating the reaction mixture at a desired temperature for a desired length of reaction time to glycosylate MGs with glucose moieties present in the glucose-donor molecule. In some embodiments, after achieving a desired ratio of GMG- and residual MG contents, the reaction mixture can be heated to a sufficient temperature for a sufficient amount of time to inactivate the enzyme. In some embodiments, the enzyme is removed by filtration in lieu of inactivation. In other embodiments, the enzyme is removed by filtration following inactivation. In some embodiments the resulting solution comprising GMGs, residual MGs and dextrin is decolorized. In certain embodiments the resulting solution of GMGs, including residual MGs and dextrin is dried. In some embodiments, the drying is by spray drying. In some embodiments, step (i) comprises the substeps of (a) mixing a glucose-donor material with a desired amount of water to form a suspension, (b) adding a desired amount of enzyme to the suspension and (c) incubate the suspension at a desired temperature for a desired time to form liquefied glucose-donor material. Starch can be a suitable substitute for dextrin(s) and/or dextrin(s) can be obtained by the hydrolysis of starch.

### C. Preparation of Glycosylation Products

In certain embodiments, the GMGs used in the present application are prepared as follows: i) dissolving a sugar-donor material in water to form a liquefied sugar-donor material; ii) adding a starting mogroside composition or monk fruit extract to liquefied sugar-donor material to obtain a mixture; and iii) adding an effective amount of an enzyme to the mixture to form a reaction mixture, wherein the enzyme catalyzes the transfer of sugar moieties from the sugar-donor material to mogrosides present in mogroside composition or monk fruit extract; and iv) incubating the reaction mixture at a desired temperature for a desired length of reaction time to glycosylate mogrosides with sugar moieties present in the sugar-donor molecule.

In some embodiments, after achieving a desired ratio of GMGs and residual mogroside (MG) contents, the reaction mixture can be heated to a sufficient temperature for a sufficient amount of time to inactivate the enzyme. In some embodiments, the enzyme is removed by filtration in lieu of inactivation. In other embodiments, the enzyme is removed by filtration following inactivation. In some embodiments the sugar is glucose, and the sugar donor is a glucose donor. In some embodiments, the glucose donor is starch. In some embodiments the resulting solution comprising GMGs, residual MGs and dextrin is decolorized.

In certain embodiments the resulting solution of GMGs, including residual MGs and dextrin is dried. In some embodiments, the drying is by spray drying. In some embodiments, step i) comprises the substeps of (a) mixing a glucose-donor material with a desired amount of water to form a suspension, (b) adding a desired amount of enzyme to the suspension and (c) incubate the suspension at a desired temperature for a desired time to form liquefied glucose-donor material. Starch can be a suitable substitute for dextrin(s) and/or dextrin(s) can be obtained by the hydrolysis of starch.

In some embodiments, the GMGs are prepared from a monk fruit extract containing one or more enriched MGs, such as MGV.

In some embodiments, the GMGs are prepared from a monk fruit extract enriched for triterpene glycosides.

In some embodiments, the one or more GMGs include glycosylation products of one or more MGs selected from the group consisting of mogroside V (MGV), isomogroside V (IMGV), dehydroxy mogroside V (DMGV), 7-oxomogroside V (7-OMGV), 11-oxomogroside V (11-OMGV), mogroside Ia, mogroside lel, mogroside IIa1, mogroside IIa2, mogroside IIb mogroside IIe (MGIIe), 7-oxo-mogroside IIe, mogroside III (MGIII), 11-deoxy-mogroside III, mogroside IIIa1, mogroside IIIa2, mogroside IIIe (MGIIIe), mogroside IV (MGIV), mogroside IVa (MGIVa), mogroside IVe (MGIVe), 7-oxomogroside IVa, mogroside VI (MGVI), 11-oxomogroside VI (11-OMGVI), mogroside A (MGA), 11-oxo-mogroside A1, neomogroside (NMG), mogroester (MG-E), siamenoside I (SSI), grosvenorine I (GVRI), grosvenorine II (GVRII), grosmomoside I (GMSI) and grosmomoside II (GMSII), and neomogroside.

In certain particular embodiments, the GMGs are formed from MGV as a starting material. In this case, the resulting GMGVs may be characterized by different levels of glycosylation, including but are not limited to GMGVs with 1-50 additional monosaccharide units that are added to the MGV backbone during an exogenous man-made glycosylation reaction. In some embodiments, the additional monosaccharide units are glucose units. In some embodiments, the additional monosaccharide units are non-glucose units, such as fructose, xylose, and galactose units. In some embodiments, the additional monosaccharide units are a mixture of glucose units and non-glucose units.

In some embodiments where the GMGs are formed from a particular mogroside as a starting material, the resulting products are present in an amount greater than 10%, 15%, 20%, 25%, 30%, 35%, 40%, 45%, 50%, 55%, 60%, 65%, 70%, 75%, 80%, 85%, 90% or 95% by weight of the total GMGs. In other embodiments, the resulting products are present in an amount of less than 90%, 80%, 75%, 70%, 65%, 60%, 55%, 50%, 45%, 40%, 35%, 30%, 25%, 20%, 15% or 10% by weight of the total GMGs.

In some embodiments where GMGs are formed from MGV as a starting material, the resulting products contain mono-glycosylated GMGV (containing one added monosaccharide unit to the MGV backbone) in an amount less than 10%, 8%, 6%, 4% or 2% by weight of the total GMGV in the glycosylation products. In some embodiments, the GMGs contain mono-glycosylated GMGV in an amount greater than 1%, 2%, 5%, 5%, 10%, 15%, 20%, 25%, 30%, 35%, 40%, 45%, 50%, 55% or 60% by weight of the total GMGV in the glycosylation products.

In some embodiments where GMGs are formed from MGV as a starting material, the resulting products contain bi-glycosylated GMGV (containing two added monosaccharide units to the MGV backbone) in an amount less than 15%, 12%, 10%, 8%, 6%, 4% or 2% by weight of the total GMGV in the glycosylation products. In some embodiments, the GMGs contain bi-glycosylated GMGV in an amount greater than 1%, 2%, 5%, 5%, 10%, 15%, 20%, 25%, 30%, 35%, 40%, 45% or 50% by weight of the total GMGV in the glycosylation products.

In some embodiments where GMGs are formed from MGV as a starting material, the resulting products contain tri-glycosylated GMGV (containing three added monosaccharide units to the MGV backbone) in an amount less than 5%, 4%, 3%, 2%, 1% by weight of the total GMGV in the glycosylation products. In some embodiments, the GMGs contain tri-glycosylated GMGV in an amount greater than 5%, 10%, 15%, 20%, 25%, 30%, 35% or 40% by weight of the total GMGV in the glycosylation products.

In some embodiments, the GMGs include mono-glycosylated GMGV, bi-glycosylated GMGV and tri-glycosylated GMGV in a total amount of less than 30%, 25%, 20%, 15% or 10% by weight of the total GMGV in the glycosylation products. In some embodiments, the GMGs include mono-glycosylated GMGV, bi-glycosylated GMGV and triglycosylated GMGV in a total amount of greater than 1%, 2%, 5%, 10%, 15%, 20%, 25%, 30%, 35%, 40%, 45%, 50%, 55%, 60%, 65%, 70%, 75%, 80%, 85% or 90% by weight of the total GMGV in the glycosylation products. In some embodiments, the GMGs include mono-glycosylated GMGV, bi-glycosylated GMGV, triglycosylated GMGV, tetraglycosylated GMGV, pentaglycosylated GMGV, hexaglycosylated GMGV, heptaglycosylated GMGV, octoglycosylated GMGV, enneaglycosylated GMGV, decaglycosylated GMGV, hendecaglycosylated GMGV, and dodecaglycosylated GMGV in a total amount of greater than 1%, 2%, 5%, 10%, 15%, 20%, 25%, 30%, 35%, 40%, 45%, 50%, 55%, 60%, 65%, 70%, 75%, 80%, 85% or 90% by weight of the total GMGV in the glycosylation products.

In some embodiments, the glycosylation products are produced from a monk fruit extract composition where the weight percentage of mogrosides is at least 0.1%, 1%, 5%, 8%, or 10%. In some embodiments, the glycosylation products are produced from enriched GMGV, where the enriched GMGV is produced from monk fruit.

### IV. GMG-MRP Based Sweetening and Flavoring Compositions

Monk fruit components (MCs), including MGs, MGEs, GMGs and GMGEs are of interest due to their capability of masking, reducing, suppressing bitterness, sourness and astringency of compounds and consumable products. In particular, a number of high intensity sweeteners, such as sucralose, aspartame, acesulfame-K, neotame, glycyrrhizic acid, glycyrrhizic acid ammonium salt, sodium cyclamate, saccharin, advantame, neohesperidin dihydrochalcone (NHDC), N-[N-[3-(3-hydroxy-4-methoxyphenyl)propyl]-alpha-aspartyl]-L-phenylalanine 1-methyl ester, neotame; glycyrrhizin-derived substances, licorice extracts, SGs, SEs, STEs, STGs, GSGs, GSEs, GSTEs, GSTGs, can create a bitter and astringent taste when used at higher concentrations, thereby limiting their potential applications. Thus, there is a need to find compositions and methods to overcome these disadvantages to facilitate widespread embrace of their use in the food, beverage, pharmaceutical and cosmetic industries.

As described in the present application, adding sufficient amounts and proportions of one or more GMG-MRPs to a sweetener, flavoring agent, food, or beverage product can significantly enhance their sensory taste profiles. The same applies to other natural, synthetic, or semi-synthetic high intensity sweeteners and/or sweetening enhancers

In one aspect, the present application provides a GMG-MRP based sweetening and flavoring composition containing a GMG-MRP alone or in combination with one or more high intensity sweeteners. The sweetening or flavoring composition is particularly useful when added to food and beverage products as further described below.

In some embodiments, the GMG-MRP containing sweetening and flavoring composition further includes one or more high intensity sweeteners selected from the group consisting of MG, GMG, SGs, SEs, GSGs, GSEs, STGs, STEs, GSTGs, GSTEs, combinations thereof, and MRPs thereof, including but not limited to S-MRPs, ST-MRPs, C-MRPs; sucralose, aspartame, acesulfame-K, neotame, saccharin and aspartame, glycyrrhizic acid ammonium salt, sodium cyclamate, saccharin, advantame, neohesperidin dihydrochalcone (NHDC), mixtures thereof, salts thereof, and derivatives thereof.

Monk fruit plants contain a wide variety of compounds, macromolecules, and glycosides (collectively monk fruit components or “MCs”) that can be glycosylated to form one or more GMGs. These GMGs can serve as useful high-intensity sweeteners in the sweetening or flavoring composition described herein and as substrates for forming GMG-MRPs for use in the GMG-MRP-based flavoring or sweetening compositions of the present application.

In some embodiments, the GMG-MRP-containing sweetening or flavoring composition includes one or more GMG-MRPs formed from one or more mogrosides selected from the group consisting of mogroside V (MGV), isomogroside V (IMGV), dehydroxy mogroside V (DMGV), 7-oxomogroside V (7-OMGV), 11-oxomogroside V (11-OMGV), mogroside IIb, mogroside IIe (MGIIe), 7-oxo-mogroside II E, mogroside III (MGIII), 11-deoxy-mogroside III, mogroside IIIe (MGIIIe), mogroside III A2, mogroside IV (MGIV), mogroside IVa (MGIVa), mogroside IVe (MGIVe), -oxomogroside IV A mogroside VI (MGVI), 11-oxomogroside VI (11-OMGVI), mogroside A (MGA), 11-oxo-mogroside A1, neomogroside (NMG), mogroester (MG-E), siamenoside I (SSI), grosvenorine I (GVRI), grosvenorine II (GVRII), grosmomoside I (GMSI) and grosmomoside II (GMSII), and neomogroside.

Optionally, the GMG-MRP-containing sweetening or flavoring composition may further include one or more of the foregoing MGs.

In some embodiments, the GMG-MRP-containing sweetening or flavoring composition includes a GMG composition containing e.g., enriched GMGVs, MGVs, or both.

In some embodiments, the sweetening or flavoring composition includes purified GMGV-MRP.

In some embodiments, the GMG-MRP-containing sweetening or flavoring composition includes at least one GMG-MRP formed from a composition enriched in GMGV or from a composition containing purified GMGV.

In some embodiments, the GMG-MRP-containing sweetening or flavoring composition includes at least one GMG-MRP formed from a composition enriched in GMGV or from a composition containing purified GMGV in combination with purified or enriched MGs, such as MGV.

In some embodiments, the GMG-MRP-containing sweetening or flavoring composition further includes one or more GMGs or GME. In other embodiments, the GMG-MRP-containing sweetening or flavoring composition further includes one or more glycosylated non-MG glycosides. In some embodiments, the GMG-MRP-containing sweetening or flavoring composition further includes thaumatin.

In certain embodiments, the GMG-MRP-containing sweetening or flavoring composition further includes one or more components selected from the group consisting of SGs, SEs, GSGs, GSEs, STGs, STEs, STCs, GSTGs, GSTEs, GSTCs, S-MRPs, ST-MRPs and C-MRPs.

Monk fruit plants and extracts therefrom include a wide variety of biochemically active MCs, including diterpenes, diterpenoids, triterpenes, triterpenoids, carotenoids (tetraterpenoids), flavonoids, isoflavonoids, polyphenols, tannins, carotenoids, free amino acids, vitamins, and the like.

To the extent that any of the aforementioned MCs includes a free hydroxyl group, it can serve as a substrate for a sugar donor in a glycosylation reaction. Moreover, to the extent that any of the MCs has a free amino group or a reactive carbonyl group in the form of a free aldehyde (aldose) or free ketone (ketose), among others, it can serve as a substrate for a Maillard reaction. Notwithstanding the foregoing, Applicants have unexpectedly found that MGs and GMGs can serve as substrates for forming MRPs in the absence of reducing sugars.

In some embodiments, the sweetening or flavoring composition includes one or more monk fruit components (MCs) as MC-MRPs or as MCs added to the sweetening or flavoring composition of the present application.

In some embodiments, the sweetening or flavoring composition includes one or more monk fruit components (MCs) selected from the group consisting of polysaccharides, polyphenols, flavonoids, di-terpene glycosides, and mono-terpene glycosides.

In one embodiment, the present application provides a sweetening or flavoring composition comprising one or more GMGs and/or GMG-MRPs in an amount of 000.1-99.9 wt % of the composition.

In some embodiments, the sweetening or flavoring composition of the present application includes one or more GMG-MRPs in an amount of 000.1-99.9 wt % of the composition. It should be understood that where the amounts of GMG-MRPs in the sweetener or flavoring composition are described in the present application, the same amounts are applicable to MGs and GMGs (non-MRP), which may be optionally added to a sweetening or flavoring composition.

In some embodiments, the sweetening or flavoring composition has a GMG-RP content of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the sweetening or flavoring composition has a GMG-MRP content of 0.001-99 wt %, 0.001-75 wt %, 0.001-50 wt %, 0.001-25 wt %, 0.001-10 wt %, 0.001-5 wt %, 0.001-2 wt %, 0.001-1 wt %, 0.001-0.1 wt %, 0.001-0.01 wt %, 0.01-99 wt %, 0.01-75 wt %, 0.01-50 wt %, 0.01-25 wt %, 0.01-10 wt %, 0.01-5 wt %, 0.01-2 wt %, 0.01-1 wt %, 0.1-99 wt %, 0.1-75 wt %, 0.1 wt-50 wt %, 0.1-25 wt %, 0.1-10 wt %, 0.1-5 wt %, 0.1-2 wt %, 0.1-1 wt %, 0.1-0.5 wt %, 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt %.

In some embodiments, the GMG-MRPs are present in the sweetening or flavoring composition in an amount greater than 0.01 wt %, 0.1 wt %, 1 wt %, 2 wt %, 5 wt %, 10 wt %, 20 wt %, 30 wt %, 40 wt %, 50 wt %, 60 wt %, 70 wt %, 80 wt %, 90 wt %, 95 wt %, or 99 wt %.

In some embodiments, the GMG-MRPs are present in the sweetening or flavoring composition in an amount of less than 80%, 75%, 70%, 65%, 60%, 55%, 50%, 45%, 40%, 35%, 30%, 25%, 20%, 15% or 10% by weight of the sweetening or flavoring composition.

In certain preferred embodiments, the GMG-MRPs include GMGV-MRP in the sweetening or flavoring composition. In particular embodiments, the sweetening or flavoring composition has a GMGV-MRP content of at least 1 wt %, at least 2 wt %, at least 5 wt %, at least 10 wt %, at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, at least 75 wt %, at least 80 wt %, at least 85 wt %, at least 90 wt %, at least 95 wt %, at least 99 wt %, or any range defined by any pair of these integers.

In some embodiments, the above-described GMG-MRP containing sweetening or flavoring composition has a GMGV-MRP content of 0.001-99 wt %, 0.001-75 wt %, 0.001-50 wt %, 0.001-25 wt %, 0.001-10 wt %, 0.001-5 wt %, 0.001-2 wt %, 0.001-1 wt %, 0.001-0.1 wt %, 0.001-0.01 wt %, 0.01-99 wt %, 0.01-75 wt %, 0.01-50 wt %, 0.01-25 wt %, 0.01-10 wt %, 0.01-5 wt %, 0.01-2 wt %, 0.01-1 wt %, 0.1-99 wt %, 0.1-75 wt %, 0.1 wt-50 wt %, 0.1-25 wt %, 0.1-10 wt %, 0.1-5 wt %, 0.1-2 wt %, 0.1-1 wt %, 0.1-0.5 wt %, 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt %.

In some embodiments, the above-described GMG-MRP containing sweetening or flavoring composition further comprises one or more MGs, MEs and/or MCs in an amount of 0.001-99 wt %, 0.001-75 wt %, 0.001-50 wt %, 0.001-25 wt %, 0.001-10 wt %, 0.001-5 wt %, 0.001-2 wt %, 0.001-1 wt %, 0.001-0.1 wt %, 0.001-0.01 wt %, 0.01-99 wt %, 0.01-75 wt %, 0.01-50 wt %, 0.01-25 wt %, 0.01-10 wt %, 0.01-5 wt %, 0.01-2 wt %, 0.01-1 wt %, 0.1-99 wt %, 0.1-75 wt %, 0.1 wt-50 wt %, 0.1-25 wt %, 0.1-10 wt %, 0.1-5 wt %, 0.1-2 wt %, 0.1-1 wt %, 0.1-0.5 wt %, 1-99 wt %, 1-95 wt %, 1-90 wt %, 1-80 wt %, 1-70 wt %, 1-60 wt %, 1-50 wt %, 1-40 wt %, 1-30 wt %, 1-20 wt %, 1-10 wt %, 1-5 wt %, 5-99 wt %, 5-95 wt %, 5-90 wt %, 5-80 wt %, 5-70 wt %, 5-60 wt %, 5-50 wt %, 5-40 wt %, 5-30 wt %, 5-20 wt %, 5-10 wt %, 10-99 wt %, 10-95 wt %, 10-90 wt %, 10-80 wt %, 10-70 wt %, 10-60 wt %, 10-50 wt %, 10-40 wt %, 10-30 wt %, 10-20 wt %, 20-99 wt %, 20-95 wt %, 20-90 wt %, 20-80 wt %, 20-70 wt %, 20-60 wt %, 20-50 wt %, 20-40 wt %, 20-30 wt %, 30-99 wt %, 30-95 wt %, 30-90 wt %, 30-80 wt %, 30-70 wt %, 30-60 wt %, 30-50 wt %, 30-40 wt %, 40-99 wt %, 40-95 wt %, 40-90 wt %, 40-80 wt %, 40-70 wt %, 40-60 wt %, 40-50 wt %, 50-99 wt %, 50-95 wt %, 50-90 wt %, 50-80 wt %, 50-70 wt %, 50-60 wt %, 60-99 wt %, 60-95 wt %, 60-90 wt %, 60-80 wt %, 60-70 wt %, 70-99 wt %, 70-95 wt %, 70-90 wt %, 70-80 wt %, 80-99 wt %, 80-95 wt %, 80-90 wt %, 90-99 wt %, 90-95 wt %, or 95-99 wt % of the total composition.

In some embodiments, the GMG-MRP containing sweetening or flavoring composition further includes one or more high intensity sweeteners described herein. In certain preferred embodiments, the GMG-MRP containing sweetening or flavoring composition further includes thaumatin.

In more particular embodiments, the GMG-MRP containing sweetening or flavoring composition further includes one or more high intensity natural sweeteners selected from the group consisting of SGs, SEs, GSGs, GSEs, STGs, STEs, STCs, GSTGs, GSTEs, GSTCs, S-MRPs, ST-MRPs, and C-MRPs.

In some embodiments, the above-described GMG-MRP containing sweetening or flavoring agent composition further comprises one or more SGs, SEs, GSGs, GSEs, STGs, STEs, STCs, GSTGs, GSTEs, GSTCs, S-MRPs, ST-MRPs, and C-MRPs in the amount of 1% wt/wt, 2% wt/wt, 3% wt/wt, 4% wt/wt, 5% wt/wt, 6% wt/wt, 7% wt/wt, 8% wt/wt. 9% wt/wt, 10% wt/wt, 11% wt/wt, 12% wt/wt, 13% wt/wt, 14% wt/wt, 15% wt/wt, 16% wt/wt, 17% wt/wt, 18% wt/wt, 19% wt/wt, 20% wt/wt, 21% wt/wt, 22% wt/wt, 23% wt/wt, 24% wt/wt, 25% wt/wt, 26% wt/wt, 27% wt/wt, 28% wt/wt, 29% wt/wt, 30% wt/wt, 31% wt/wt, 32% wt/wt, 33% wt/wt, 34% wt/wt, 35% wt/wt, 36% wt/wt, 37% wt/wt, 38% wt/wt, 39% wt/wt, 40% wt/wt, 41% wt/wt, 42% wt/wt, 43% wt/wt, 44% wt/wt, 45% wt/wt, 46% wt/wt, 47% wt/wt, 48% wt/wt, 49% wt/wt, 50% wt/wt, 51% wt/wt, 52% wt/wt, 53% wt/wt, 54% wt/wt, 55% wt/wt, 56% wt/wt, 57% wt/wt, 58% wt/wt, 59% wt/wt, 60% wt/wt, 61% wt/wt, 62% wt/wt, 63% wt/wt, 64% wt/wt, 65% wt/wt, 66% wt/wt, 67% wt/wt, 68% wt/wt, 69% wt/wt, 70% wt/wt, 71% wt/wt, 72% wt/wt, 73% wt/wt, 74% wt/wt, 75% wt/wt, 76% wt/wt, 77% wt/wt, 78% wt/wt, 79% wt/wt, 80% wt/wt, 81% wt/wt, 82% wt/wt, 83% wt/wt, 84% wt/wt, 85% wt/wt, 86% wt/wt, 87% wt/wt, 88% wt/wt, 89% wt/wt, 90% wt/wt, 91% wt/wt, 92% wt/wt, 93% wt/wt, 94% wt/wt, 95% wt/wt, 96% wt/wt, 97% wt/wt, 98% wt/wt or 99% wt/wt, or any range encompassed by any pair of the foregoing integer values.

In some embodiments, the GMG-MRP containing sweetening or flavoring agent composition further includes one or more SGs, SEs, GSGs, GSEs, STGs, STEs, STCs, GSTGs, GSTEs, GSTCs, S-MRPs, ST-MRPs, and C-MRPs in the amount of less than 80% wt/wt, 70% wt/wt, 60% wt/wt, 50% wt/wt, 40% wt/wt, 30% wt/wt, 20% wt/wt, 10% wt/wt or 5% wt/wt.

In some embodiments, the GMG-MRP containing sweetening or flavoring agent composition further includes one or more SGs, SEs, GSGs, GSEs, STGs, STEs, STCs, GSTGs, GSTEs, GSTCs, S-MRPs, ST-MRPs, and C-MRPs in the amount of 1% wt/wt to about 99% wt/wt, from about 1% wt/wt to about 98% wt/wt, from about 1% wt/wt to about 97% wt/wt, from about 1% wt/wt to about 95% wt/wt, from about 1% wt/wt to about 90% wt/wt, from about 1% wt/wt to about 80% wt/wt, from about 1% wt/wt to about 70% wt/wt, from about 1% wt/wt to about 60% wt/wt, from about 1% wt/wt to about 50% wt/wt, from about 1% wt/wt to about 40% wt/wt, from about 1% wt/wt to about 30% wt/wt, from about 1% wt/wt to about 20% wt/wt, from about 1% wt/wt to about 10% wt/wt, from about 1% wt/wt to about 5% wt/wt, from about 2% wt/wt to about 99% wt/wt, from about 2% wt/wt to about 98% wt/wt, from about 2% wt/wt to about 97% wt/wt, from about 2% wt/wt to about 95% wt/wt, from about 2% wt/wt to about 90% wt/wt, from about 2% wt/wt to about 80% wt/wt, from about 2% wt/wt to about 70% wt/wt, from about 2% wt/wt to about 60% wt/wt, from about 2% wt/wt to about 50% wt/wt, from about 2% wt/wt to about 40% wt/wt, from about 2% wt/wt to about 30% wt/wt, from about 2% wt/wt to about 20% wt/wt, from about 2% wt/wt to about 10% wt/wt, from about 2% wt/wt to about 5% wt/wt, from about 3% wt/wt to about 99% wt/wt, from about 3% wt/wt to about 98% wt/wt, from about 3% wt/wt to about 97% wt/wt, from about 3% wt/wt to about 95% wt/wt, from about 3% wt/wt to about 90% wt/wt, from about 3% wt/wt to about 80% wt/wt, from about 3% wt/wt to about 70% wt/wt, from about 3% wt/wt to about 60% wt/wt, from about 3% wt/wt to about 50% wt/wt, from about 3% wt/wt to about 40% wt/wt, from about 3% wt/wt to about 30% wt/wt, from about 3% wt/wt to about 20% wt/wt, from about 3% wt/wt to about 10% wt/wt, from about 3% wt/wt to about 5% wt/wt, from about 5% wt/wt to about 99% wt/wt, from about 5% wt/wt to about 98% wt/wt, from about 5% wt/wt to about 97% wt/wt, from about 5% wt/wt to about 95% wt/wt, from about 5% wt/wt to about 90% wt/wt, from about 5% wt/wt to about 80% wt/wt, from about 5% wt/wt to about 70% wt/wt, from about 5% wt/wt to about 60% wt/wt, from about 5% wt/wt to about 50% wt/wt, from about 5% wt/wt to about 40% wt/wt, from about 5% wt/wt to about 30% wt/wt, from about 5% wt/wt to about 20% wt/wt, from about 5% wt/wt to about 10% wt/wt, from about 10% wt/wt to about 99% wt/wt, from about 10% wt/wt to about 98% wt/wt, from about 10% wt/wt to about 97% wt/wt, from about 10% wt/wt to about 95% wt/wt, from about 10% wt/wt to about 90% wt/wt, from about 10% wt/wt to about 80% wt/wt, from about 10% wt/wt to about 70% wt/wt, from about 10% wt/wt to about 60% wt/wt, from about 10% wt/wt to about 50% wt/wt, from about 10% wt/wt to about 40% wt/wt, from about 10% wt/wt to about 30% wt/wt, from about 10% wt/wt to about 20% wt/wt, from about 20 to less than about 50 percentage by weight, from about 30 to less than about 50 percentage by weight, from about 40 to less than about 50 percentage by weight, and from about 20 to 45 percentage by weight of the of the sweetening or flavoring agent composition.

In some embodiments, the GMG-MRP containing sweetening or flavoring composition further includes one or more flavonoid glycosides, isoflavone glycosides, saponin glycosides, phenol glycosides, cyanophore glycosides, anthraquinone glycosides, cardiac glycosides, bitter glycosides, coumarin glycosides, or sulfur glycosides.

In some embodiments, the GMG-MRP containing sweetening or flavoring composition further includes one or more glycosylated flavonoid glycosides, glycosylated isoflavone glycosides, glycosylated saponin glycosides, glycosylated phenol glycosides, glycosylated cyanophore glycosides, glycosylated anthraquinone glycosides, glycosylated cardiac glycosides, glycosylated bitter glycosides, glycosylated coumarin glycosides, or glycosylated sulfur glycosides.

Exemplary flavonoids include, but are not limited to, anthocyanidins; anthoxanthins, including flavones, such as luteolin, apigenin, tangeritin; and flavonols, such as quercetin, kaempferol, myricetin, fisetin, galangin, isorhamnetin, pachypodol, rhamnazin, pyranoflavonols, furanoflavonols; flavanones, such as hesperetin, naringenin, eriodictyol, and homoeriodictyol; flavanonols, such as taxifolin (or dihydroquercetin) and dihydrokaempferol; and flavans, including flavanols, such as catechin, gallocatechin, catechin 3-gallate, gallocatechin 3-gallate, epicatechin, epigallocatechin (EGC), epicatechin 3-gallate, epigallocatechin 3-gallate, theaflavin, theaflavin-3′-gallate, theaflavin-3,3′-digallate, thearubigin, and proanthocyanidins, which are dimers, trimers, oligomers, or polymers of the flavanols, and glycosides thereof.

Exemplary isoflavonoids include isoflavones, such as genistein, daidzein, glycitein; isoflavanes, isoflavandiols, isoflavenes, coumestans, pterocarpans, and glycosides thereof.

Exemplary polyphenols include gallic acid, ellagic acid, quercetin, isoquercitrin, rutin, citrus flavonoids, catechins, proanthocyanidins, procyanidins, anthocyanins, resveratrol, isoflavones, curcumin, hesperidin, naringin, and chlorogenic acid, and glycosides thereof.

Exemplary tannins include gallic acid esters, ellagic acid esters, ellagitannins, including rubusuaviins A, B, C, D, -E, and —F; punicalagins, such as pedunculagin and 1(β)-O-galloyl pedunculagin; strictinin, sanguiin H-5, sanguiin H-6, 1-desgalloyl sanguiin H-6. lambertianin A, castalagins, vescalagins, castalins, casuarictins, grandimins, punicalins, roburin A, tellimagrandin II, terflavin B; gallotannins, including digalloyl glucose and 1,3,6-trigalloyl glucose; flavan-3-ols, oligostilbenoids, proanthocyanidins, polyflavonoid tannins, catechol-type tannins, pyrocatecollic type tannins, flavolans, and glycosides thereof.

Exemplary carotenoids include carotenes, including α-, β-, γ-, δ-, and ε-carotenes, lycopene, neurosporene, phytofluene, phytoene; and xanthophylls, including canthaxanthin, cryptoxanthin, zeaxanthin, astaxanthin, lutein, rubixanthin, and glycosides thereof.

In some embodiments, the GMG-MRP containing sweetening or flavoring composition includes one or more diterpenes, diterpenoids, triterpenes and/or triterpenoids. Exemplary diterpenes and diterpenoids include steviol, ent-16α,17-dihydroxy-kaurane-19-oic acid, ent-13-hydroxy-kaurane-16-en-19-oic acid, ent-16β,17-dihydroxy-kaurane-3-one, ent-16α,17-dihydroxy-kaurane-19-oic acid, ent-16α,17-dihydroxy-kaurane-3-one, ent-kaurane-3α,16β,17-3-triol, ent-13,17-dihydroxy-kaurane-15-en-19-oic acid, and glycosides thereof. Exemplary triterpenes and triterpenoids, include oleanolic acid, ursolic acid, saponin, and glycosides thereof.

In some embodiments, the GMG-MRP-containing sweetening or flavoring composition further includes MRPs formed from one or more flavonoid glycosides, isoflavone glycosides, saponin glycosides, phenol glycosides, cyanophore glycosides, anthraquinone glycosides, cardiac glycosides, bitter glycosides, coumarin glycosides, and/or sulfur glycosides.

In some embodiments, the GMG-MRP-containing sweetening or flavoring composition further includes MRPs formed from one or more glycosylated flavonoid glycosides, glycosylated isoflavone glycosides, glycosylated saponin glycosides, glycosylated phenol glycosides, glycosylated cyanophore glycosides, glycosylated anthraquinone glycosides, glycosylated cardiac glycosides, glycosylated bitter glycosides, glycosylated coumarin glycosides, and/or glycosylated sulfur glycosides.

In some embodiments, the GMG-MRP-containing sweetening or flavoring composition further includes MRPs formed from one or more flavonoid glycosides, isoflavone glycosides, saponin glycosides, phenol glycosides, cyanophore glycosides, anthraquinone glycosides, cardiac glycosides, bitter glycosides, coumarin glycosides, or sulfur glycosides.

In some embodiments, the GMG-MRP-containing sweetening or flavoring composition further includes MRPs formed from one or more glycosylated flavonoid glycosides, glycosylated isoflavone glycosides, glycosylated saponin glycosides, glycosylated phenol glycosides, glycosylated cyanophore glycosides, glycosylated anthraquinone glycosides, glycosylated cardiac glycosides, glycosylated bitter glycosides, glycosylated coumarin glycosides, and/or glycosylated sulfur glycosides.

### V. Rationale for the Subject Matter of the Present Application

The inventor of the present application has surprisingly found GMG-MRP compositions of the present application deliver unique retronasal aromas to the olfactory epithelium which serve to better synchronize and increase the intensity, duration of flavor, mouthfeel and taste when added to food and beverage products. Further, the retronasal olfaction results from present compositions disclosed herein show an enhancement in the ripeness of fruity/berry notes in foods and beverages. Additionally, when starting with compositions derived from acidic fruits or berries during preparation of the GMG-MRP compositions of the present application, the resulting products can increase the green and fresh notes in foods and beverages. Thus, the use of the GMG-MRP compositions of the present application can improve the flavor intensity, increase the duration of flavor, and provide improved mouthfeel and taste to consumable products and can enhance the fruity and green notes of flavor in foods and beverages.

Metallic off-notes are a common problem for modem sugar reduction methodologies applied to plant-based sweetening or flavoring compositions for use in foods and beverages. The inventor of the present application has surprisingly found through retronasal olfaction effects described in the present application that GMG-MRPs can block or remove the metallic off-notes in plant-based sweetening or flavoring compositions used in foods and beverages. Therefore, embodiments of the present application include the addition of GMG-MRPs compositions described herein to block or remove these metallic off-notes in consumables.

Clear and strong stimuli (congruent flavors can strengthen stimuli synergistically) catch our attention quickly and favor a bottom-up sensory recognition process. A bottom-up process produces a very short time to a decision. If the decision involves recognition of flavor with a positive perception, the bottom-up sensory recognition process yields satisfaction. Unclear and weak stimuli trigger ambiguity in the brain processing and favor the top-down process (i.e., autonomous, non-stimuli related decision) with dissatisfaction. Not wishing to be bound by theory, the inventor believes that neural circuits involved in oral sensation such as taste sensation, oral somatosensation, retronasal olfaction for recognition, perception, and hedonic rating of integrated flavors in foods and beverages overlap with one another. The inventor believes that the combination of retronasal stimuli, subconscious somatosensory stimuli, and subconscious taste stimuli in this invention can provide cues for priming effect and associative learning, thus make the orthonasal smell and overall flavor learning experience of both sugar and sugar-reduced food and beverage faster.

It is important to pair orally sourced retronasal and somatosensory stimuli for orthonasal smell so that consumers can recognize an orthonasal smell of a consumable that is associated with good taste. Current nutritional sugars such as sucrose, corn syrup, honey etc. contain unconscious retronasal stimuli in consumables, thereby creating a need for compositions to replace sugar's multi-function including mouthfeel to make consumable palatable. Adding the GMG-MRP compositions of the present application to consumables can improve the overall flavor experience of both sugar and sugar-reduced consumables by enhancing the taste sensation, somatosensation, and retronasal olfaction to provide priming effects and associative learning to achieve faster taste and odor learning. These compositions can further provide a quick onset of sweetness and mouthfeel for consumables when using high intensity sweeteners alone or in combination with others.

Lingering means “long” or “long lasting”. Lingering may be described as a “persistent sensation” constituting a horizontal aspect of sensory analysis. Such persistence can be attributed to ortho- and retro-olfactory, taste and tactile sensations. Reduced lingering shortens sensations. Shortening sensations can be achieved by competitive occupation of receptors, by accelerated release from receptors (i.e., pH changes, dilution with increased salivation) or by flavor modulation (i.e., drawing sensory attention to alternate sensations). The inventor has surprisingly found that the GMG-MRP compositions of the present application can erase the lingering of high intensity sweeteners, such as sucralose and stevia glycosides by faster occupation of sweeteners' receptors. Accordingly, adding the GMG-MRP compositions of the present application to consumable products can reduce or eliminate lingering by promoting faster occupation of sweeteners' receptors when high intensity sweeteners are used.

Bitterness is a quickly recognized retronasal sensation; astringency is a mechanosensation (tactile sensation) caused by increased viscosity (loss of lubricity) of saliva (either triggered directly by astringents or by precipitation of saliva proteins). Astringency builds up slowly in intensity and it is difficult to clear from the mouth. Astringency is described as drying-out, roughening, and puckery (bitter, mouth-contracting) sensation felt in the mouth. Compounds known to increase the viscosity of saliva are sometimes wrongly perceived as being bitter. Increased viscosity relates to mouth-drying and prompts an increase in saliva flow. adding the GMG-MRP compositions of the present application to consumable products can mask such bitterness when high intensity sweeteners or plant-based sweetening ingredients are used.

Memories of taste and flavor are sequential and in order. They can be accessed in the order that they are remembered. Like Marcel Proust wrote in his book, human beings are unable to directly reverse the sequence of a memory. Each sensory characteristic of taste and flavor of consumables is remembered as an elaborate hierarchy of nested activities.

Consumers are constantly predicting the future and hypothesizing what we will experience in taste and smell. This expectation influences what we perceive from consumables. Consumers' conscious experience of perceptions is changed by their interpretations. Consumers can recognize a pattern of taste and flavor of consumables even if only part of it is perceived and even if it contains alterations. Consumers' recognition ability is apparently able to detect invariant features of a pattern-characteristics that survive real-world variations. Segmenting the temporal sequence and size of the tasting decision, this implicates familiar tastes and smells that spark the memory and allows a taster's attention to focus on expected familiar tastes and flavors of consumables, particularly those where the perception is positive.

The present application provides compositions and methods for providing the major components of flavor playing crucial roles in recognition of flavor by simultaneously activating millions of pattern recognitions for a given flavor. As each input from a low-level recognition of taste and flavor from a consumable flow up to a higher level, the perceptional connection can be weighted to provide an indication of how important that particular element in the pattern is. Thus, the more significant elements of pattern recognition for flavors are more heavily weighted in the context of triggering recognition by the taster. If a particular level is unable to fully process and recognize the taste and flavor, the task of recognition would be sent to the next higher level. If none of the levels succeeds in recognizing the pattern of taste and flavor of consumables, it is deemed to be a new pattern of taste and flavor.

Classifying a pattern of taste and flavor as new does not necessarily mean that every aspect of it is new. A person's brain has evolved to save energy when making recognition decisions of taste and flavor. The earlier the flavor is recognized at low-level pattern recognizer, the less energy is spent for recognition by the brain. The present application provides a method to accelerate the speed of recognition of a taste and flavor in consumable, thereby increasing its palatability. Whereas the thalamus is considered a gateway for collecting and preparing sensory information of consumables to enter the neocortex, the neocortex is responsible for sensory perception. Hundreds of millions of pattern recognitions of taste and flavor in the neocortex are being constantly processed by the thalamus. The neocortex determines whether a sensory experience of taste and flavor is novel or not in order to present it to the hippocampus. The present application provides a composition containing many familiar patterns of substances which can be recognized at low-level of recognizer. Compositions of the present application can be beneficially used by consumers suffering from memory loss by ingesting consumable products containing the compositions of the present application to evoke their memories of familiar tastes and flavors.

The inventors have surprisingly found that the compositions of the present application can be used for enhancing the umami attribute of consumable. A particular aspect of what makes umami delicious is aftertaste of consumables. Umami develops over a different time frame than do saltiness and sourness, which disappear quite quickly. Umami persists for longer than all the other basic tastes. This lingering aftertaste is probably one of the reasons why consumers associate umami with deliciousness and something pleasant. It is a taste sensation with fullness and roundness that completely permeates the oral cavity and then dissipates very slowly.

The enhanced umami by the compositions of the present application could successfully mask the unpleasant taste of low sugar, low fat, and low salt consumables. The receptors for sweetness are closely related to the receptors for umami taste. Without bound by the theory, the inventor found there is strong synergy between umami taste substances such as MSG, 5′ribonucleotides (such as IMP, GMP). An embodiment of composition containing umami substances which could increase palatability of high intensity sweeteners. Alanine also plays a role for umami except MSG. Alapyridaine enhances not only the umami tastes, but also strengthens the sweet and salty tastes. An embodiment of composition of the present application includes alapyridaine.

Oligosaccharides are carbohydrate chains containing 3-10 sugar units. Oligosaccharides can be made of any sugar monomers, such as ADMO s (algae derived marine oligosaccharide)AOS(Arabino-oligosaccharides),COS (chitooligosaccharides), FOS(Fructooligosaccharides), GOS (galactooligosaccharides), HMO (Human milk oligosaccharides), MAOS (Mannan oligosaccharides), MOS (maltooligosaccharides),POS (Pectic oligosaccharides), SOS (soya-oligosaccharides), TOS (transgalactosylated oligosaccharides), XOS (xylooligosaccharides). Oligosaccharides normally have mild sweet taste, lower viscosity, moisturizing, low water activity. Adding oligosaccharides to the compositions of the present application can improve the sweet taste of composition, such as creating honey flavored sweet and flavor composition. Moreover, the compositions of the present application can block the crystallization of ice creams etc., thereby providing improved taste and flavor to consumable products. Accordingly, in one embodiment, a GMG-containing composition of the present application further includes one or more oligosaccharides.

When ingesting consumables, trigeminal sensation instead of taste buds on the tongue and olfactory bulb cells gets the first impression of taste sensation such as sourness, salty, sweetness of consumables. There has been a lot of research regarding the synergy between taste and flavor. The inventor surprisingly found that trigeminal sensation has strong interaction with taste and flavor. There are many compounds present in many foods or aromatic spices creates trigeminal stimuli, such as substances present in mustard oil, chili peppers, or horseradish, are responsible for pungency. Other trigeminal stimuli such as menthol or eucalyptol are also responsible for cooling sensations. Astringency is another trigeminal sensation, described as a dry mouthfeel that is generated by particular foods (unripe fruits) or drinks (tea or red wine), which are rich in polyphenolic compounds such as tannins. An embodiment of a method to use trigeminal stimuli to improve the taste and flavor of consumables, especially consumables with less sugar, less fat, and less salt. An embodiment of composition of a sweetener or a flavor includes (a) one or more GMG-MRP compositions and (b) trigeminal stimulatory substances.

Trigeminal stimulatory substances play the big role for mouthfeel, especially mouth contracting and mouth drying. Mouthfeel could be classified into three categories: Mouth coating, mouth contracting, and mouth dry. Mouth coating is one type of mouthfeel. The word coating is chosen because these elements leave a thin layer behind in the mouth. Saliva becomes thicker, more viscous. Mouth coating is related strongly to texture of consumable. Compared with mouth coating, mouth contracting is another type of mouthfeel. Mouth contracting is a somatosensory feeling of refreshment or cleansing the mouth initiated by somatosensory stimuli such as CO₂, ginger, pepper, vinegar, radish, onion, citric acid etc. Mouth contracting stimuli often stimulates saliva flow Just as carbonic acid (CO2) does in a variety of drinks, such as mineral water, sparkling wines, beer, and soda. Light, fresh white and red wines with a nice acidity are examples of ‘contracting’ drinks. A low temperature also makes the mouth contract. This implies that serving temperature influences mouthfeel (and flavor intensity as we will see). Contraction gives the impression of refreshment, of cleansing the mouth. Contracting elements will often stimulate saliva flow. An embodiment of the present application improves the mouth-contracting of consumables.

As one of main attribute of mouth contracting, freshness stands for the property of being pure and fresh (as if newly made) of consumable. From a sensory point of view perception of freshness is a multi-sensory decision process. Freshness cannot be perceived by single taste receptors nor is it represented by a single stimulus of somatosensory neurons. Freshness can be triggered on a perceptual level and is an important part of the sensory characteristics of a product (smell, taste, mouth-feeling, cognitive mechanisms, and psychophysiological factors). Semantic and perceptual information is processed concomitantly, inter-connected and each other influencing. The processing involves a continuous context-based alignment with information stored in our memory. At the end of the processing stands a decision whether freshness is perceived.

Freshness perception is mandatory to generate a refreshing feeling that is associated positively in the memory with freshness. Fresh fruits are a good model to comprehend the perceived freshness and the refreshing feeling (i.e., apple, orange). Freshness is not necessarily associated with refreshing (i.e., fresh bread, fresh fish) but in case of beverages, especially fruit-based ones, refreshing feeling is in most cases the ultimate target to achieve. A refreshing feeling is connected to the positive experiences of alleviating unpleasant symptoms in the mouth and throat (dry mouth, thirst) as consequence of feeling hot, of exercise or of mental fatigue. Accordingly, the compositions of the present application can improve the freshness of consumables and provide quicker recognition of flavor.

Quick sweet and or freshness perception are important contributors to a consumer's “hedonic preference”. A complicated and long-lasting sensory decision-making process to recognize a taste or a flavor triggers failure search and defect analysis (lower overall quality rating). The quick sweet and or freshness decision depends on the combination of sensory signals and their fit with our acquired perception of freshness. The clearer, easier, and more recognizable a set of signals appears, the quicker and easier our brain decides in favor of positive sweetness and or freshness perception, while paying less attention to other attributes of sensory perception. Ambiguity in a set of signals prevents a quick decision-making process. A set of unclear and/or unrecognized sensory signals triggers uncertainty in our brain. This uncertainty is either interpreted as “not recognizable” or yields a decision telling us “similar to . . . with following defects” with psychological attention.

Quick and early recognition of a taste and or a flavor has major importance for the sweetness and/or freshness decision. Our brain tends to stop further consideration once a decision is made and is considered to provide an evolutionarily useful feature, as thinking costs a lot of energy). In other words, once a familiar sweetness or freshness decision is made, sensory attributes will no longer be followed thereby making failure responses or defective analysis much less probable than in cases taking a longer time to recognize a taste or flavor.

Freshness is an ignored sensory attribution by the food and beverage industry. Slow sweet perception is an underestimated factor for palatability of consumables. An embodiment of composition in this invention could improve the freshness and or quick onset sweetness which could significantly improve the palatability of consumables.

In one embodiment, a food and beverage include one or more GMG-MRPs alone or blended with other natural high intensity sweeteners described herein can contribute sucrose equivalences (SugarEs) above 1%, above 1.5%, above 2%, above 2.5%, above 3%, above 4, above 5%. In other embodiments, the present application provides methods for using GMG-MRPs alone or as blended compositions described herein as food ingredients or food additives. A further embodiment of a food ingredient or additive includes one or more GMG-MRPs. It should be noted that the GMGs used in the compositions and methods of the present application can originate from any source, including but not limited to monk fruit, enzymatic conversion from mogrosides and mogroside extracts, fermentation, hydrolysis, and other biosynthetic or synthetic methods.

As alluded to above, the inventor has surprisingly found that GMG-MRPs can significantly mask the bitterness, metallic taste of natural high intensity sweeteners in stevia extracts, sweet tea extracts, monk fruit extracts, licorice extracts, glycosides present in those extracts, as well as high synthetic sweeteners, such as Acesulfame K and sucralose. Thus, in certain embodiments, a food flavor or sweetener can include one or more GMG-MRPs and one or more natural or synthetic high intensity sweeteners.

High intensity sweeteners, including natural sweeteners such as e.g., stevia extracts, sweet tea extracts, monk fruit extracts and synthetic sweeteners, such as sucralose, acesulfame-K, aspartame, sodium saccharin etc. are often characterized by their slow on-site, less high-peak sweetness, lower tongue heaviness, sweet aftertaste, less mouth coating, slipperiness, and high bitter aftertaste, metallic aftertaste. An extraordinarily good beverage must have a synchronized or harmonized sweetness temporal profile, acidity temporal profile and/or aroma temporal profile. However, it is challenging for food and beverage formulators when using these high intensity sweeteners to effectively synchronize these sensory profiles, especially for sugar reduced, sugar free products. Normally, the sequence of formulation is to have balanced sweetness and sourness, and then add flavor. However, is difficult to have sufficiently balanced sweetness and sourness for sugar reduced, sugar free products. The shortcomings of high intensity sweeteners render current diet products less palatable to consumers. In currently prevailing market, flavor, acidity, and sweetness are not sufficiently integrated in diet products. Therefore, such non-synchronized products leave either an initial bad taste/flavor reluctant to be swallowed, or an aftertaste or after flavor that leaves an unpleasant impression. In most cases, the flavor temporal profile is very short, or the flavor comes first before the sweet or sour taste, or the bitterness, lingering, and/or metallic taste. All so-called “good” tastes associated with natural sweeteners, such as GSGs, higher molecule SGs such as RI, RD, RM, highly purified RA and RE, and synthetic sweeteners, such as Ac-K and sucralose, can create metallic and lingering taste, which can make consumers reluctant to swallow. Swallowing is a big decision for consumers. Thinking about feeding baby and kids, if it is bitter, they use tongue to repel the food out of tongue. The act of swallowing is the first and most important frontier to secure our lives. Our mouth is the scout to identify the risk. Ideally, a good food and beverage should create a synchronized aroma/taste allowing us to relax and release the alertness or suspiciousness associated with swallowing a food or beverage product.

Tasty foods and beverages possess unique sensory characteristics. The inventor has surprisingly found that GMG-MRPs alone or in combination with other sweetening or flavoring agents can provide great tools for improving upon the taste of foods and beverages. Tasting a beverage has a particular physical and psychological sequence; well-designed products have a characteristic rhythm and temporal sequence in providing a satisfactory response to the product. For example, the physical sequence of drinking beverage consists of ordering a drink, looking at the drink, taking in the drink and swallowing the drink. The psychological sequence of drinking a beverage can be described by three stages: LIKING, WANTING and THINKING.

LIKING: When ordering a drink, consumers always have something in their memo, it means consumers have expectation. Therefore, color of product, words and photos in the package, sound of opening cans, sniff smell, all these are alluring factors for liking. The simple top note currently provided by flavor houses might not be enough for creating LIKING, especially for sugar reduced product. Liking is not only an issue to have volatile top note. [??] The inventor has found GMG-MRPs and blends thereof can create retronasal aroma to enhance the orthonasal smell. An embodiment of composition includes one or more GMG-MRPs and blends thereof in formulated to create a retronasal aroma for enhancing the orthonasal smell.

WANTING: When drinking the beverage in mouth, if the general impression including flavor/taste is good, it is easy to make a big “swallowing” decision. If the product does not taste good, the swallowing will be restricted. If the product is so, we swallow, then our natural reaction is to stretch our tongue out of mouth to show dislike, resulting in a feeling of regret or making a mistake. Wanting is not an issue only for taste, but strongly depends on the hidden retronasal aroma. Use of the GMG-MRPs according to the present application provides retronasal aromas which can accelerate the speed and frequency of swallowing. Therefore, in preferred embodiments, a composition of the present application includes one or more GMG-MRPs formulated to accelerate the speed and frequency of swallowing.

THINKING: After swallowing, the first reaction psychologically is to confirm the expectation. Great designed products create surprise and desire. The present application provides a product which can make foods and beverages tasty, thereby exceeding expectations and leading the consumer to desire more of the product. Therefore, in preferred embodiments, a composition of the present application includes one or more GMG-MRPs formulated to create improved retronasal aromas enhance a consumer's approval and desire for the food and beverage products containing the GMG-MRPs.

The inventor has surprisingly found that GMG-MRPs can better synchronize the overall taste dimensions of sweetness, flavor, sourness, and mouthfeel to provide quick sweetness onset, less sweet lingering, and a characteristic flavor. These features are useful for many food and beverage applications and can make the formulation job easier and faster. Thus, the present application has been developed to provide GMG-MRPs and blends thereof which can synchronize the sweetness, sourness, mouthfeel and flavor in food and beverage products. An embodiment of composition includes GMG-MRPs and blends thereof which have been formulated to provide quick onset of sweetness/flavor and less lingering sweetness. In certain embodiments, GMG-MRPs, blends thereof, and one or more other high intensity sweeteners are formulated to provide quick onset of sweetness/flavor and less lingering sweetness. In certain particular embodiments, a modified food or beverage includes a GMG-MRP composition, such as a GMGV-MRP composition in an amount less than 100 ppm. In a further embodiment, the modified food or beverage includes GMGV-MRPs, one or more other GSG-MRPs, and thaumatin, where the GMGV-MRPs are present in an amount less than 100 ppm.

In one embodiment, a food or beverage product includes GMGV-MRP and one or more components selected from STEs, STCs, GSTEs, GSTCs, ST-MRPs, G-ST-MRPs and high intensity sweeteners where: 1) the GMGV-MRP content is less than 100 ppm; or 2) total content of GMG-MRPs and MGV-MRPs is less than 1,000 ppm, less than 800 ppm, 600 ppm, less than 500 ppm, less than 400 ppm, less than 200 ppm, less than 100 ppm, less than 50 ppm, less than 20 ppm or less than 10 ppm.

In another embodiment, a food or beverage product includes one or more GMG-MRPs, including GMGV-MRP, and one or more components selected from GSTEs, GSTCs, ST-MRPs, GST-MRPs. In some embodiments, the food or beverage product includes one or more GMG-MRPs, including GMGV-MRP in combination with MGV, including mono-glycosylated MGV, where the mono-glycosylated MGV content is more than 10 wt %, 20 wt %, 30 wt %, 40 wt %, 50 wt %, 60 wt %, 70 wt %, 80 wt %, 90 wt % or 95 wt % by weight of the total GMGs. Alternatively, the food or beverage product includes one or more one or more GMG-MRPs, including GMGV-MRP, where the GMGV-MRPs are formed from a GMGV composition containing mono-glycosylated MGV, where the mono-glycosylated MGV content is more than 10 wt %, 20 wt %, 30 wt %, 40 wt %, 50 wt %, 60 wt %, 70 wt %, 80 wt %, 90 wt % or 95 wt % by weight of the total GMGs formed in the glycosylation reaction

In another embodiment, the food or beverage product includes GMG-MRPs, such as GMGV-MRP, where the GMGV-MRPs are formed from a GMGV composition containing mono-glycosylated MGV, where the mono-glycosylated MGV content in the GMGV composition is more than 1 ppm, 10 ppm, 50 ppm, 100 ppm, 150 ppm, 200 ppm, 250 ppm, 300 ppm, 500 ppm, 1,000 ppm or 10,000 ppm. In some embodiments, the food or beverage further includes GMGV-MRPs formed from a GMG composition containing unconverted MGV.

A further embodiment of a food or beverage includes GMG-MRPs, such as GMGV-MRP, where the GMGV-MRPs are formed from a GMGV composition containing mono-glycosylated MGV, where the mono-glycosylated MGV content in the GMGV composition less than 10,000 ppm, 5,000 ppm, 1,000 ppm, 500 ppm, 300 ppm, 250 ppm, 100 ppm, 50 ppm, 10 ppm, 5 ppm or 1 ppm. In some embodiments, the food or beverage further includes unconverted rubusosides.

The nasal cavity has a large surface area that presents a useful medium for brain nutrition and medicines. Sublingual administration has certain advantages over oral administration. Being more direct, it is often faster and effective. The intranasal and sublingual routes of drug administration have been used for a variety of medications. The present application provides a solution to make intranasal and sublingual nutritional products and medicines more palatable. Therefore, in some embodiments, an intranasal or sublingual composition includes one or more GMG-MRPs. In one embodiment a CBD, cannabis extract or cannabis oil product includes one or more GMG-MRPs for use in a food or beverage product.

Masking bitter tastes remains a primary goal for the food and beverage industry. Bitterness has been a challenge with a wide range of foodstuffs, such as fruits including grapefruit, passionfruit, oranges, vegetables including cucumbers, avocados, beverage including beer, coffee, chocolate, and protein products including dairy and soy products. The inventor has successfully developed new compositions containing GMG-MRPs that can mask the bitterness of foods and beverages.

The inventor has surprisingly found that MRPs formed from natural plant derived products, including monk fruit, stevia, sweet tea, licorice etc. can maintain the overall flavor intensity and sensory quality of beverage and foods during processing and storage, thereby also could reducing the amount of flavor added in a food and beverage. In one embodiment, a consumable product includes one or more GMG-MRPs ingredients in amounts sufficient to maintain the overall flavor intensity and sensory quality of the consumable product.

The inventor also surprisingly found that GMG-MRPs can enhance the astringency, accelerate the quick acidity sensation. In one embodiment, the sweetening or flavoring agent composition of the present application includes one or more GMG-MRPs enhancing the astringency and quick acid on-site sensation. In certain preferred embodiments, the consumable product contains a tea extract, a tea concentrate, cranberry juice, cranberry flavor, cranberry concentrate, grapefruit juice, grapefruit concentrate, grapefruit flavor, or a lemon and/or lime-flavored juice or concentrate. In a particular embodiment, the consumable product contains one or more GMG-MRPs and quinic acid, where the quinic acid is above 0.1 ppm, 1 ppm, 5 ppm, 10 ppm, 50 ppm, 100 ppm, 200 ppm, 500 ppm, 1,000 ppm, 2,000 ppm, 5,000 ppm, 10,000 ppm, 50,000 ppm or 100,000 ppm.

Surprisingly, the inventor has also found that GMG-MRPs can improve the solubility and enhance the sweetness of mogrosides, stevia glycosides, and sweet tea glycosides. In particular, synergistic effects have been observed when these components have been combined. In some embodiments, a consumable product includes one or more GMG-MRPs in combination with one or more mogroside extract, sweet tea extracts, or stevia extracts, as well as one or more stevia glycosides selected from Reb A, Reb B, Reb C, Reb D, Reb E, Reb I, Reb M, Reb O, such that the solubility and/or sweetness of the stevia extract(s) is increased.

In one embodiment, the sweetening or flavoring agent composition of the present application includes a GMG-MRP, where the ratio of one glucose residue being added to the MG in the glycosylation reaction to two glucose residues being added to the MG is more than 1.

In another embodiment, the GMG-MRP containing sweetening or flavoring agent composition further includes an STE, where the rubusoside content is less than 90%, less than 70%, less than 50%, less than 30%, less than 20%, less than 15%, less than 10%, less than 5%, where the non-rubusoside substances in the STE is above 5%, 10%, 20%, 30%, 40%, 50%, 60%, 70%, 80%, 90% or 95%.

In another embodiment, the GMG-MRP containing sweetening or flavoring agent composition further includes a GSTE, where the total glycosylated rubusosides is less than less than 90%, less than 70%, less than 50%, less than 30%, less than 20%, less than 15%, less than 10%, less than 5%, where the non-rubusoside substances or their glycosylated form in the GSTE is above 5%, 10%, 20%, 30%, 40%, 50%, 60%, 70%, 80%, 90% or 95%.

Poor aqueous solubility is not only an obstacle to extend their application for stevia glycosides, but also for many other pharmaceutical active substances, herb extract. for instance, carotenoids like lutein, zeaxanthin, lutein esters, epilutein, polyphenols like apple polyphenols, kiwi polyphenols, grape seed polyphenols, flavonoids such as flavonoids extracted from gingko biloba, alkaloids such as devil's claw extract etc. The inventor found high intensity sweetener extracts, such as stevia extract, sweet tea extract, monk fruit extract could improve the solubility of substances which have poor water solubility, preferably the crude extract includes non-stevia glycosides or non-sweetening substances. An embodiment of composition comprising a) one or more ingredients selected from sweet tea extracts, stevia extracts, monk fruit extracts, licorice extracts, their glycosylated products, and their MRPs, and b) one or more ingredients selected from herb extracts or pharmaceutical active ingredients, where a) could improve the solubility and bioavailability of b).

Flavors from edible products such as fruits, berries, herbs, and species are useful to enhance the palatability of food and beverage. However, the prevailing mindset of flavor industry takes volatile substances to bring the olfactory smell as key factor to measure the quality of flavor. The inventor found flavors containing flavor substances from plant juices such as fruit juice, berries juice, fresh herb or species juices could have substantially positive impact on retronasal flavors when adding into a food or beverage. The flavor compositions include less volatile and/or non-volatile substances are important to influence the palatability of food and beverage. An embodiment of composition comprising a) one or more ingredients selected from sweet tea extracts, stevia extracts, monk fruit extracts, licorice extracts, their glycosylated products, and their MRPs, and b) one or more extracted flavors or concentrated ingredients selected from plant juices, such as fruits juices, berries juices, herb and species fresh juices, where b) comprises less-volatile and/or non-volatile substances from juices, and the composition could improve the palatability of food and beverage substantially. An additional embodiment of such composition includes water soluble juicy substances, such as fruit concentrates or juice concentrates, or extracts from watermelon, bilberry, citrus, orange, lime, lemon, kiwi, apple etc.

In some embodiments, a GMG-MRP can be formed from an MG or GMG composition enriched for the presence of aromatic terpene substances containing oxygen in the structure. In some embodiments, a citrus or tangerine taste is enhanced by heat-treating a terpene- and/or terpenoid rich STE under acidic conditions comprising e.g., citric acid, tartaric acid, fumaric acid, lactic acid, malic acid etc., more preferably citric acid. In addition, substances such as linalool can react with citric acid with or without Maillard reaction. Vacuum distillation of fractions or column chromatography employing macroporous resins and/or silica gels, including ion exchange resins produced by Dow and Sunresin can be used for further purification.

In one embodiment, the present application provides a tangerine (or citrus) flavored GMG-MRP composition where e.g., a method to produce the citrus or tangerine flavored GMG-MRP involves a heat process with or without Maillard reaction under acid conditions, more preferably in a Maillard reaction with citric acid. In another embodiment, a method to produce a citrus or tangerine flavored GMG-MRP involves the inclusion of glutamic acid and fructose in the Maillard reaction.

In another embodiment, the present application provides a caramel flavored GMG-MRP composition, where e.g., a method to produce the caramel flavored GMG-MRP involves the inclusion of alanine and xylose in the Maillard reaction.

In another embodiment, the present application provides a popcorn flavored GMG-MRP composition, where e.g., a method to produce the popcorn flavored GMG-MRP involves the inclusion of proline and rhamnose in the Maillard reaction.

In another embodiment, the present application provides a honey flavored GMG-MRP composition, where e.g., a method to produce the honey flavored GMG-MRP involves the inclusion of phenylalanine and xylose in the Maillard reaction.

In some embodiments, the GMG-MRP compositions of the present application include flavor substances from monk fruit plants, stevia, sweet tea plants or other natural sweetener plants, including those derived from leaves, roots, seeds, etc.

### VI. Consumable Products Containing the GMG-MRP-Based Sweetening or Flavoring Composition

The compositions and methods described herein are useful in a wide range of consumable products. A non-limiting outline of products for application of the sweet tea-based sweetening or flavoring compositions described herein includes the following:
1 Dairy Products
1.1 Milk and dairy-based drinks
Milk and buttermilk
Buttermilk (plain)
Dairy based drinks, flavored and/or fermented
1.2 Fermented, renneted milk products (excluding drinks)
1.3 Condensed milk and analogues
Condensed milk (plain)
Beverage whiteners

1.4 Cream (plain) and similar products
Pasteurized cream
Sterilized, UHT, whipping or whipped and reduced-fat creams
Clotted cream
Cream analogues
1.5 Milk or cream powders
Milk or cream powders
Milk or cream powders analogues

1.6 Cheese
Unripened cheese
Ripened cheese
Whey cheese
Processed cheese
Cheese analogues
1.7 Dairy-based desserts (e.g., ice cream, ice milk, pudding, fruit, or flavored yogurt)
1.8 Whey and whey products, excluding whey cheese
2 Fats and oils and fat emulsions (type water-in-oil)
2.1 Fats and oils essentially free from water
2.2 Fat emulsions, water-in-oil
2.3 Fat emulsions other than 2.2, including mixed and/or flavored products based on fat emulsions.
2.4 Fat-based desserts (excluding dairy-based desserts)
3 Edible ices, including sherbet and sorbet
4, Fruits and vegetables (including mushrooms and fungi, roots and tubers, pulses, and legumes) and nuts and seeds
4.1 Fruit
4.1.1 Fresh fruit
Untreated fruit
Surface—treated fruit
Peeled or cut fruit
4.1.2 Processed fruit
Frozen fruit
Dried fruit
Fruit in vinegar, oil, or brine
Canned or bottled (pasteurized) fruit
Jams, jellies, and marmalades
Fruit-based spread
Candied fruit
Fruit preparations, including pulp and fruit toppings
Fruit-based desserts, including fruit-flavored water-based desserts
Fermented fruit products
Fruit fillings for pastries
Cooked or fried fruits
4.2 Vegetables (including mushrooms and fungi, roots and tubers, pulses, and legumes) and nuts and seeds
4.2.1 Fresh vegetables
Untreated vegetables
Surface treated vegetables
Peeled or cut vegetables
4.2.2 Processed vegetable and nuts and seeds
Frozen vegetable
Dried vegetables
Vegetables in vinegar, oil, or brine
Canned or bottled (pasteurized) vegetables
Vegetable, nut and seed purees and spreads
Vegetable, nut and seed pulps and preparations
Fermented vegetable products
Cooked or fried vegetables
5 Confectionery
5.1 Cocoa products and chocolate products, including imitations and chocolate substitutes
Cocoa mixes (powder and syrups)
Cocoa based spreads, including fillings
Cocoa and chocolate products (e.g., milk chocolate bars, chocolate flakes, white chocolate)
Imitation chocolate and chocolate substitute products
5.2 Sugar-based confectionery other than 5.1, 5.3 and 5.4, including hard and soft candy and nougats
5.3 Chewing gum
5.4 Decorations (e.g., for fine bakery wares), toppings (non-fruit) and sweet sauces
6 Cereals and cereal products, including flours and starches from roots and tubers, and pulses and legumes, excluding bakery wares
Whole, broken, or flaked grain, including rice
Flours and starches
Breakfast cereals, including rolled oats
Pastas and noodles
Cereals and starch-based desserts (e.g., rice pudding, tapioca pudding)
Batters (e.g., for fish or poultry)
7 Bakery wares
7.1 Bread and ordinary bakery wares
Breads and rolls
Crackers, excluding sweet crackers
Other ordinary bakery products (e.g., bagels, pitta, English muffins)
Bread-type products, including bread stuffing and breadcrumbs
7.2 Fine bakery wares
Cakes, cookies, and pies (e.g., fruit-filled or custard types)
Other fine bakery products (e.g., doughnuts, sweet rolls, scones, and muffins)
Mixes for fine bakery wares (e.g., cakes, pancakes)
8 Meat and meat products, including poultry and game
8.1 Fresh meat, poultry, and game
Fresh meat, poultry and game, whole pieces, or cuts
Fresh meat, poultry, and game, comminuted
8.2 Processed meat, poultry and game products in whole pieces or cuts
8.3 Processed comminuted meat, poultry, and game products
8.4 Edible casings (e.g., sausage casings)
9, Fish and fish products, including mollusks, crustaceans, and echinoderms
9.1 Fish and fish products
9.2 Processed fish and fish products
9.3 Semi-preserved fish and fish products
9.4 Fully preserved fish and fish products
10 Eggs and egg products
10.1 Fresh egg
10.2 Egg products
10.3 Preserved eggs
10.4 Egg-based desserts
11 Sweeteners, including honey
11.1 White and semi-white sugar (sucrose or saccharose), fructose, glucose (dextrose), xylose, sugar solutions and syrups, and (partially) inverted sugars, including molasses, treacle and sugar toppings.
11.2 Other sugar and syrups (e.g., brown sugar, maple syrup)
11.3 Honey
11.4 Table-top sweeteners, including those containing high-intensity sweeteners, other than 11.1-11.3
12 Salt, spices, soups, sauces, salads, protein products, etc.
12.1 Salt
12.2 Herbs, spices, seasonings (including salt substitutes) and condiments
12.3 Vinegars
12.4 Mustards
12.5 Soups and broths
Ready-to-eat soups and broths, including canned, bottled, and frozen
Mixes for soups and broths
12.6 Sauces and similar products
Emulsified sauces (e.g., mayonnaise, salad dressing)
Non-emulsified sauces (e.g., ketchup, cheese sauce, cream sauce, brown gravy)
Mixes for sauces and gravies
12.7 Salads (e.g., macaroni salad, potato salad) and sandwich spreads (excluding cocoa- and nut-based spreads)
12.8 Yeast
12.9 Protein products
13 Foodstuffs intended for nutritional uses
13.1 Infant formulae and follow-up formulae
13.2 Foods for young children (weaning food)
13.3 Diabetic foods intended for special medical purposes
13.4 Diabetic formulae for slimming purposes and weight reduction
13.5 Diabetic foods other than 13.1-13.4
13.6 Food supplements
14 Beverage excluding dairy products
14.1 Non-alcoholic (“soft”) beverages
14.1.1 Waters
   Natural mineral waters and source waters
   Table waters and soda waters
14.1.2 Fruit and vegetable juices
   Canned or bottled (pasteurized) fruit juice
   Canned or bottled (pasteurized) vegetable juice
   Concentrates (liquid or solid) for fruit juice
   Concentrates (liquid or solid) for vegetable juice
14.1.3 Fruit and vegetable nectars
   Canned or bottled (pasteurized) fruit nectar
   Canned or bottled (pasteurized) vegetable nectar
   Concentrate (liquid or solid) for fruit nectar
   Concentrate (liquid or solid) for vegetable nectar
14.1.4 Water-based flavored drinks, including ‘sport’ or ‘electrolyte” drinks
   Carbonated drinks
   Non-carbonated drinks, including punches
   Concentrates (liquid or solid) for drinks
14.1.15 Coffee, coffee substitutes, tea, herbal infusions, and other hot cereal beverages, excluding cocoa
14.2 Alcoholic beverages, including alcohol-free and low-alcoholic counterparts
14.2.1 Beer or malt beverage
14.2.2 Cider and perry
14.2.3 Wines
Still wine
Sparking and semi-sparkling wines
Fortified wine and liquor wine
Aromatized wine
14.2.4 Fruit wine
14.2.5 Mead
14.2.6 Spirituous beverages
Spirituous beverage containing at least 15% alcohol
Spirituous beverage containing less than 15% alcohol
15 Ready-to-eat savories
Snacks, potato-, cereal-, flour-, or starch-based (from roots and tubers, pulses, and legumes)
Processed nuts, including coated nuts and nut mixtures (with e.g., dried fruit)
16 Composite foods (e.g., casseroles, meat pies, mincemeat)—foods that could not be placed in categories 1-15.

In one aspect, the present application provides an orally consumable product comprising one or more GMG-MRP based sweetening or flavoring compositions of the present application described herein. The term “consumables”, as used herein, refers to substances which are contacted with the mouth of man or animal, including substances, which are taken into and subsequently ejected from the mouth, substances which are drunk, eaten, swallowed or otherwise ingested, and are safe for human or animal consumption when used in a generally acceptable range.

The GMG-MRP based sweetening or flavoring compositions of the present application can be added to an orally consumable product to provide a sweetened product or a flavored product. The GMG-MRP based sweetening or flavoring compositions of the present application can be incorporated into any oral consumable product, including but not limited to, for example, beverages and beverage products, food products or foodstuffs (e.g., confections, condiments, baked goods, cereal compositions, dairy products, chewing compositions, and tabletop sweetener compositions), pharmaceutical compositions, smoking compositions, oral hygiene compositions, dental compositions, and the like. Consumables can be sweetened or unsweetened. Consumables employing the GMG-MRP based sweetening or flavoring compositions of the present application are also suitable for use in processed agricultural products, livestock products or seafood; processed meat products such as sausage and the like; retort food products, pickles, preserves boiled in soy sauce, delicacies, side dishes; soups; snacks, such as potato chips, cookies, or the like; as shredded filler, leaf, stem, stalk, homogenized leaf cured and animal feed.

### A. Beverages and Beverage Products

In some embodiments, a beverage or beverage product is modified to include the GMG-MRP composition of the present application, or a sweetener composition containing the same. The unmodified beverage may be sweetened or unsweetened. The GMG-MRP composition of the present application, or sweetener composition comprising the same, may be added to a beverage to sweeten the beverage or enhance its existing sweetness or flavor profile. In some embodiments, the GMG-MRP composition for modifying the food or beverage product includes one or more high intensity natural or synthetic sweeteners, including those selected from the group consisting of SGs, SEs, GSGs, GSEs, STGs, STEs, STCs, GSTGs, GSTEs, GSTCs, S-MRPs, ST-MRPs and C-MRPs.

A “beverage” or “beverage product,” is used herein with reference to a ready-to-drink beverage, beverage concentrate, beverage syrup, or powdered beverage. Suitable, ready-to-drink beverages include carbonated and non-carbonated beverages. Carbonated beverages include, but are not limited to, frozen carbonated beverages, enhanced sparkling beverages, cola, fruit-flavored sparkling beverages (e.g., lemon-lime, orange, grape, strawberry, and pineapple), ginger-ale, soft drinks, and root beer. Non-carbonated beverages include, but are not limited to, fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g., black tea, green tea, red tea, oolong tea), coffee, cocoa drink, broths, beverages comprising milk components (e.g., milk beverages, coffee comprising milk components, cafe au lait, milk tea, fruit milk beverages), beverages comprising cereal extracts, and smoothies. Beverages may be frozen, semi-frozen (“slush”), non-frozen, ready-to-drink, concentrated (powdered, frozen, or syrup), dairy, non-dairy, probiotic, prebiotic, herbal, non-herbal, caffeinated, non-caffeinated, alcoholic, non-alcoholic, flavored, non-flavored, vegetable-based, fruit-based, root/tuber/corm-based, nut-based, other plant-based, cola-based, chocolate-based, meat-based, seafood-based, other animal-based, algae-based, calorie enhanced, calorie-reduced, and calorie-free.

The resulting beverages may be dispensed in open containers, cans, bottles, or other packaging. Such beverages and beverage preparations can be in ready-to-drink, ready-to-cook, ready-to-mix, raw, or ingredient form and can use the composition as a sole sweetener or as a co-sweetener.

A significant challenge in the beverage industry is to preserve flavor in drinks. Normally, essential oils and their fractions are used as key flavors. They are prone to be oxidized to create unpleasant flavor(s) or the components easily evaporate to cause the food or beverage to lose their initial designed flavors as they sit on shelves. The embodiments herein provide new methods and compositions to overcome those disadvantages and provide new solutions to the food and flavor industry.

Compared with conventional flavors, which are mainly preserved in different oils or oil-soluble solvents, the present embodiments provide new methods to provide water soluble solutions, syrups, and powders for flavoring agents.

Compared to conventional isolated flavors, often as extracts from plant or animal sources, which are not always compatible for top note flavor and/or taste when sugar replacement sweeteners are added, the current embodiments provide new types of combined multi components which are compatible for a designed flavor.

The GMG-MRPs of the present application surprisingly create sugar reduced sweeteners which have better taste than sugar or other sweetening agents, including certain stevia extracts, sweet tea extracts, monk fruit extracts, licorice, glycoside therefrom etc., as well as synthetic sweetener such as sucralose.

Beverage concentrates and beverage syrups can be prepared with an initial volume of liquid matrix (e.g., water) and the desired beverage ingredients. Full strength beverages are then prepared by adding further volumes of water. Powdered beverages are prepared by dry mixing all the beverage ingredients in the absence of a liquid matrix. Full strength beverages are then prepared by adding the full volume of water.

Beverages comprise a matrix, i.e., the basic ingredient in which the ingredients—including the compositions of the present application—are dissolved. In one embodiment, a beverage comprises water of beverage quality as the matrix, such as, for example deionized water, distilled water, reverse osmosis water, carbon-treated water, purified water, demineralized water, or combinations thereof, can be used. Additional suitable matrices include, but are not limited to phosphoric acid, phosphate buffer, citric acid, citrate buffer and carbon-treated water.

The beverage concentrations below can be provided by the composition of the present application or sweetener composition of the present application.

Compared with simple blends of the same individual ingredients together, the GMG-MRP compositions of the present application can generate different concentrations of reacted and unreacted sugar donors and amine donors, where the totality of reaction products produces different interactions affecting the taste profile of the added sugar donors remaining.

Traditionally, the use of regular guar gum and other thickeners have been limited to certain applications due to their notable “beany” or “grassy” off notes in both flavor and aroma. These “off notes” are the result of volatile organic compounds such as hexanal and hexanoic acid etc. These compounds can influence the sensation of many delicate flavors in food and beverage applications. The GMG-MRPs described herein, can modify the taste of thickeners, such as guar gum, caragum, xanthan gum etc. so that the taste is more pleasing to the consumer. Additionally, the GMG-MRPs described herein can partially or totally replace thickeners used in the food and beverage industry. There is a synergy between the GMG-MRPs and thickeners that can provide a balance of taste and cost. There is also a synergy between the GMG-MRPs and other high intensity natural sweeteners, including those selected from the group consisting of SGs, SEs, GSGs, GSEs, STGs, STEs, STCs, GSTGs, GSTEs, GSTCs, S-MRPs, ST-MRPs and C-MRPs to produce improved taste profiles. A desired taste and aroma of a food or beverage product can be obtained by adjusting the type(s) of GMG-MRPs and ratio of reactants and reaction conditions, such as temperature, pressure, reaction time etc.

The size of bubbles in a carbonated beverage can significantly affect the mouth feel and flavor of the beverage. It is desirable to manipulate one or more properties of the bubbles produced in a beverage. Such properties can include the size of bubbles produced, the shape of bubbles, the number of bubbles generated, and the rate at which bubbles are released or otherwise generated. Taste tests revealed a preference for carbonated beverages containing bubbles of smaller size.

The inventors of the present application have surprisingly found that adding certain GMG-MRPs can minimize the size of bubbles, thereby improving the mouth feel and flavor of beverages. Accordingly, in some embodiments, GMG-MRPs with or without other additives such as sweetening agents and/or thaumatin, can be used as additives to manipulate the size of bubbles, preferably for reducing the size of bubbles.

Additionally, the inventors surprisingly found that inclusion of thaumatin in the Maillard reaction or the addition of thaumatin to the GMG-MRPs of the present application can significantly improve the overall taste profile of foods and beverages to have a better mouth feel, a creamy taste, and a reduction in bitterness attributed to other ingredients in food and beverage, as exemplified by the astringency of tea, proteins, or their extracts, as well as the acidic nature and bitterness of coffee, etc. GMG-MRPs can also reduce lingering, bitterness, metallic aftertaste, and flavor of natural or synthetic high intensity sweeteners, and combinations thereof to a greater extent than thaumatin itself. Thus, the GMG-MRPs of the present application play a unique role in sugar reduction, particularly in the context of sugar free or reduced sugar products. Further, the GMG-MRPs can be used as an additive for improving the taste performance of food and beverage products comprising one or more sweetening agents or sweeteners such as sucralose, acesulfame-K, aspartame, steviol glycosides, swingle extract, sweet tea extracts, allulose, sodium saccharin, sodium cyclamate or siratose.

A probiotic beverage normally is made by fermenting milk, or skimmed milk powder, sucrose and/or glucose with selected bacteria strains, by manufacturers such as Yakult or Weichuan. Normally, a large amount of sugar is added to the probiotic beverage to provide nutrients to the probiotics to keep them alive during shelf life. The main function of such a large amount of sugar is also needed to counteract the sourness of probiotic beverage and enhance its taste. Sweetness and the thickness are the two key attributes that are most affected for the acceptability of the beverage. It is a challenge for the manufacturers to produce tasteful probiotic beverages of reduced sugar versions.

In any of the embodiments described in the present application, the final concentration of any of GMG-MRPs in the beverage may be 0.0001 ppm, 0.001 ppm, 0.01 ppm, 0.1 ppm, 1 ppm, 2 ppm, 5 ppm, 10 ppm, 15 ppm, 20 ppm, 25 ppm, 30 ppm, 35 ppm, 40 ppm, 45 ppm, 50 ppm, 55 ppm, 60 ppm, 65 ppm, 70 ppm, 75 ppm, 80 ppm, 85 ppm, 90 ppm, 100 ppm, 110 ppm, 120, ppm, 130 ppm, 140 ppm, 150 ppm, 160 ppm, 170 ppm, 180 ppm, 190 ppm, 200 ppm, 220 ppm, 240 ppm, 260 ppm, 280 ppm, 300 ppm, 320 ppm, 340 ppm, 360 ppm 380 ppm, 400 ppm, 420 ppm, 440 ppm, 460 ppm, 480 ppm, 500 ppm, 525 ppm, 550 ppm, 575 ppm, 600 ppm, 625 ppm, 650 ppm, 675 ppm, 700 ppm, 725 ppm, 750 ppm, 775 ppm, 800 ppm, 825 ppm, 850 ppm, 875 ppm, 900 ppm, 925 ppm, 950 ppm, 975 ppm, 1,000 ppm, 1,200 ppm, 1,400 ppm, 1,600 ppm, 1,800 ppm, 2,000 ppm, 2,200 ppm, 2,400 ppm, 2,600 ppm, 2,800 ppm, 3,000 ppm, 3,200 ppm, 3,400 ppm, 3,600 ppm, 3,800 ppm, 4,000 ppm, 4,200 ppm, 4,400 ppm, 4,600 ppm, 4,800 ppm, 5,000 ppm, 5,500 ppm, 6,000 ppm, 6,500 ppm, 7,000 ppm, 7,500 ppm, 8,000 ppm, 8,500 ppm, 9,000 ppm, 9,500 ppm, 10,000 ppm, 11,000 ppm, 12,000 ppm, 13000 ppm, 14,000 ppm, 15,000 ppm, or a range defined by any pair of the aforementioned concentration values in this paragraph.

In more particular embodiments, any of the GMG-MRPs or their natural sweetening and flavoring agents described herein may be present in the beverage at a final concentration ranging from 1 ppm to 15,000 ppm, from 1 ppm to 10,000 ppm, from 1 ppm to 5,000 ppm, from 10 ppm to 1,000 ppm, from 50 ppm to 900 ppm, from 50 ppm to 600 ppm, from 50 ppm to 500 ppm, from 50 ppm to 400 ppm, from 50 ppm to 300 ppm, from 50 ppm to 200 ppm, from 100 ppm to 600 ppm, from 100 ppm to 500 ppm, from 100 ppm to 400 ppm, from 100 ppm to 300 ppm, from 100 ppm to 200 ppm, from 125 ppm to 600 ppm, from 125 ppm to 500 ppm, from 125 ppm to 400 ppm, from 125 ppm to 300 ppm, from 125 ppm to 200 ppm, from 150 ppm to 600 ppm, from 150 ppm to 500 ppm, from 150 ppm to 500 ppm, from 150 ppm to 400 ppm, from 150 ppm to 300 ppm, from 150 ppm to 200 ppm, from 200 ppm to 600 ppm, from 200 ppm to 500 ppm, from 200 ppm to 400 ppm, from 200 ppm to 300 ppm, from 300 ppm to 600 ppm, from 300 ppm to 500 ppm, from 300 ppm to 400 ppm, from 400 ppm to 600 ppm, from 500 ppm to 600 ppm, from 20 ppm to 200 ppm, from 20 ppm to 180 ppm, from 20 ppm to 160 ppm, from 20 ppm to 140 ppm, from 20 ppm to 120 ppm, from 20 ppm to 100 ppm, from 20 ppm to 80 ppm, from 20 ppm to 60 ppm, from 20 ppm to 40 ppm, from 40 ppm to 150 ppm, from 40 ppm to 130 ppm, from 40 ppm to 100 ppm, from 40 ppm to 90 ppm, from 40 ppm to 70 ppm, from 40 ppm to 50 ppm, from 20 ppm to 100 ppm, from 40 ppm to 100 ppm, from 50 ppm to 100 ppm, from 60 ppm to 100 ppm, from 80 ppm to 100 ppm, from 5 ppm to 100 ppm, from 5 ppm to 95 ppm, from 5 ppm to 90 ppm, from 5 ppm to 85 ppm, from 5 ppm to 80 ppm, from 5 ppm to 75 ppm, from 5 ppm to 70 ppm, from 5 ppm to 65 ppm, from 5 ppm to 60 ppm, from 5 ppm to 55 ppm, from 5 ppm to 50 ppm, from 5 ppm to 45 ppm, from 5 ppm to 40 ppm, from 5 ppm to 35 ppm, from 5 ppm to 30 ppm, from 5 ppm to 25 ppm, from 5 ppm to 20 ppm, from 5 ppm to 15 ppm, from 5 ppm to 10 ppm, any aforementioned concentration value in this paragraph, or any range defined by any pair of the aforementioned concentration values in this paragraph. As used herein, “final concentration” refers to the concentration of, for example, any one of the aforementioned components present in any final composition or final orally consumable product (i.e., after all ingredients and/or compounds have been added to produce the composition or to produce the orally consumable product).

### B. Confections

In some embodiments, the consumable product containing the GMG-MRP composition of the present application is a confection. In some embodiments, a “confection” refers to a sweet, a lollipop, a confectionery, or similar term. The confection generally contains a base composition component and a sweetener component. A “base composition” refers to any composition which can be a food item and provides a matrix for carrying the sweetener component. The GMG-MRP can serve as the sweetener component. The confection may be in the form of any food that is typically perceived to be rich in sugar or is typically sweet.

In other embodiments of the present application, the confection may be a bakery product, such as a pastry, Bavarian cream, blancmange, cake, brownie, cookie, mousse and the like; a dessert, such as yogurt, a jelly, a drinkable jelly, a pudding; a sweetened food product eaten at tea time or following meals; a frozen food; a cold confection, such as ice, ice milk, lacto-ice and the like (food products in which sweeteners and various other types of raw materials are added to milk products, and the resulting mixture is agitated and frozen); ice confections, such as sherbets, dessert ices and the like (food products in which various other types of raw materials are added to a sugary liquid, and the resulting mixture is agitated and frozen); general confections, e.g., baked confections or steamed confections such as crackers, biscuits, buns with bean-jam filling, halvah, alfajor, and the like; rice cakes and snacks; table top products; general sugar confections such as chewing gum (e.g., including compositions which comprise a substantially water-insoluble, chewable gum base, such as chicle or substitutes thereof, including jetulong, guttakay rubber or certain comestible natural synthetic resins or waxes), hard candy, soft candy, mints, nougat candy, jelly beans, fudge, toffee, taffy, Swiss milk tablet, licorice candy, chocolates, gelatin candies, marshmallow, marzipan, divinity, cotton candy, and the like; sauces including fruit flavored sauces, chocolate sauces and the like; edible gels; cremes including butter cremes, flour pastes, whipped cream and the like; jams including strawberry jam, marmalade and the like; and breads including sweet breads and the like or other starch products, or combinations thereof.

Suitable base compositions for embodiments of this application may include flour, yeast, water, salt, butter, eggs, milk, milk powder, liquor, gelatin, nuts, chocolate, citric acid, tartaric acid, fumaric acid, natural flavors, artificial flavors, colorings, polyols, sorbitol, isomalt, maltitol, lactitol, malic acid, magnesium stearate, lecithin, hydrogenated glucose syrup, glycerin, natural or synthetic gum, starch, and the like, or combinations thereof. Such components generally are recognized as safe (GRAS) and/or are U.S. Food and Drug Administration (FDA)-approved.

In any of the confections described herein, the GMG-MRPs of the present application may be present in the confection at a final weight concentration of 0.0001 wt %, 0.001 wt %, 0.01 wt %, 0.1 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, or a weight concentration range defined by any two of the aforementioned weight percentages in this paragraph.

In more particular embodiments, the GMG-MRPs of the of the present application may be present in any of the confections described herein at a final weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %, 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt % to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, 90 wt % to 99 wt %, or a weight concentration range defined by any two of the aforementioned weight percentages in this paragraph.

The base composition of the confection may optionally include other artificial or natural sweeteners, bulk sweeteners, or combinations thereof. Bulk sweeteners include both caloric and non-caloric compounds. Non-limiting examples of bulk sweeteners include sucrose, dextrose, maltose, dextrin, dried invert sugar, fructose, or fruit sugar, levulose, honey, unrefined sweetener, galactose, syrups, such as agave syrup or agave nectar, maple syrup, corn syrup, including high fructose corn syrup (HFCS); solids, tagatose, polyols (e.g., sorbitol, mannitol, xylitol, lactitol, erythritol, and maltitol), hydrogenated starch hydrolysates, isomalt, trehalose, or mixtures thereof. Generally, the amount of bulk sweetener present in the confection ranges widely depending on the particular embodiment of the confection and the desired degree of sweetness. Those of ordinary skill in the art will readily ascertain the appropriate amount of bulk sweetener.

### C. Condiments

In some embodiments, the consumable product that contains the GMG-MRPs of the present application is a condiment. Condiments, as used herein, are compositions used to enhance or improve the flavor of a food or beverage. Non-limiting examples of condiments include ketchup (catsup); mustard; barbecue sauce; butter; chili sauce; chutney; cocktail sauce; curry; dips; fish sauce; horseradish; hot sauce; jellies, jams, marmalades, or preserves; mayonnaise; peanut butter; relish; remoulade; salad dressings (e.g., oil and vinegar, Caesar, French, ranch, bleu cheese, Russian, Thousand Island, Italian, and balsamic vinaigrette), salsa; sauerkraut; soy sauce; steak sauce; syrups; tartar sauce; and Worcestershire sauce.

Condiment bases generally comprise a mixture of different ingredients, non-limiting examples of which include vehicles (e.g., water and vinegar); spices or seasonings (e.g., salt, pepper, garlic, mustard seed, onion, paprika, turmeric, or combinations thereof); fruits, vegetables, or their products (e.g., tomatoes or tomato-based products (paste, puree), fruit juices, fruit juice peels, or combinations thereof); oils or oil emulsions, particularly vegetable oils; thickeners (e.g., xanthan gum, food starch, other hydrocolloids, or combinations thereof); and emulsifying agents (e.g., egg yolk solids, protein, gum arabic, carob bean gum, guar gum, gum karaya, gum tragacanth, carageenan, pectin, propylene glycol esters of alginic acid, sodium carboxymethyl-cellulose, polysorbates, or combinations thereof). Recipes for condiment bases and methods of making condiment bases are well known to those of ordinary skill in the art.

Generally, condiments also comprise caloric sweeteners, such as sucrose, high fructose corn syrup, molasses, honey, or brown sugar. In exemplary embodiments of the condiments provided herein, a composition containing one or more GMG-MRPs of the present application can be used instead of traditional caloric sweeteners.

The condiment composition optionally may include other natural and/or synthetic high-potency sweeteners, bulk sweeteners, pH modifying agents (e.g., lactic acid, citric acid, phosphoric acid, hydrochloric acid, acetic acid, or combinations thereof), fillers, functional agents (e.g., pharmaceutical agents, nutrients, or components of a food or plant), flavoring agents, colorings, or combinations thereof.

In any of the confections described herein, the GMG-MRPs of the present application may be present in the confection at a final weight concentration of 0.0001 wt %, 0.001 wt %, 0.01 wt %, 0.1 wt %, 1 wt %, 2 wt %, 3 wt %, 4 wt %, 5 wt %, 6 wt %, 7 wt %, 8 wt %, 9% 0 wt %%, 11 wt %, 12 wt %, 13 wt %, 14 wt %, 15 wt %, 16 wt %, 17 wt %, 18 wt % 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, or a weight concentration range defined by any two of the aforementioned weight percentages in this paragraph.

In more particular embodiments, the GMG-MRPs of the present application may be present in any of the confections described herein, at a final weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %, 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt % to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, 90 wt % to 99 wt %, or a weight concentration range defined by any two of the aforementioned weight percentages in this paragraph.

### D. Dairy Products

A wide variety of dairy products can be made using the GMG-MRPs of the present invention. Such products include without limitation, milk, whole milk, buttermilk, skim milk, infant formula, condensed milk, dried milk, evaporated milk, fermented milk, butter, clarified butter, cottage cheese, cream cheese, and various types of cheese.

In any of the solid dairy compositions described herein, the GMG-MRPs of the present application may be present in the solid dairy composition at a final weight concentration of 0.0001 wt %, 0.001 wt %, 0.01 wt %, 0.1 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, or a weight concentration range defined by any two of the aforementioned weight percentages in this paragraph.

In more particular embodiments, the GMG-MRPs of the present application may be present in any of the confections described herein, at a weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %, 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt % to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, 90 wt % to 99 wt %, or a weight concentration range defined by any two of the aforementioned weight percentages in this paragraph.

Alternatively, in any of the liquid dairy compositions described herein, the GMG-MRPs of the present application may be present in the liquid dairy composition at a final concentration of 0.0001 ppm, 0.001 ppm, 0.01 ppm, 0.1 ppm, 1 ppm, 2 ppm, 5 ppm, 10 ppm, 15 ppm, 20 ppm, 25 ppm, 30 ppm, 35 ppm, 40 ppm, 45 ppm, 50 ppm, 55 ppm, 60 ppm, 65 ppm, 70 ppm, 75 ppm, 80 ppm, 85 ppm, 90 ppm, 100 ppm, 110 ppm, 120, ppm, 130 ppm, 140 ppm, 150 ppm, 160 ppm, 170 ppm, 180 ppm, 190 ppm, 200 ppm, 220 ppm, 240 ppm, 260 ppm, 280 ppm, 300 ppm, 320 ppm, 340 ppm, 360 ppm 380 ppm, 400 ppm, 420 ppm, 440 ppm, 460 ppm, 480 ppm, 500 ppm, 525 ppm, 550 ppm, 575 ppm, 600 ppm, 625 ppm, 650 ppm, 675 ppm, 700 ppm, 725 ppm, 750 ppm, 775 ppm, 800 ppm, 825 ppm, 850 ppm, 875 ppm, 900 ppm, 925 ppm, 950 ppm, 975 ppm, 1,000 ppm, 1,200 ppm, 1,400 ppm, 1,600 ppm, 1,800 ppm, 2,000 ppm, 2,200 ppm, 2,400 ppm, 2,600 ppm, 2,800 ppm, 3,000 ppm, 3,200 ppm, 3,400 ppm, 3,600 ppm, 3,800 ppm, 4,000 ppm, 4,200 ppm, 4,400 ppm, 4,600 ppm, 4,800 ppm, 5,000 ppm, 5,500 ppm, 6,000 ppm, 6,500 ppm, 7,000 ppm, 7,500 ppm, 8,000 ppm, 8,500 ppm, 9,000 ppm, 9,500 ppm, 10,000 ppm, 11,000 ppm, 12,000 ppm, 13000 ppm, 14,000 ppm, 15,000 ppm, or a range defined by any pair of the aforementioned concentration values in this paragraph.

In more particular embodiments, the GMG-MRPs of the present application may be present in the liquid dairy composition at a final concentration ranging from 1 ppm to 15,000 ppm, from 1 ppm to 10,000 ppm, from 1 ppm to 5,000 ppm, from 10 ppm to 1,000 ppm, from 50 ppm to 900 ppm, from 50 ppm to 600 ppm, from 50 ppm to 500 ppm, from 50 ppm to 400 ppm, from 50 ppm to 300 ppm, from 50 ppm to 200 ppm, from 100 ppm to 600 ppm, from 100 ppm to 500 ppm, from 100 ppm to 400 ppm, from 100 ppm to 300 ppm, from 100 ppm to 200 ppm, from 125 ppm to 600 ppm, from 125 ppm to 500 ppm, from 125 ppm to 400 ppm, from 125 ppm to 300 ppm, from 125 ppm to 200 ppm, from 150 ppm to 600 ppm, from 150 ppm to 500 ppm, from 150 ppm to 500 ppm, from 150 ppm to 400 ppm, from 150 ppm to 300 ppm, from 150 ppm to 200 ppm, from 200 ppm to 600 ppm, from 200 ppm to 500 ppm, from 200 ppm to 400 ppm, from 200 ppm to 300 ppm, from 300 ppm to 600 ppm, from 300 ppm to 500 ppm, from 300 ppm to 400 ppm, from 400 ppm to 600 ppm, from 500 ppm to 600 ppm, from 20 ppm to 200 ppm, from 20 ppm to 180 ppm, from 20 ppm to 160 ppm, from 20 ppm to 140 ppm, from 20 ppm to 120 ppm, from 20 ppm to 100 ppm, from 20 ppm to 80 ppm, from 20 ppm to 60 ppm, from 20 ppm to 40 ppm, from 40 ppm to 150 ppm, from 40 ppm to 130 ppm, from 40 ppm to 100 ppm, from 40 ppm to 90 ppm, from 40 ppm to 70 ppm, from 40 ppm to 50 ppm, from 20 ppm to 100 ppm, from 40 ppm to 100 ppm, from 50 ppm to 100 ppm, from 60 ppm to 100 ppm, from 80 ppm to 100 ppm, from 5 ppm to 100 ppm, from 5 ppm to 95 ppm, from 5 ppm to 90 ppm, from 5 ppm to 85 ppm, from 5 ppm to 80 ppm, from 5 ppm to 75 ppm, from 5 ppm to 70 ppm, from 5 ppm to 65 ppm, from 5 ppm to 60 ppm, from 5 ppm to 55 ppm, from 5 ppm to 50 ppm, from 5 ppm to 45 ppm, from 5 ppm to 40 ppm, from 5 ppm to 35 ppm, from 5 ppm to 30 ppm, from 5 ppm to 25 ppm, from 5 ppm to 20 ppm, from 5 ppm to 15 ppm, from 5 ppm to 10 ppm, any aforementioned concentration value in this paragraph, or a range defined by any pair of the aforementioned concentration values in this paragraph.

### E. Cereal Compositions

In some embodiments, the consumable product comprising the GMG-MRPs of the present application is a cereal composition. Cereal compositions typically are eaten either as staple foods or as snacks. Non-limiting examples of cereal compositions for use in some embodiments include ready-to-eat cereals as well as hot cereals. Ready-to-eat cereals are cereals which may be eaten without further processing (i.e., cooking) by the consumer. Examples of ready-to-eat cereals include breakfast cereals and snack bars. Breakfast cereals typically are processed to produce a shredded, flaky, puffy, or extruded form. Breakfast cereals generally are eaten cold and are often mixed with milk and/or fruit. Snack bars include, for example, energy bars, rice cakes, granola bars, and nutritional bars. Hot cereals generally are cooked, usually in either milk or water, before being eaten. Non-limiting examples of hot cereals include grits, porridge, polenta, rice, oatmeal, and rolled oats.

Cereal compositions generally comprise at least one cereal ingredient. As used herein, the term “cereal ingredient” denotes materials such as whole or part grains, whole or part seeds, and whole or part grass. Non-limiting examples of cereal ingredients for use in some embodiments include maize, wheat, rice, barley, bran, bran endosperm, bulgur, sorghums, millets, oats, rye, triticale, buckwheat, fonio, quinoa, bean, soybean, amaranth, teff, spelt, and kaniwa.

The cereal composition includes one or more GMG-MRPs of the present application and at least one cereal ingredient. The GMG-MRPs of present application may be added to the cereal composition in a variety of ways, such as, for example, as a coating, as a frosting, as a glaze, or as a matrix blend (i.e., added as an ingredient to the cereal formulation prior to the preparation of the final cereal product).

Accordingly, in some embodiments, one or more GMG-MRPs of the present application are added to the cereal composition as a matrix blend. In one embodiment, one or more GMG-MRPs are blended with a hot cereal prior to cooking to provide a sweetened hot cereal product. In another embodiment, one or more GMG-MRPs are blended with the cereal matrix before the cereal is extruded.

In some embodiments, one or more GMG-MRPs are added to the cereal composition as a coating, such as, for example, in combination with food grade oil and applying the mixture onto the cereal. In a different embodiment, one or more GMG-MRPs and the food grade oil are applied to the cereal separately, by applying either the oil or the sweetener first. Non-limiting examples of food grade oils for use some embodiments include vegetable oils such as corn oil, soybean oil, cottonseed oil, peanut oil, coconut oil, canola oil, olive oil, sesame seed oil, palm oil, palm kernel oil, or mixtures thereof. In yet another embodiment, food grade fats may be used in place of the oils, provided that the fat is melted prior to applying the fat onto the cereal.

In another embodiment, one or more GMG-MRPs are added to the cereal composition as a glaze. Non-limiting examples of glazing agents for use in some embodiments include corn syrup, honey syrups and honey syrup solids, maple syrups and maple syrup solids, sucrose, isomalt, polydextrose, polyols, hydrogenated starch hydrolysate, aqueous solutions thereof, or mixtures thereof. In another such embodiment, one or more GMG-MRPs are added as a glaze by combining with a glazing agent and a food grade oil or fat and applying the mixture to the cereal. In yet another embodiment, a gum system, such as, for example, gum acacia, carboxymethyl cellulose, or algin, may be added to the glaze to provide structural support. In addition, the glaze also may include a coloring agent, and/or a flavor.

In another embodiment one or more GMG-MRPs are added to the cereal composition as a frosting. In one such embodiment, one or more GMG-MRPs are combined with water and a frosting agent and then applied to the cereal. Non-limiting examples of frosting agents for use in some embodiments include maltodextrin, sucrose, starch, polyols, or mixtures thereof. The frosting also may include a food grade oil, a food grade fat, a coloring agent, and/or a flavor.

In any of the cereal compositions described herein, the one or more GMG-MRPs are present in the cereal composition at a final weight concentration of 0.0001 wt %, 0.001 wt %, 0.01 wt %, 0.1 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, or a weight concentration range defined by any two of the aforementioned weight percentages in this paragraph.

In some embodiments, one or more GMG-MRPs are present in the cereal composition at a weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %, 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt % to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, 90 wt % to 99 wt %, or a weight concentration range defined by any two of the aforementioned weight percentages in this paragraph.

### F. Chewing Compositions

In some embodiments, the consumable product comprising GMG-MRPs of the present application is a chewing composition. The term “chewing compositions” include chewing gum compositions, chewing tobacco, smokeless tobacco, snuff, chewing gum and other compositions which are masticated and subsequently expectorated.

Chewing gum compositions generally comprise a water-soluble portion and a water-insoluble chewable gum base portion. The water-soluble portion, which typically includes one or more GMG-MRPs of the present application, dissipates with a portion of the flavoring agent over a period of time during chewing while the insoluble gum base portion is retained in the mouth. The insoluble gum base generally determines whether a gum is considered chewing gum, bubble gum, or a functional gum.

The insoluble gum base, which is generally present in the chewing gum composition in an amount in the range of about 15 to about 35 weight percent of the chewing gum composition, generally comprises combinations of elastomers, softeners (plasticizers), emulsifiers, resins, and fillers. Such components generally are considered food grade, recognized as safe (GRA), and/or are U.S. Food and Drug Administration (FDA)-approved.

Elastomers, the primary component of the gum base, provide the rubbery, cohesive nature to gums and can include one or more natural rubbers (e.g., smoked latex, liquid latex, or guayule); natural gums (e.g., jelutong, perillo, sorva, massaranduba balata, massaranduba chocolate, nispero, rosindinha, chicle, and gutta hang kang); or synthetic elastomers (e.g., butadiene-styrene copolymers, isobutylene-isoprene copolymers, polybutadiene, polyisobutylene, and vinyl polymeric elastomers). In a particular embodiment, the elastomer is present in the gum base in an amount in the range of about 3 to about 50 weight percent of the gum base.

Resins are used to vary the firmness of the gum base and aid in softening the elastomer component of the gum base. Non-limiting examples of suitable resins include a rosin ester, a terpene resin (e.g., a terpene resin from α-pinene, β-pinene and/or D-limonene), polyvinyl acetate, polyvinyl alcohol, ethylene vinyl acetate, and vinyl acetate-vinyl laurate copolymers. Non-limiting examples of rosin esters include a glycerol ester of a partially hydrogenated rosin, a glycerol ester of a polymerized rosin, a glycerol ester of a partially dimerized rosin, a glycerol ester of rosin, a pentaerythritol ester of a partially hydrogenated rosin, a methyl ester of rosin, or a methyl ester of a partially hydrogenated rosin. In some embodiment, the resin is present in the gum base in an amount in the range of about 5 to about 75 weight percent of the gum base.

Softeners, which also are known as plasticizers, are used to modify the ease of chewing and/or mouth feel of the chewing gum composition. Generally, softeners comprise oils, fats, waxes, and emulsifiers. Non-limiting examples of oils and fats include tallow, hydrogenated tallow, large, hydrogenated or partially hydrogenated vegetable oils (e.g., soybean, canola, cottonseed, sunflower, palm, coconut, corn, safflower, or palm kernel oils), cocoa butter, glycerol monostearate, glycerol triacetate, glycerol abietate, lecithin, monoglycerides, diglycerides, triglycerides acetylated monoglycerides, and free fatty acids. Non-limiting examples of waxes include polypropylene/polyethylene/Fisher-Tropsch waxes, paraffin, and microcrystalline and natural waxes (e.g., candelilla, beeswax and carnauba). Microcrystalline waxes, especially those with a high degree of crystallinity and a high melting point, also may be considered as bodying agents or textural modifiers. In some embodiments, the softeners are present in the gum base in an amount in the range of about 0.5 to about 25 weight percent of the gum base.

Emulsifiers are used to form a uniform dispersion of the insoluble and soluble phases of the chewing gum composition and have plasticizing properties. Suitable emulsifiers include glycerol monostearate (GMS), lecithin (phosphatidyl choline), polyglycerol polyricinoleic acid (PPGR), mono and diglycerides of fatty acids, glycerol distearate, tracetin, acetylated monoglyceride, glycerol triacetate, and magnesium stearate. In some embodiments, the emulsifiers are present in the gum base in an amount in the range of about 2 to about 30 weight percent of the gum base.

The chewing gum composition also may comprise adjuvants or fillers in either the gum base and/or the soluble portion of the chewing gum composition. Suitable adjuvants and fillers include lecithin, inulin, polydextrin, calcium carbonate, magnesium carbonate, magnesium silicate, ground limestone, aluminum hydroxide, aluminum silicate, talc, clay, alumina, titanium dioxide, and calcium phosphate. In some embodiments, lecithin can be used as an inert filler to decrease the stickiness of the chewing gum composition. In other some embodiments, lactic acid copolymers, proteins (e.g.a, gluten and/or zein) and/or guar can be used to create a gum that is more readily biodegradable. The adjuvants or fillers are generally present in the gum base in an amount up to about 20 weight percent of the gum base. Other optional ingredients include coloring agents, whiteners, preservatives, and flavors.

In some embodiments of the chewing gum composition, the gum base comprises about 5 to about 95 weight percent of the chewing gum composition, more desirably about 15 to about 50 weight percent of the chewing gum composition, and even more desirably from about 20 to about 30 weight percent of the chewing gum composition.

The soluble portion of the chewing gum composition may optionally include other artificial or natural sweeteners, bulk sweeteners, softeners, emulsifiers, flavoring agents, coloring agents, adjuvants, fillers, functional agents (e.g., pharmaceutical agents or nutrients), or combinations thereof. Suitable examples of softeners and emulsifiers are described above.

Bulk sweeteners include both caloric and non-caloric compounds. Non-limiting examples of bulk sweeteners include sucrose, dextrose, maltose, dextrin, dried invert sugar, fructose, high fructose corn syrup, levulose, galactose, corn syrup solids, tagatose, polyols (e.g., sorbitol, mannitol, xylitol, lactitol, erythritol, and maltitol), hydrogenated starch hydrolysates, isomalt, trehalose, or mixtures thereof. In some embodiments, the bulk sweetener is present in the chewing gum composition in an amount in the range of about 1 to about 75 weight percent of the chewing gum composition.

Flavoring agents may be used in either the insoluble gum base or soluble portion of the chewing gum composition. Such flavoring agents may be natural or artificial flavors. In some embodiments, the flavoring agent comprises an essential oil, such as an oil produced from a plant or a fruit, peppermint oil, spearmint oil, other mint oils, clove oil, cinnamon oil, oil of wintergreen, bay, thyme, cedar leaf, nutmeg, allspice, sage, mace, and almonds. In another embodiment, the flavoring agent comprises a plant extract or a fruit essence such as apple, banana, watermelon, pear, peach, grape, strawberry, raspberry, cherry, plum, pineapple, apricot, or mixtures thereof. In still another embodiment, the flavoring agent comprises a citrus flavor, such as an extract, essence, or oil of lemon, lime, orange, tangerine, grapefruit, citron, or kumquat.

In some embodiments, the chewing gum composition comprises one or more GMG-MRPs of the present application and a gum base.

In any of the chewing gum compositions described herein, the one or more GMG-MRPs of the present application may be present in the chewing gum composition at a final weight concentration of 0.0001 wt %, 0.001 wt %, 0.01 wt %, 0.1 wt %, 1 wt %, 2 wt %, 3 wt, 4 wt %, 5 wt %, 6 wt %, 7 wt 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, or a weight concentration range defined by any two of the aforementioned weight percentages in this paragraph.

In more particular embodiments, the GMG-MRPs of the present application are present in any of the chewing gum compositions described herein, at a weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %, 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt % to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, 90 wt % to 99 wt %, or a weight concentration range defined by any two of the aforementioned weight percentages in this paragraph.

### G. Tabletop Sweetener Compositions

In general, tabletop sugar replacements lack certain taste attributes associated with sugar, especially for solid tabletop sweeteners. In addressing this need, the inventor of the present application has developed more palatable tabletop sugar replacements than commonly known. Specifically, in some embodiments, the present application provides an orally consumable product comprising one or more GMG-MRPs of the present application in the form of an orally consumable tabletop sweetener composition. In one embodiment, the orally consumable tabletop sweetener composition has a taste similar to molasses.

In some embodiments, the tabletop sweetener composition may further include at least one bulking agent, additive, anti-caking agent, functional ingredient, or combination thereof.

Suitable “bulking agents” include, but are not limited to, maltodextrin (10 DE, 18 DE, or 5 DE), corn syrup solids (20 or 36 DE), sucrose, fructose, glucose, invert sugar, sorbitol, xylose, ribulose, mannose, xylitol, mannitol, galactitol, erythritol, maltitol, lactitol, isomalt, maltose, tagatose, lactose, inulin, glycerol, propylene glycol, polyols, polydextrose, fructooligosaccharides, cellulose and cellulose derivatives, and the like, or mixtures thereof. Additionally, in accordance with still other embodiments of the application, granulated sugar (sucrose) or other caloric sweeteners such as crystalline fructose, other carbohydrates, or sugar alcohol can be used as a bulking agent due to their provision of good content uniformity without the addition of significant calories.

As used herein, the phrase “anti-caking agent” and “flow agent” refers to any composition which assists in content uniformity and uniform dissolution. In some embodiments, non-limiting examples of anti-caking agents include cream of tartar, aluminium silicate (Kaolin), calcium aluminium silicate, calcium carbonate, calcium silicate, magnesium carbonate, magnesium silicate, mono-, di- and tri-calcium orthophosphate, potassium aluminium silicate, silicon dioxide, sodium aluminium silicate, salts of stearic acid, microcrystalline cellulose (Avicel, FMC BioPolymer, Philadelphia, Pennsylvania), and tricalcium phosphate. In one embodiment, the anti-caking agents are present in the tabletop sweetener composition in an amount from about 0.001 to about 3% by weight of the tabletop sweetener composition.

The tabletop sweetener compositions can be packaged in any form known in the art. Non-limiting forms include, but are not limited to, powder form, granular form, packets, tablets, sachets, pellets, cubes, solids, and liquids.

In one embodiment, the tabletop sweetener composition is a single-serving (portion control) packet comprising a dry-blend. Dry-blend formulations generally may comprise powder or granules. Although the tabletop sweetener composition may be in a packet of any size, an illustrative non-limiting example of conventional portion control tabletop sweetener packets are approximately 2.5 by 1.5 inches and hold approximately 1 gram of a sweetener composition having a sweetness equivalent to 2 teaspoons of granulated sugar (˜8 g). The amount of an MRP composition of the present application in a dry-blend tabletop sweetener formulation can vary. In some embodiments, a dry-blend tabletop sweetener formulation may comprise a Composition of the present application in an amount from about 1% (w/w) to about 10% (w/w) of the tabletop sweetener composition.

Solid tabletop sweetener embodiments include cubes and tablets. A non-limiting example of conventional cubes is equivalent in size to a standard cube of granulated sugar, which is approximately 2.2×2.2×2.2 cm3 and weighs approximately 8 g. In one embodiment, a solid tabletop sweetener is in the form of a tablet, or any other form known to those skilled in the art.

A tabletop sweetener composition also may be embodied in the form of a liquid, where one or more GMG-MRPs of the present application are combined with a liquid carrier. Suitable non-limiting examples of carrier agents for liquid tabletop sweeteners include water, alcohol, polyol, glycerin base or citric acid base dissolved in water, or mixtures thereof. The sweetness equivalent of a tabletop sweetener composition for any of the forms described herein or known in the art may be varied to obtain a desired sweetness profile. For example, a tabletop sweetener composition may have a degree of sweetness comparable to that of an equivalent amount of standard sugar. In another embodiment, the tabletop sweetener composition may comprise a sweetness of up to 100 times that of an equivalent amount of sugar. In another embodiment, the tabletop sweetener composition may comprise a sweetness of up to 90 times, 80 times, 70 times, 60 times, 50 times, 40 times, 30 times, 20 times, 10 times, 9 times, 8 times, 7 times, 6 times, 5 times, 4 times, 3 times, and 2 times that of an equivalent amount of sugar.

In any of the tabletop sweetener compositions described herein, one or more GMG-MRPs of the present application are present in the tabletop sweetener composition at a final weight concentration of 0.0001 wt %, 0.001 wt %, 0.01 wt %, 0.1 wt %, 1 wt %, 2 wt %, 3 wt, 4 wt %, 5 wt %, 6 wt %, 7 wt 8 wt %, 9 wt, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt %, or 100 wt %, or a weight concentration range defined by any two of the aforementioned weight percentages in this paragraph.

In more particular embodiments, one or more GMG-MRPs of the present application may be present in any of the tabletop sweetener compositions described herein, at a weight percentage range from 0.001 wt % to 99 wt %, 0.001 wt % to 75 wt %, 0.001 wt % to 50 wt %, 0.001 wt % to 25 wt %, 0.001 wt % to 10 wt %, 0.001 wt % to 5 wt %, 0.001 wt % to 2 wt %, 0.001 wt % to 1 wt %, 0.001 wt % to 0.1 wt %, 0.001 wt % to 0.01 wt %, 0.01 wt % to 99 wt %, 0.01 wt % to 75 wt %, 0.01 wt % to 50 wt %, 0.01 wt % to 25 wt %, 0.01 wt % to 10 wt %, 0.01 wt % to 5 wt %, 0.01 wt % to 2 wt %, 0.01 wt % to 1 wt %, 0.1 wt % to 99 wt %, 0.1 wt % to 75 wt %, 0.1 wt % to 50 wt %, 0.1 wt % to 25 wt %, 0.1 wt % to 10 wt %, 0.1 wt % to 5 wt %, 0.1 wt % to 2 wt %, 0.1 wt % to 1 wt %, 0.1 wt % to 0.5 wt %, 1 wt % to 99 wt %, 1 wt % to 75 wt %, 1 wt % to 50 wt %, 1 wt % to 25 wt %, 1 wt % to 10 wt %, 1 wt % to 5 wt %, 5 wt % to 99 wt %, 5 wt % to 75 wt %, 5 wt % to 50 wt %, 5 wt % to 25 wt %, 5 wt % to 10 wt %, 10 wt % to 99 wt %, 10 wt % to 75 wt %, 10 wt % to 50 wt %, 10 wt % to 25 wt %, 10 wt % to 15 wt %, 20 wt % to 99 wt %, 20 wt % to 75 wt %, 20 wt % to 50 wt %, 30 wt % to 99 wt %, 30 wt % to 75 wt %, 30 wt % to 50 wt %, 40 wt % to 99 wt %, 40 wt % to 75 wt %, 40 wt % to 50 wt %, 50 wt % to 99 wt %, 50 wt % to 75 wt %, 60 wt % to 99 wt %, 60 wt % to 75 wt %, 70 wt % to 99 wt %, 70 wt % to 75 wt %, 80 wt % to 99 wt %, 80 wt % to 90 wt %, 90 wt % to 99 wt %, or a weight concentration range defined by any two of the aforementioned weight percentages in this paragraph.

### H. Medicinal Compositions

In certain embodiments, one or more GMG-MRPs of the present application may be used in medicinal compositions. As used herein, the term “medicinal composition” includes solids, gases and liquids which are ingestible materials having medicinal value, such as cough syrups, cough drops, medicinal sprays, vitamins, and chewable medicinal tablets that are administered orally or used in the oral cavity in the form of e.g., a pill, tablet, spray, capsule, syrup, drop, troche agent, powder, and the like.

### I. Oral Hygiene Compositions

In some embodiments, one or more GMG-MRPs of the present application may be used in an oral hygiene composition. As used herein, the “oral hygiene composition” includes mouthwashes, mouth rinses, breath fresheners, toothpastes, tooth polishes, dentifrices, mouth sprays, teeth whitening agents, soaps, perfumes, and the like. J. Cosmetic Compositions

In some embodiments, one or more GMG-MRPs of the present application is utilized in a cosmetic composition for enhancing the aroma of a cosmetic or skin-care product. As used herein, the term “cosmetic composition” means a composition that is formulated for topical application to skin, which has a pleasant color, odor and feel, and which does not cause unacceptable discomfort (stinging, tautness, or redness) liable to discourage the consumer from using it.

Cosmetic composition may be preferably formulated in the form of an emulsion, e.g., W/O (water-in-oil), O/W (oil-in-water), W/0/W (water-in-oil-in-water), O/W/O (oil-in-water-in-oil) emulsion, PIT emulsion, Pickering emulsion, emulsion with a low oil content, micro- or nanoemulsion, a solution, e.g., in oil (fatty oils or fatty acid esters, in particular C6-C₃₂ fatty acid C₂-C₃₀ esters) or silicone oil, dispersion, suspension, creme, lotion or milk, depending on the production method and ingredients, a gel (including hydrogel, hydrodispersion gel, oleogel), spray (e.g., pump spray or spray with propellant) or a foam or an impregnating solution for cosmetic wipes, a detergent, e.g., soap, synthetic detergent, liquid washing, shower and bath preparation, bath product (capsule, oil, tablet, salt, bath salt, soap, etc.), effervescent preparation, a skin care product such as e.g., an emulsion (as described above), ointment, paste, gel (as described above), oil, balsam, serum, powder (e.g., face powder, body powder), a mask, a pencil, stick, roll-on, pump, aerosol (foaming, non-foaming or post-foaming), a deodorant and/or antiperspirant, mouthwash and mouth rinse, a foot care product (including keratolytic, deodorant), an insect repellent, a sunscreen, aftersun preparation, a shaving product, aftershave balm, pre- and aftershave lotion, a depilatory agent, a hair care product such as e.g., shampoo (including 2-in-1 shampoo, anti-dandruff shampoo, baby shampoo, shampoo for dry scalps, concentrated shampoo), conditioner, hair tonic, hair water, hair rinse, styling creme, pomade, perm and setting lotion, hair spray, styling aid (e.g., gel or wax), hair smoothing agent (detangling agent, relaxer), hair dye such as e.g., temporary direct-dyeing hair dye, semi-permanent hair dye, permanent hair dye, hair conditioner, hair mousse, eye care product, make-up, make-up remover or baby product.

### K. Smokable Compositions

In some embodiments, one or more GMG-MRPs of the present application may be used in a smokable composition. The term “smokable composition,” as used herein, includes any material that can be smoked or inhaled, such as tobacco and cannabis, as well as any smokable material that is burned to provide desirable aromas (e.g., charcoal briquettes for grilling foods, incense etc.). The smoking compositions may encompass cigarettes, electronic cigarettes (e-cigarettes), cigars, pipe and cigar tobacco, chew tobacco, vaporizable liquids, and all forms of tobacco such as shredded filler, leaf, stem, stalk, homogenized leaf cured, reconstituted binders, reconstituted tobacco from tobacco dust, fines, or other sources in sheet, pellet, or other forms. “Smokable compositions” also include cannabis compositions (e.g., flower materials, leaf materials, extracts, oils, edible candies, vaporizable liquids, cannabis-infused beverages, etc.) and tobacco substitutes formulated from non-tobacco materials.

### VII. Taste Profiles and Taste Testing of Compositions Containing One or More GMG-MRPs

The GMG-MRP compositions and methods described herein are useful for improved taste and aroma profiles of many consumable products relative to control samples. The phrase “taste profile”, which is interchangeable with “sensory profile” and “sweetness profile”, may be defined as the temporal profile of all basic tastes of a sweetener. The “temporal profile” may be considered to represent the intensity of sweetness perceived over time in tasting of the composition by a human, especially a trained “taster”. Carbohydrate and polyol sweeteners typically exhibit a quick onset followed by a rapid decrease in sweetness, which disappears relatively quickly on swallowing a food or beverage containing the same. In contrast, high intensity natural sweeteners typically have a slower sweet taste onset reaching a maximal response more slowly, followed by a decline in intensity more slowly than with carbohydrate and polyol sweeteners. This decline in sweetness is often referred to as “sweetness linger” and is a major limitation associated with the use of high intensity natural sweeteners.

In the context of taste tasting, the terms “improve”, “improved” and “improvement” are used interchangeably with reference to a perceived advantageous change in a composition or consumable product upon introduction of one or more GMG-MRPs of the present application relative to the original taste profile of the composition or consumable product without the added GMG-MRPs. The taste improvements may include less bitterness, better sweetness, better sour taste, better aroma, better mouth feel, better flavor, less aftertaste, etc. The terms “improve” or “improvement” can refer to a slight change, a change, or a significant change of the original taste profile, etc., which makes the composition more palatable to an individual.

In some embodiments, the one or more GMG-MRPs of the present application and methods described herein are useful for improving the taste and aroma profiles for other synthetic sweeteners, such as sucralose, ACE-K, aspartame, sodium saccharin, and mixtures thereof, and for natural high intensity sweeteners such as steviol glycosides, stevia extracts, monk fruit extract, monk fruit components, licorice extract, licorice components.

In some embodiments, the GMG-MRPs of the present application may be evaluated with reference to the degree of their sucrose equivalence. Accordingly, the GMG-MRPs compositions of the present application may be diluted or modified with respect to its ingredients to conform with this sucrose equivalence.

The onset and decay of sweetness when one or more GMG-MRPs of the present application are consumed can be perceived by trained human tasters and measured in seconds from first contact with a taster's tongue (“onset”) to a cutoff point (typically 180 seconds after onset) to provide a “temporal profile of sweetness”. A plurality of such human tasters is called a “sensory panel.” In addition to sweetness, sensory panels can also judge the temporal profile of the other “basic tastes”: bitterness, saltiness, sourness, piquance (aka spiciness), and umami (aka savoriness or meatiness). The onset and decay of bitterness when a sweetener is consumed, as perceived by trained human tasters and measured in seconds from first perceived taste to the last perceived aftertaste at the cutoff point, is called the “temporal profile of bitterness.” Aromas from aroma producing substances are volatile compounds which are perceived by the aroma receptor sites of the smell organ, i.e., the olfactory tissue of the nasal cavity. They reach the receptors when drawn in through the nose (orthonasal detection) and via the throat after being released by chewing (retronasal detection). The concept of aroma substances, like the concept of taste substances, is to be used loosely, since a compound might contribute to the typical aroma or taste of one food, while in another food it may cause a faulty aroma or taste, or both, resulting in an off flavor. Thus, sensory profile may include evaluation of aroma as well.

The term “mouth feel” involves the physical and chemical interaction of a consumable in the mouth. More specifically, as used herein, the term “mouth feel” refers to the fullness sensation experienced in the mouth, which relates to the body and texture of the consumable such as its viscosity. Mouth feel is one of the most important organoleptic properties and the major criteria that consumers use to judge the quality and freshness of foods. Subtle changes in a food and beverage product's formulation can change mouth feel significantly. Simply taking out sugar and adding a high intensity sweetener can cause noticeable alterations in mouth feel, making a formerly good product unacceptable to consumers. Sugar not only sweetens, but it also builds body and viscosity in food and beverage products and leaves a slight coating on the tongue. For example, reducing salt levels in soup changes not only taste, but can alter mouth feel as well. Primarily it is the mouth feel that is always the compliant with non-sugar sweeteners.

The phrase “sweetness detection threshold” refers to the minimum concentration at which panelists consisting of 1-10 persons can detect sweetness in a composition, liquid or solid. This is further defined as provided in the Examples herein and are conducted by the methods described in Sensory Testing for Flavorings with Modifying Properties by Christie L. Harman, John B. Hallagan, and the FEMA Science, Committee Sensory Data Task Force, November 2013, Volume 67, No. 11 and Appendix A attached thereto, the teachings of which are incorporated herein by reference.

“Threshold of sweetness” refers to a concentration of a material below which sweetness cannot be detected but can still impart a flavor to a consumable (including water). When half of a trained panel of testers determines something is “sweet” at a given concentration, then the sample meets the threshold. When less than half of a panel of testers cannot discern sweetness at a given concentration, then concentrations of the substance below the sweetness level are considered a flavoring agent.

It should be understood that the flavoring agents described herein, including the GMG-MRPs of the present application, can be used in combination with other materials, including other natural sweeteners from plants, to encapsulate and reduce or eliminate the unwanted off taste present in the composition. There is a sequence of steps in Maillard reaction(s) that can be used to produce flavor(s). That is, there can be a first step where a first reaction takes place between a first sugar donor and a first amine donor under appropriate conditions followed by a second reaction with a second sugar donor and a second amine donor, and possible subsequent reactions to provide a complex flavorant composition that is a combination of various Maillard reaction products between, for example, the first sugar donor and first amine donor, along with the reaction between the first sugar donor and a second amine donor or a second sugar donor reacting with the first sugar donor, etc. under the Maillard reaction conditions described herein. The processes described herein can be used to preserve flavors.

For example, to dissolve any flavor or flavor combination in a dissolved glycoside solution, afterwards, the solution could be ready to use, or it could be further concentrated to syrup or powder form. For evaluating the taste profile of a given composition, a sample may be tested by e.g., a panel of 1-10 people. In some cases, a trained taster may independently taste the sample(s) first. The taster may be asked to describe the taste profile and score 0-5 according to the increasing sugar like, bitterness, aftertaste, and lingering taste profiles. The taster may be allowed to re-taste, and then make notes for the sensory attributes perceived. Afterwards, another group of 1-10 tasters may similarly taste the sample(s), record its taste attributes, and discuss the samples openly to find a suitable description. Where more than 1 taster disagrees with the results, the tasting may be repeated. For example, a “5” for sugar like is the best score for having a taste that is sugar like and conversely a value of 0 or near zero is not sugar like. Similarly, a “5” for bitterness, aftertaste and lingering is not desired. A value of zero or near zero means that the bitterness, aftertaste and/or lingering is reduced or is removed. Other taste attributes may include astringency and overall likability.

In some embodiments, vanilla, maltol or other flavor modifier product(s) “FMPs” can be added to the compositions described herein to further improve the taste. FMPs, such as maltol, ethyl-maltol, vanillin, ethyl vanillin, m-methylphenol, and m-n-propylphenol can further enhance the mouth feel, sweetness and aroma of the ST-MRP compositions described herein. Thus, in some embodiments, one or more FMPs may be added before or after the Maillard reaction, such as maltol, ethyl-maltol, vanillin, ethyl vanillin, m-methylphenol, m-n-propylphenol, or combinations thereof. In certain embodiments, MRPs and/or sweeteners may be combined with one or more FMPs. Particular MRP/FMP combinations include MRPs and maltol; MRPs and vanillin; sweetener(s) and maltol; sweetener(s) and vanillin etc. Such compositions may be used in any of the food or beverage products described herein.

Production of GMG-MRPs may include the use of any of the following methodologies, including reflux at atmospheric pressure, reaction under pressure, oven drying, vacuum oven drying, roller/drum drying, surface scraped heat exchange, and/or extrusion.

The inventors of the present application have also developed a unique process which could preserve useful flavor substances originating from monk fruit and recovered in in the form of monk fruit extracts. Such substances are further amplified in glycosylation and/or Maillard reactions involving sweet extracts in combination with various amine donors as described herein.

Additionally, the flavor substances in the sweet tea plant should also contain any new possible flavor substances from sweet new tea varieties by hybridizing, grafting and other cultivating methods.

A flavoring agent, other than a flavor derived from a Maillard reaction product as described herein, can be added to the compositions described herein before or after a Maillard reaction has been completed. Suitable flavoring agents include, for example, natural flavors, vitamins, such as vitamin C, artificial flavors, spices, seasonings, and the like. Exemplary flavor agents include synthetic flavor oils and flavoring aromatics and/or oils, uronic acids (e.g., glucuronic acid and galacturonic acid) or oleoresins, essences, and distillates, and a combination comprising at least one of the foregoing.

During the Maillard reaction or following completion of the Maillard reaction, “top note” agents may be added, which are often quite volatile, vaporizing at or below room temperature. “Top notes” are often what give foods their fresh flavors. Suitable top note agents include but are not limited to, for example, furfuryl mercaptan, methional, nonanal, trans,trans-2,4-decadienal, 2,2′-(dithiodimethylene) difuran, 2-methyl-3-furanthiol, 4-methyl-5-thiazoleethanol, pyrazineethanethiol, bis(2-methyl-3-furyl) disulfide, methyl furfuryl disulfide, 2,5-dimethyl-2,5-dihydroxy-1,4-dithiane, 95%, trithioacetone, 2,3-butanedithiol, methyl 2-methyl-3-furyl disulfide, 4-methylnonanoic acid, 4-methyloctanoic acid, or 2-methyl-3-tetrahydrofuranthiol.

Flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors, such as vanilla, and citrus oils including lemon, orange, lime, grapefruit, yuzu, sudachi, and fruit essences including apple, pear, peach, grape, raspberry, blackberry, gooseberry, blueberry, strawberry, cherry, plum, prune, raisin, cola, guarana, neroli, pineapple, apricot, banana, melon, apricot, cherry, tropical fruit, mango, mangosteen, pomegranate, papaya, and so forth.

Additional exemplary flavors imparted by a flavoring agent include a milk flavor, a butter flavor, a cheese flavor, a cream flavor, and a yogurt flavor; a vanilla flavor; tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, a wasabi (Japanese horseradish) flavor; a nut flavor, such as an almond flavor, a hazelnut flavor, a macadamia nut flavor, a peanut flavor, a pecan flavor, a pistachio flavor, and a walnut flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor.

Generally, any flavoring agent or food additive, such as those described in “Chemicals Used in Food Processing”, Publication No 1274, pages 63-258, by the National Academy of Sciences, can be used. This publication is incorporated herein by reference.

As used herein, a “flavoring agent” or “flavorant” herein refers to a compound or an ingestibly acceptable salt or solvate thereof that induces a flavor or taste in an animal or a human. The flavoring agent can be natural, semi-synthetic, or synthetic. Suitable flavorants and flavoring agent additives for use in the compositions of the present application include, but are not limited to, vanillin, vanilla extract, mango extract, cinnamon, citrus, coconut, ginger, viridiflorol, almond, bay, thyme, cedar leaf, nutmeg, allspice, sage, mace, menthol (including menthol without mint), an essential oil, such as an oil produced from a plant or a fruit, such as peppermint oil, spearmint oil, other mint oils, clove oil, cinnamon oil, oil of wintergreen, or an oil of almonds; a plant extract, fruit extract or fruit essence from grape skin extract, grape seed extract, apple, banana, watermelon, pear, peach, grape, strawberry, raspberry, cherry, plum, pineapple, apricot, a flavoring agent comprising a citrus flavor, such as an extract, essence, or oil of lemon, lime, orange, tangerine, grapefruit, citron, kumquat, or combinations thereof. Flavorants for use in the present application include both natural and synthetic substances which are safe for humans or animals when used in a generally accepted range.

Non-limiting examples of proprietary flavorants include Dohler™ Natural Flavoring Sweetness Enhancer K14323 (Dohler™, Darmstadt, Germany), Symrise™ Natural Flavor Mask for Sweeteners 161453 and 164126 (Symrise™, Holzminden, Germany), Natural Advantage™ Bitterness Blockers 1, 2, 9 and 10 (Natural Advantage™, Freehold, New Jersey, U.S.A.), and Sucramask™ (Creative Research Management, Stockton, California, U.S.A.).

In the any of the embodiments described in the present application, the flavoring agent is present in the sweetening or flavoring composition of the present application in an amount effective to provide a final concentration of about 0.1 ppm, 0.5 ppm, 1 ppm, 2 ppm, 5 ppm, 10 ppm, 15 ppm, 20 ppm, 25 ppm, 30 ppm, 35 ppm, 40 ppm, 45 ppm, 50 ppm, 55 ppm, 60 ppm, 65 ppm, 70 ppm, 75 ppm, 80 ppm, 85 ppm, 90 ppm, 100 ppm, 110 ppm, 120 ppm, 130 ppm, 140 ppm, 150 ppm, 160 ppm, 170 ppm, 180 ppm, 190 ppm, 200 ppm, 220 ppm, 240 ppm, 260 ppm, 280 ppm, 300 ppm, 320 ppm, 340 ppm, 360 ppm, 380 ppm, 400 ppm, 425 ppm, 450 ppm, 475 ppm, 500 ppm, 550 ppm, 600 ppm, 650 ppm, 700 ppm, 750 ppm, 800 ppm, 850 ppm, 900 ppm, 950 ppm, 1000 ppm, 1500 ppm, 2000 ppm, 2500 ppm, 3000 ppm, 3500 ppm, 4000 ppm, 4500 ppm, 5000 ppm, 6000 ppm, 7000 ppm, 8000 ppm, 9000 ppm, 10,000 ppm, 11,000 ppm, 12,000 ppm, 13,000 ppm, 14,000 ppm, or 15,000 ppm; or to provide a final concentration corresponding to any one of the aforementioned values in this paragraph; or to provide a final concentration range corresponding to any pair of the aforementioned values in this paragraph.

In more particular embodiments, the flavoring agent is present in the composition of the present application in an amount effective to provide a final concentration ranging from 10 ppm to 1000 ppm, from 50 ppm to 900 ppm, from 50 ppm to 600 ppm, from 50 ppm to 500 ppm, from 50 ppm to 400 ppm, from 50 ppm to 300 ppm, from 50 ppm to 200 ppm, from 75 ppm to 600 ppm, from 75 ppm to 500 ppm, from 75 ppm to 400 ppm, from 75 ppm to 300 ppm, from 75 ppm to 200 ppm, from 75 ppm to 100 ppm, from 100 ppm to 600 ppm, from 100 ppm to 500 ppm, from 100 ppm to 400 ppm, from 100 ppm to 300 ppm, from 100 ppm to 200 ppm, from 125 ppm to 600 ppm, from 125 ppm to 500 ppm, from 125 ppm to 400 ppm, from 125 ppm to 300 ppm, from 125 ppm to 200 ppm, from 150 ppm to 600 ppm, from 150 ppm to 500 ppm, from 150 ppm to 500 ppm, from 150 ppm to 400 ppm, from 150 ppm to 300 ppm, from 150 ppm to 200 ppm, from 200 ppm to 600 ppm, from 200 ppm to 500 ppm, from 200 ppm to 400 ppm, from 200 ppm to 300 ppm, from 300 ppm to 600 ppm, from 300 ppm to 500 ppm, from 300 ppm to 400 ppm, from 400 ppm to 600 ppm, from 500 ppm to 600 ppm; or to provide a final concentration corresponding to any one of the aforementioned values in this paragraph; or to provide a final concentration range corresponding to any pair of the aforementioned values in this paragraph.

### VI. GMG-MRPs as Flavor Enhancers

The inventors have surprisingly found that GMG-MRPs can bind the volatiles of various flavors used in food, beverages, cosmetics, feeds, and pharmaceuticals. The GMG-MRPs prepared by the methods disclosed herein could be widely soluble in water, water/alcohol, alcohol, and other organic solvents used for the flavor industry at different temperatures. The sweet tea composition could naturally encapsulate the flavor produced during the processes described herein. Therefore, it is also excellent carrier or encapsulating material for flavors, including but not limited to flavors and spices originated from plants such as bark, flowers, fruits, leaves, animals such as concentrated meat and sea food soups etc., and their extracts such as essential oils etc. In one aspect, a processed flavor is added to solution containing one or more GMG-MRPs, then dried into a powder by any method, including but not limited spray-drying, crystallization, tray-drying, freeze drying etc. Thus, volatile flavors could be preserved. Normally, MRP flavors must be maintained at low temperatures such as 10 degrees centigrade. An advantage of the present embodiments is that encapsulated flavors by GMG-MRPs could be kept at room temperature or even higher temperatures without much loss of flavor. The antioxidant properties of GMG-MRPs can play an additional role in protecting the flavors. In addition, depending on desired product, specially designed compositions can enhance a foam for a specific application such as foamed/frothy coffee. In addition, an anti-foaming agent could be added together or separately during the reaction processes descried herein, such that the product could be used to prevent foaming for beverage bottling applications.

Another advantage of the present embodiments is that flavors can be absorbed in or to the inner surface of pores of GMG-MRPs powders. Flavors are preserved and can be released when in solution. The present embodiments avoid the use of starch, or dextrin as a carrier which can bring wheat taste to the flavors.

Another advantage is that three or more molecules selected from rubusosides, or suaviosides bind one water molecule and act as a moisture preserver. An embodiment of composition comprises one more GMG-MRPs as a moisture preserver.

Citrus flavors are among the most popular flavors in the food market. They are widely used in sauces and dressings as well as in sweet products, such as beverages, cookies, and desserts. Their consumption is growing steadily at more than 3% per year. Unfortunately, they are highly susceptible to the surroundings and deteriorate during processing and storage. Of all commercial citrus products, citrus flavor in beverages is the most delicate and difficult flavor to preserve. Lemon oil or lemon juice volatiles contain unstable flavor substances such as citral. The degradation of citrus flavors lowers intensity and balance and develops unacceptable “off-flavors” from the degradation products. The generation of off-flavors is an especially troublesome problem negatively impacting the market potential of citrus flavors in the marketplace. Therefore, many investigators have attempted to better understand the mechanism of deterioration and inhibit deterioration of these flavors.

Compared with traditional essential oil flavors which must be emulsified before being added to beverages, the compositions and methods of the present application do not require the use of emulsifiers. This maximizes the intensity of flavor, stabilizes the flavor from degradation by oxygen, light, heat etc., and makes the beverage transparent. In one embodiment, a stabilized flavor composition includes one or more GMG-MRPs in combination with a flavor substance. In a further aspect, a consumable food or beverage product contains these substances.

Freshness is one of the most important factors representing consumers' satisfaction with the sensory qualities present in fruit or berry juices, juice flavored beverages, fruited foods etc. Freshly squeezed juices without any treatment provide a refreshing, pleasant flavor with the mouth-contracting characteristics of fruits. Mouth-contracting is one type of mouthfeeling where ingredients cause contraction like freshness, acidity, salt, and spiciness in the mouth. Contracting substances typically stimulate saliva flow. Commercial fruit juices have shown variations in quality and freshness resulted from deterioration of flavor substances during the product's shelf-life as well as seasonal variations in fruit quality. Juice flavor is composed of a broad mixture of different aroma fractions containing a variety of volatile compounds. The aroma compounds in these fractions may undergo several changes during processing and storage that gradually lead to a loss of freshness and the formation of unpleasant aromas (off-flavors). Most of these changes are acid-catalyzed reactions supported by the acidity of the juice and accelerated by high processing and storage temperatures.

Freshness is an important character of quality for food and beverage products and is characterized by various definitions or aspects. In one aspect, the freshness or lack of freshness is perceived as a sensation. For example, a basil leave on a plant has a fresh smell and fresh taste. The same leaf after 2 days on the shelf doesn't smell fresh or taste fresh. In another aspect, freshness is derived from a multisensory sensation and a learned expectation together which can provide a “refreshing” sensation. For example, a consumer can assess sparkling water as fresh or refreshing even before drinking it. When people are thirsty and an unknown drink is provided, the effect of the unknown drink may be subconsciously compared with sparkling water. The basic properties of cognitive freshness are clear. Coldness, colorless, carbonated are typical characters of refreshing; sourness enhances freshness; colors such as red or orange increase thirst-quenching perception; flavors, such as mint, orange, peppermint, lemon, citrus, and peach are among the most refreshing aromas.

Without being bound by theory, the inventor's surprising findings strongly show that retronasal aroma is an inseparable part of taste. Taste and retronasal aromas arise from integrated senses. A lot of what is perceived as taste by human beings is in fact the result of retronasal aromas passing through the nose. It is known that people with severe colds have a greatly reduced sense of taste, because retronasal aromas cannot reach the retronasal olfactory receptors in the nose. Retronasal aromas compete with taste when reaching a sensory impression of a food or beverage product by the brain. Sweetness and mouthfeel cannot be solely attribute sensory perceptions originating on the tongue or in the mouth. Retronasal aroma (or nose-feeling) significantly contributes to what is considered traditional mouthfeel (mouth-contracting, mouth-coating, mouth-dry) without necessarily increasing the viscosity of a food or beverage. Aromas contracting with the mouth give the impression of refreshment and cleansing of the mouth. The compositions of the present application can be classified as contracting aromas that can stimulate saliva flow.

Compared with prevailing industry approaches for improving the overall taste and flavor of food and beverage products, the present application provides a unique approach to taste and flavor that better integrates aroma and taste to provide more tasteful food and beverage products. For example, in contrast to many of the traditional approaches in the flavor industry that rely on the use of essential oils having strong orthonasal sensory characteristics, the inventor of the present application has surprisingly found that retronasal aroma plays a more important role than orthonasal smell in making a consumable product with improved hedonic characteristics. By providing good mouthfeel and intensity of aroma, the compositions of the present application provide improved overall flavor. In one embodiment, a composition of the present application includes one or more GMG-MRPs alone or in combination with one or more substances selected from MGs, MEs, MCs, GMGs, GMEs, GMCs, SGs, SEs, GSGs, GSEs, STGs, STEs, STCs, GSTGs, GSTEs, GSTCs, S-MRPs, ST-MRPs and C-MRPs, wherein one or more sensory attributes selected from mouth-contracting, mouth-coating, mouthfeel, flavor intensity, and sweetness are increased relative to a composition without the one or more substances.

In some instances, people have acquired a reduction or loss in their sensory capabilities for taste and smell, especially upon aging or following infections by viruses, such as COVID-19. The compositions and methods of the present application provide effective tools for enhancing retronasal olfactory senses to make food and beverages more palatable for being swallowed. This can improve the speed of drinking beverages or eating foods by those with such reduced senses. Without being bound by theory, it is believed that the compositions of the present application are anti-inflammatory for the mucous membranes of the oral cavity, throat and retronasal cavity, and cause increased permeability of aroma substances through the epithelium. Thus, in some embodiments, the composition includes GMG-MRPs alone or in combination with one or more substances selected from MGs, MEs, MCs, GMGs, GMEs, GMCs, SGs, SEs, GSGs, GSEs, STGs, STEs, STCs, GSTGs, GSTEs, GSTCs, S-MRPs, ST-MRPs and C-MRPs, where at least one of the substances is an angiogenesis inhibitor. In some embodiments, the composition may further include one or more members selected from lutein, epilutein, and/or anthocyanins. Such composition may be used, for example, in patients suffering from COVID-19 or other sensory deficiencies.

The inventor has surprisingly found that compositions comprising GMG-MRP can increase the freshness of food and beverage products, and provide an improved, quicker onset of sweetness. These substances are further believed to provide an earlier recognition of flavor by the brain. The resultant effect of quick-onset of sweetness and refreshing flavor enables consumers to categorize food or beverage products quicker than if those glycosides were not added. The effect of this addition can provide improved overall flavor and taste of food and beverage products.

For instance, when certain high intensity sweeteners, such as sucralose, Acesulfame K, and certain glycosides are used as sweeteners, lingering is always generated. The lingering becomes the lead sensation. It dominates other sensations and distracts tasters from other sensations. However, the GMG-MRP containing compositions of the present application can block the lingering and bitterness of high intensity sweeteners and act synergistically to improve sweetness.

In one embodiment, a sweetening or flavoring composition includes one or more GMG-MRPs that can generate a quick onset of sweetness, enhance the strength of orthonasal smell, improve the freshness, and/or increase the sweetness of a food or beverage product.

In another embodiment, a method to accelerate flavor identification by the brain comprises adding one or more GMG-MRPs alone or in combination with one or more substances selected from MGs, MEs, MCs, GMGs, GMEs, GMCs, SGs, SEs, GSGs, GSEs, STGs, STEs, STCs, GSTGs, GSTEs, GSTCs, S-MRPs, ST-MRPs and C-MRPs, wherein the identification is accelerated by less than 1 second, less than 0.1 second, less than 0.01 second, or less than 0.001 second.

Oral mucosa can be classified into three different types: masticatory mucosa, lining mucosa and specialized mucosa. Masticatory mucosa covers the gingiva and hard palate, which accounts for about 25% of the oral mucosa. Specialized mucosa with characteristics of both masticatory and lining mucosa is found on the dorsum of the tongue. The dorsum of tongue accounts for about 15% of the oral mucosa. Lining mucosa covers the remaining regions, except for the dorsal surface of the tongue. Liming mucosa is related to the conventional third of the major chemosensory systems, the trigeminal chemosensory system. The neurons and their associated endings in this system are typically activated by chemicals classified as irritants, including air pollutants (e.g., sulfur dioxide), ammonia (smelling salts), ethanol (liquor), acetic acid (vinegar), carbon dioxide (in soft drinks), menthol (in various inhalants), and capsaicin (the compound in chili peppers that elicits the characteristic burning sensation). Contrary to conventional knowledge, the inventor of the present application believes that the lining mucosa contains taste and aroma receptors and plays a principal role in overall taste and aroma together with retronasal nose-tasting, retronasal nose-coating, retronasal nose-aroma and taste by tongue. This means that the overall flavor, including taste and aroma, is an integrated and inseparable entity created by taste and flavor receptors spreading in lining mucosal sites, in addition to tongue, throat and retronasal areas.

GMG-MRPs can stimulate trigeminal nerve receptors in the mouth and retronasal cavity and play an important role in flavor and taste identification of consumable products. Further, when combining GMG-MRPs with pungent and irritant chemicals, synergistic effects are observed. Whereas pungent and irritant chemicals can activate trigeminal nerve receptors at lower thresholds or concentrations when combined with rubusoside-based glycosides or other small molecular stevia glycosides. Thus, in one embodiment, a composition or consumable product comprises: (a) one or more flavor and/or taste substances, and (b) one or more GMG-MRPs such that the threshold for activating trigeminal receptors is reduced compared to a composition or product containing only the one or more flavor and/or taste substance in part (a).

The inventor has surprisingly found that GMG-MRPs can be used as trigeminal nerve stimulants. When used together with other taste or flavor stimulants, these substances can induce nerve firing, elicit enhanced sensations such as irritation, burning, stinging, tingling, pain, as well as the general perception of temperature, viscosity, weight, and freshness. When used at higher concentrations, these trigeminal stimulants can suppress the perception of olfactory compounds. Thus, in one embodiment, a composition or consumable product comprises: (a) one or more flavor and taste substances, and (b) one or more GMG-MRPs, where stimulation strength of (a) is enhanced when using (b) at lower concentrations and where the stimulation strength of (a) is reduced when using (b) at higher concentrations.

Without being bound by theory, the inventor believes that masticatory mucosa and lining mucosa are essentially responsible for mouth-contracting, and specialized mucosa is mainly responsible for mouth-coating or tongue-coating. Both are responsible for mouthfeel. It is further believed that the lining mucosa is responsive to rubusosides, glycosylated rubusosides and MRPs therefrom exhibit significant flexibility, biocompatibility, and propensity for adhesively attaching to these mucosal surfaces. Accordingly, these substances are believed to improve permeability and adhesiveness of flavor substances to oral mucosa to bind sensory receptors responsive to bitterness, as well as metallic and synthetic tastes, thereby blocking other unpleasant substances to these receptors that would otherwise have a negative effect on taste and flavor. Nasal mucosae are particularly sensitive; GMG-MRPs exhibit better accessibility and stronger impact on nasal mucosa.

In view of the foregoing, a method of the present application includes adding one or more GMG-MRPs to a consumable product to enhance the mouth-contracting and freshness of the consumable product. In a more particular embodiment, a composition of the present application includes one or more components selected from MGs, MEs, MCs, GMGs, GMEs, GMCs, SGs, SEs, GSGs, GSEs, STGs, STEs, STCs, GSTGs, GSTEs, GSTCs, S-MRPs, ST-MRPs and C-MRPs.

Improving the freshness of food and beverage products can modify their overall flavor, acidity, and sweetness profiles, regardless of whether the product contains sugar(s) or a reduced sugar content. In particular, the freshness of food and beverage products, including both sugar containing and reducing sugar versions thereof, can be significantly improved by combining the GMG-MRPs of the present application with flavor substances, especially water phase essence flavors or water phase concentrated flavors, such as lemon juice concentrated aroma, orange juice concentrated aroma, cucumber concentrated aroma, and apple juice concentrated aroma etc. Adding these compositions to food and beverage products can enhance the contracting mouthfeel, orthonasal smell, retronasal aroma, reduce lingering, reduce metallic and artificial aftertaste of both natural and synthetic high intensity sweeteners, make the food and beverage products more palatable, and provide new flavors with improved sensory characteristics.

In another embodiment, a food or beverage product includes a composition comprising one or more GMG-MRPs present in the food or beverage product in an amount of at least 1 ppm, at least 5 ppm, at least 10 ppm, at least 20 ppm, at least 50 ppm, at least 100 ppm, at least 200 ppm, at least 300 ppm, at least 500 ppm, or at least 1,000 ppm.

In another embodiment, a food or beverage product includes a composition comprising: (a) a composition containing one or more GMG-MRPs; and (b) a composition containing one or more sweeteners selected from MGs, MEs, MCs, GMGs, GMEs, GMCs, SGs, SEs, GSGs, GSEs, STGs, STEs, STCs, GSTGs, GSTEs and GSTCs, where the contents of part (a) are added in sufficient amounts to significantly improve solubility, increase sweetness, reduce bitterness, and/or reduce metallic or lingering aftertastes present in (b).

In another embodiment, a food or beverage product includes a composition comprising: (a) a composition containing one or more GMG-MRPs; and (b) a composition containing one or more sweeteners selected from MGs, MEs, MCs, GMGs, GMEs, GMCs, SGs, SEs, GSGs, GSEs, STGs, STEs, STCs, GSTGs, GSTEs and GSTCs, where the ratio (w/w) of the composition in part (a) to the composition in part (b), is 1:99 to 99:1. In some embodiments, the ratio (w/w) of the composition in part (a) to the composition in part (b), is 1:99 to 30:1, 1:99 to 10:1, 1:99 to 3:1, 1:99 to 1:1, 1:99 to 1:3, 1:99 to 1:10, 1:99 to 1:30, 3:99 to 99:1, 3:99 to 30:1, 3:99 to 10:1, 3:99 to 3:1, 3:99 to 1:1, 3:99 to 1:3, 3:99 to 1:10, 10:99 to 99:1, 10:99 to 30:1, 10:99 to 10:1, 10:99 to 3:1, 10:99 to 1:1, 10:99 to 1:3, 30:99 to 99:1, 30:99 to 30:1, 30:99 to 10:1, 30:99 to 3:1, 30:99 to 1:1, 1:1 to 99:1, 1:1 to 30:1, 1:1 to 10:1, 1:1 to 3:1, 3:1 to 99:1, 3:1 to 30:1, 3:1 to 10:1, 10:1 to 99:1, 10:1 to 30:1, or 30:1 to 99:1. In some embodiments, part (a) is about, or great than, 1%, 2%, 5%, 10%, 15%, 20%, 25%, 30%, 35%, 40%, 45%, 50%, 55%, 60%, 65%, 70%, 75%, 80%, 85%, 90% or 95% by weight of the composition. In some embodiments, part (b) is about, or less than, 50%, 40%, 30%, 20%, 10%, 5%, 2% or 1% by weight of the composition.

In another embodiment, a flavor composition or sweetener composition comprises: (a) one or more GMG-MRPs; and (b) one or more sweeteners selected from MGs, MEs, MCs, GMGs, GMEs, GMCs, SGs, SEs, GSGs, GSEs, STGs, STEs, STCs, GSTGs, GSTEs and GSTCs, where the one or more GMG-MRPs include at least 1%, at least 2%, at least 3%, at least 4%, at least 5%, at least 10%, at least 20%, at least 30%, at least 50%, at least 60%, at least 80%, at least 90%, or at least 95% (w/w) of the flavor or sweetener. In a further aspect, a food or beverage product include the substances in each of parts (a) and (b), where the GMG-MRPs in part (a) are present in a food or beverage product in an amount of at least 1 ppm, at least 5 ppm, at least 10 ppm, at least 20 ppm, at least 50 ppm, at least 100 ppm, at least 200 ppm, at least 300 ppm, at least 500 ppm, or at least 1,000 ppm (w/w). In a further embodiment, a food or beverage product includes the substances in each of parts (a) and (b), where the solubility (in the food or beverage product) of the one or more sweeteners selected from MGs, MEs, MCs, GMGs, GMEs, GMCs, SGs, SEs, GSGs, GSEs, STGs, STEs, STCs, GSTGs, GSTEs and GSTCs in part (b) are significantly improved in the presence of part (a), or where the overall sweetness of the product is increased relative to a food or beverage product without the aforementioned substances, or where the bitterness, metallic aftertaste and/or lingering aftertaste are reduced relative to a food or beverage product without the aforementioned substances, or where the ratio of the GMG-MRPs in part (a) to the one or more sweeteners in part (b) is between 1:99 and 99:1 on a w/w basis.

In another embodiment, a flavor or sweetener includes: (a) one or more GMG-MRPs, and (b) one or more substances selected from sucralose, acesulfame K, saccharin, aspartame, Neotame, and alitame, where the GMG-MRPs in part (a) are present in the flavor or sweetener in an amount of at least 1%, at least 2%, at least 3%, at least 4%, at least 5%, at least 10%, at least 20%, at least 30%, at least 50%, at least 60%, at least 80%, at least 90%, or at least 95% (w/w). In a further aspect, a food or beverage product includes the substances in each of parts (a) and (b), where the GMG-MRPs in part (a) are present in the food or beverage product in an amount of at least 1 ppm, at least 5 ppm, at least 10 ppm, at least 20 ppm, at least 50 ppm, at least 100 ppm, at least 200 ppm, at least 300 ppm, at least 500 ppm, or at least 1,000 ppm (w/w). In a further embodiment, the food or beverage product includes the one or more substances in each of parts (a) and (b), where the solubility (in the food or beverage product) of the one or more substances in part (b) is significantly improved, or where the overall sweetness of the product is increased relative to a food or beverage product without the aforementioned substances, or where the bitterness, metallic aftertaste and/or lingering aftertaste are reduced relative to a food or beverage product without the aforementioned substances, or where the ratio of the GMG-MRPs in part (a) to the one or more substances in part (b) is between 1:99 and 99:1 on a w/w basis.

In another embodiment, a flavor or sweetener includes: (a) one or more GMG-MRPs, and (b) one or more substances selected from polydextrins, modified starch, inulin, erythritol, where the one or more GMG-MRPs in part (a) are present in the flavor or sweetener in an amount of at least 1%, at least 2%, at least 3%, at least 4%, at least 5%, at least 10%, at least 20%, at least 30%, at least 50%, at least 60%, at least 80%, at least 90%, or at least 95% (w/w). In a further aspect, a food or beverage product includes the one or more substances in each of parts (a) and (b), where the one or more GMG-MRPs in part (a) are present in the food or beverage product in an amount of at least 1 ppm, at least 5 ppm, at least 10 ppm, at least 20 ppm, at least 50 ppm, at least 100 ppm, at least 200 ppm, at least 300 ppm, at least 500 ppm, or at least 1,000 ppm (w/w). In a further embodiment, the food or beverage product includes the one or more substances in each of parts (a) and (b), where the solubility (in the food or beverage product) of the one or more substances in part (b) is significantly improved, or where the overall sweetness of the product is increased relative to a food or beverage product without the aforementioned substances, or where the bitterness, metallic aftertaste and/or lingering aftertaste are reduced relative to a food or beverage product without the aforementioned substances, or where the ratio of the one or more GMG-MRPs in part (a) to the one or more substances in part (b) is between 1:99 and 99:1 on a w/w basis.

In another embodiment, a flavor or sweetener composition contains GMG-MRPs and GMGs, where the ratio of GMG-MRPs to GMGs is from 1:99 to 99:1, optionally where the flavor or sweetener composition further comprises one or more carriers, such as maltodextrin.

In another embodiment, a flavor or sweetener composition is formulated to include one or more GMG-MRPs, to improve the taste profile of high intensity sweeteners, such as sucralose, Acesulfame K, Aspartame, saccharin, stevia extract, stevia glycosides, monk fruit extract, mogrosides, licorice extract. Accordingly, in certain embodiments, a flavor or sweetener composition containing one or more GMG-MRPs further includes one or more high intensity sweeteners selected from sucralose, Acesulfame K, Aspartame, saccharin, stevia extract, stevia glycosides, sweet tea extracts, sweet tea glycosides, and licorice extract. In another aspect, a method to improve the taste profile of a high intensity sweetener includes the step of adding to a composition containing the high intensity sweetener one or more GMG-MRPs.

In another embodiment, a consumable product includes one or more GMG-MRPs, where the total content of the GMG-MRPs in the consumable product is at least 0.1 ppm, at least 1 ppm, at least 5 ppm, at least 10 ppm, at least 50 ppm, at least 100 ppm, at least 250 ppm, at least 500 ppm, at least 1,000 ppm, at least 1%, at least 5%, or at least 10% on weight:weight basis.

Umami is a delicious aroma formed by convergence of taste and retronasal olfactory pathways in the human brain. Soy sauces are widely used in Asian area. There is strong demand to reduce salt and or added sugar in soy sauces. The inventor has surprisingly found that adding one or more GMG-MRPs can reduce the amount of salt, increase the mouthfeel or mouth-coating, minimize the off-taste of fermentation and soybean, and/or improve the umami taste when used in soy sauces. In one aspect, a method to improve the taste profile of a sugar or reduced sugar soy sauce includes the step of adding to the soy sauce one or more GMG-MRPs described in the present application, optionally with one or more substances selected from MGs, MEs, MCs, GMGs, GMEs, GMCs, SGs, SEs, GSGs, GSEs, STGs, STEs, STCs, GSTGs, GSTEs, GSTCs, S-MRPs, ST-MRPs and C-MRPs.

Jams contain high sugars such as sucrose, fructose etc. The inventor has surprisingly found that adding one or more GMG-MRPs, optionally with one or more substances selected from SGs, SEs, GSGs, GSEs, Stevia-MRPs and C-MRPs in a jam can increase the freshness of fruit flavors in the jam, increase the sweetness of the jam and or increase the mouthfeel of the jam.

Fermented milks, such as yogurt exhibit long lasting sourness, which is unpleasant to many consumers. There is huge challenge to reduce sugar and fat in yogurt and other milk products. Plant-based protein beverages, such as soybean milk and coconut milk have grassy, beany off-note aromas. The inventor has surprisingly found that adding compositions of the present application containing one or more GMG-MRPs, optionally with one or more MGs, MEs, MCs, GMGs, GMEs, GMCs, SGs, SEs, GSGs, GSEs, STGs, STEs, STCs, GSTGs, GSTEs, GSTCs, S-MRPs, ST-MRPs and C-MRPs can improve the mouthfeel or mouth-coating, quick onset sweetness, reduce unpleasant aftertastes, and/or reduce the sourness of fermented protein beverages, where the protein is from an animal and/or plant source. The compositions of the present application are particularly well suited for use with plant-based proteins to provide taste and retronasal olfactory inputs to the brain that can be observed by neuroimaging.

Glucose transporters GLUT1 (transports glucose) and GLUT5 (transports fructose) have been implicated in several diseases including cancer and diabetes. In one embodiment, the present application provides a method for weight management, comprising oral administration of a consumable product containing one or more GMG-MRPs in an amount sufficient for reducing absorption of glucose and/or fructose or inhibiting their transport by GLUT1 and/or GLUT5.

In one embodiment, one or more raw materials for obtaining GMGs for preparing a GMG-MRP composition are obtained by fermentation or chemical synthesis, where the content of the MGs or GMGs in the composition are at least 99%, at least 95%, at least 75%, at least 50%, at least 10%, at least 5%, at least 1%, or at least 0.1% (w/w) of the GMG-MRP composition.

The inventor has surprisingly found that compositions of the present application containing GMG-MRPs therefrom can act synergistically with vanilla extract, vanillin, or ethyl vanillin to reduce the amount of vanilla or vanillin needed in a consumable. In one embodiment, a composition of the present application includes one or more GMG-MRP compositions (optionally containing unreacted MGs and GMGs) in combination with one or more substances selected from vanilla extract, vanillin, and ethyl vanillin.

The inventor has surprisingly found that compositions of the present application composition containing GMG-MRPs formed therefrom can create a fatty taste sensation or enhance the fat taste-feeling of skim milk, vegetable burgers, and other low-fat food and beverage products. In this case, it is believed that the GMG-MRP compositions (optionally containing unreacted MGs and GMGs) can act in combination with fat to produce a synergistic effect with respect to fat taste sensations in a consumable product containing these substances. Accordingly, in one embodiment, a composition of the present application includes one or more GMG-MRP compositions (optionally containing unreacted MGs and GMGs) in combination with one or more fats.

When modified starches, such as hydroxypropyl distarch phosphate (cross-linked hydroxylpropyl ether starch) are used as a stabilizers or fat replacers in food and beverages, they create a chalky or starchy taste, which may be characterized by the sensation of granules or particles on the tongue or in the cavity of the mouth. The inventor has surprisingly found that compositions of the present application can significantly minimize the chalky or starchy taste when modified starch is used in a consumable. In one embodiment, a composition of the present application includes one or more GMG-MRPs in combination with one or more modified starches, where the one or more substances are added in an amount sufficient to reduce an otherwise chalky or starchy taste, characterized by the sensation of granules or particles on the tongue or mouth cavity.

When water insoluble or less water-soluble substances, such as stevia extracts or stevia glycosides are combined with the compositions of the present application, the solubility of the substances can be improved. Moreover, when the poorly water soluble or insoluble substances are high intensity sweeteners combined with the compositions of the present application, the overall sweetness can be synergistically increased. In one embodiment, a composition of the present application includes one or more GMG-MRPs and one or more poorly water soluble or insoluble stevia glycosides, including but not limited to Reb A, Reb B, Reb C, stevioside, Reb D, Reb I, Reb N, Reb M, Reb O, where the solubility and sweetness of the one or more poorly water soluble or insoluble stevia glycosides is increased when combined with the GMG-MRPs.

The fresh pressed sugarcane or sugar beet juice, its concentrate with low temperature or short time concentration could be combined with the composition in this invention to boost the sweet taste profile of products. In one embodiment, a GMG-MRP containing composition contains one or more GMG-MRPs and one or more products obtained from sugarcane, preferably fresh pressed sugarcane or sugar beet juice, or a concentrate thereof produced at low temperatures to maximize flavor preservation. In another embodiment, a GMG-MRP containing composition contains one or more GMG-MRPs and one or more products obtained from sugarcane, where the sugar-cane product has less sweetness than caramelized molasses or dark colored sugarcane or sugar beet products.

In one aspect, the present application relates to a composition comprising (a) one or more GMG-MRPs; and (b) one or more substances selected from MGs, MEs, MCs, GMGs, GMEs, GMCs, SGs, SEs, GSGs, GSEs, STGs, STEs, STCs, GSTGs, GSTEs, GSTCs, where the components in part (a) is added in sufficient amounts so that the sweetness of the one or more substances in part (b) is synergistically increased by the addition of the GMG-MRPs, or where the lingering aftertaste, metallic aftertaste and/or bitter aftertaste of the one or more substances in part (b) is reduced by the addition of the GMG-MRPs. In this embodiment, the MGs for preparing the GMG-MRPs in part (a) are obtained from monk fruit extracts, or by fermentation, bioconversion from other substances, such as terpenes, or by chemical synthesis.

In some embodiments, the weight ratio of the GMG-MRPs in part (a) to the substances in part (b) is 1:99 to 99:1. In some embodiments, the ratio (w/w) of the composition in part (a) to the composition in part (b) is 1:99 to 30:1, 1:99 to 10:1, 1:99 to 3:1, 1:99 to 1:1, 1:99 to 1:3, 1:99 to 1:10, 1:99 to 1:30, 3:99 to 99:1, 3:99 to 30:1, 3:99 to 10:1, 3:99 to 3:1, 3:99 to 1:1, 3:99 to 1:3, 3:99 to 1:10, 10:99 to 99:1, 10:99 to 30:1, 10:99 to 10:1, 10:99 to 3:1, 10:99 to 1:1, 10:99 to 1:3, 30:99 to 99:1, 30:99 to 30:1, 30:99 to 10:1, 30:99 to 3:1, 30:99 to 1:1, 1:1 to 99:1, 1:1 to 30:1, 1:1 to 10:1, 1:1 to 3:1, 3:1 to 99:1, 3:1 to 30:1, 3:1 to 10:1, 10:1 to 99:1, 10:1 to 30:1, or 30:1 to 99:1. In some embodiments, part (a) is greater than or equal to about 1%, 2%, 5%, 10%, 15%, 20%, 25%, 30%, 35%, 40%, 45%, 50%, 55%, 60%, 65%, 70%, 75%, 80%, 85%, 90% or 95% by weight of the composition. In some embodiments, part (b) is about, or less than, 50%, 40%, 30%, 20%, 10%, 5%, 2% or 1% by weight of the composition.

The inventor has surprisingly found a sweetness synergy between GMG-MRPs and other sweeteners. In one embodiment, a GMG-MRP containing composition of the present application includes: (a) one or more GMG-MRPs; and (b) one or more components selected from the group consisting of MGs, GMGs, MG-MRPs, GMG-MRPs, SGs, SGEs, GSGs, GSGEs, GSG-MRPs, GSGE-MRPs, STCs, STGs, STEs, GSTCs, GSTGs, GSTEs, STC-MRPs, STG-MRPs, STE-MRPs, GSTC-MRPs, GSTG-MRPs, GSTE-MRPs, reducing sugars, salts, sweeteners, sweetener enhancers, and any combination thereof, including multiple components and permutations thereof.

It should be noted that the plural component forms above should be construed to embrace singular component forms also. Additionally, the plural and singular component forms above are not limited to the recited component forms in isolation and include compositions comprising the respective component forms. Thus, the term “MGs” is not limited to a singular MG or plurality of MGs in isolation, but include compositions containing an MG or a plurality of MGs.

In another embodiment, the foregoing GMG-MRP composition contains one or more GMG-MRPs from part (a) and one or more components from part (b), where the weight ratio of (a) to (b) is from 1:99 to 99:1. In a further embodiment, a food and beverage product contains one or more GMG-MRPs from part (a) and one or more components from part (b). In a further embodiment, a food and beverage product contains one or more GMG-MRPs from part (a) and one or more components from part (b), where the total amount of the components from parts (a) and (b) is from 1 ppm to 10,000 ppm.

Caramelization can occur during the Maillard reaction. Exemplary reactions include:
1. equilibration of anomeric and ring forms
2. sucrose inversion to fructose and glucose
3. condensation
4. intramolecular bonding
5. isomerization of aldoses to ketoses
6. dehydration reactions
7. fragmentation reactions
8. unsaturated polymer formation

One embodiment comprises one or more of these non-volatile substances originated from GMG-MRPs including remaining sugar donor, remaining amine donor, it could also include caramelized substances such as disaccharides, trisaccharides, tetrasaccharides etc. which are formed by sugar donors, dimer-peptide, tri-peptide, tetra-peptides etc. which are formed by amine donors, glycosylamine and their derivatives such as Amadori compounds, Heyns compounds, enolisated compounds, sugar fragments, amino acid fragments and non-volatile flavor compounds which are formed by Maillard reaction of sugars and amino acid donors.

Thickeners such as hydrocolloids or polyols are used in liquid to improve the mouth feel by increasing the viscosity, they are also used in solid base product as filler for low-cost sugar products. However, they could create a chalky or a floury taste, and higher viscosities would make a beverage less palatable. Therefore, there is a need to find a solution to reduce the amount of thickeners used in foods and beverages, especially for sugar, fat, and salt reduction products. The inventors surprisingly found that adding one or more GMG-MRPs could enhance the mouth feel of thickeners and have a synergistic effect without necessarily increasing the viscosity, thus improving the palatability of the food or beverage. An embodiment comprises one or more GMG-MRPs and sweetening agent(s), or mixture of one or more GMG-MRPs, sweetening agent and thaumatin) and a thickener, wherein the thickener is selected from one or more hydrocolloids and/or polyols. In one embodiment, the composition of the present invention can comprise one or more GMG-MRPs and at least one of sweetening agent and/or sweeteners. The one or more GMG-MRPs are a direct result of a Maillard reaction without separation or purification. The one or more GMG-MRPs comprise the reaction product of an amine donor and a sugar donor. Wherein, the sugar donor comprises reducing sugar, sweetener and/or sweetening agent. The sweetener comprises one or more sweeteners selected from the group consisting of sorbitol, xylitol, mannitol, aspartame, acesulfame-K, neotame, erythritol, trehalose, raffinose, cellobiose, tagatose, DOLCIA PRIMA™ allulose, inulin, N—[N-[3-(3-hydroxy-4-methoxyphenyl)propyl]-alpha-aspartyl]-L-phenylalanine 1-methyl ester, glycyrrhizin, sodium cyclamate, or mixtures thereof. The sweetening agent includes one or more products selected from the group consisting of a licorice extract, a stevia extract, a sweet tea extract, a glycosylated stevia extract, a glycosylated sweet tea extract, a glycosylated steviol glycoside, a glycosylated suavioside, and a mixture thereof. SGEs includes one or more steviol glycoside components (SGCs). From the perspective of volatile and non-volatile substances, the Maillard reaction comprises volatile substances (comprising pure and impure substances) and non-volatile substances (comprising pure and impure substances).

GMG-MRPs may include various isolated products, either partially volatile substances or partially non-volatile substances removed from the direct result of the Maillard reaction. With increasing demand of natural flavors such as vanilla, citrus, cocoa, coffee etc., the food and beverage industry face a big challenge to meet consumers' requirements. For example, the harvest of citrus in recent years has been heavily influenced by fruit disease which has created a shortage. Vanilla, coffee, and Cocoa supply is always strongly influenced by climate. To increase their availability, farmers must use more land to compete with other necessary cultivation of food and vegetable products, thus there is an additional danger of deforestation. Therefore, there is a need to find alternative sources to complement the market demand. The inventors surprisingly found that adding one or more GMG-MRPs can significantly improve the taste profile of flavors, lower the threshold of flavors, and reduce the number of flavors to be used. In one embodiment, a GMG-containing composition includes one or more GMG-MRPs (or mixture of one or more GMG-MRPs and sweetening agent, or mixture of one or more GMG-MRPs, sweetening agents and thaumatin) and a flavor.

Consumers are demanding ‘cleaner’ labels while retailers demand longer shelf life. The use of natural antioxidants such as tocopherols and rosemary extracts can solve these problems simultaneously. However, natural antioxidants always retain their own characteristic aroma, which makes it difficult to incorporate them in food and beverages. There is a need to look for alternative solutions. The inventors surprisingly found that adding one or more GMG-MRPs to food or beverage products can significantly reduce the negative aroma of antioxidants and provide a synergy of antioxidant property. In one embodiment, a GMG-containing composition includes one or more GMG-MRPs (or a mixture of one or more GMG-MRPs and sweetening agent(s), or a mixture of one or more GMG-MRPs, sweetening agent(s) and thaumatin) and a natural antioxidant.

Thaumatin is a good alternative solution for sugar reduction. However, its lingering taste makes it difficult to be used at higher dosages. The inventors surprisingly found adding one or more GMG-MRPs can substantially reduce the lingering and bitterness of thaumatin and widen its usage in foods and beverages. In one aspect, compositions comprising one or more GMG-MRPs and thaumatin are disclosed, including food or beverages comprising one or more GMG-MRPs and thaumatin. Addition of a sweetening agent, such as stevia, together with one or more GMG-MRPs can significantly improve the taste profile of thaumatin, reducing its lingering taste. Thaumatin has synergy with one or more ST-MRPs to reduce the bitterness and/or aftertaste of stevia.

Various compositions can include combinations of one or more GMG-MRPs; or one or more GMG-MRPs with thaumatin (or one or more sweeteners; or one or more GMG-MRPs with one or more sweetening agents; or one or more GMG-MRPs with one or more sweetening agents and one or more sweeteners, e.g., thaumatin.

Maillard reaction products can also create problems for the food industry. A lot of resources have been expended to prevent Maillard reactions in food proceeding to maintain food quality. Therefore, there is a need to find methods for producing useful Maillard reaction products benefiting the food and beverage industry. For example, 2-Amino-1-methyl-6-phenylimidazo (4, 5-b)pyridine (PhlP) is usually responsible for around 80% of the aromatic amines present in cooked meat products, is often formed in high amounts and is listed on the IARC list of carcinogens. It is now understood that (HAAs) are over 100-fold more mutagenic than Aflatoxin B1. For example, heterocyclic aromatic amines (HAAs) can be formed under mild conditions—when glucose, glycine and creatine/creatinine are left at room temperature ina phosphate buffer for 84 days HAA's are formed. HAA's are reported in all kinds of cooked meat and fish products especially those that have beengrilled, barbecued, or roasted. Traditional restaurant food preparation tends to produce more HAA's than fast food outlets. With chicken, deep fat frying produces the highestlevels of HAA's. Increasing mutagenic activity correlates with increased weight loss during cooking.

Barbecued beef contains additional mutagenic components. Acrylamide for example, was first identified in 2002 by Margaret Tornquist of Stockholm University. She compared the blood samples of Swedish tunnel builders working with a sealant containing acrylamide with those of the general population. The results showed that the general population was regularly exposed to high levels of acrylamide. Rat feeding studies have revealed that acrylamide increases the incidence of several types of cancer. All these results demonstrate a need for alternative solutions to provide desired tastes without these harmful substances, especially for bread, grilled meat, roasted coffee, and chocolate.

The inventor's solution is to select a suitable sugar and amine donor to create taste or flavor which can be added in food or beverages, especially for sweet foods and beverages. The addition of GMG-MRPs can allow for conditions of baking, frying, grilling, roasting of food to be carried out at lower temperatures, to have shorter heating times, and reduce or avoid production of harmful substances compared with traditional food process methods. Meanwhile, traditional methods for heating foods consume a lot of energy and create more pollution in comparison to the compositions and methods of the present application. The present application facilitates the creation of new methods of baking, frying, grilling, and roasting without compromising taste. In one embodiment, a method for making a healthier or less harmful food or beverage includes the step of adding one or more GMG-MRPs to a food or beverage product.

Proteins constitute an important dietary component in foods and beverages. However, in certain cases the raw egg taste and smell associated with proteins can present an obstacle for wider consumption. Bean proteins, whey proteins and coconut proteins possess characteristically unpleasant tastes following drying. Therefore, there is a need to find compositions and method for making them more palatable. The inventors of the present application have surprisingly found that adding the GMG-MRP compositions to consumable products can significantly block the unpleasant tastes associated with proteins to make them more palatable to consumers. In one embodiment, a composition, food product, or beverage product contains one or more food proteins and one or more GMG-MRPs, either alone or in combination with one or more sweetening agent(s), and/or thaumatin.

Other embodiments of the present application pertain to beverages comprising one or more GMG-MRPs, or a mixture of one or more GMG-MRPs and one or more sweetening agent, or a mixture of one or more GMG-MRPs. one or more sweetening agents and thaumatin. Reduced fat foods and beverages are prevalent in the market. However, lack of mouthfeel and saturated fat taste on the tongue make them unpalatable for consumers. There exists a need to find a solution to solve it. The inventors surprisingly found adding compositions this invention could significantly improve the mouth feel and overall taste of reduced fat food and beverages. One embodiment pertains to compositions comprising fat and one or more GMG-MRPs (or a mixture of one or more ST-MRPs and sweetening agent(s), or a mixture of one or more GMG-MRPs, sweetening agent(s) and thaumatin). One embodiment pertains to partially or completed reduced fat foods and beverages comprising one or more GMG-MRPs, or a mixture of one or more GMG-MRPs and one or more sweetening agents, or a mixture of one or more GMG-MRPs, one or more sweetening agents and thaumatin.

Reduced salt foods and beverages are in high demand. However, the taste is not very satisfying to most consumers. There is need to find a solution to enhance the salty taste without increasing sodium intake. The inventors surprisingly found there is synergy of one or more GMG-MRPs, mixture(s) of one or more GMG-MRPs and sweetening agent(s), mixture(s) of one or more GMG-MRPs and sweetening agent(s) and thaumatin with salt. One embodiment pertains to reduced compositions of salt with one or more GMG-MRPs, or mixture(s) of one or more GMG-MRPs and sweetening agent(s), mixture(s) of one or more GMG-MRPs and sweetening agent(s) and thaumatin. One embodiment provides salt foods or beverages comprising one or more GMG-MRPs, or a mixture of one or more GMG-MRPs and one or more sweetening agents, or a mixture of one or more GMG-MRPs, one or more sweetening agents and thaumatin.

Foods and beverages containing vegetable or vegetable juices, especially garlic, ginger, beet root etc. have their strong characteristic flavors, which sometimes become taste barriers for certain consumers. There is need to find solution to neutralize or harmonize the taste of this type of food or beverage. The inventors surprisingly found that adding the compositions this invention could harmonize the taste of such foods and beverages and make them more consumer-likeable products. One embodiment provides vegetable containing foods and beverages comprising one or more GMG-MRPs, or a mixture of one or more GMG-MRPs and one or more sweetening agents, or a mixture of one or more GMG-MRPs, one or more sweetening agents and thaumatin.

Vegetables with a bitter taste such as artichoke, broccoli, radicchio, arugula, brussels sprout, chicory, white asparagus, endive, kale and brassica, dandelion, eggplant, and bitter melon are added into foods and beverages providing healthy choices to consumers. However, there is a need to find a solution to neutralize or mask the bitter taste associated with the vegetables. The inventors surprisingly found that adding the compositions of this invention could harmonize the taste of such foods and beverages and make them more consumer-likeable products. One embodiment pertains to bitter vegetable containing foods and beverages comprising one or more GMG-MRPs, or a mixture of one or more GMG-MRPs and one or more sweetening agents, or mixture of one or more GMG-MRPs, one or more sweetening agents and thaumatin.

Foods and beverages containing juices, juice concentrate, or fruit extract such as cranberry, pomegranate, bilberry, raspberry, lingonberry, grapefruit, lime, and citrus have a sour and astringent taste. The inventors surprisingly found that adding compositions of this invention could harmonize the taste and make it acceptable to consumers. One embodiment contains fruit or fruit juice foods or beverages comprising one or more GMG-MRPs, or a mixture of one or more GMG-MRPs and one or more sweetening agents, or mixture of one or more GMG-MRPs, one or more sweetening agents and thaumatin.

Foods and beverages containing minerals and trace elements can have a metallic taste. There is a need to find a solution to overcome this drawback. The inventors surprisingly found that adding compositions of this invention could block the metallic taste of minerals, thus improving the palatable taste of foods and beverages to consumers. One embodiment pertains to mineral enriched foods or beverages comprising one or more GMG-MRPs, or a mixture of one or more GMG-MRPs and one or more sweetening agents, or mixture of one or more GMG-MRPs, one or more sweetening agents and thaumatin.

Vitamin fortified foods and beverages provide challenges to acceptable taste due to bitterness or stale taste associated with Vitamin B series and sour and tingling tastes for Vitamin C. The inventors surprisingly found that adding composition of this invention could block the bitterness of Vitamin B series and improve the taste and mouth feel of Vitamin C as well as overall likeability. One embodiment is a vitamin fortified food or beverage one or more GMG-MRPs, or a mixture of one or more GMG-MRPs and one or more sweetening agents, or mixture of one or more GMG-MRPs, one or more sweetening agents and thaumatin.

Foods and beverages containing amino acids such as arginine, aspartic acid, cysteine HCl, glutamine, histidine HCl, isoleucine, lysine HCl, methionite, proline, tryptophan and valine have bitter, metallic or an alkaline taste. A solution is required to overcome these drawbacks. The inventors surprisingly found that adding compositions of this invention to amino acids could block the bitter, metallic, or alkaline taste. One embodiment pertains to amino acid enriched foods and beverages comprising one or more GMG-MRPs, or a mixture of one or more GMG-MRPs and one or more sweetening agents, or mixture of one or more GMG-MRPs, one or more sweetening agents and thaumatin.

Foods and beverages containing fatty acids such as linoleic acid, linolenic acid and palmitoleic acid have a mineral or pungent taste. There is a need to find a solution to overcome these drawbacks. The inventors surprisingly found that adding composition of this invention could block the mineral or pungent taste of fatty acids. One embodiment pertains to fatty acid containing foods and beverages comprising one or more GMG-MRPs, or a mixture of one or more GMG-MRPs and one or more sweetening agents, or mixture of one or more GMG-MRPs, one or more sweetening agents and thaumatin.

Foods and beverages that contain natural herbs, natural herb extracts, concentrates, purified substances from herbs such as tonic water, etc. have earthy, grassy, herb tastes which are unpalatable to a lot of consumers. There is need to find a solution. The inventors surprisingly found that adding the compositions this invention could significantly mask or reduce the grassy, earthy or herb taste in such foods and beverages. One embodiment provides an herb or herb extract enriched food or beverage comprising one or more GMG-MRPs, or a mixture of one or more GMG-MRPs and one or more sweetening agents, or mixture of one or more GMG-MRPs, one or more sweetening agents and thaumatin.

Foods and beverages that contain caffeine, tea extract, ginseng juice or ginseng extract, taurine or guarana that function to boost energy, while having an earthy or bitter taste, which requires a solution. The inventors surprisingly found that adding the compositions of this invention could significantly mask or reduce the earthy or bitter taste of such foods and beverages. One embodiment provides an energy food or beverage comprising one or more GMG-MRPs, or a mixture of one or more GMG-MRPs and one or more sweetening agents, or mixture of one or more GMG-MRPs, one or more sweetening agents and thaumatin.

Foods and beverages that contain cocoa powder or coffee powder, cocoa, or coffee extract, have a bitter taste. The inventors surprisingly found that adding the compositions of this invention could significantly mask the bitter taste and/or enhance the flavor of such foods and beverages. One embodiment provides a cocoa or coffee containing foods or beverages comprising one or more GMG-MRPs, or a mixture of one or more GMG-MRPs and one or more sweetening agents, or mixture of one or more GMG-MRPs, one or more sweetening agents and thaumatin.

Foods and beverages that contain tea powder or tea extract, or flavored tea have a bitter taste or astringent mouth feel. The inventors surprisingly found that adding the compositions of this invention could significantly mask the bitter taste and/or improve the mouth feel.

An embodiment provides a tea containing food or beverage comprising one or more GMG-MRPs, or a mixture of one or more GMG-MRPs and one or more sweetening agents, or mixture of one or more GMG-MRPs, one or more sweetening agents and thaumatin.

Alcoholic products such as wine, liquor, whisky etc. have huge variations in taste due to changes in quality of raw materials from year to year. Also, there are customers that cannot accept the astringent taste etc. of the alcohol, thus, there is a need to find a solution to produce tasty alcohol products. The inventors surprisingly found that adding the compositions of this invention could block the astringent taste and make the product taste fuller. One embodiment of alcohol in products comprising one or more GMG-MRPs, or a mixture of one or more GMG-MRPs and one or more sweetening agents, or mixture of one or more GMG-MRPs, one or more sweetening agents and thaumatin.

Sauces, such as soybean sauces, Jams, chocolate, butter, cheese etc. cannot depend upon fermentation to create flavors to meet consumers' demands. There is a need to find a simple solution to enhance the taste and flavor of these products. The inventors found that adding the compositions of this invention could improve the overall taste of these fermented products. One embodiment provides sauces or fermented products comprising one or more GMG-MRPs, or a mixture of one or more GMG-MRPs and one or more sweetening agents, or mixture of one or more GMG-MRPs, one or more sweetening agents and thaumatin.

With the increase of obesity and a diabetic population, limiting sugar became a top concern for a healthy diet choice worldwide, with consumers preferring for low sugar foods and beverages but without a sacrifice in taste. High intensity natural sugar alternatives such as stevia extract, monk fruit extract and sweet tea extract, and artificial high intensity sweetener such as sucralose, ACE-K, and aspartame, are applied in foods and beverages for reduced sugar product claims, each of these highly intensive sugar alternatives has a unique taste profile but none tastes exactly like sugar. Some bring bitter or metallic off notes which results in the low sugar food and beverage to have an unsatisfactory taste to consumers' palate. A solution to improve the taste of low sugar foods and beverages is imperative in the promotion of a healthy diet.

Current beverages with low sugar or sugar free, such as fruit juices and concentrates for fruit juice, vegetable juice and concentrate for vegetable juice, fruit nectars and concentrates from fruit nectar, vegetable nectar and concentrate from vegetable nectar, tastes flat and watery with an unpleasant aftertaste. The inventors surprisingly found that adding the composition of this invention could improve the taste profile, remove bitter or metallic aftertaste, and make the beverage taste more like sugar. One embodiment of low sugar or sugar free beverages comprising one or more GMG-MRPs, or a mixture of one or more GMG-MRPs and one or more sweetening agents, or mixture of one or more GMG-MRPs, one or more sweetening agents and thaumatin.

Water-based flavored beverages, including ‘sport’, ‘energy’ or ‘electrolyte’ beverages and in particular, beverages such as carbonated water-based flavored beverages, non-carbonated water based flavored beverages, concentrates (liquid or solid) for water-based flavored beverages, often taste flat and watery with an unpleasant aftertaste. The inventors surprisingly found that by adding the compositions of this invention to the beverages could improve the taste profile, remove bitter or metallic aftertaste, and/or the flavor is enhanced. One embodiment pertains to low sugar or sugar free water-based flavored beverages comprising one or more GMG-MRPs, or a mixture of one or more GMG-MRPs and one or more sweetening agents, or mixture of one or more GMG-MRPs, one or more sweetening agents and thaumatin.

Low sugar or sugar free dairy foods and beverages such as milk and flavored milk, butter milk and flavored butter milk, fermented and renneted milk, flavored fermented and renneted milk, condensed milk and flavored condensed milk, and flavored ice-cream taste flat and watery with an unpleasant aftertaste. The inventors surprisingly found that adding the compositions of this invention could improve the taste profile, remove bitter or metallic aftertaste, enhance flavor, and improve the mouth feel and/or overall likeability. One embodiment pertains to low sugar or sugar free dairy products comprising one or more GMG-MRPs, or a mixture of one or more GMG-MRPs and one or more sweetening agents, or mixture of one or more GMG-MRPs, one or more sweetening agents and thaumatin.

Cannabidiol (CBD) oil, for example, is extracted from the stalks, seeds, and flower of plants like hemp and has a taste that is commonly described as nutty, earthy, or grassy. There is a need to find a solution to make it palatable for eating and smoking. Adding the compositions of this invention to CBD oil could mask the unpleasant taste. One embodiment pertains to of CBD oil comprising one or more GMG-MRPs, or a mixture of one or more GMG-MRPs and one or more sweetening agents, or mixture of one or more GMG-MRPs, one or more sweetening agents and thaumatin.

Nicotine has a bitter or astringent taste and aroma when inhaled. Popular electronic cigarettes require an improved taste and aroma. Adding the compositions of this invention to nicotine could mask nicotine's unpleasant taste. One embodiment pertains to nicotine contained in a cigarette product, either in solid or liquid form, comprising one or more GMG-MRPs, or a mixture of one or more GMG-MRPs and one or more sweetening agents, or mixture of one or more GMG-MRPs, one or more sweetening agents and thaumatin.

The compositions of the present application could be used for cosmetic, pharmaceutical, feed industry, In some embodiments, the compositions of the present application comprise one or more GMG-MRPs. In some embodiments, the compositions of the present application comprise one or more GMG-MRPs and one or more other additives such as thickeners, flavors, salts, and fats. In some embodiments, the compositions of the present application comprises one or more GMG-MRPs and one or more sweetening agents. In some embodiments, the compositions of the present application comprise one or more GMG-MRPs, one or more sweetening agents and thaumatin.

Maillard reaction products from Maillard reaction can taste bitter when applied to foods and beverages, especially when the reaction time is long at elevated temperatures or when the Maillard reaction products are used at higher dosages. For bitterness-sensitive people, Maillard reaction products are bitter at all concentrations in solution. The inventors found GMG-MRPs could block the bitterness of Maillard reaction products, while one or more GMG-MRPs could modify the lingering, bitterness, aftertaste etc. Surprisingly, the bitterness from GMG-MRPs is not superimposed or multiplied.

In some instances, MRPs taste bitter. Thaumatin has a slow sweetness onset and lingering sweetness. Surprisingly, when combing (1) a GMG-MRP with (B) one or more MGs or GMGs together, the bitterness of MGs or GMGs and lingering of thaumatin are not superimposed or multiplied. To the contrary, MGs and GMGs act as bridge between GMG-MRPs and thaumatin, while GMG-MRPs act as a bridge between MGs or GMGs and thaumatin to create a pleasant integrated taste profile.

Depending on requirement of flavor or flavor enhancing intensity, sweetening derived one or more GMG-MRPs could be further blended with a sweetening agent(s), sweetener(s), or other ingredients to obtain acceptable taste and aroma profiles.

In one aspect, a flavoring agent(s) in combination with one or more GMG-MRPs is provided. It has been found that substances including MGs and/or GMGs surprisingly protects the flavoring agent. Not to be limited by any theory, there is a surprising protective effect exerted by MGs, GMGs, and MG/GMG-derived products on the flavoring agent(s).

For example, unlike typical powdered flavoring agents which have a strong aroma, the inventors have surprisingly found that the combination of (1) one or more GMG-MRPs and (2) one or more flavoring agents in a powder form results in a composition with minimal smell. However, when the same combination is dissolved in a solution (e.g., water, alcohol, or mixtures thereof), the aroma of the flavoring agent is released resulting in a strong smell.

The above observations are not meant to be limited to powders. The one or more GMG-MRPs and the flavoring agent(s) can be part of a liquid composition, such as a syrup.

In one aspect, the reaction products of the embodiments described herein can be dissolved at neutral pH.

In one embodiment, the processes of the embodiments described herein are useful for improvement of taste and aroma profile for other natural sweeteners, including but not limited to licorice, thaumatin etc., their mixtures, their mixtures with sweet tea or rubusoside-rich derived products, etc.

In another embodiment, the processes of the embodiments described herein are used for improvement of taste and aroma profile for other synthetic sweeteners, including but not limited to Ace-K, aspartame, sodium saccharin, sucralose, or their mixtures.

The embodiments described above are applicable for any synthetic sweetener, blends thereof and other natural sweeteners, blends thereof, or mixtures of synthetic and natural sweetener(s), especially with sucralose.

For example, one or more MGs and/or GMGs can be added in ratio from about 1 to about 99% (w/w) of total raw material into the following formulation to create a baked ham flavor:
Water 10%
Pork lard 5% to 10%
Cysteine 1% to 5%
Xylose 1% to 5%
Char Oil hickory 1% to 5%
Hydrolyzed vegetable protein 5% to 10%
Sunflower oil 50% to 75%
Mix them well with heating to 110° C. for two hours.
Cool with mixing to 95° C. for one hour.
Allow to separate and filter top oil layer while warm.

Another example is to add one or more MGs and/or GMGs in a ratio from about 1 to about 99% (w/w) of total material in the following formulation to create tea flavored products:
Reducing sugar: high fructose corn syrup
Amino acid: theanine
Acids: citric acid or phosphoric acid

The ratio of reducing sugar and acid is 1 to 0.5. Theanine is from about 0.01 to about 0.5%.

1. The mixture was heated at 100 to 120° C. for 15 minutes.

2. Soluble tea solids was added to the solution and then heated at 182° C. for 30 minutes. The ratio of tea solids and reducing sugar is about 1:6 to about 2:8.

3. Distilled water was added to the mixture and kept at 100° C. for 45 minutes followed by filtration.

Another example is to add one or more MGs and/or GMGs in a ratio rom about 1 to about 99% (w/w) of total raw material in the following formulation to create specific vegetable flavored products:
Reducing sugars: glucose, fructose, or sucrose.
Dehydrated vegetables: cabbage, onion, leek, tomato, eggplant, broccoli sprouts, kidney beans, corn, and bean sprouts.

| | | |
|---|---|---|
| Soybean oil | 500~700 | Kgs. |
| Selected vegetable | 30~70 | Kgs. |
| Sugar and water | 25~50 | Kgs. |
| Cysteine | 0.001~0.05 | Kgs. |

The mixture was mixed uniformly and maintained at the temperature of 135° C. for 3 hours.

The solution was cooled down.

Mushroom flavor products can be prepared by adding one or more MGs and/or GMGs in a ratio from about 1 to about 99% (w/w) of total raw material by following procedures:

### 1. Mushroom Hydrolysate:

Milled dry mushroom 10 to about 30 grams were mixed with distilled water in a ratio of 1:10 to about 1:50.

The mixtures were preheated at 85° C. for 30 minutes to denature protein.

After cooling the mixture to 0° C., the enzymatic hydrolysis was conducted in two steps.

### 1st Step:

The pH of the mixture was adjusted to about 4 to about 6, then cellulase was added at a ratio of 2:100 or 5:100 while the temperature was between about 55 and about 70° C. for 2˜3 hours.

### 2nd Step:

The pH was adjusted to 7, then neutral protease was added with at a ratio of 3:100.

The mixture was digested at 55° C. for another 2 hours.

The hydrolysate was heated at 100° C. or higher for 30 minutes to inactivate the enzymes and was then centrifuged.

The final supernatant was collected.

### 2. Maillard Reaction of Mushroom

D-xylose (0.05-0.20 g) and L-cysteine (0.10-0.20 g) were dissolved into 30 ml of mushroom hydrolysate.

The pH of the mixture was adjusted to 7.4-8.

Then the mixture was heated at 140° C. for 135 minutes.

In another embodiment, one or more MGs and/or GMGs in ratio from about 1 to about 99% (w/w) of total raw material can be added in the following enzyme modified cheese flavor process:
Cheddar cheese base preparation: Cheddar cheese: 48% Water: 48%
Trisodium Citrate: 2%
Salt: 1.85%
Sorbic Acid: 0.15%

### Method:

Cook the Cheddar cheese base, then cool cheddar cheese base to about 40-45 centigrade, add the enzyme (the enzyme could be one or more selected from Lipase AY30, R, Protease M, A2, P6, Glutaminase SD);
Mix thoroughly;
Pour the mixture into the jar provided, seal the lid;
Incubate for 7.5 hours at 45° C.;
Allow to cool.

In another embodiment, one or more MGs and/or GMGs can be added in ratio from about 1 to about 99% (w/w) of total raw material in the following white meat reaction flavor preparation formulation:

1.25 g cysteine, 1.00 g leucine, 1.25 g xylose, 2.00 g dextrose, 2.00 g salt, 3 g torula yeast bionis goldcell (one or more other type of yeasts such as baker's yeast Biospringer BA10, Antolysed Yeast D120/8-PW, Maxarome standard powder, Prime Extract Maxarome Selected, HVP(Protex 2538, Exter 301, Springer 2020, Gistex HUMLS could be used too), 1.5 g sunflower oil, and 13 g water.

Method: Make the mixture and heat it as per general process flavor's production method.

In another embodiment, one or more MGs and/or GMGs can be added in ratio from about 1 to about 99% (w/w) of total raw material in the following red meat reaction flavor preparation:

1.5 g cysteine hydrocholoride, 1.0 g methionine, 1.0 g thiamine, 1.0 g xylose, 1.5 g MSG, 0.5 g ribotide, 9.0 g maxarome plus, 5.0 g gistex, 1.5 g onion powder, 1.0 g groundnut oil, 0.1 g black pepper oleoresin, and 26.0 g water.

Method: Weigh ingredients into screw cap bottles provided;

Mix thoroughly then measure the pH;

React under pressure at 125° C. for 30 minutes at 20 psi.

Above prepared flavors could be used in beef burger as an example:

102 g Minced beef, 100 g Minced chicken, 36 g chopped onion, 5 g rusk (dry type), 3 g water, 2.5 g salt, 0.25 g ground black pepper and 1.25-3.00 g reaction flavors.

Method: weigh ingredients into a bowl; mix until ingredients combined; divide into 60 g portion; form into a burger shape, fry.

Again, it should be emphasized that one or more MGs and/or GMGs detailed herein can be added before, during or after the Maillard reaction, preferably before and during the reaction without limitation of examples. The amine donor could be amino acid, peptide, protein or their mixture from either vegetable or animal source or their mixture. The fat could be either vegetable or animal source or their mixture, too.

Consumers are now open and willing to experiment with spices to experience new flavors like tamarind, lemongrass, ginger, kaffir lime, cinnamon, and clove. From candy to beer to tea, everything with ginger is now fashionable. Ginger works well in alcoholic beverages as a mixer, in ginger beer itself, in confections, muffins and cookies.

Sodium metabisulfite, olive oil and ascorbic acid were found to be effective to stabilize the antibacterial activity. 1.5% CMC shows a good performance too. Ginseng is one of the top 10 best-selling herbal dietary supplements in US, but ginseng-containing products have been mostly limited to beverages, despite a growing functional food market. The original ginseng flavors include bitterness and earthiness, which must be minimized to gain acceptance in the US market. The embodiments described herein can successfully solve this issue and make new ginseng food products such as cookies, snacks, cereals energy bars, chocolates, and coffee with great taste.

In Asia, especially south-east Asia, rose, jasmine, pandan, lemon grass, yellow ginger, blue ginger, lime leaf, curry leave, lilies, basil, coriander, coconut etc. are specific local flavors. In East Asia, many herbs are used in the cooking such as Artemisia argyi, dandelion, Codonopsis pilosula, Radix Salviae Miltiorrhizae, Membranous Milkvetch Root rhizoma gastrodiae etc. The inventors have found that adding one or more GMG-MRPs significantly improve the taste profile of these flavors and their added products. For example, one or more GMG-MRPs can be added in ratio of from about 1 to about 99% on a weight-to-weight basis of total raw material in the following processes to prepare such flavored products:

Lilies as a raw material were washed and milled to give a lily slurry.

Alpha-amylase (0.1-0.8%) was added and treated at 70° C. for one and half hours.

Protease (0.05-0.20% by mass of the lily) was then added and heated at 55° C. for 70 minutes.

One or more ingredients selected from adding one or more MGs and/or GMGs could be also added in following process:

Fenugreek extract:

The seeds were roasted and crushed uniformly.

The seeds were extracted with ethyl alcohol, filtered to obtain a yellowish-brown solution followed by concentration.

An extract 10 parts, glucose 1 part and proline 0.6 parts were mixed and heated at 110-120° C. for 4-6 hours.

Savory is full of flavor, delicious and tasty-usually something that someone has cooked.

Savory foods are appetizing, pleasant or agreeable to the taste or smell, but there is a need to find suitable compatible a sweet taste balanced solution. One or more ingredients selected from adding one or more MGs and/or GMGs can be added into following formulation in ratio of 1-99% on a weight-to-weight basis of total raw material to produce well balanced sweet products: 1) Tomato sauce formula:

| | | |
|---|---|---|
| olive oil | 25~50 | grams |
| onion diced | 150~200 | grams |
| garlic minced | 10~20 | grams |
| tomato paste | 600~900 | grams |
| salt | 5~10 | grams |
| basil chopped | 10~20 | grams |
| black pepper ground | 0.5~2 | gram |

Cooking and mixing for 25 minutes

### 2) Grilled Flavor Formula:

Beef tallow or soybean oil is passed through a grilling device being heated at 450° C. continuously. The grilled flavor is collected through a condenser.

### 3) Roasted Meat Flavor:

A mixture of 8.0-10 grams of cysteine, 8.0-10 grams of thiamine, and 300 grams of vegetable protein hydrolysate is brought to 1000 grams by the addition of water and adjusted to a pH of 5.

The mixture is then boiled under reflux condition (100-110° C.) at atmospheric pressure for 3-5 hours and allowed to cool. A roasted meat flavor was formed.

### 4) Chicken Base Flavored Products:

| water | 10% |
|---|---|
| hydrolyzed vegetable protein | 10~20% |
| xylose | 0.10~0.50% |
| cysteine | 0.20~0.50% |
| Premixing to form slurry. | |
| Adding premix to sunflower oil while mixing. | |
| sunflower oil | 50~80% |

Heating the with constant mixing to about 100-110° C. for two to three hours.

Cool the mixture down to about 80° C. with mixing for another one hour.

Flavonoids are an important and widespread group of plant natural products that possess many biological activities. These compounds are part of the wide range of substances called “polyphenols”, which are widely known mainly by their antioxidant properties, and are present in human dietary sources showing great health benefits.

Neohesperidine and naringin, which are flavanone glycosides present in citrus fruits and grapefruit, are responsible for the bitterness of citrus juices. These substances and their derivates such as neohesperidine chalcone, naringin chalcone, phloracetophenone, neohesperidine dihydrochalcone, naringin dihydrochalcone etc. can be good candidates for bitterness or sweetener enhancers. The inventors surprisingly found adding these components in the compositions described herein could help the masking the bitterness or aftertaste of other ingredients and made the taste cleaner. One embodiment includes the compositions described herein and further comprises flavonoids, more preferably flavonoids containing flavonone glycosides. The ratio of flavonoids in the composition could be in range of from about 0.1 ppm to 99.9%.

Metal salts of dihydrochalcone having the following formula:

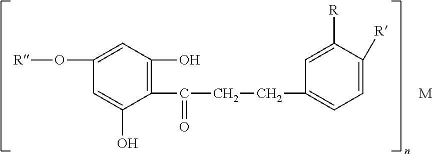

wherein R is selected from the group consisting of hydrogen and hydroxy, R′ is selected from the group consisting of hydroxy, methoxy, ethoxy and propoxy, and R″ is selected from the group consisting of neohesperidoxyl, B-rutinosyl and ß-D-glucosyl, M is a mono- or divalent metal selected from the group consisting of an alkali metal and an alkaline earth metal, and n is an integer from 1 to 2 corresponding to the valence of the selected metal M.

Typical compounds of the above formula are the alkali or alkaline earth metal monosalts of the following:

Neohesperidin dihydrochalcone, having the formula:

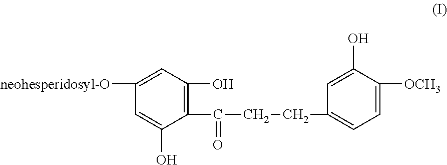

2′, 4′, 6′, 3-tetrahydroxy-4-n-propoxydihydrochalcone 4′-ß neohesperidoside having the formula:

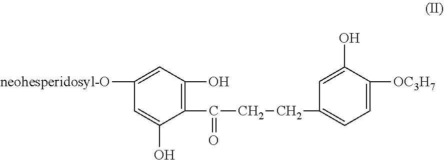

naringin dihydrochalcone of the formula:

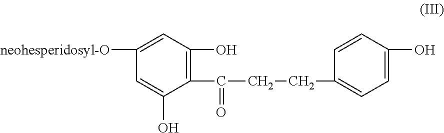

prunin dihydrochalcone of the formula:

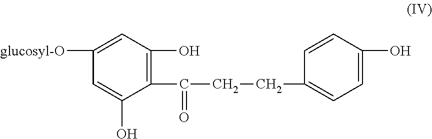

hesperidin dihydrochalcone having the formula:

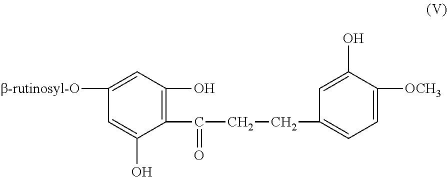

and hesperitin dihydrochalcone glucoside having the formula:

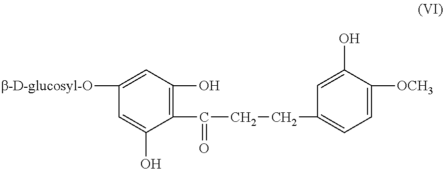

The alkali metal includes sodium, potassium, lithium, rubidium, caesium, and ammonium, while the term alkaline earth metal includes calcium, strontium, and barium. Other alkali amino acids can serve as counterions. Thus, embodiments of compositions described herein further comprises one or more salts of dihydrochalone.

The compositions described herein can further comprise one or more products selected from Trilobatin, phyllodulcin, Osladin, Polypodoside A, Eriodictyol, Homoeriodicyol sodium salt, hesperidin or hesperetin, Neohesperidin dihydrochalcone, naringin dihydrocholcone, or advantame to provide additional flavors and products. Another embodiment comprises of the compositions described herein and one or more of the aforementioned products, wherein the ratio of one or more products selected in the composition can be in the range of from about 0.1% to about 99.9%.

Advantame is high potency synthetic sweetener and can be used as a flavor enhancer. The inventors found that adding advantame into the compositions described herein can boost the flavor and taste profile of a food or beverage. In one aspect, Advantame can be added after conventional or non-conventional Maillard reaction. One embodiment provides compositions described herein which further comprise advantame, wherein the amount of advantame can be in the range of from about 0.01 ppm to about 100 ppm.

Creating a sweet enhanced meat process flavor can be obtained by adding MGs, MEs, GMGs, GMEs, SGs, SEs, GSGs, GSEs, STE, STC, GSTE, GSTC by using one or more of following ingredients: A source of sulfur: cysteine, (cystine), glutathione, methionine, thiamine, inorganic sulfides, meat extracts, egg derivatives; an amino nitrogen source: amino acids, HVP's, yeast extracts, meat extracts; a sugar component: pentose and hexose sugars, vegetable powders, (onion powder, tomato powder), hydrolyzed gums, dextrins, pectins, alginates; fats and oils: animal fats, vegetable oils, coconut oil, enzyme hydrolyzed oils and fats; and/or other components: herbs, spices, IMP, GMP, acids, etc.

Pigs, especially young pigs, appreciate good and pleasant tastes and aroma much the way young children do. Cats are notoriously fussy about the taste and smell of their feed. Feeds such as rapeseed meal, which has a bitter taste, are used as good protein sources for cattle, sheep, and horses. Even chickens are known for their taste discrimination, as chickens are selective to their feeds. Green, natural, or organic farming of animals become more and more popular. Therefore, there is a need to find a solution to satisfy market requirements. An embodiment of feed or feed additives comprises the compositions described herein.

The intense sweetness and flavor/aroma enhancement properties of the compositions described herein provide useful applications in improving the palatability of medicines, traditional Chinese medicine, food supplements, beverage, food containing herbs, particularly those with unpleasant long-lasting active ingredients not easily masked by sugar or glucose syrups, let alone sweetening agents or synthetic high intensity sweeteners. The inventors surprisingly found the compositions described herein can mask the unpleasant taste and smell of the products containing these substances, for instance Goji berries juice, sea buckthorn juice, milk thistle extract, Ginkgo biloba extract etc. Thus, traditional Chinese medicine, or food supplements can be combined with one or more of compositions described herein, especially when used as a masking agent.

Except for a reduced sugar donor and an amine donor, all other ingredients can be either added before, during and after the conventional Maillard reaction, more preferably before and during the Maillard reaction. An embodiment of composition in this invention preparable by adding all ingredients in the Maillard reaction to react together.

Products such as maltol, ethyl-maltol, vanillin, ethyl vanillin, m-methylphenol, and m-(n)-propylphenol can further enhance the mouthfeel, sweetness and aroma of the compositions described herein. In some embodiments, the sweetening or flavoring agent composition of the present application further comprises one or more products selected from maltol, ethyl-maltol, vanillin, ethyl vanillin, m-methylphenol, m-(n)propylphenol. In some embodiments, the sweetening or flavoring agent compositions of the present application includes a combination of one or more C-MRPs and maltol, C-MRPs and Vanillin, a combination of one or more GMG-MRPs and maltol, a combination of one or more GMG-MRPs and vanillin, etc. are provided. In some embodiments, a food or beverage comprises the above-described sweetening or flavoring agent compositions.

Aquaplants and seafood cultivated from fresh water or sea water always have a fish smell or marine aroma. Examples of aromaiferous aquatic foodstuffs include spirulina powder or its enriched protein extract, protein extracted from duckweeds (lemnoideae family), fish protein, fish meal etc. There is a need to minimize or cover the unpleasant aroma to make the food product palatable. The inventors surprisingly found that compositions described herein could be added in these products to minimize the aromas to make them more acceptable to consumers including feeds for animals. Embodiments of consumables comprise components from aquaplants and/or seafood, and any of the compositions described herein.

Foods and beverages containing acids can irritate the tongue. For instance, products containing acetic acid can irritate the tongue and make that product unpalatable. The inventors surprisingly found that adding any of the compositions described herein could significantly balance the acid taste and make the products palatable.

Beverages containing vinegar, such as apple cider vinegar drink, shrub, switchel etc. have become popular in the market due to vinegar's health attributes. The acetic acid can be naturally occurring, for instance it is originated from fermentation of fruits such as apple, pear, persimmon etc., grains such as rice, wheat etc. It could be also synthetic. However, the taste of acetic acid is strong and sour and tends to burn the throat. Therefore, there is a need to find a solution to harmonize it. The inventors surprisingly found that adding any of the compositions described herein can strongly harmonize the taste of beverages containing acetic acid and make them palatable. One embodiment provides a composition comprising acetic acid and any of the compositions described herein. Another embodiment provides a method to harmonize the taste of acetic acid by using any of the compositions described herein. Another embodiment provides a consumable that comprises acetic acid and any of the compositions described herein. Another embodiment provides the use of any the compositions described herein in beverages containing acetic acid, where the dosage of the composition(s) described herein is above 10(−9) ppb. Embodiments of the composition(s) described herein include, for example, one or more GMG-MRPs, combinations of thaumatin and one or more GMG-MRPs, combinations of one or more of GMG-MRPs and one or more high intensity sweeteners, combinations of thaumatin, one or more GMG-MRPs, and one or more high intensity sweetener.

Thermotreating MGs, especially thermo-reaction treatment can result in improved taste of MGs. Thermo-treatment is like caramelization of MGs (without MRP(s)). The temperature range can be from 0-1000° C., in particular from about 20 to about 200° C., more particularly from about 60 to about 120° C. The period of treatment can be from be from a few seconds to a few days, more particularly about one day and even more particularly from about 1 hour to about 5 hours.

The inventors surprisingly found that adding one or more GMG-MRPs, combinations of (1) thaumatin and (2) one or more GMG-MRPs, combinations of (1) one or more GMG-MRPs and (2) one or more high intensity sweeteners, combinations of (1) thaumatin, (2) one or more GMG-MRPs and (3) high intensity sweetener in food and beverages containing alcohol can enhance the strength of alcohol. Embodiments provide food and beverages containing alcohol comprising composition selected from one or more GMG-MRPs.

Flavor of beer, the size and the amount of bubbles are important factors in measuring the quality of beer. Compositions described herein can be used for enhancing the flavor of beer taste and to adjust the size and number of bubbles. In one embodiment, beer or beer containing products can include one or more GMG-MRPs.

Foods having high sugar content such as area catechu, spicy bar (or called spicy strip, hot strip, spicy glutein), pickled vegetables, meat and fishes, or fermented foods always require large amounts of sugar to balance the total taste profile and make them more palatable. The inventors surprisingly found that adding thaumatin, one or more of GMG-MRPs, combinations of (1) one or more GMG-MRPs and (2) thaumatin, combinations of (1) one or more GMG-MRPs and (2) high intensity sweetener, or combinations of (1) one or more GMG-MRPs, (2) one or more high intensity sweetener and (3) thaumatin, could significantly improve the taste profile and/or palatability, especially when sugar reduction is required for such foods. For example, embodiments of such compositions include area catechu, spicy bar, pickled food, or fermented foods with one of composition(s) described herein.

Vegetable burgers have become popular in recent years, but the taste is still not palatable to most consumers. Compositions described herein can be used for enhancing the flavor and taste of the vegetable burger. In one embodiment, a vegetable burger comprises thaumatin, one or more GMG-MRPs, combinations of (1) one or more GMG-MRPs and (2) thaumatin, combinations of (1) one or more GMG-MRPs and (2) high intensity sweetener, or combinations of (1) one or more GMG-MRPs, (2) one or more high intensity sweetener and (3) thaumatin.

Grilled foods often incorporate sugar to enhance the taste. However, sugar creates strong colors during grilling, and when the fried foods become cold, the sugar syrup becomes sticky. The inventors found that by adding the compositions described herein to the food to be grilled, these disadvantages can be overcome. For example, embodiments include grilled foods that include thaumatin, one or more of GMG-MRPs, combinations of (1) one or more GMG-MRPs and (2) thaumatin, combinations of (1) one or more GMG-MRPs and (2) high intensity sweetener, or combinations of (1) one or more GMG-MRPs, (2) one or more high intensity sweetener and (3) thaumatin.

An embodiment of composition comprises A) one or more ingredients selected from GMG-MRPs and B) one or more substances selected from fibers, such as polydextrose; inulin, Promitor produced by Tate&Lyle; monosaccharide-derived polyols such as erythritol, mannitol, xylitol, and sorbitol; disaccharide-derived alcohols such as isomalt, lactitol, and maltitol; and hydrogenated starch hydrolysates, synthetic high intensity sweeteners such as sodium saccharin, sucralose, aspartame, acesulfame-K, N-[N-[3-(3-hydroxy-4-methoxyphenyl)propyl]-alpha-aspartyl]-L-phenylalanine 1-methyl ester, sodium cyclamate, neotame; natural low intensity sweeteners such as trehalose, raffinose, cellobiose, tagatose, DOLCIA PRIMA™ allulose; Natural high intensity sweeteners such as Licorice extract, glycyrrhizin-derived substances, stevia extract, monk fruit extract, glycosylated stevia extract, glycosylated monk fruit extract; modified starch such as Rezista, Claria, Kolgauard etc. produced by Tate&Lyle; or mixtures thereof. A further embodiment of composition comprises A) and B), where ratio of A) to B) is from 1:99 to 99:1. An additional embodiment of composition comprises A) and B), where the final product is in powder or liquid form. In one embodiment, a food or beverage syrup comprises A) and B).

An embodiment of composition comprises A) one or more ingredients selected from GMG-MRPs and B) a stevia glycoside composition contains one or more stevia glycosides selected from Reb A, Reb B, Reb C, Reb D, Reb E, Reb I, Reb M, Reb N, Reb O, Stevioside. An additional embodiment of composition of A) and B), where ratio of A) to B) is from 1:99 to 99:1. A further embodiment of food and beverage comprises A) and/or B), where the total concentration of A) is in range of 1 ppm to 10,000 ppm; and/or B) where the total concentration of B) is in range of 1 ppm to 2,000 ppm. In one embodiment, a food or beverage syrup comprises A) and B).

The inventor has surprisingly found that the present application can improve the solubility of stevia extract, stevia glycosides. An embodiment comprises A) one or more GMG-MRPs and B) one or more stevia glycosides selected from Reb A, Reb B, Reb C, Reb D, Reb E, Reb I, Reb M, Reb N, Reb O, Stevioside, where A) improves the solubility of B).

In one embodiment, a food or beverage product includes one or more GMG-MRPs to improve the tolerance of lactose and/or gluten. A further embodiment contemplates the use of such consumables for weight management.

The volatile substances from monk fruit may form aerosol when formulated in food and beverage. These substances may inhibit the absorption of pollen or other substances which bring on allergies in humans. Thus, the GMG-MRPs of the present application may be included in anti-allergy products. The product could be consumable, or health supplement or medical formulation such as sprayer.

Another aspect of the present application relates to GMG-MRP compositions containing one or more terpenoid glycosides (TGs). TGs include mogrosides and other high intensity natural sweetening agents from plants, including glycosides, which may serve as sugar substitutes, and which are further described below.

A glycoside is a molecule in which a sugar is bound to another functional group via a glycosidic bond. The sugar group is known as the glycone and the non-sugar group as the aglycone or genin part of the glycoside. Glycosides are prevalent in nature and represent a significant portion of all the pharmacologically active constituents of botanicals. As a class, aglycones are much less water-soluble than their glycoside counterparts.

Depending on whether the glycosidic bond lies “below” or “above” the plane of the cyclic sugar molecule, glycosides of the present application can be classified as α-glycosides or β-glycosides. Some enzymes such as α-amylase can only hydrolyze α-linkages; others, such as emulsin, can only affect β-linkages. Further, there are four types of linkages present between glycone and aglycone: a C-linked glycosidic bond, which cannot be hydrolyzed by acids or enzymes”; an O-linked glycosidic bond; an N-linked glycosidic bond; or an S-linked glycosidic bond.

The glycone can consist of a single sugar group (monosaccharide) or several sugar groups (oligosaccharide). Exemplary glycones include glucose, galactose, fructose, mannose, rhamnose, rutinose, xylose, lactose, arabinose, glucuronic acid etc. An aglycone is the compound remaining after the glycosyl group on a glycoside is replaced by a hydrogen atom. When combining a glycone with an aglycone, several different glycosides may be formed, including steviol glycosides, terpenoid glycosides, alcoholic glycosides, anthraquinone glycosides, coumarin glycosides, chromone glycosides, cucurbitane glycosides, cyanogenic glycosides, flavonoid glycosides, phenolic glycosides, steroidal glycosides, iridoid glycosides, and thioglycosides.

For example, the term “flavonoid aglycone” refers to an unglycosylated flavonoid. Flavonoid aglycones include flavone aglycones, flavanol aglycones, flavanone aglycones, isoflavone aglycones and mixtures thereof. Thus, the terms “flavone aglycone”, “flavanol aglycone”, “flavanone aglycone” and “isoflavone aglycones” refer to unglycosylated flavones, flavanols, flavanones and isoflavones, respectively. More particularly, the flavonoid aglycone may be selected from the group consisting of apigenin, luteolin, quercetin, kaempferol, myricetin, naringenin, pinocembrin, hesperetin, genistein, and mixtures thereof.

Terpenoid glycosides (TGs) for use in the present application, include e.g., steviol glycosides, Stevia extracts, mogrosides (MGs), Siraitia grosvenorii (luo han guo or monk fruit) plant extracts, rubusosides (RUs), Rubus suavissimus (Chinese sweet tea) plant extracts; flavanoid glycosides, such as neohesperidin dihydrochalcone (NHDC); osladin, a sapogenin steroid glycoside from the rhizome of Polypodium vulgare; trilobatin, a dihydrochalcone glucoside from apple leaves; eriodictyol, a bitter-masking flavonoid glycoside extracted from yerba santa (Eriodictyon californicum), one of the four flavanones extracted from this plant as having taste-modifying properties, along homoeriodictyol, its sodium salt, and sterubin; polypodoside A (from the rhizome of Polypodium glycyrrhiza); phyllodulcin, a coumarin glycoside found in Hydrangea macrophylla and Hydrangea serrata; swingle glycosides, such as mogroside V, mogroside IV, siamenoside I, and 11-oxomogroside V, which are cucurbitane glycosides; monatin, a naturally occurring, high intensity sweetener isolated from the plant Sclerochiton ilicifolius, and its salts (monatin SS, RR, RS, SR); hernandulcin, an intensely sweet chemical compound gained from the chiefly Mexican and South American plant Lippia dulcis; phlorizin, plant-derived dihydrochalcone that is a glucoside of phloretin, which is found primarily in unripe Malus (apple) and the root bark of apple; glycyphyllin, an alpha-L-rhamnoside derived from phloretin, the aglucone of phlorizin, a plant-derived dihydrochalcone; baiyunoside, a diterpene glycoside isolated from the Chinese drug Bai-Yun-Shen; pterocaryoside A and pterocaryoside B, secodammarane saponin glycosides isolated from Pterocarya paliurus Batal. (Juglandaceae), which are native to China; mukuroziosides Ia, Ib, IIa and IIb, acyclic sesquiterpene oligoglycosides isolated from the pericarp of Sapindus mukurossi and Sapindus rarak; phlomisoside I, a furanolabdane-type diterpene glycoside isolated from the roots of the Chinese plant, Phlomis betonicoides Diels (Lamiaceae); periandrin I and V, two sweet-tasting triterpene-glycosides from Periandra dulcis; abrusoside A-D, four sweet tasting triterpene glycosides from the leaves of Abrus precatorius; cyclocariosides I; II, and III, and synthetically glycosylated compositions thereof (e.g., GSGs, glycosylated Stevia extracts etc.). Lithocarpus litseifolius folium (latin name) is a kind of species of sweet tea. Phlorizin and trilobatin are the main ingredients. Phlorizin is a glucoside of phloretin, a dihydrochalcone. Phlorhizin is abundant in the leaves of another kind of Sweet Tea (Lithocarpus polystachyus Rehd), too.

In some embodiments, a GMG-MRP containing composition of the present application is a flavor composition comprising one or more glycosylated terpenoids from a GMG extract in an amount of above 0.01 ppm, 0.1 ppm, 1 ppm, 10 ppm, 100 ppm, 1,000 ppm, 1%, 5%, 10%, 20%, 50% or 90% by weight.

In some embodiments, a GMG-MRP containing composition of the present application is a flavor composition comprising one or more glycosylated non-sweet terpenoids, from a GMG in an amount of above 0.01 ppm, 0.1 ppm, 1 ppm, 10 ppm, 100 ppm, 1,000 ppm, 1%, 5%, 10%, 20%, 50%, 90%, where the content of the glycosylated non-sweet terpenoids is higher than that in the MG or ME from which the GMG is derived. For example, glycosylated monk fruit glycosides and glycosylated monk fruit extracts contain higher glycosylated monk fruit terpenoid levels than the monk fruit glycosides and monk fruit extracts before glycosylation. GMGs derived from glycosylated monk fruit extracts contain higher levels of glycosylated monk fruit terpenoid glycosides than from their MG-originating extracts before glycosylation. Glycosylated monk fruit terpenoid glycosides in GMG compositions can serve as sugar donors to react with amine donor(s) in a Maillard reaction.

In some embodiments, the consumable product is a beverage containing one or more GMG-MRPs in combination with one or more glycosylated monk fruit terpenoid glycosides from MG or GMG extracts in an amount of 0.01-5000 ppm.

Throughout this specification, when reference is made to a specific terpenoid glycoside or high intensity natural sweetening agent, such as an SG, SGE, mogroside, monk fruit extract, sweet tea extract, NIDC, or any glycosylated derivative thereof, that the corresponding description is meant to be inclusive and applicable to all the other terpenoid glycosides or high intensity natural sweetening agents in these classes. The same principle applies to other sweeteners: when reference is made to a sweetening agent, such as a terpenoid glycoside sweetener, MG sweetener, steviol glycoside sweetener, high intensity natural sweetener, sweetener enhancer, high intensity synthetic sweetener, reducing sugar, or non-reducing sugar, that the corresponding description is meant to be inclusive and applicable to all the other sweeteners or sweetening agents in any given class.

Plants contain aglycones, which normally are hydrophobic, water insoluble volatile compounds. There are also glycosides in plants which are more water soluble. The inventor has found that the glycosylation process can convert the foregoing hydrophobic compounds into water soluble and stable forms in aqueous solutions. The inventor has surprisingly found that adding these substances in food and beverage can significantly improve the intensity of retronasal aroma, such that the GMG-MRPs exhibit synergistic effects with these glycoside compounds to create a stronger palatable retronasal aroma when adding together in food and beverage products.

In one embodiment, a flavor composition GMG-MRPs in combinations with one or more GMGs having a glycoside content higher than in the natural plant source materials before glycosylation, where the ingredients originate from plant sources, such as leaves, flowers, fruits, berries, barks, seeds etc. In a further embodiment, a GMG-MRP composition of the present application further includes one or more components selected from stevia extracts, stevia glycosides, glycosylated stevia extracts, glycosylated stevia glycosides, sweet tea extracts, sweet tea components, glycosylated sweet tea extracts, glycosylated sweet tea components, licorice root extracts, licorice root components, glycosylated licorice root extracts, and glycosylated licorice root components. In another embodiment, any of the foregoing glycosylated plant ingredients, MRPs thereof or blends thereof are added to a food or beverage product.

There is a huge waste when producing food or beverage ingredients from natural sources, such as juice and flavor production, there is need to find solution to take use of these natural gifted waste to create new commercial value. Plant waste after extraction of flavor or other health active compounds could be useful in this invention. The present application could create commercial value to make use of every individual compound from a natural source. For example, the chocolate production process isn't typically very sustainable. The pulp, husk, and other components that surround the cacao bean are generally discarded as waste. Cacao juice is the juice from the mucilage, or the sticky pulp surrounding the cacao bean. This mucilage is a key element in the development of the flavor of chocolate. Cacao farmers use a wild fermentation process that starts with this sugary juice, which attracts certain bacteria. Cacao begins to ferment as soon as it is harvested, a process that is critical to its flavor. The cacao juice or other waste from Chocolate production or glycosylated treated cacao juice could be excellent source of raw material to provide sugar donor for additional Maillard reaction to create a fresh retronasal chocolate aroma. The same is applied for coffee products, especially for green coffee bean extract, which is rich in chlorogenic acids. An embodiment of flavor composition comprises glycosylated cacao juice. A further consumable product embodiment contains glycosylated cacao juice and Maillard reaction products at increased levels compared to their original natural sources.

Green vanilla contains glycosides, namely gluco-vanillin (vanilloside) and glucovanillic alcohol. The water or water extraction of green vanilla can be used as retronasal aroma flavor. In one embodiment, a flavor composition contains enriched vanilla glycosides at increased levels compared to their naturally occurring source. In a further embodiment, green vanilla is utilized as a raw material in preparing the flavor composition. In another embodiment, a food or beverage product includes vanilloside, where the vanilloside content is greater than 0.01 ppm, 0.1 ppm, 1 ppm, 5 ppm, 10 ppm, 50 ppm, 100 ppm, or 1,000 ppm.

Apples contains rich flavanols, phenolic acids, dihydrochalcones, and flavanols, such as gallic acid, ferulic acid, caffeic acid, phloretin-2-O-beta-glucoside, quercetin-3-O-galactoside, qucercetin-3-O-glucoside, quecetin-3-O-rutinoside, quercetin-3-O-xyloside, qucertin-3-O-arabonoside, qucertin-3-O-rahmnoside etc. The polyphenols in apple extracts can be further glycosylated. The apple polyphenols or their further glycosylated compounds can act as sugar donors for the Maillard reaction producing MRPs that can be used as flavors to enhance the retronasal flavor intensity. In one embodiment, a flavor composition contains glycosides from apple polyphenols at higher levels compared to their original natural sources. A further embodiment of a consumable contains apple polyphenols with enriched glycosides in amount of greater than 0.01 ppm, 0.1 ppm, 1 ppm, 5 ppm, 100 ppm, 1,000 ppm, or 5,000 ppm.

Green coffee bean is rich in chlorogenic acids, but also contains other substances such as three trans-cinnamic acids (caffeic, ferulic and dimethoxycinnamic), six cinnamoyl-amino acid conjugates (caffeoyl-N-tyrosine, p-coumaroyl-N-tyrosine, caffeoyl-N-tryptophan, p-coumaroyl-N-tryptophan, feruloyl-N-tryptophan, caffeoyl-N-phenylalanine) and three cinnamoyl glycosides (caffeoylhexose, dicaffeoylhexose and dimethoxycinnamoylhexose). The green coffee bean extract could be glycosylated. Green coffee bean extract and/or glycosylated green coffee bean extract could act as sugar donor or amine donor for Maillard reactions. An embodiment of a flavor composition comprises glycosylated substances in green coffee bean extracts higher than its original natural sources. A further embodiment of a consumable comprises green coffee bean extracts with enriched glycosylated substances in amount of higher than 0.01 ppm, 0.1 ppm, 1 ppm, 5 ppm, 100 ppm, 1,000 ppm, 5,000 ppm, 1%, 5%, 10%.

Flavonoids are widely contained in citrus such as lemon, conferring the typical taste and biological activities to lemon. There are five main flavonoid glycosides, of which the aglycone are eriocitrin, narirutin, hesperidin, rutin, and diosmin, respectively. Citrus extract could be glycosylated. Citrus extract or its glycosylated product could act as sugar donor for Maillard reaction. An embodiment of a flavor composition comprises glycosylated substances in citrus extracts higher than its original natural sources. A further embodiment of a consumable comprises lemon extract with enriched glycosylated substances in amount of higher than 0.01 ppm, 0.1 ppm, 1 ppm, 5 ppm, 100 ppm, 1,000 ppm, 5,000 ppm, 1%, 5% or 10% by weight.

Oleoresins are semi-solid extracts composed of a resin in solution in an essential and/or fatty oil, obtained by evaporation of the hydrocarbon solvent(s) used for their production. Compared to essential oils obtained by steam distillation, oleoresins is rich in heavier, less volatile and lipophilic compounds, such as resins, waxes, fats and fatty oils. Gummo-oleoresins (oleo-gum resins, gum resins) occur mostly as crude balsams and contain also water-soluble gums. Oleoresins are prepared from spices, such as basil, capsicum (paprika), cardamom, celery seed, cinnamon bark, clove bud, fenugreek, fir balsam, ginger, jambu, labdanum, mace, marjoram, nutmeg, parsley, pepper (black/white), pimenta (allspice), rosemary, sage, savory (summer/winter), thyme, turmeric, vanilla, West Indian bay leaves. The solvents used are nonaqueous and may be polar (alcohols) or nonpolar (hydrocarbons, carbon dioxide). The waste after removing oleoresins, preferably, the water extraction of waste after removing oleoresins, more preferably, its glycosylated treated water extraction of waste after removing oleoresin, most preferably, the fresh juice, water or water/alcohol extracted from plant source, could be used as raw material as sugar donor, to have Maillard reaction with one or more of amine donors to create a pleasant retronasal aroma. Any natural sweetening agent in this invention could be added before or after the Maillard reaction. Surely water or water alcohol extraction of whole plant source material such as flower, seed, bark, leaves etc. could be used as raw material for glycosylation and/or Maillard rection, too. For example, Zingiberaceae is the large diverse family comprised of rhizomatous plants with a higher concentration of phenolic compounds containing aglycones and glycosides. The normal ginger (Zingiber officinale Rosc.) and black ginger (Kaempferia parviflora Wall.) belongs to this family. The water extract of whole ginger root, the fresh ginger root juice, the water or water/alcohol extraction of ginger after removing oleoresins, preferably, the glycosylated products of these extracts could be flavor ingredients. Any of these ginger extracts or their glycosylated products could be used as sugar donor to have Maillard reaction with any single or combined amine donors. One or more natural high intensity sweetener could be added before or after the Maillard reaction.

Natural sources used to produce food and beverage, such as apple to produce apple juice, citrus peels to produce citrus flavor. During the concentration of juice, water soluble volatile substances could be collected and could be used in the formulation of retronasal aroma. An embodiment of retronasal aroma composition comprises water soluble volatile substances. In some embodiments, the consumable product is a beverage or food, and the beverage or food comprises (a) one or more GMG-MRPs and (b) water soluble volatile substances from fruit juices, berries, species, where the water-soluble volatile substances in an amount of 0.01-5000 ppm.

The glycosides from original plants, their extracts or after glycosylation of plant extracts, could provide sugar donor to Maillard reaction and create a stable form of aroma substances, which could result in stronger and palatable retronasal flavor for consumables, such as food and beverage. An embodiment of composition comprises Maillard reaction products prepared by reacting one or more amine donors with one or more sugar donors comprising one or more glycoside ingredients selected from isolated plant glycosides, plant extracts, additional glycosylation treated glycosides isolated from plants, and additional glycosylation treated plant extracts with or without additional sugar donors.

An embodiment of method to produce a palatable flavor by making Maillard reaction of amine donor and one or more ingredients selected from plant extract, isolated glycosides from plant, additional glycosylation treated glycosides isolated from plant, and glycosylation treated plant extract. It could further add sugar donor.

An embodiment of food and beverage comprises ingredients prepared by a Maillard reaction of an amine donor in combination with one or more ingredients selected from isolated glycosides from plant, plant extract, additional glycosylation treated glycosides isolated from plant, and additional glycosylation treated plant extract with or without additional sugar donor.

The glycosides can also originate from animal sources. Amine donors can originate from animal sources, vegetable sources, fermentation, or chemical synthesis. The Maillard reaction could be controlled to have complete reaction by consuming amine donor and/or sugar donor completely or it contains residue of amine donor and/or sugar donor. An embodiment of flavor comprises one or more ingredients selected from a sugar conjugated substance from plant, an amine conjugated substance and their reacted products. An embodiment of consumable comprises such ingredient.

The embodiments described above are applicable for any synthetic sweetener, blends thereof and other natural sweeteners, blends thereof, or mixtures of synthetic and natural sweetener(s), especially sucralose.

### EXAMPLES

### Example 1. Preparation of Caramel-Like Flavored Maillard Reaction Product (GMGV50-MRP-Caramel) from Glycosylated Mogroside (GMGV50), Alanine and Xylose

Materials: GMGV50 (available from EPC Natural Products Co., Ltd., Lot #: 315-13-3), the content of remaining mogroside V is no more than 20% Process: 24 g of GMGV50, 4 g alanine, 12 g xylose were mixed and dissolved into 20 g deionized water. The mixture solution was then heated to and maintained at 100° C. for 2 hours. When the reaction was completed, the solution was then filtered through filter paper and the filtrate was dried with a spray dryer. Resulting in about 32 g of GMGV50-MRP-Caramel as powder.

### Example 2. Preparation of Maillard Reaction Product (GMGV50-MRP-Tangerine) from GMGV50, Glutamic Acid and Fructose

Materials: GMGV50 (available from EPC Natural Products Co., Ltd., Lot #: 315-13-3), the content of remaining mogroside V is no more than 20%.

Process: 18 g of GMGV50, 1 g glutamic acid, 1 g fructose were mixed and dissolved into 10 g deionized water. The mixture solution was then heated to and maintained at 100° C. for 90 minutes. When the reaction was completed, the solution was then filtered through filter paper and the filtrate was dried with a spray drier. Resulting in about 16 g of GMGV50-MRP-Tangerine as powder.

### Example 3. Evaluation of GMGV50-MRPs in Water Solutions

Materials: GMGV50-MRPs: 1) GMGV50-MRP-Caramel (product of Example 1), 2) GMGV50-MRP-Tangerine (product of Example 2)

Process: GMGV50-MRP-Caramel and GMGV50-MRP-Tangerine were weighed, mixed dissolved in 100 mL pure water as set forth in Table 3-1, and subjected to sensory evaluation tests, the results of which are shown in Table 3-2.

TABLE 3-1
Preparation of water solutions of GMGV50-MRP-Caramel and
GMGV50-MRP-Tangerine

| | | Volume | |
|---|---|---|---|
| | | of | |
| Sample | | pure | Concentration o [symbol] |
| mixture | | water | GMGV50-MRP |
| No. | Weight of GMGV50-MRPs (mg) | (mL) | (ppm) |
| 3-01 | 50 (product 1-01 from Example 1) | 100 | 500 |
| 3-02 | 50 (product 2-01 from Example 1) | | 500 |

[symbol]

indicates data missing or illegible when filed

TABLE 3-2
Flavor profile of GMGV50-MRPs in water

| Sample mixture No. | Flavor profile |
|---|---|
| 3-01 | Caramel-like, pleasant |
| 3-02 | Sugar-like, pleasant |

### Example 4. GMGV50-MRP-Tangerine (Product of Example 2) Improves the Taste Profile of Reb M Solution

Materials: 1) GMGV50-MRP-Tangerine: product of Example 2, 2) Reb M: available from available from Tate & Lyle USA, PLC, Lot #:DP18I92701.

Process: GMGV50-MRP-Tangerine (product of Example 2), citric acid and Reb M were weighed, mixed, dissolved in 100 mL pure water as set forth in Table 4-1, and subjected to sensory evaluation tests according to the evaluation method below, the results of which are shown in Table 4-8.

TABLE 4-1
Sample composition

| | | | | Weight | Volume |
|---|---|---|---|---|---|
| | | Weight | | of | of |
| | Ratio of Reb M to | of | Weight of | citric | pure |
| | GMGV50-MRP- | Reb M | GMGV50-MRP- | acid | water |
| No. | Tangerine | (mg) | Tangerine (mg) | (mg) | (mL) |
| 4-00 | 100/0 | 40 | 0 | 75 | 100 |
| 4-01 | 100/1 | | 4 | | |
| 4-02 | 100/5 | | 20 | | |
| 4-03 | 100/8 | | 32 | | |
| 4-04 | 100/10 | | 40 | | |
| 4-05 | 100/20 | | 80 | | |
| 4-06 | 100/25 | | 100 | | |
| 4-07 | 100/50 | | 200 | | |
| 4-08 | 100/100 | | 400 | | |

### Sensory Evaluation Methods

Products were evaluated in terms of sweetness onset, bitterness, sweet lingering, mouthfeel, metallic aftertaste, creaminess, and overall likability. A panel of 6 trained testers evaluated the samples and gave scores of 1-5 according to the followed standards. The average score of the panel members was taken as the score of each factor.

### 1) Sweetness Onset

Evaluation standard: The sample to be evaluated was dissolved in neutral deionized water. The tester placed 20-30 mL of the evaluation solution in their mouth, and timing was started to record the sweetness start time and peak time. The test solution was then spit out. The time at which the sweetness of the solution can be detected by the panelists was recorded as the time of sweetness onset time and was compared in the table below to determine the score of sweetness onset.

TABLE 4-2
Sweetness onset evaluation test standard

| Time at which sweetness | <0.2 s | | | | |
|---|---|---|---|---|---|
| can be detected | | | | | |
| Score of bitterness | 5 | 4 | 3 | 2 | 1 |
| Time at which sweetness | <0.2 s | 0.2-1 s | 1-2 s | 2~3 s | >3 s |
| can be detected | | | | | |

### 2) Bitterness

Quinine (99% purity) concentration of 10⁻⁸-10⁻⁴ mol/L was the bitterness standard, and the specific bitterness scoring standards are shown in the following table.

TABLE 4-3
Bitterness evaluation test standard

| | | | | | |
|---|---|---|---|---|---|
| Range of | <8 × 10⁻⁷ | 8 × 10⁻⁷~ | 7 × 10⁻⁶~ | 2 × 10⁻⁵~ | >1 × 10⁻⁴ |
| quinine | | 3 × 10⁻⁶ | 2 × 10⁻⁵ | 1 × 10⁻⁴ | |
| concentration | | | | | |
| mol/L | | | | | |
| Score of | 1 | 2 | 3 | 4 | 5 |
| bitterness | | | | | |

The sample to be evaluated was dissolved in neutral deionized water. The tester placed 20-30 mL of the evaluation solution in their mouth. After 5 seconds the sample was spit out. After a rinse step with water, the standard solution was tasted. If the bitter taste was similar, the bitterness of the sample could be determined as the bitterness value of the standard solution. Otherwise, it was necessary to take additional standard solution(s) and try again until the bitterness value was determined.

### 3) Sweet Lingering

The sample to be evaluated was dissolved in neutral deionized water. The tester placed 20-30 mL of the evaluation solution in their mouth, and timing was started to record the sweetness start time and peak time. The test solution was then spit out. Recording of time continued for the time when the sweetness disappeared completely. The time at which the sweetness completely disappeared was compared to the time in the table below to determine the value of sweet lingering.

TABLE 4-4
Sweet lingering evaluation test standard

| Time at which sweetness | <20 s | 20-30 s | 30-40 s | 40-50 s | >50 s |
|---|---|---|---|---|---|
| completely disappears | | | | | |
| Score of sweet lingering | 1 | 2 | 3 | 4 | 5 |

### 4) Metallic Aftertaste

Sucralose (available from Anhui Jinhe Industrial Co., Ltd and Lot # is 201810013) was used as a standard reference. The specific metallic aftertaste scoring standards are shown in Table 3-5.

TABLE 4-5
Metallic aftertaste evaluation test standard

| Range of sucralose | <50 ppm | 50-100 ppm | 100-150 ppm | 150-200 ppm | >200 pp [symbol] |
|---|---|---|---|---|---|
| concentration | | | | | |
| Score of metallic aftertaste | 1 | 2 | 3 | 4 | 5 |

[symbol]

indicates data missing or illegible when filed

The sample to be evaluated was dissolved in neutral deionized water. The tester placed 20-30 mL of the evaluation solution in their mouth. After 5 seconds, the solution was spit out. After a rinse step with water the standard solution was tasted. If the metallic aftertaste was similar, the metallic aftertaste of the sample was determined as the metallic aftertaste score of the standard liquid, otherwise it was necessary to take additional standard liquid samples and taste it again until the metallic aftertaste score was determined.

### 5) Mouthfeel

Evaluation standard: A 5% sucrose solution with neutral water was prepared. This solution was used as a standard solution to which the mouthfeel degree was set as 5.

A 250 ppm RA (available from Sweet Green Fields) solution was prepared with neutral water. This solution was used as a standard solution to which the mouthfeel degree was set as 1.

An appropriate amount of yeast extract (available from Leiber, 44400P-145) was dissolved in a 250 ppm aqueous solution of RA97 such that the degree of mouthfeel of the resulting solution was consistent with the standard solution of mouthfeel degree of 5 (5% sucrose). After evaluation by a panel of 6 testers, it was determined that a solution of 100 ppm the yeast extract dissolved in 250 ppm RA97 was substantially identical to the degree of mouthfeel of the 5% sucrose solution. Thus, the criteria for determining the degree of mouthfeel are as follows.

TABLE 4-6
Mouthfeel evaluation test standard

| RA97 | 250 ppm | | | | |
|---|---|---|---|---|---|
| Range of | <25 ppm | 25-50 ppm | 50-75 ppm | 75-100 ppm | >100 ppm |
| yeast | | | | | |
| extract | | | | | |
| concen- | | | | | |
| trati [symbol] | | | | | |
| Score of | 1 | 2 | 3 | 4 | 5 |
| mouthfeel | | | | | |
| level | | | | | |

[symbol]

indicates data missing or illegible when filed

### 6) Overall Likability

Overall likability is the general impact of the sample. The sample to be evaluated was dissolved in neutral deionized water. The tester places 20-30 mL of the evaluation solution in their mouth and evaluate the general impact based on its mouthfeel, bitterness, bitterness lingering, sweet lingering, and metallic aftertaste. The test solution was then spit out. A score of 1-5 indicates a strong dislike, dislike, average, like, and strong like 7) Time-intensity curves

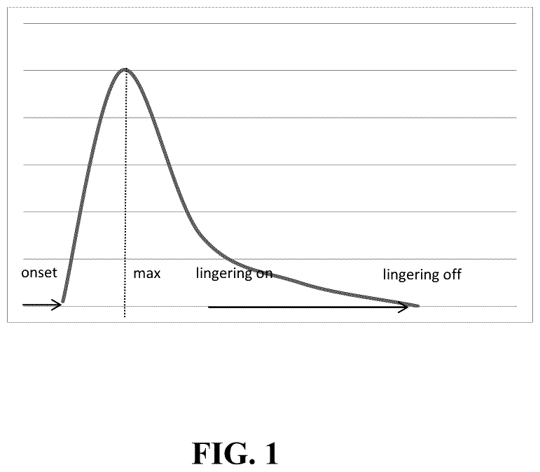

Evaluation method: Each person of the test panel had to drink sample solutions with defined concentrations. During the test, all persons had a time clock. They had to note the appearance-time for four specific points of a time-intensity curves (onset, maximum sweetness, lingering on and lingering off). The results were recorded and make a graph, mean values were calculated from at least 6 individual test persons. FIG. 1 shows a schematic diagram of the Time-intensity curve.

### 8) Creaminess

The sample to be evaluated was dissolved in neutral deionized water. The tester places 20-30 mL of the evaluation solution in their mouth and evaluate the creaminess of the solution. The test solution was then spit out. A score of 1-5 indicates a weak, relatively weak, moderate, relatively strong, and strong creaminess of the tested solution.

TABLE 4-7
Creaminess evaluation test standard

| | | Relatively | | Relatively | |
|---|---|---|---|---|---|
| Intensity of creaminess | Weak | weak | Moderate | Strong | Strong |
| Score of creaminess | 1 | 2 | 3 | 4 | 5 |

TABLE 4-8
Sensory evaluation results

| | Overall | Sweetness | Sweet | | Metallic |
|---|---|---|---|---|---|
| No. | likability | onset | lingering | Bitterness | aftertaste |
| 4-00 | 2.5 | 3 | 4 | 2.5 | 4.5 |
| 4-01 | 3.0 | 3 | 4 | 2.5 | 4 |
| 4-02 | 3.0 | 3 | 3.5 | 2 | 3.5 |
| 4-03 | 3.5 | 3 | 3.5 | 2 | 3 |
| 4-04 | 3.5 | 3.5 | 3 | 2 | 3 |
| 4-05 | 4 | 4 | 3 | 2 | 3 |
| 4-06 | 4 | 4 | 2.5 | 1.5 | 2.5 |
| 4-07 | 3 | 3.5 | 2.5 | 1.5 | 2.5 |
| 4-08 | 3 | 3 | 3 | 1.5 | 2.5 |

Conclusion: The result showed that the GMGV50-MRP-Tangerine prepared with GMGV50, fructose and glutamic acid improved the taste profile of Reb M solution by cutting sweet lingering, reducing the bitterness, significantly reducing the metallic aftertaste and quicken the sweetness onset of the 400 ppm Reb M solution. This effect can be extended to the Reb M to GMGV50-MRP-Tangerine ratio range of 99:1 to 1:99. This example shows that the GMGV50-MRP-Tangerine could improve the taste profile of natural intense sweeteners such as Reb M. This effect can be extended to other natural intense sweeteners derived from steviol glycosides such as Reb A, stevioside, Reb D, etc. It can also improve the taste profile of sweet tea extract accordingly.

### Example 5. GMGV50-MRP-Caramel (Product of Example 1) Improves the Taste Profile of Reb M Solution

Raw material: 1) GMGV50-MRP-Caramel: product of example 1; 2) Reb M: Tate & Lyle USA, PLC, Lot #: DP18I92701, the content of Reb M is no less than 95%.

Process: GMGV50-MIRP-Caramel (product of Example 1), citric acid and Reb M were weighed, mixed, dissolved in 100 mL pure water as set forth in Table 5-1, and subjected to sensory evaluation tests according to the evaluation method below, the results of which are shown in Table 5-2.

TABLE 5-1
Sample composition

| | | | | Weight | Volume |
|---|---|---|---|---|---|
| | | Weight | | of | of |
| | Ratio of Reb M to | of | Weight of | citric | pure |
| | GMGV50-MRP- | Reb M | GMGV50-MRP- | acid | water [symbol] |
| No. | Caramel | (mg) | Caramel (mg) | (mg) | (mL) |
| 5-00 | 100/0 | 40 | 0 | 75 | 100 |
| 5-01 | 100/1 | | 4 | | |
| 5-02 | 100/5 | | 20 | | |
| 5-03 | 100/8 | | 32 | | |
| 5-04 | 100/10 | | 40 | | |
| 5-05 | 100/20 | | 80 | | |
| 5-06 | 100/25 | | 100 | | |
| 5-07 | 100/50 | | 200 | | |
| 5-08 | 100/100 | | 400 | | |

[symbol]

indicates data missing or illegible when filed

Experiments: Several mixtures of BGMGV5i-MRP-Caramel (product of Example 1) and 400 ppm Reb M solution were prepared and evaluated according to the sensory evaluation method in Example 4.

The average scores from the panel were taken as the evaluation test results to produce the taste profiles depicted in Table 5-2.

TABLE 5-2
Sensory evaluation results

| | Overall | Sweetness | Sweet | | Metallic |
|---|---|---|---|---|---|
| No. | likability | onset | lingering | Bitterness | aftertaste |
| 5-00 | 2.5 | 3 | 4 | 2.5 | 4.5 |
| 5-01 | 3 | 3 | 3.5 | 2 | 4 |
| 5-02 | 3 | 3 | 3.5 | 2 | 3.5 |
| 5-03 | 3.5 | 3.5 | 3 | 2 | 3 |
| 5-04 | 3.5 | 4 | 3 | 1.5 | 3 |
| 5-05 | 4 | 4 | 3 | 1.5 | 2.5 |
| 5-06 | 4 | 4.5 | 2.5 | 1.5 | 2 |
| 5-07 | 3.5 | 4.5 | 2.5 | 2 | 2 |
| 5-08 | 3.5 | 4.5 | 3 | 2 | 2.5 |

Conclusion: The results showed that the GMGV50-MRP-Caramel could significantly reduce the unpleasant sweet linger, metallic aftertaste, bitterness and quicken the sweetness onset of the 400 ppm Reb M solution. This effect was observed in all the tested Reb M to GMGV50-MIRP-Caramel ratios mentioned in the tables above. The effect can be extended to the Reb M to GMGV50-MRP-Caramel ratio range of 99:1 to 1:99. This example demonstrate that GMGV50-MRP-Caramel can improve taste profile of the 400 ppm Reb M solutions. The example could also be extended to other natural intense sweeteners such as stevioside, Reb A, Reb B, etc. It could also improve the taste profile of sweet tea extract accordingly.

### Example 6. Preparation of Popcorn-Flavored Product GMGV50-MRP-Popcorn Using Proline and Rhamnose

Materials: GMGV50 (available from EPC Natural Products Co., Ltd., Lot #: 315-13-3), the content of remaining mogroside V is no more than 20%.

Process: 24 g of GMGV50, 2.4 g proline, 3.6 g rhamnose were mixed and dissolved into 15 g deionized water. The mixture solution was then heated to and maintained at 100° C. for an hour. When the reaction was completed, the solution was then filtered through filter paper and the filtrate was dried with a spray dryer. Resulting in about 24 g of GMGV50-MRP-Popcorn as off-white powder.

### Example 7. Preparation of Honey-Flavored Product GMGV50-MRP-Honey Using Xylose and Phenylalanine

Materials: GMGV50 (available from EPC Natural Products Co., Ltd., Lot #: 315-13-3), the content of remaining mogroside V is no more than 20%.

Process: 24 g of GMGV50, 4 g xylose, 2 g phenylalanine were mixed and dissolved into 15 g deionized water. The mixture solution was then heated to and maintained at 100° C. for an hour. When the reaction was completed, the solution was then filtered through filter paper and the filtrate was dried with a spray dryer. Resulting in about 24 g of GMGV50-MRP-Honey as off-white powder.

### Example 8. Preparation of Colorless Caramel-Like Flavored Product GMGV50-MRP-Caramel Using GMGV50, Xylose and Alanine

Materials: GMGV50 (available from EPC Natural Products Co., Ltd., Lot #: 315-13-3), the content of remaining mogroside V is no more than 20%.

Process: 28 g of GMGV50, 9 g xylose, 3 g alanine were mixed and dissolved into 240 g deionized water. The mixture solution was then heated to and maintained at 95° C. for 2 hours. When the reaction was completed, the solution was then filtered through filter paper and the filtrate was dried with a spray dryer. Resulting in about 32 g of GMGV50-MRP-Caramel as off-white powder.

### Example 9. Preparation of GMGV50-MRP-Tangerine Using GMGV50, Fructose and Glutamic Acid

Materials: GMGV50 (available from EPC Natural Products Co., Ltd., Lot #: 315-13-3), the content of remaining mogroside V is no more than 20%.

Process: 36 g of GMGV50, 3 g fructose, 1 g glutamic acid were mixed and dissolved into 20 g deionized water. The mixture solution was then heated to and maintained at 100° C. for 1.5 hours. When the reaction was completed, the solution was then filtered through filter paper and the filtrate was dried with a spray dryer. Resulting in about 32 g of GMGV50-MRP-Tangerine as off-white powder.

### Example 10. GMGV50-MRP-Popcorn Improved the Taste Profile of RA97

Raw material: 1) GMGV50-MRP-Popcorn: product of Example 6; 2) RA97: available from Sweet Green Fields, Lot #: 3050123, the content of Reb A is no less than 97%.

Process: GMGV50-MRP-Popcorn (product of Example 6), citric acid and RA97 were weighed, mixed, dissolved in 100 mL pure water as set forth in Table 10-1, and subjected to sensory evaluation tests according to the evaluation method below, the results of which are shown in Table 10-2.

TABLE 10-1
Sample composition

| | | | | Weight | Volume |
|---|---|---|---|---|---|
| | | Weight | Weight of | of | of |
| | Ratio of RA97 to | of | GMGV5 [symbol] | citric | pure |
| | GMGV50-MRP- | RA97 | MRP-Popcorn | acid | water |
| No. | Popcorn | (mg) | (mg) | (mg) | (mL) |
| 10-00 | 200/0 | 20 | 0 | 75 | 100 |
| 10-01 | 200/10 | | 1 | | |
| 10-02 | 200/25 | | 2.5 | | |
| 10-03 | 200/50 | | 5 | | |
| 10-04 | 200/100 | | 10 | | |
| 10-05 | 200/200 | | 20 | | |
| 10-06 | 200/400 | | 40 | | |
| 10-07 | 200/800 | | 80 | | |

[symbol]

indicates data missing or illegible when filed

Experiments: Several mixtures of GMGV50-MRP-Popcorn (product of Example 6) and 200 ppm RA97 solution were prepared and evaluated according to the sensory evaluation method in Example 4.

The average scores from the panel were taken as the evaluation test results to produce the taste profiles depicted in Table 10-2.

TABLE 10-2
Sensory evaluation results

| Sample | | | | | |
|---|---|---|---|---|---|
| mixture | Sweetness | Sweet | | Metallic | Overall |
| No. | onset | lingering | Bitterness | aftertaste | likability |
| 10-00 | 3 | 4.5 | 4 | 4.5 | 2 |
| 10-01 | 3 | 4 | 3.5 | 4 | 3 |
| 10-02 | 3.5 | 3 | 3 | 3 | 3 |
| 10-03 | 3.5 | 2.5 | 2 | 2.5 | 3.5 |
| 10-04 | 4 | 2 | 1.5 | 2 | 4.5 |
| 10-05 | 4 | 2.5 | 1.5 | 2 | 4 |
| 10-06 | 3.5 | 3 | 2 | 2 | 3.5 |
| 10-07 | 3.5 | 3.5 | 2 | 2 | 3.5 |

Conclusion: The results showed that GMGV50-MRP-Popcorn could significantly reduce the sweet linger, bitterness and metallic aftertaste of the 200 ppm RA97 solution. It can also quicken the sweetness onset. This effect was observed in all the tested RA97 to GMGV50-MRP-Popcorn ratios mentioned in the tables above. The effect can be extended to the RA97 to GMGV50-MRP-Popcorn ratio range of 99:1 to 1:99. This example demonstrated that GMGV50-MRP-Popcorn could improve the taste profile and the overall likability of the RA97 solutions. It can also be extended to other natural intense sweeteners such as Reb D, Reb M, stevioside etc.

### Example 11. GMGV50-MRP-Honey Improved the Taste Profile of Reb M Solutions

Raw material: 1) GMGV50-MRP-Honey: product of Example 7; 2) Reb M: Tate & Lyle USA, PLC, Ltd., Lot #: DP18I92701, the content of Reb M is no less than 95%.

Process: GMGV50-MRP-Honey (product of Example 7), citric acid and Reb M were weighed, mixed, dissolved in 100 mL pure water as set forth in Table 11-1, and subjected to sensory evaluation tests according to the evaluation mentioned in Example 4, the results of which are shown in Table 11-2.

TABLE 11-1
Sample composition

| | Ratio of | | Weight of | | |
|---|---|---|---|---|---|
| | Reb M to | Weight | GMGV50- | Weight of | Volume of |
| | GMGV50- | of Reb | MRP- | citric acid | pure water |
| No. | MRP-Honey | M (mg) | Honey (mg) | (mg) | (mL) |
| 11-00 | 400/0 | 40 | 0 | 75 | 100 |
| 11-01 | 400/10 | | 4 | | |
| 11-02 | 400/25 | | 20 | | |
| 11-03 | 400/50 | | 32 | | |
| 11-04 | 400/100 | | 40 | | |
| 11-05 | 400/200 | | 80 | | |
| 11-06 | 400/400 | | 100 | | |
| 11-07 | 400/800 | | 200 | | |

Experiments: Several mixtures of GMGV50-MRP-Honey (product of Example 7) and 400 ppm Reb M solution were prepared and evaluated according to the sensory evaluation method in Example 4.

The average scores from the panel were taken as the evaluation test results to produce the taste profiles depicted in Table 11-2.

TABLE 11-2
Sensory evaluation results

| | Overall | Sweetness | Sweet | | Metallic |
|---|---|---|---|---|---|
| No. | likability | onset | lingering | Bitterness | aftertaste |
| 11-00 | 2.5 | 3 | 4 | 2.5 | 4.5 |
| 11-01 | 3 | 3 | 3 | 2 | 4 |
| 11-02 | 3 | 3.5 | 2.5 | 1.5 | 3 |
| 11-03 | 3.5 | 4 | 2.5 | 1.5 | 2.5 |
| 11-04 | 3.5 | 4 | 2.5 | 1.5 | 2.5 |
| 11-05 | 4 | 3.5 | 3 | 1.5 | 3 |
| 11-06 | 4 | 3.5 | 3 | 1.5 | 3 |
| 11-07 | 3.5 | 3 | 3.5 | 2 | 3.5 |

Conclusion: The results showed that MMGV50-MRP-Honey could reduce the sweet linger, bitterness and metallic aftertaste of the 400 ppm Reb M solution. It can also quicken the sweetness onset. This effect was observed in all the tested Reb M to GMGV50-MRP-Honey ratios mentioned in the tables above. The effect can be extended to the Reb M to GMGV50-MRP-Honey ratio range of 99:1 to 1:99. This example demonstrated that GMGV50-MRP-Honey could improve the taste profile and the overall likability of the Reb M solutions. It can also be extended to other natural intense sweeteners such as Reb B, stevioside, Reb B etc.

### Example 12. GMGV50-MRP-Caramel (Product of Example 8) Improved the Taste Profile of Sucralose Solution

Raw material: 1)GMGV50-MRP-Caramel: product of Example 8, 2) sucralose: available from Anhui Jinhe Industrial Co., Ltd and Lot #: 201810013.

Process: GMGV50-MRP-Caramel (product of Example 8), citric acid and sucralose were weighed, mixed, dissolved in 100 mL pure water as set forth in Table 12-1, and subjected to sensory evaluation tests according to the evaluation mentioned in Example 4, the results of which are shown in Table 12-2.

TABLE 12-1
Sample compositions

| | Ratio of | | | Weight of | |
|---|---|---|---|---|---|
| | sucralose | Weight of | Weight of | GMGV50- | Volume of |
| | GMGV50- | citric acid | Sucralose | MRP- | pure |
| No. | MRP-Caramel | (mg) | (mg) | Caramel (mg) | water (mL) |
| 12-00 | 150/0 | 75 | 15 | 0 | 100 |
| 12-01 | 150/15 | 75 | 15 | 1.5 | 100 |
| 12-02 | 150/30 | 75 | 15 | 3 | 100 |
| 12-03 | 150/50 | 75 | 15 | 5 | 100 |
| 12-04 | 150/100 | 75 | 15 | 10 | 100 |
| 12-05 | 150/150 | 75 | 15 | 15 | 100 |
| 12-06 | 150/300 | 75 | 15 | 30 | 100 |
| 12-07 | 150/600 | 75 | 15 | 60 | 100 |

Experiments: Several mixtures of GMGV50-MRP-Caramel (product of Example 8) and 150 ppm sucralose solution were prepared and evaluated according to the sensory evaluation method in Example 4.

The average scores from the panel were taken as the evaluation test results to produce the taste profiles depicted in Table 12-2.

TABLE 12-2
Sensory evaluation results.

| | Overall | | Sweet | Metallic |
|---|---|---|---|---|
| No. | likability | Mouthfeel | lingering | aftertaste |
| 12-00 | 3 | 2.5 | 4 | 4 |
| 12-01 | 3.5 | 2.5 | 3.5 | 3.5 |
| 12-02 | 3.5 | 3 | 3 | 3 |
| 12-03 | 4 | 3 | 2.5 | 2.5 |
| 12-04 | 4 | 3 | 2.5 | 2.5 |
| 12-05 | 4.5 | 3.5 | 2 | 2 |
| 12-06 | 4 | 3.5 | 3 | 3 |
| 12-07 | 3.5 | 3 | 2.5 | 3 |

Conclusion: The result showed that GMGV50-MRP-Caramel (product of Example 8) significantly improved the mouthfeel, cut the sweet lingering, and decrease the metallic aftertaste of sucralose. This effect was observed in all the tested sucralose-to-GMGV50-MRP-Caramel ratios (from 10:1 to 10:40). The effect can be extended to a sucralose-to-GMGV50-MRP-Caramel ratio range of 99:1 to 1:99. This example demonstrates that GMGV50-MRP-Caramel could improve taste profile of artificial sweetener such as sucralose. Such effect can be extended to all artificial sweeteners.

### Example 13. GMGV50-MRP-Tangerine (Product of Example 9) Improved the Taste Profile of RA97 Solutions

Materials: 1) GMGV50-MRP-Tangerine (product of Example 9), 2) RA97: available from Sweet Green Fields, Lot #: 3050123, the content of Reb A is no less than 97%.

Process: GMGV50-MRP-Tangerine (product of Example 9), citric acid and RA97 were weighed, mixed, dissolved in 100 mL pure water as set forth in Table 13-1, and subjected to sensory evaluation tests according to the evaluation mentioned in Example 4, the results of which are shown in Table 13-2.

TABLE 13-1
Sample composition

| | The ratio of | | Weight of | | |
|---|---|---|---|---|---|
| | RA97 to | Weight | GMGV50- | | |
| | GMGV50- | of | MRP- | Weight of | Volume of |
| | MRP- | RA97 | Tangerine | citric acid | pure |
| No. | Tangerine | (mg) | (mg) | (mg) | Water (mL) |
| 13-00 | 200/0 | 20 | 0 | 75 | 100 |
| 13-01 | 200/10 | | 1 | | |
| 13-02 | 200/25 | | 2.5 | | |
| 13-03 | 200/50 | | 5 | | |
| 13-04 | 200/100 | | 10 | | |
| 13-05 | 200/200 | | 20 | | |
| 13-06 | 200/400 | | 40 | | |
| 13-07 | 200/800 | | 80 | | |

TABLE 13-2
Sensory evaluation results

| Sample | | | | | |
|---|---|---|---|---|---|
| mixture | Sweetness | Sweet | | Metallic | Overall |
| No. | onset | lingering | Bitterness | aftertaste | likability |
| 13-00 | 3 | 4.5 | 4 | 4.5 | 2 |
| 13-01 | 3 | 4 | 3 | 3.5 | 2.5 |
| 13-02 | 3 | 4 | 3 | 3 | 3 |
| 13-03 | 3.5 | 3.5 | 2.5 | 3 | 3.5 |
| 13-04 | 4 | 2.5 | 2.5 | 3 | 4 |
| 13-05 | 3.5 | 2.5 | 2.5 | 3 | 4 |
| 13-06 | 3 | 3 | 2.5 | 3.5 | 3.5 |
| 13-07 | 3 | 3 | 2.5 | 3.5 | 3.5 |

Conclusion: The result showed that GMGV50-MRP-Tangerine (product of Example 9) significantly cut the sweet lingering and decrease the metallic aftertaste and bitterness of RA97 solutions. This effect was observed in all the tested RA97-to-GMGV50-MIRP-Tangerine ratios. The effect can be extended to a RA97-to-GMGV50-MIR-Tangerine ratio range of 99:1 to 1:99. This example demonstrates that GMGV50-MRP-Tangerine could improve overall likability, quicken the sweetness onset, and cut the bitterness and metallic aftertaste of natural sweetener such as RA97. Such effect can be extended to all natural intense sweeteners.

### Example 14. GMGV50-MRP-Popcorn Improved the Taste Profile of Thaumatin Solutions

Materials: 1) GMGV50-MRP-Popcorn (product of Example 6), 2) thaumatin: available from EPC Natural Products Co., Ltd., the content of thaumatin is 93%, lot #: 20200201

Process: GMGV50-MRP-Popcorn (product of Example 6) and thaumatin were weighed, mixed, dissolved in 100 mL pure water as set forth in Table 14-1, and subjected to sensory evaluation tests according to the evaluation mentioned in Example 4, the results of which are shown in Table 14-2.

TABLE 14-1
Sample composition

| | The ratio of | | | |
|---|---|---|---|---|
| | thaumatin to | Weight of | Weight of | Volume |
| | GMGV50-MRP | thaumatin | GMGV50-MRP | of pure |
| No. | Popcorn | (mg) | Popcorn (mg) | water (mL) |
| 14-00 | 15/0 | 1.5 | 0 | 100 |
| 14-01 | 15/15 | | 1 | |
| 14-02 | 15/50 | | 2.5 | |
| 14-03 | 15/100 | | 5 | |
| 14-04 | 15/150 | | 10 | |
| 14-05 | 15/300 | | 20 | |
| 14-06 | 15/600 | | 40 | |
| 14-07 | 15/1500 | | 80 | |

TABLE 14-2
Sensory evaluation results.

| | Overall | Sweetness | Sweet |
|---|---|---|---|
| No. | likability | onset | lingering |
| 14-00 | 1 | 1 | 4.5 |
| 14-01 | 1.5 | 1.5 | 4 |
| 14-02 | 2.5 | 3 | 3.5 |
| 14-03 | 2.5 | 3 | 3.5 |
| 14-04 | 3 | 4 | 3 |
| 14-05 | 4.5 | 3.5 | 2 |
| 14-06 | 4 | 4 | 2.5 |
| 14-07 | 2.5 | 4 | 3.5 |

Conclusion: The result showed that GMGV50-MRP-Popcorn (product of Example 6) significantly cut the sweet lingering and quicken the sweetness onset of the 15 ppm thaumatin solutions. This effect was observed in all the tested thaumatin to-GMGV50-MRP-Popcorn ratios. The effect can be extended to a thaumatin-to-GMGV50-MRP-Popcorn ratio range of 99:1 to 1:99. This example demonstrates that GMGV50-MRP-Popcorn could improve overall likability, quicken the sweetness onset, and cut the sweet lingering of natural sweetener with large molecular weight such as thaumatin. Such effect can be extended to all sweet proteins such as monellin, brazzein, etc.

### Example 15. GMGV50-MRP-Popcorn Improved the Taste Profile of Commercial Mixed Dairy Beverage

Materials: 1) GMGV50-MRP-Popcorn (product of Example 6);
2) Commercial dairy beverage: Yili Yousuanru dairy beverage, available from Inner Mongolia Yili Industrial Group Co., Ltd.
Beverage type: mixed dairy beverage.

Ingredients: water, full-fat milk powder, granulated sugar, whey protein powder, high fructose corn syrup, concentrated apple juice, food additives (carboxymethylcellulose sodium, xanthan gum, lactic acid, citric acid, sodium citrate, mono- and di-glycerides, propylene glycol alginate, succinylated monoglyceride, diacetyl tartaric acid ester of mono(di)glycerides, sucralose, acesulfame potassium, neotame, food flavoring).

Process: Powdered GMGV50-MRP-Popcorn product was weighed and dissolved in the selected commercial dairy beverage outlined in Table 15-1 below.

TABLE 15-1
Sample composition.

| | | Volume | Concentration of |
|---|---|---|---|
| | Weight of GMGV50- | of selected | GMGV50-MRP- |
| Sample | MRP-Popcorn (mg) | beverage (ml) | Popcorn (ppm) |
| Base | — | 100 | — |
| 15-01 | 10 | 100 | 100 |

Experiment: The mixture sample was evaluated to the sensory evaluation method in Example 4. Average score from the test panel for each sensory criterion were recorded as the sensory evaluation results to produce the following taste profile depicted in Table 15-2 and FIG. 1.

TABLE 15-2
Sensory evaluation results

| | Overall | | | Sweet |
|---|---|---|---|---|
| | likability | Creaminess | Mouthfeel | lingering |
| Base | 3 | 3 | 3 | 3.5 |
| 15-01 | 4 | 4 | 4.5 | 2.5 |

Conclusion: GMGV50-MRP-Popcorn (product of Example 6) significantly enhanced the creaminess, and mouth feel of the dairy beverage, resulting in an improved overall likability of the mixed dairy beverage product (15-01). The results showed that glycosylated mogroside-based Maillard reaction products can improve the taste profile of dairy beverages.

### Example 16. GMGV50-MRP-Honey Improved the Taste Profile of Commercial Fruit Juice

Materials: 1) GMGV50-MRP-Honey (product of Example 7);
2) Commercial fruit juice: Chabaa Peach & Mango Juice, available from Chabaa Bangkok Co., Ltd.
Beverage type: fruit juice
Ingredients: Recovered peach juice (water, concentrated peach juice), mango juice, fresh peach pulp.

Process: Powdered GMGV50-MRP-Honey product was weighed and dissolved in the selected commercial fruit juice outlined in Table 16-1 below.

TABLE 16-1
Sample composition.

| | Weight of | Volume | Concentration of |
|---|---|---|---|
| | GMGV50-MRP- | of selected | GMGV50- |
| Sample | Honey (mg) | beverage (ml) | MRP-Honey (ppm) |
| Base | — | 100 | — |
| 16-01 | 5 | 100 | 50 |

Experiment: The mixture sample was evaluated to the sensory evaluation method in Example 4. Average score from the test panel for each sensory criterion were recorded as the sensory evaluation results to produce the following taste profile depicted in Table 16-2.

TABLE 16-2
Sensory evaluation results

| | Overall | | | |
|---|---|---|---|---|
| | likability | Juiciness | Mouthfeel | Flavor |
| Base | 2.5 | 2 | 3 | 3 |
| 16-01 | 3.5 | 2.5 | 4 | 4 |

Conclusion: GMGV50-MRP-Honey (product of Example 7) significantly enhanced the juiciness, mouthfeel, and the peach & mango flavor of the selected fruit juice, resulting in an improved overall likability of the mixed dairy beverage product (16-01). The results showed that glycosylated mogroside-based Maillard reaction products can improve the taste profile of commercial fruit juices.

### Example 17. GMGV50-MRP-Honey Improved the Taste Profile of Commercial Flavored Tea Beverages

Materials: 1) GMGV50-MRP-Honey (product of Example 7);
2) Commercial flavored tea beverage: Nestle Chacui Passionfruit Green Tea
Beverage type: flavored tea beverage

Ingredients: water, granulated sugar, concentrated apple juice, concentrated passionfruit juice, instant green tea, food additives (citric acid, sodium citrate, sodium tripolyphosphate, DL-malic acid, D-ascorbic acid, sucralose), food flavoring.

Process: Powdered GMGV50-MRP-Honey product was weighed and dissolved in the selected commercial flavored tea beverage outlined in Table 17-1 below.

TABLE 17-1
Sample composition.

| | Weight of | | Concentration |
|---|---|---|---|
| | GMGV50- | Volume of | GMGV50- |
| | MRP-Honey | selected | MRP-Honey |
| Sample | (mg) | beverage (ml) | (ppm) |
| Base | — | 100 | — |
| 17-01 | 10 | 100 | 100 |

Experiment: The mixture sample was evaluated according to the sensory evaluation method in Example 4. Average score from the test panel for each sensory criterion were recorded as the sensory evaluation results to produce the following taste profile depicted in Table 17-2.

TABLE 17-2
Sensory evaluation results

| | Overall | | | |
|---|---|---|---|---|
| | likability | Juiciness | Mouthfeel | Flavor |
| Base | 2.5 | 2.5 | 2.5 | 3 |
| 17-01 | 3.5 | 3 | 4 | 4 |

Conclusion: GMGV50-MRP-Honey (product of Example 7) significantly enhanced the juiciness, mouthfeel, and the pleasant tea flavor of the selected tea beverage, resulting in an improved overall likability of the flavored tea beverage (17-01). The results showed that glycosylated mogroside-based Maillard reaction products can improve the taste profile of commercial flavored tea beverage.

### Example 18. GMGV50-MRP-Caramel (Product of Example 8) Improved the Taste Profile of Commercial Functional Beverages

Materials: 1) GMGV50-MRP-Caramel (product of Example 8);
2) Commercial functional beverage: Monster Energy Ultra
Beverage type: functional beverage\energy drink.

Ingredients: water, maltodextrin, erythritol, citric acid, sodium citrate, food flavoring (contains guarana extract), carbon dioxide, L-carnitine tartrate, concentrated black tea powder, taurine, potassium citrate, potassium sorbate, ginseng powder, sucralose, concentrated green tea powder, concentrated coffee bean powder, sodium benzoate, inositol, potassium acetylsulfonate, salt, nicotinamide, vitamin B6, vitamin B12.

Process: Powdered GMGV50-MRP-Caramel product was weighed and dissolved in the selected commercial functional beverage outlined in Table 18-1 below.

TABLE 18-1
Sample composition.

| | Weight of | Volume | Concentration |
|---|---|---|---|
| | GMGV50-MRP- | of selected | GMGV50-MRP- |
| Sample | Caramel (mg) | beverage (ml) | Caramel (ppm) |
| Base | — | 100 | — |
| 18-01 | 10 | 100 | 100 |

Experiment: The mixture sample was evaluated according to the sensory evaluation method in Example 4. Average score from the test panel for each sensory criterion were recorded as the sensory evaluation results to produce the following taste profile depicted in Table 18-2.

TABLE 18-2
Sensory evaluation results

| | Overall | Sweet | | |
|---|---|---|---|---|
| | likability | lingering | Mouthfeel | Flavor |
| Base | 3 | 4 | 3 | 3 |
| 18-01 | 3.5 | 2.5 | 3.5 | 3.5 |

Conclusion: GMGV50-MRP-Caramel (product of Example 8) significantly reduced the sweet lingering, enhanced the mouthfeel and the flavor of the selected functional beverage, resulting in an improved overall likability of the functional beverage (18-01). The results showed that glycosylated mogroside-based Maillard reaction products can improve the taste profile of commercial functional beverage.

### Example 19. Preparation of GMGV50-MRP-ATA Using Concentrated Apple Juice and Glutamic Acid

Materials: 1) GMGV50 (available from EPC Natural Products Co., Ltd., Lot #: 315-13-3), the content of remaining mogroside V is no more than 20%. 2) decolorized and deacidified concentrated apple juice (fructose content: 36.77%), available from China Haisheng Fresh Fruit Juice Co., Ltd, Weinan Branch, lot #: 25191005B01-05.

Process: 18 g of GMGV50, 1 g glutamic acid, 8.16 g apple juice were mixed and dissolved into 8.72 g deionized water. The mixture solution was then heated to and maintained at 100° C. for 90 minutes. When the reaction was completed, the solution was then filtered through filter paper and the filtrate was dried with a spray dryer. Resulting in about 20 g of GMGV50-MRP-ATA as off-white powder.

### Example 20. GMGV50-MRP-ATA (Product of Example 19) Improved the Taste Profile of Near Water

Materials: 1) GMGV50-MRP-ATA (product of Example 19);
2) Commercial near water: Suntory Lemon Water.
Beverage type: flavored near water
   Ingredients: water, granulated sugar, food additives (citric acid, sodium citrate), food flavoring, honey, concentrated lemon juice, concentrated lime juice.
   Process: Powdered GMGV50-MRP-ATA (product of Example 19) was weighed and dissolved in the selected near water outlined in Table 20-1 below.

TABLE 20-1
Sample composition

| | Weight of | Volume | Concentration of |
|---|---|---|---|
| | GMGV50- | of selected | GMGV50- |
| Sample | MRP-ATA (mg) | beverage (ml) | MRP-ATA (ppm) |
| Base | — | 100 | — |
| 20-01 | 5 | 100 | 50 |

Experiment: The mixture sample was evaluated according to the sensory evaluation method in Example 4. Average score from the test panel for each sensory criterion were recorded as the sensory evaluation results to produce the following taste profile depicted in Table 20-2.

TABLE 20-2
Sensory evaluation results

| | Overall | Sweet | | |
|---|---|---|---|---|
| | likability | lingering | Astringency | Flavor |
| Base | 2.5 | 4 | 3 | 2 |
| 20-01 | 4 | 2 | 2 | 3.5 |

Conclusion: GMGV50-MRP-ATA (product of Example 19) significantly reduced the sweet lingering and astringency while enhanced the lemon flavor of the selected near water, resulting in an improved overall likability of the lemon flavored near water (18-01). The results showed that glycosylated mogroside-based Maillard reaction products using apple juice as the sugar donor can improve the taste profile of commercial near water beverages.

### Example 21. Preparation of GMGV50-MRP-ACaramel Using GMGV50, Concentrated Apple Juice and Alanine

Materials: 1) GMGV50 (available from EPC Natural Products Co., Ltd., Lot #: 315-13-3), the content of remaining mogroside V is no more than 20%. 2) decolorized and deacidified concentrated apple juice (fructose content: 36.77%), available from China Haisheng Fresh Fruit Juice Co., Ltd, Weinan Branch, lot #: 25191005B01-05; 2).
Process: 24 g of GMGV50, 4 g alanine, 32.64 g apple juice were mixed and dissolved into 11 g deionized water. The mixture solution was then heated to and maintained at 100° C. for 2 hours. When the reaction was completed, the solution was then filtered through filter paper and the filtrate was dried with a spray dryer. Resulting in about 42 g of GMGV50-MRP-ACaramel as powder.

### Example 22. GMGV50-MRP-ACaramel (Product of Example 21) Improved the Taste Profile of RD/RM Solution

Materials: 1) GMGV50-MRP-ACaramel: product of Example 21, 2) RD: available from Sweet Green Fields, Lot #: 478/38/70, the content of Reb D is no less than 95%, 3) RM: available from Tate & Lyle USA, PLC, Lot #: DP18I92701, the content of Reb M is no less than 95%.
Process: GMGV50-MRP-ACaramel (product of Example 21) RD and RM were weighed, mixed, dissolved in 100 mL pure water as set forth in Table 21-1, and subjected to sensory evaluation tests, the results of which are shown in Table 21-2.

TABLE 21-1
Preparation of mixtures of GMGV50
(product 1-03 from Example 1) and RD/RM

| | Ratio of | | | Weight of | |
|---|---|---|---|---|---|
| | GMGV50- | | | GMGV50- | |
| | MRP- | | | MRP- | |
| | ACaramel | | | ACaramel | |
| | (produc [symbol] | | | (produc [symbol] | Volume |
| Sample | of Example | Weight | Weight | of | of pure |
| mixture | 21) to RD | of RM | of RD | Example 21) | water |
| No. | to RM | (mg) | (mg) | (mg [symbol] | (mL) |
| 8-00 | 0/200/200 | 20 | 20 | 0 | 100 |
| 8-01 | 20/180/200 | | 18 | 2 | |
| 8-02 | 50/150/200 | | 15 | 5 | |
| 8-03 | 100/100/200 | | 10 | 10 | |
| 8-04 | 150/50/200 | | 5 | 15 | |
| 8-05 | 200/0/200 | | 0 | 20 | |

[symbol]

indicates data missing or illegible when filed

Experiments: Several mixtures of GMGV50-MRP-ACaramel (product of Example 21), Reb M and Reb D solution were prepared and evaluated according to the sensory evaluation standard in Example 4. Average scores from the test panel for each sensory criterion were taken as the evaluation test results.

TABLE 22-2
Sensory evaluation results

| Sample | Sweetness | Sweet | Metallic | Overall |
|---|---|---|---|---|
| mixture No. | onset | lingering | aftertaste | likability |
| 8-00 | 3 | 4.5 | 4.5 | 1.5 |
| 8-01 | 4 | 3.5 | 3 | 2.5 |
| 8-02 | 4 | 3 | 2.5 | 3 |
| 8-03 | 4 | 2.5 | 2 | 3.5 |
| 8-04 | 4 | 2 | 2 | 4 |
| 8-05 | 4 | 3 | 3 | 3 |

Conclusion: The results showed that with an increase in the proportion of GMGV50-MRP-ACaramel to RD in the 200 ppm RM solution could significantly reduce the unpleasant sweet linger, metallic aftertaste and quicken sweetness onset of the mixture solution. It demonstrated that GMGV50-MRP-ACaramel can improve the taste profile, cut sweet linger, reduce the metallic aftertaste, and improve the overall likability of the mixture solutions. This example demonstrates that glycosylated mogroside-based Maillard reaction products using apple juice as the sugar donor could improve the taste profile of steviol glycosides of relatively higher (longer chain) molecular weight such as combination of Reb D and Reb M. It could further include one or more steviol glycosides selected from Reb A, Reb B, stevioside etc.

### Example 23. GMGV50-MRP-ATA (Product of Example 19) Improved the Taste Profile of Coke Stevia

Materials: 1) GMGV50-MRP-ATA (product of Example 19),
2) Commercial carbonated beverage: Coke Stevia

Main ingredients: carbonated water, sucrose, caramel color, flavoring, phosphoric acid, preservative (sodium benzoate), caffeine and steviol glycoside (stevia leaf extract).

Available from: Coca-Cola Singapore Beverages PTE. Ltd, Lot #: 9555589209654.

Process: Powdered GMGV50-MRP-Tangerine (product of Example 19) was weighed and dissolved in the selected carbonated beverage (Coke Stevia) outlined in Table 23-1 below.

TABLE 23-1
Sample Composition

| | Weight of | Volume | Concentration |
|---|---|---|---|
| | GMGV50- | of selected | of GMGV50- |
| | MRP-ATA | beverage | MRP-ATA |
| Sample | (mg) | (ml) | (ppm) |
| Base | — | 100 | — |
| 23-01 | 7.5 | 100 | 75 |

Experiment: The mixture sample was evaluated according to the sensory evaluation method in Example 4. Average score from the test panel for each sensory criterion were recorded as the sensory evaluation results to produce the following taste profile depicted in Table 23-2.

TABLE 23-2
Sensory evaluation results

| | Overall | | | |
|---|---|---|---|---|
| | likability | Bitterness | Mouthfeel | Flavor |
| Base | 2.5 | 3.5 | 2.5 | 3 |
| 23-01 | 4 | 2.5 | 4 | 4 |

Conclusion: GMGV50-MRP-ATA (product of Example 19) significantly reduced the bitterness while enhanced the unique caramel flavor and the round mouthfeel of the Coke Stevia, resulting in an improved overall likability of the beverage. The results showed that glycosylated mogroside-based Maillard reaction products can improve the taste profile of commercial carbonated beverages using steviol glycosides as sweeteners. The effect can be extended to other beverages with added stevia glycosides of different molecular weights, including stevia leaf extracts.

### Example 24. Preparation of GMGV50 Using GMGV20% as Raw Material

Materials: Mogroside V 20% (available from Hunan Huacheng Biotech, Inc., Lot #: LHGE160111; CGTase (available from Amino Enzyme, Inc., Lot #CGTN0450202SLK), maltodextrin (available from Baolingbao Biology Co., Ltd., Lot #:16052872)

A glycosylated reaction product composition was prepared using mogroside V 20% according to the following method:

Mogroside V 20%, maltodextrin, water and CGTase were weighed as Table 24-1.

The weighed maltodextrin was dissolved in 100 mL deionized water

The weighted mogroside V 20% was added to the dissolved dextrin solution to form a mixture

The weighed CGTase enzyme and deionized water were added to the mixture and incubated at 69° C. for 10 hours to glycosylate the mogroside V 20% with glucose molecules derived from maltodextrin

The reaction mixture of iii) was heated to 85° C. for 10 min to inactivate the CGTase which was then removed by filtration

The resulting solution of glycosylated mogroside V 20% (GMGV20), residual mogroside and dextrin were spray dried, thereby resulting GMGV20 as powder

TABLE 24-1
Sample composition

| | Weight of | Weight of | |
|---|---|---|---|
| Product | mogroside V | maltodextrin | Weight of |
| No. | 20 (g) | (g) | water (g) |
| 24-01 | 40 | 33 | 400 |

### Example 25. Preparation of Maillard Reaction Product GMGV20-MRP-Tangerine Using GMGV20 (Product of Example 24), Fructose and Glutamic Acid

Materials: GMGV20 (Product of Example 24),
Process: 18 g of GMGV20, 1 g glutamic acid, 1 g fructose were mixed and dissolved into 10 g deionized water. The mixture solution was then heated to and maintained at 100° C. for 90 minutes. When the reaction was completed, the solution was then filtered through filter paper and the filtrate was dried with a spray drier. Resulting in about 16 g of GMGV20-MRP-Tangerine as powder.

### Example 26. GMGV20-MRP-Tangerine Improved the Taste Profile of Reb D Solution

Materials: 1)GMGV20-MRP-Tangerine: product of Example 25, 2) Reb D: available from Sweet Green Fields, Lot #: 478/38/70, the content of Reb D is no less than 95%
Process: GMGV50-MRP-Tangerine (product of Example 25 citric acid and Reb D weighed, mixed, dissolved in 100 mL pure water as set forth in Table 26-1, and subjected to sensory evaluation tests according to the evaluation mentioned in Example 4, the results of which are shown in Table 26-2.

TABLE 26-1
Sample composition

| | The ratio | | | | |
|---|---|---|---|---|---|
| | of Reb | Weight | | Weight of | Volume |
| | D to | of | Weight | GMGV20- | of |
| | GMGV20- | citric | of | MRP- | pure |
| | MRP- | acid | Reb | Tangerine | water |
| No. | Tangerine | (mg) | D (mg) | (mg) | (mL) |
| 12-00 | 200/0 | 75 | 20 | 0 | 100 |
| 12-01 | 200/10 | 75 | 20 | 1 | 100 |
| 12-02 | 200/20 | 75 | 20 | 2 | 100 |
| 12-03 | 200/50 | 75 | 20 | 5 | 100 |
| 12-04 | 200/200 | 75 | 20 | 20 | 100 |
| 12-05 | 200/400 | 75 | 20 | 40 | 100 |
| 12-06 | 200/800 | 75 | 20 | 80 | 100 |
| 12-07 | 200/2000 | 75 | 20 | 200 | 100 |

Experiment: Several mixtures of GMGV20-MRP-Tangerine (product of Example 25) and 200 ppm RD solution were prepared and evaluated according to the sensory evaluation standard in Example 4. Average scores from the test panel for each sensory criterion were taken as the evaluation test results. The taste profiles of the resulting beverage product samples are based on the sensory criteria in Example 4.

TABLE 26-2
Sensory evaluation results.

| Sample | | | | |
|---|---|---|---|---|
| mixture | Sweetness | Sweet | Metallic | Overall |
| No. | onset | lingering | aftertaste | likability |
| 26-00 | 2.5 | 4 | 4 | 2 |
| 26-01 | 2.5 | 3.5 | 3.5 | 2.5 |
| 26-02 | 2.5 | 3.5 | 3.5 | 2.5 |
| 26-03 | 3 | 3 | 3.5 | 3 |
| 26-04 | 3 | 2 | 2.5 | 3.5 |
| 26-05 | 3 | 2.5 | 2.5 | 3 |
| 26-06 | 3 | 2.5 | 3 | 3 |
| 26-07 | 3 | 3 | 3 | 3 |

Conclusion: The results show that GMGV20-MRP-Tangerine could significantly reduce the unpleasant sweet linger, metallic aftertaste, and quicken sweetness onset of 200 ppm RD solution. This effect was observed in all the tested GMGV20-MRP-Tangerine-to-RD ratios mentioned in the tables above. The effect can be extended to the GMGV20-MRP-Tangerine-to-RD ratio range of 99:1 to 1:99. This example demonstrates that GMGV50-MRPs prepared with monk fruit extract with less mogroside V content can improve the taste profile, cut sweet linger, reduce the metallic aftertaste while quickening the sweetness onset of the RD solutions. This effect can be extended to GMGV50-MRPs prepared with different raw materials such as mogroside V 10%, mogroside V 40%, mogroside V 80% etc.

### Example 27. Preparation of GMGV50-MRP-Lemon Using GMGV50, Fructose, Glutamic Acid, and Essential Oil

Raw material: 1) GMGV50: available from EPC Natural Products Co., Ltd, lot #: 315-13-3, the content of remaining mogroside V is no more than 20%.
2) Essential oil: Lemon Juice Aroma Extract: available from Chongqing Zhengyuan Flavor Co., Ltd., Lot #: Y0034434.
Process: GMGV50, fructose, glutamic acid, essential oil/essence, and water were weighed as follows (Table 27-1). The solution was then heated at about 100° C. for 2 hours. When the reaction was completed, the solution was filtered through filter paper and the filtrate was dried with a spray dryer, thereby resulting in product as off-white powder.

TABLE 27-1
Sample composition

| Weight of | Weight of | Weight of | | |
|---|---|---|---|---|
| GMGV50 | fructose | glutamic | Weight of | Weight of essential |
| (g) | (g) | acid(g) | water(mL) | oil/essence(mL) |
| 27 | 2.25 | 0.75 | 15 | Lemon Juice Aroma |
| | | | | Extract/0.5mL |

### Example 28. GMGV50-MRP-Lemon (Product of Example 27) Improved the Taste Profile of Flavored Carbonated Beverage

Materials: 1) GMGV50-MRP-Lemon (product of Example 27)
2) Commercial flavored carbonated beverage: Fanta Zero Calorie Orange Flavored Soda.
Beverage type: flavored carbonated beverage.
Main ingredients: water, food additives (carbon dioxide, citric acid, aspartame (contains phenylalanine), sodium benzoate, acesulfame-K, sucralose, Sunset Yellow FCF, tartrazine), food flavoring.
   Available from: COFCO COCA-COLA Beverages (Beijing) Ltd.

### Lot #: 0646BJ06.

Process: Powdered GMGV50-MRP-Lemon (product of Example 27) was weighed and dissolved in the selected Fanta Orange carbonated beverage outlined in Table 28-1 below.

TABLE 28-1
Sample Composition

| | Weight of | Volume | Concentration |
|---|---|---|---|
| | GMGV50- | of selected | of GMGV50- |
| | MRP- | beverage | MRP- |
| Sample | Lemon (mg) | (ml) | Lemon (ppm) |
| Base | — | 100 | — |
| 28-01 | 5 | 100 | 50 |

Experiment: The mixture sample was evaluated according to the sensory evaluation method in Example 4. Average score from the test panel for each sensory criterion were recorded as the sensory evaluation results to produce the following taste profile depicted in Table 28-2.

TABLE 28-2
Sensory evaluation results

| | Overall | | |
|---|---|---|---|
| | likability | Freshness | Flavor |
| Base | 3 | 3 | 3 |
| 28-01 | 4 | 4.5 | 3.5 |

Conclusion: GMGV50-MRP-Lemon (product of Example 27) enhanced the orange flavor while enhanced the freshness of the orange flavored carbonated beverage, resulting in an improved overall likability of the beverage. The results showed that glycosylated mogroside-based Maillard reaction products with the addition of essential oil/essence can improve the taste profile of orange flavored carbonated beverages. The effect can be extended to other carbonated beverages with other flavors, such as lemon, passionfruit etc.

### Example 29. Sensory Evaluation of GMG-MRPs

### Materials: Provided by EPC Natural Products Co., Ltd.

GMG-MRP-Caramel, Part #315-62-01;
GMG-MRP-Honey, Part #315-62-02;
GMG-MRP-Popcorn, Part #315-62-03;
GMG-MRP-Tangerine, Part #315-62-04;
Concentrations of GMG-MRPs to reach sweetness of a 3%-4% sucrose solution

Test design: Different solutions of GMG-MRPs were made. The solutions were compared to sucrose solutions in concentrations from 0% to 4%. The target was to find out the right amount to reach the same maximum sweetness as the reference solutions. All samples were prepared in distilled water.

Results: The results are summarized in Table 29.1.

TABLE 29-1
Concentrations of GMG-MRPs to reach sweetness of a 3%-4% sucrose solution

| | Concentration [ppm] | | | | | | |
|---|---|---|---|---|---|---|---|
| Sample | 50 | 75 | 100 | 125 | 150 | 175 | 200 |
| GMG- | neutral | slight | slight | slight | slight | slight | slight |
| MRP- | flavor, | caramel | caramel | caramel | caramel | caramel | caramel |
| Caramel | neutral | flavor, | flavor, | flavor, | flavor, | flavor, | flavor, |
| | taste, | neutral | slight | slight | slight | slight | slight |
| | no | taste, | caramel | caramel | caramel | caramel | caramel |
| | lingering | no | aftertaste, | aftertaste, | aftertaste, | aftertaste, | aftertaste, |
| | | lingering | no | no | no | no | no |
| | | | lingering | lingering | lingering | lingering | lingering |
| SE | 0 | 0.3 | 0.6 | 0.9 | 1.2 | 1.5 | 1.8 |
| GMG- | neutral | neutral | neutral | neutral | slight | slight | slight |
| MRP- | flavor, | flavor, | flavor, | flavor, | flowery | flowery | flowery |
| Honey | neutral | neutral | slight | slight | flavor, | flavor, | flavor, |
| | taste, | taste, | flowery | flowery | slight | slight | slight |
| | no | no | aftertaste, | aftertaste, | flowery | flowery | flowery |
| | lingering | lingering | no | no | aftertaste, | aftertaste, | aftertaste, |
| | | | lingering | lingering | no | no | no |
| | | | | | lingering | lingering | lingering |
| SE | 0 | 0.3 | 0.6 | 0.9 | 1.2 | 1.5 | 1.8 |
| GMG- | neutral | neutral | neutral | neutral | slight | slight | slight |
| MRP- | flavor, | flavor, | flavor, | flavor, | popcorn | popcorn | popcorn |
| Popcorn | neutral | neutral | slight | slight | flavor, | flavor, | flavor, |
| | taste, | taste, | popcorn | popcorn | slight | slight | slight |
| | no | no | aftertaste, | aftertaste, | popcorn | popcorn | popcorn |
| | lingering | lingering | no | no | aftertaste, | aftertaste, | aftertaste, |
| | | | lingering | lingering | no | no | no |
| | | | | | lingering | lingering | lingering |
| SE | 0 | 0.3 | 0.6 | 0.9 | 1.2 | 1.5 | 1.8 |
| GMG- | neutral | neutral | neutral | neutral | neutral | neutral | neutral |
| MRP- | flavor, | flavor, | flavor, | flavor, | flavor, | flavor, | flavor, |
| Tangerine | neutral | neutral | neutral | neutral | neutral | neutral | neutral |
| | taste, | taste, | taste, | taste, | taste, | taste, | taste, |
| | no | no | no | no | no | no | no |
| | lingering | lingering | lingering | lingering | lingering | lingering | lingering |
| SE | 0 | 0.3 | 0.6 | 0.9 | 1.2 | 1.5 | 1.8 |

| | Concentration [ppm] | | | | | |
|---|---|---|---|---|---|---|
| Sample | 250 | 300 | 350 | 400 | 450 | 500 |
| GMG- | caramel | caramel | caramel | caramel | caramel | caramel |
| MRP- | flavor, | flavor, | flavor, | flavor, | flavor, | flavor, |
| Caramel | slight | slight | slight | slight | slight | slight |
| | caramel | caramel | caramel | caramel | caramel | caramel |
| | aftertaste, | aftertaste, | aftertaste, | aftertaste, | aftertaste, | aftertaste, |
| | no | slight | slight | slight | slight | slight |
| | lingering | lingering | lingering | lingering | lingering | lingering |
| SE | 2.1 | 2.4 | 2.7 | 3 | 3.3 | 3.5 |
| GMG- | flowery | flowery | flowery | flowery | flowery | flowery |
| MRP- | flavor, | flavor, | flavor, | flavor, | flavor, | flavor, |
| Honey | flowery | flowery | flowery | flowery | flowery | flowery |
| | aftertaste, | aftertaste, | aftertaste, | aftertaste, | aftertaste, | aftertaste, |
| | no | slight | slight | no | slight | slight |
| | lingering | lingering | lingering | lingering | lingering | lingering |
| SE | 2.1 | 2.4 | 2.7 | 3 | 3.3 | 3.5 |
| GMG- | popcorn | popcorn | popcorn | popcorn | popcorn | popcorn |
| MRP- | flavor, | flavor, | flavor, | flavor, | flavor, | flavor, |
| Popcorn | popcorn | popcorn | popcorn | popcorn | popcorn | popcorn |
| | aftertaste, | aftertaste, | aftertaste, | aftertaste, | aftertaste, | aftertaste, |
| | no | slight | slight | slight | slight | slight |
| | lingering | lingering | lingering | lingering | lingering | lingering |
| SE | 2.1 | 2.4 | 2.7 | 3 | 3.3 | 3.5 |
| GMG- | neutral | neutral | neutral | neutral | neutral | neutral |
| MRP- | flavor, | flavor, | flavor, | flavor, | flavor, | flavor, |
| Tangerine | neutral | neutral | neutral | neutral | neutral | neutral |
| | taste, | taste, | taste, | taste, | taste, | taste, |
| | no | slight | slight | slight | slight | slight |
| | lingering | lingering | lingering | lingering | lingering | lingering |
| SE | 2.1 | 2.4 | 2.7 | 3 | 3.3 | 3.5 |

Conclusion: When using GMG-MRP Below 175 ppm, it could be excellent flavor or flavor modifying products as per FEMA GRAS regulation. When using GMP-MRP below 250 ppm, it could be used as sweetening agent without lingering.

### Example 30. Sensory Evaluation of GMG-MRPs

### 1. Principle of Sensory Tasting: Testing Sensory Attributes

Before tasting the tasters are discussing the upcoming series of samples and taste regular samples (without added GMG MRPs) to find a common sense of the description. Thereafter the flavor is tasted at the use level to find a common sense on how to describe the flavors (taste, smell, intensity).

Then the “trained” tasters (4-5) are tasting blinded and independently all samples of a series. They are allowed to re-taste and are making notes for the sensory attributes perceived.

In the last step the attributes noted are discussed openly to find a compromise description. In case that more than 1 taster disagrees with the compromise, the tasting is repeated.

### 2. Sensory Evaluation of GMG MRPs in Iced Tea

Materials: Black tea extract, kwl, Ref Nr: K245856;
27102 Citric acid monohydrate gritty, puriss, Lot 60960, Riedel-de Haen;
01602636 Peach Aroma, Akras Flavours GmbH;
Steviol glycoside RA 50, Lot #20180823-1;
GMG-MRP-Caramel, Part #315-62-01;
GMG-MRP-Honey, Part #315-62-02;
GMG-MRP-Popcorn, Part #315-62-03;
GMG-MRP-Tangerine, Part #315-62-04, Part #315-62-04
Test design: To perform the test a self-prepared iced tea with peach flavor was used.

### Basic Iced Tea Recipe

| Ingredients | | 100% sugar | 50 % sugar |
|---|---|---|---|
| Black tea extract | [g/L] | 2 | 2 |
| Sucrose | [g/L] | 70 | 35 |
| 01602636 Peach flavor | [μl/L] | 100 | 100 |
| Citric acid monohydrate | [g/L] | 1.5 | 1.5 |

The reference sample contains 7 g sugar per 100 ml, the test sample 3.5 g per 100 ml. The test compositions and results are shown in Table 30-1.

TABLE 30-1

| | Black | | | | GMG- | GMG- | GMG- | GMG- | |
|---|---|---|---|---|---|---|---|---|---|
| | tea | | Citric | | MRP- | MRP- | MRP- | MRP- | |
| | extract | Sugar | acid | RA 50 | Caramel | Honey | Popcorn | Tangerine | |
| | [g/L] | [g/L] | [g/L] | [mg/L] | [mg/L] | [mg/L] | [mg/L] | [mg/L] | Sensory evaluation |
| 100% sugar | 2 | 70 | 1.5 | | | | | | Peach flavor, sweet, only sweet, pleasant, sweet, |
| | | | | | | | | | and sour |
| 50% sugar | 2 | 35 | 1.5 | 165 | | | | | Slow onset of sweetness, similar sweet to 100% |
| | | | | | | | | | sugar, sweet lingering aftertaste, less peach |
| | | | | | | | | | flavor |
| 50% sugar | 2 | 35 | 1.5 | 110 | 130 | | | | Quick sweetness onset, reduced lingering |
| | | | | | | | | | aftertaste, enhanced peach flavor |
| 50% sugar | 2 | 35 | 1.5 | 130 | 110 | | | | Quick sweetness onset, no lingering, enhanced |
| | | | | | | | | | peach flavor, overall taste similar to 100% sugar |
| 50% sugar | 2 | 35 | 1.5 | 110 | | 130 | | | Quick sweetness onset, reduced lingering |
| | | | | | | | | | aftertaste, enhanced peach flavor |
| 50% sugar | 2 | 35 | 1.5 | 130 | | 110 | | | Quick sweetness onset, no lingering, enhanced |
| | | | | | | | | | peach flavor, overall taste similar to 100% sugar |
| 50% sugar | 2 | 35 | 1.5 | 110 | | | 130 | | Quick sweetness onset, reduced lingering |
| | | | | | | | | | aftertaste, enhanced peach flavor |
| 50% sugar | 2 | 35 | 1.5 | 130 | | | 110 | | Quick sweetness onset, no lingering, enhanced |
| | | | | | | | | | peach flavor, overall taste similar to 100% sugar |
| 50% sugar | 2 | 35 | 1.5 | 110 | | | | 130 | Quick sweetness onset, reduced lingering |
| | | | | | | | | | aftertaste, enhanced peach flavor |
| 50% sugar | 2 | 35 | 1.5 | 130 | | | | 110 | Quick sweetness onset, no lingering, enhanced |
| | | | | | | | | | peach flavor, overall taste similar to 100% sugar |

Conclusion: Adding GMG-MRP could significantly improve the taste temporal profile of stevia glycosides contained beverage such as improvement on quick sweetness onset, reduction of lingering and enhance the flavor. The added amount could be extended from 1 ppm to 500 ppm depends on optimized requirement of overall flavor profile.

### 3. Sensory Evaluation of GMG-MRPs in Lemon Beverage

Materials: 100% lemon juice, Alnatura, 09.09.2021 03:56 8369;
Steviol glycoside RA 50, Lot #20180823-1;
GMG-MRP-Caramel, Part #315-62-01;
GMG-MRP-Honey, Part #315-62-02;
GMG-MRP-Popcorn, Part #315-62-03;
GMG-MRP-Tangerine, Part #315-62-04

Test design: To perform the test a self-prepared lemonade drink was used. The 100% direct lemon juice “Alnatura” was diluted 1:5 with water and to the obtained drink 6% of sugar was added. This sample was used as a control sample. The test sample contained 3 g sugar per 100 ml. The sensory evaluation consisted of comparable sweetness, flavor, and acidity intensity (each test sample compared to control). The test compositions and results are show in Table 30-2.

TABLE 30-2

| | | | GMG- | GMG- | GMG- | GMG- | |
|---|---|---|---|---|---|---|---|
| | | | MRP- | MRP- | MRP- | MRP- | |
| | Sugar | RA 50 | Caramel | Honey | Popcorn | Tangerine | |
| | [g/L] | [mg/L] | [mg/L] | [mg/L] | [mg/L] | [mg/L] | Sensory evaluation |
| 100% sugar | 60 | | | | | | Refreshing lemon flavor, acidic, astringent, quick onset of |
| | | | | | | | acidity |
| 50% sugar | 30 | 170 | | | | | Slow onset of sweetness, similar sweet to 100% sugar, |
| | | | | | | | sweet lingering aftertaste, less acidic, less lemon flavor |
| 50% sugar | 30 | 150 | 120 | | | | Quick sweetness onset, reduced lingering aftertaste, less |
| | | | | | | | acidic, smoother, enhanced lemon flavor |
| 50% sugar | 30 | 120 | 150 | | | | Quick sweetness onset, no lingering, enhanced lemon |
| | | | | | | | flavor, less acidic, smoother, overall taste similar to 100% |
| | | | | | | | sugar |
| 50% sugar | 30 | 150 | | 120 | | | Quick sweetness onset, reduced lingering aftertaste, less |
| | | | | | | | acidic, smoother, enhanced lemon flavor |
| 50% sugar | 30 | 120 | | 150 | | | Quick sweetness onset, no lingering, less acidic, smoother, |
| | | | | | | | enhanced lemon flavor with slight flowery notes, taste |
| | | | | | | | similar to 100% sugar |
| 50% sugar | 30 | 150 | | | 120 | | Quick sweetness onset, reduced lingering aftertaste, less |
| | | | | | | | acidic, smoother, enhanced lemon flavor |
| 50% sugar | 30 | 120 | | | 150 | | Quick sweetness onset, no lingering, enhanced lemon |
| | | | | | | | flavor, less acidic, smoother, overall taste similar to 100% |
| | | | | | | | sugar |
| 50% sugar | 30 | 150 | | | | 120 | Quick sweetness onset, reduced lingering aftertaste, less |
| | | | | | | | acidic, smoother, enhanced lemon flavor |
| 50% sugar | 30 | 120 | | | | 150 | Quick sweetness onset, no lingering, less acidic, smoother |
| | | | | | | | enhanced lemon flavor, overall taste similar to 100% sugar |

Conclusion: Adding GMG-MRP in lemon flavor beverage containing stevia glycosides could improve its quick sweetness onset, reduce the lingering and acidity, and enhance the lemon flavor. The added amount would be extended to 1 ppm to 500 ppm depends on optimized requirement of overall taste and flavor profile. The flavor could be extended to any other flavors used in consumables.

1. A OMG-MRP composition prepared from a Maillard reaction mixture comprising one or more glycosylated mogrosides (GMGs) and/or glycosylated monk fruit extracts (GMEs).

2.-5. (canceled)

6. The composition of claim 1, wherein the one or more GMGs and/or GMEs comprise mono-glycosylated mogrosides in an amount less than 40%, 30%, 20%, 15%, 12%, 10%, 8%, 6%, 4% or 2% by weight of the total glycosylated mogrosides.

7. The composition of claim 1, wherein the one or more GMGs and/or GMEs comprise mono-glycosylated mogrosides in an amount greater than 1%, 2%, 5%, 10%, 15%, 20%, 25%, 30%, 35%, 40%, 45%, 50%, 55% or 60% by weight of the total glycosylated mogrosides.

8. The composition of claim 1, wherein the one or more GMGs and/or GMEs comprise bi-glycosylated mogrosides in an amount less than 30%, 20%, 15%, 12%, 10%, 8%, 6%, 4% or 2% by weight of the total glycosylated mogrosides.

9. The composition of claim 1, wherein the one or more GMGs and/or GMEs comprise bi-glycosylated mogrosides in an amount greater than 1%, 2%, 5%, 5%, 10%, 15%, 20%, 25%, 30%, 35%, 40%, 45% or 50% by weight of the total glycosylated mogrosides.

10. The composition of claim 1, wherein the one or more glycosylated mogrosides comprise tri-glycosylated mogrosides in an amount less than 20%, 15%, 12%, 10%, 8%, 6%, 4% or 2% by weight of the total glycosylated mogrosides.

11. The composition of claim 1, wherein the one or more glycosylated mogrosides comprise tri-glycosylated mogrosides in an amount greater than 1%, 2%, 5%, 5%, 10%, 15%, 20%, 25%, 30%, 35% or 40% by weight of the total glycosylated mogrosides.

12. The composition of claim 1, wherein the one or more glycosylated mogrosides comprise tetra-glycosylated mogrosides in an amount less than 15%, 12%, 10%, 8%, 6%, 4% or 2% by weight of the total glycosylated mogrosides.

13. The composition of claim 1, wherein the one or more glycosylated mogrosides comprise tetra-glycosylated mogrosides in an amount greater than 1%, 2%, 5%, 5%, 10%, 15%, 20%, 25% or 30% by weight of the total glycosylated mogrosides.

14. The composition of claim 1, wherein the one or more glycosylated mogrosides comprise mono-glycosylated mogrosides, bi-glycosylated mogrosides and tri-glycosylated mogrosides and tetra-glycosylated mogrosides in a total amount of less than 60%, 50%, 40%, 30% 20% or 10% by weight of the total glycosylated mogrosides.

15. The composition of claim 1, wherein the one or more glycosylated mogrosides comprise mono-glycosylated mogrosides, bi-glycosylated mogrosides and tri-glycosylated mogrosides and tetra-glycosylated mogrosides in a total amount of greater than 10%, 15%, 20%, 25%, 30%, 35%, 40%, 45%, 50%, 55%, 60%, 65%, 70%, 75%, 80%, 85%, 90% or 95% by weight of the total glycosylated mogrosides.

16. The composition of claim 1, wherein the GMG-MRP composition is prepared from a Maillard reaction mixture comprising a reducing sugar, an amine donor, and one or more glycosylated mogrosides.

17. The composition of claim 16, wherein the composition is a tangerine flavored GMG-MRP composition prepared from a Maillard reaction mixture comprising glutamic acid, fructose, and one or more glycosylated mogrosides.

18. The composition of claim 16, wherein the composition is a caramel flavored GMG-MRP composition prepared from a Maillard reaction mixture comprising alanine, xylose, and one or more glycosylated mogrosides.

19. The composition of claim 16, wherein the composition is a popcorn flavored GMG-MRP composition prepared from a Maillard reaction mixture comprising proline, rhamnose, and one or more glycosylated mogrosides.

20. The composition of claim 16, wherein the composition is a honey flavored GMG-MRP composition prepared from a Maillard reaction mixture comprising phenylalanine, xylose, and one or more glycosylated mogrosides.

21.-23. (canceled)

24. A consumable product, comprising the GMG-MRP composition of claim 1 in a final concentration in the range of 1-15,000 ppm.

25.-27. (canceled)

28. A method for modifying the taste profile of a consumable product, comprising adding to the consumable product one or more GMG-MRPs at a final concentration ranging from 0.0001 wt % to 90 wt %.

29. The method of claim 28, wherein the consumable product is a beverage product.

30. The method of claim 29, wherein the one or more GMG-MRPs are added to the beverage product in a final concentration range of 1-15,000 ppm.
